(19) United States
(12) Patent Application Publication
(10) Pub. No.: US 2025/0238768 A1
(43) Pub. Date: Jul. 24, 2025

(54) ASSET LIFE CYCLE OPTIMIZATION SYSTEMS AND METHODS

(71) Applicant: The Equity Technology Group, Inc., Shaker Heights, OH (US)

(72) Inventors: Charles Panzarella, Concord Township, OH (US); Aaron Joseph Stenta, Brockway, PA (US); David A. Osage, Shaker Heights, OH (US)

(21) Appl. No.: 19/033,030

(22) Filed: Jan. 21, 2025

Related U.S. Application Data
(60) Provisional application No. 63/623,475, filed on Jan. 22, 2024.
(60) Provisional application No. 63/676,717, filed on Jul. 29, 2024.

(51) Int. Cl. G06Q 10/20; G06Q 10/0635

(52) U.S. Cl. CPC G06Q 10/20; G06Q 10/0635

(57) ABSTRACT

Systems and methods for asset life cycle optimization and management are provided. A probabilistic, physics-based, causal method for predicting the evolution of damage and failure time of an aging asset. The method comprises providing a probabilistic, physics-based, causal network, comprising a plurality of random-variable nodes, wherein the nodes represent at least one of: damage initiation time, damage state, damage rate, damage causal factors, observations, human expert knowledge, failure state, and failure time. The method further comprises applying the probabilistic physics-based causal network to an aging asset; predicting the evolution of damage and failure time of the aging asset; and using this knowledge to make optimal design, inspection, maintenance, and operational life cycle decisions for the aging asset.

### CROSS-REFERENCE TO RELATED APPLICATIONS

This application claims the benefit of and priority to U.S. Provisional Application No. 63/623,475, filed Jan. 22, 2024, and U.S. Provisional Application No. 63/676,717, filed Jul. 29, 2024, each of the above-mentioned disclosures being hereby incorporated by reference in their entirety.

### FIELD

The present disclosure relates generally to systems and methods for life cycle optimization, and more particularly to systems and methods for life cycle optimization of aging assets.

### BACKGROUND

Industries with aging assets face significant asset management challenges, especially when balancing the benefits of operation with the costs of maintenance and unexpected failures. With vast infrastructures, it is often financially infeasible to inspect and maintain all assets all the time. Thus, companies rely on prioritizing inspection and maintenance activities with limited budgets. Such prioritizations have traditionally relied on suboptimal fixed time intervals, constant and deterministic damage-based thresholds, or at best, risk-based methods like the American Petroleum Institute Recommended Practices (“API RP”) such as API RP 581. Improvements are needed to overcome the many limitations of traditional methods in order to provide optimal solutions.

In addition to inspection and maintenance, a further challenge includes making design and operational decisions throughout the aging asset's life cycle in order to maximize return on investment (ROI). Often, a tradeoff exists between increasing production and the higher damage rates that accompany such increased production. Finding the optimal life cycle decision strategy that balances increased production against increased wear and tear on aging assets is not obvious, and as a result, the industry needs improved methods for aging asset life cycle optimization.

Another challenge is properly accounting for all uncertainties associated with the time-evolution of damage and dynamic operations. Traditional methods rely on having specific and accurate knowledge—however, that specific and accurate knowledge often is not readily available, thus creating a scenario where decisions must be made with uncertainty. Such uncertainties cannot be ignored, and new methods and systems are needed that incorporate such uncertainties into aging asset life cycle optimization.

Moreover, traditional methods suffer from the challenge of not having a system that is dynamic and that responds to changing circumstances as soon as such circumstances arise. Traditional methods do not encompass systems that respond to changing circumstances in real-time, such as by incorporating real-time information from streaming operations, process, and inspection sensor data. Thus, a need exists for asset management systems that are capable of processing information as soon as the information is acquired, notifying the user of any urgent issues, and recommending the best course of action to take in response.

### SUMMARY

In an embodiment, the subject matter of the disclosure is directed to a probabilistic, physics-based, causal method for predicting the evolution of damage and failure time of an aging asset. The method comprises: providing a probabilistic, physics-based, causal network, comprising a plurality of random-variable nodes, wherein the nodes represent at least one of: damage initiation time, damage state, damage rate, damage causal factors, observations, human expert knowledge, failure state, and failure time; applying the probabilistic physics-based causal network to an aging asset; and predicting the evolution of damage and failure time of the aging asset.

In an aspect of the method, each node in the plurality of random-variable nodes comprises one or more probabilistic states representing discrete numerical values, continuous numerical ranges, or categorical values.

In an aspect of the method, the aging asset comprises: one or more aging components; and zero or more aging damage barriers that are used to inhibit aging of the components.

In an aspect of the method, the aging asset, aging components, and aging damage barriers are aging due to the evolution of damage over time from one or more damage mechanisms resulting in one or more damage defects.

In an aspect of the method, the evolution of damage over time is represented by a time-dependent, spatial distribution of damage comprising one or more damage-state nodes at one or more locations on the aging components.

In an aspect of the method, wherein time-dependent state probabilities of one or more damage-state nodes depend on one or more damage-initiation-time nodes and one or more damage-rate nodes.

In an aspect of the method, wherein the one or more damage-initiation-time nodes and the one or more damage-rate nodes depend on zero or more damage causal factor nodes.

In an aspect of the method, the failure time node comprises an aging asset failure time node, an aging component failure time node, or an aging damage barrier failure time node, wherein the failure time node comprises states representing discretized time intervals with the probability of each state being the probability that failure occurs during that time interval.

In an aspect of the method, the probability of failure (POF) of the aging asset, aging component, or aging damage barrier during a time interval is the probability that a failure state condition is met during the time interval, wherein the failure state condition depends on the state probabilities of one or more damage-state nodes.

In an aspect of the method, the failure time of the aging asset comprises a minimum failure time selected from failure times of the aging components.

In an aspect of the method, the failure of the aging damage barrier influences the one or more damage-initiation time nodes and damage-rate nodes.

In an aspect of the method, the damage causal factor nodes comprise: physical, mechanical, chemical, and thermodynamic properties of the aging asset, aging components, and aging damage barriers; or physical, mechanical, chemical, and thermodynamic properties of an environment that the aging asset, aging components, and aging damage barriers are exposed to; or planned actions that alter physical, mechanical, chemical, or thermodynamic properties of the aging asset, aging components, aging damage barriers, or a combination thereof, or environment of the aging asset, aging components, aging damage barriers, or a combination thereof; or unplanned events that alter physical, mechanical, chemical, or thermodynamic properties of the aging asset, aging components, aging damage barriers, or a combination thereof, or environment of the aging asset, aging components, aging damage barriers, or a combination thereof; or any combination thereof.

In an aspect of the method, the observation nodes comprise observations of one or more damage causal factor nodes, one or more damage state nodes, or one or more failure time nodes.

In an aspect of the method, the observations are gathered using detection or measuring methods by a mechanical device or human, at one or more points in time.

In an aspect, the method further comprises a time node and an uncertainty node for each observation.

In an aspect of the method, the human expert knowledge nodes comprise knowledge about one or more damage causal factor nodes, one or more damage state nodes, one or more damage-initiation-time nodes, one or more damage-rate nodes, or one or more failure time nodes.

In an aspect, the method further comprises an error, variance, or confidence node representing a confidence in the human expert knowledge.

In an aspect of the method, the probabilistic, physics-based, causal network infers the state probabilities of nodes in the network from state probabilities set on other nodes in the network.

In an aspect, the method further comprises extending the probabilistic, physics-based, causal network to comprise a plurality of decision nodes representing decisions that affect the state probabilities of random-variable nodes in the network.

In an aspect of the method, the extended probabilistic, physics-based, causal network comprises a plurality of utility nodes representing conditional costs and benefits of decision nodes and random-variables nodes in the network.

In an aspect, the method further comprises using the extended probabilistic, physics-based, causal network for optimizing aging asset life cycle management decision strategies for future actions by maximizing a total expected utility or a time-averaged expected utility.

In an aspect, the method further comprises inspection effectiveness methods, comprising using one or more causal networks to account for measurement error, probability of detection, coverage area, or any combination thereof.

In an aspect, the method further comprises blending multiple knowledge sources, wherein multiple knowledge sources comprise two or more of: physics-based model predictions; observations; human expert knowledge; or any combination thereof.

In an aspect, the method further comprises sharing knowledge across a plurality of aging assets, from a plurality of facilities, from a plurality of industries, or any combination thereof.

In an aspect of the method, the aging asset further comprises: damage from one or more damage mechanisms; one or more flaws; failure due to one or more failure modes; or any combination thereof.

In an aspect of the method, the aging asset damage mechanisms comprise low temperature corrosion, high temperature corrosion, environmental corrosion, corrosion under insulation, contact point corrosion, microbiological corrosion, flow-induced corrosion, soil corrosion, low-cycle fatigue, high-cycle fatigue, vibration fatigue, crack initiation, crack growth, stress corrosion cracking, embrittlement, fracture, metallurgical attack, creep, high temperature hydrogen attack, other mechanical damage mechanisms, other chemical damage mechanisms, other electrochemical damage mechanisms, or any combination thereof.

In an aspect, the method further comprises extreme value analysis (EVA) methods comprising: using one or more causal methods to account for aging assets with complicated failure modes that have limited physics-based, predictive model availability.

In an aspect of the method, the EVA methods comprise: defining a probability of failure (POF) of the aging asset in terms of an applicable EVA cumulative distribution function (CDF); defining a corresponding probability density function (PDF) in terms of physics-based damage causal factors; updating the PDF in real-time from observations comprising field data, inspection data, maintenance data, leaks, failures, other observations, or any combination thereof and from leveraging observation data from other aging assets; using the updated PDF to predict an aging asset damage state; and using the updated CDF to predict an aging asset failure-time.

In an aspect, the method further comprises analytical and numerical solution procedures, or any combination thereof, wherein the analytical and numerical solution procedures are used for compilation, inference, and prediction, or any combination thereof.

In an aspect, the method further comprises analytical and numerical solution procedures, or any combination thereof, wherein the analytical and numerical solution procedures are used for decision strategy optimization.

In an aspect of the method, the aging asset comprises: an insulated aging asset; an uninsulated aging asset; a piping system, one or more pipes, one or more piping components, or any combination thereof; a pressure vessel, a tower, a vessel, a drum, a tank, other fixed equipment, or any combination thereof; a heat exchanger, cooler, heater, boiler, other heat transfer equipment, or any combination thereof; a compressor, pump, turbine, other rotating equipment, or any combination thereof; a pressure relief system, pressure relief valve, pressure relief device, or any combination thereof; or any combination thereof.

In an aspect, the method further comprises using the extended probabilistic, physics-based, causal network for risk-based inspection and maintenance planning comprising: determining a consequences of failure (COF) including liquid fluid release and gas fluid release; defining the COF as financial or non-financial and as absolute cost or relative cost; calculating a time-dependent risk profile by multiplying the COF and POF; simulating all inspection and maintenance strategies to determine a corresponding risk reduction before and after each strategy, and at all possible times being considered; and performing facility-wide life cycle optimization to determine optimal asset inspection and maintenance decision strategies to maximize a facility-wide return on investment (ROI).

In an aspect of the method, the risk-based inspection and maintenance planning methods comprise determining the optimal inspection frequency, inspection technique, inspection location, inspection coverage area, other prescriptive inspection guidance, maintenance frequency, maintenance technique, maintenance location, other prescriptive maintenance guidance, or any combination thereof.

In an aspect, the method further comprises using the extended probabilistic, physics-based, causal network for condition monitoring location (CML) optimization comprising: accounting for all CML inspection techniques including ultrasonic testing, radiographic testing, visual inspection, pulsed eddy current testing, magnetic flux testing, other non-destructive testing techniques, or any combination thereof; promoting CMLs to damage management locations (DML) once damage is detected; further assessing a failure state of the detected damage via applicable fitness for service assessments; simulating all inspection strategies, at all CMLs, to determine corresponding risk reduction before and after each strategy, at all CMLs, and at all possible times being considered; and performing CML optimization to determine an optimal CML inspection strategy that maximizes a facility-wide ROI. In an aspect, the fitness for service assessments comprise finite element analysis, other advanced analysis, or any combination thereof.

In an aspect of the method, the CML optimization methods comprise determining optimal CML inspection frequency, CML inspection technique, CML inspection location, CML inspection coverage area, other prescriptive CML inspection guidance, or any combination thereof.

In an aspect, the method further comprises combining probabilistic, physics-based, causal methods with statistical and data analysis methods for artificial intelligence (AI), comprising: pre-processing raw data and observations by leveraging statistical and data analysis methods for AI for classification, clustering, trending, fitting, feature extraction, other data analysis techniques, or any combination thereof; and using the pre-processed raw data and extracted features as inputs to the probabilistic, physics-based, causal methods.

In an embodiment, the subject matter of the disclosure is directed to a system for predicting the evolution of damage and failure time of an aging asset. The system comprises: an aging asset; a display output device for displaying output and visualization data for asset life cycle optimization of the aging asset; a user input device for receiving input from a user during analysis of the aging asset; and a remote web server in communication with the display output device and the user input device. The remote web server comprises: a processor; and a computer-readable memory in communication with the processor, the computer-readable memory storing instructions for generating probabilistic, physics-based, causal networks, that when executed by the processor, direct the processor to: provide a probabilistic, physics-based, causal network, comprising a plurality of random-variable nodes, wherein the nodes represent at least one of: damage initiation time, damage state, damage rate, damage causal factors, observations, human expert knowledge, failure state, and failure time; apply the probabilistic physics-based causal network to an aging asset; and predict the evolution of damage and failure time of the aging asset.

In an aspect of the system, the system comprises an application programming interface (API) and uses web-based cloud storage.

In an aspect of the system, the Application Programming Interface (API) is in communication with a user API for a local, on-premises user system.

In an aspect of the system, each node in the plurality of random-variable nodes comprises one or more probabilistic states representing discrete numerical values, continuous numerical ranges, or categorical values.

In an aspect of the system, the aging asset comprises: one or more aging components; and zero or more aging damage barriers that are used to inhibit aging of the components.

In an aspect of the system, the aging asset, aging components, and aging damage barriers are aging due to the evolution of damage over time from one or more damage mechanisms resulting in one or more damage defects.

In an aspect of the system, the evolution of damage over time is represented by a time-dependent, spatial distribution of damage comprising one or more damage-state nodes at one or more locations on the aging components.

In an aspect of the system, time-dependent state probabilities of one or more damage-state nodes depend on one or more damage-initiation-time nodes and one or more damage-rate nodes.

In an aspect of the system, the one or more damage-initiation-time nodes and the one or more damage-rate nodes depend on zero or more damage causal factor nodes.

In an aspect of the system, the failure time node comprises an aging asset failure time node, an aging component failure time node, or an aging damage barrier failure time node, wherein the failure time node comprises states representing discretized time intervals with the probability of each state being the probability that failure occurs during that time interval.

In an aspect of the system, the POF of the aging asset, aging component, or aging damage barrier during a time interval is the probability that a failure state condition is met during the time interval, wherein the failure state condition depends on the state probabilities of one or more damage-state nodes.

In an aspect of the system, the failure time of the aging asset comprises a minimum failure time selected from failure times of the aging components.

In an aspect of the system, the failure of the aging damage barrier influences the one or more damage-initiation time nodes and damage-rate nodes.

In an aspect of the system, the damage causal factor nodes comprise: physical, mechanical, chemical, and thermodynamic properties of the aging asset, aging components, and aging damage barriers; or physical, mechanical, chemical, and thermodynamic properties of an environment that the aging asset, aging components, and aging damage barriers are exposed to; or planned actions that alter physical, mechanical, chemical, or thermodynamic properties of the aging asset, aging components, aging damage barriers, or a combination thereof, or environment of the aging asset, aging components, aging damage barriers, or a combination thereof; or unplanned events that alter physical, mechanical, chemical, or thermodynamic properties of the aging asset, aging components, aging damage barriers, or a combination thereof, or environment of the aging asset, aging components, aging damage barriers, or a combination thereof; or any combination thereof.

In an aspect of the system, the observation nodes comprise observations of one or more damage causal factor nodes, one or more damage state nodes, or one or more failure time nodes.

In an aspect of the system, the observations are gathered using detection or measuring methods by a mechanical device or human, at one or more points in time.

In an aspect, the system further comprises a time node and an uncertainty node for each observation.

In an aspect of the system, the human expert knowledge nodes comprise knowledge about one or more damage causal factor nodes, one or more damage state nodes, one or more damage-initiation-time nodes, one or more damage-rate nodes, or one or more failure time nodes.

In an aspect of the system, the system further comprises an error, variance, or confidence node representing a confidence in the human expert knowledge.

In an aspect of the system, the probabilistic, physics-based, causal network infers the state probabilities of nodes in the network from state probabilities set on other nodes in the network.

In an aspect, use of the system performs a method comprising extending the probabilistic, physics-based, causal network to comprise a plurality of decision nodes representing decisions that affect the state probabilities of random-variable nodes in the network.

In an aspect of the system, the extended probabilistic, physics-based, causal network comprises a plurality of utility nodes representing conditional costs and benefits of decision nodes and random-variables nodes in the network.

In an aspect, use of the system performs a method comprising using the extended probabilistic, physics-based, causal network for optimizing aging asset life cycle management decision strategies for future actions by maximizing a total expected utility or a time-averaged expected utility.

In an aspect, use of the system performs a method comprising inspection effectiveness methods, comprising using one or more causal networks to account for measurement error, probability of detection, coverage area, or any combination thereof.

In an aspect, use of the system performs a method comprising blending multiple knowledge sources, wherein multiple knowledge sources comprise two or more of: physics-based model predictions; observations; human expert knowledge; or any combination thereof.

In an aspect, use of the system performs a method comprising sharing knowledge across a plurality of aging assets, from a plurality of facilities, from a plurality of industries, or any combination thereof.

In an aspect of the system, the aging asset further comprises: damage from one or more damage mechanisms; one or more flaws; failure due to one or more failure modes; or any combination thereof.

In an aspect of the system, the aging asset damage mechanisms comprise low temperature corrosion, high temperature corrosion, environmental corrosion, corrosion under insulation, contact point corrosion, microbiological corrosion, flow-induced corrosion, soil corrosion, low-cycle fatigue, high-cycle fatigue, vibration fatigue, crack initiation, crack growth, stress corrosion cracking, embrittlement, fracture, metallurgical attack, creep, high temperature hydrogen attack, other mechanical damage mechanisms, other chemical damage mechanisms, other electrochemical damage mechanisms, or any combination thereof.

In an aspect, use of the system performs a method comprising EVA methods comprising: using one or more causal methods to account for aging assets with complicated failure modes that have limited physics-based, predictive model availability.

In an aspect of the system, the EVA methods comprise: defining a probability of failure (POF) of the aging asset in terms of an applicable EVA CDF; defining a corresponding PDF in terms of physics-based damage causal factors; updating the PDF in real-time from observations comprising field data, inspection data, maintenance data, leaks, failures, other observations, or any combination thereof and from leveraging observation data from other aging assets; using the updated PDF to predict an aging asset damage state; and using the updated CDF to predict an aging asset failure-time.

In an aspect, use of the system performs a method comprising analytical and numerical solution procedures, or any combination thereof, wherein the analytical and numerical solution procedures are used for compilation, inference, and prediction, or any combination thereof.

In an aspect, use of the system performs a method comprising analytical and numerical solution procedures, or any combination thereof, wherein the analytical and numerical solution procedures are used for decision strategy optimization.

In an aspect of the system, the aging asset comprises: an insulated aging asset; an uninsulated aging asset; a piping system, one or more pipes, one or more piping components, or any combination thereof; a pressure vessel, a tower, a vessel, a drum, a tank, other fixed equipment, or any combination thereof; a heat exchanger, cooler, heater, boiler, other heat transfer equipment, or any combination thereof; a compressor, pump, turbine, other rotating equipment, or any combination thereof; a pressure relief system, pressure relief valve, pressure relief device, or any combination thereof; or any combination thereof.

In an aspect, use of the system performs a method comprising using the extended probabilistic, physics-based, causal network for risk-based inspection and maintenance planning comprising: determining a COF including liquid fluid release and gas fluid release; defining the COF as financial or non-financial and as absolute cost or relative cost; calculating a time-dependent risk profile by multiplying the COF and POF; simulating all inspection and maintenance strategies to determine a corresponding risk reduction before and after each strategy, and at all possible times being considered; and performing facility-wide life cycle optimization to determine optimal asset inspection and maintenance decision strategies to maximize a facility-wide ROI.

In an aspect of the system, the risk-based inspection and maintenance planning comprises determining the optimal inspection frequency, inspection technique, inspection location, inspection coverage area, other prescriptive inspection guidance, maintenance frequency, maintenance technique, maintenance location, other prescriptive maintenance guidance, or any combination thereof.

In an aspect, use of the system performs a method comprising using the extended probabilistic, physics-based, causal network for CML optimization comprising: accounting for all CML inspection techniques including ultrasonic testing, radiographic testing, visual inspection, pulsed eddy current testing, magnetic flux testing, other non-destructive testing techniques, or any combination thereof; promoting CMLs to DMLs once damage is detected; further assessing a failure state of the detected damage via applicable fitness for service assessments; simulating all inspection strategies, at all CMLs, to determine corresponding risk reduction before and after each strategy, at all CMLs, and at all possible times being considered; and performing CML optimization to determine an optimal CML inspection strategy that maximizes a facility-wide ROI. In an aspect, the fitness for service assessments comprise finite element analysis, other advanced analysis, or any combination thereof.

In an aspect of the system, the CML optimization methods comprise determining optimal CML inspection frequency, CML inspection technique, CML inspection location, CML inspection coverage area, other prescriptive CML inspection guidance, or any combination thereof.

In an aspect, use of the system performs a method comprising combining probabilistic, physics-based, causal methods with statistical and data analysis methods for AI, comprising: pre-processing raw data and observations by leveraging statistical and data analysis methods for AI for classification, clustering, trending, fitting, feature extraction, other data analysis techniques, or any combination thereof; and using the pre-processed raw data and extracted features as inputs to the probabilistic, physics-based, causal methods.

### BRIEF DESCRIPTION OF THE DRAWINGS

FIG. 1 shows a graph illustrating the determination of optimal spend on inspection and maintenance to maximize the total return on investment (total benefits minus total costs).

FIG. 2 shows a diagram illustrating the various stages of an aging asset life cycle.

FIG. 3 shows a sample output of an image where a condition monitoring location (CML) is promoted to a damage management location (DML) and analyzed via a fitness-for-service (FFS) assessment from using the systems and methods described herein.

FIG. 4 shows a sample architecture for the asset life cycle optimization system, deployed as a fully cloud-native system according to an embodiment of the disclosure.

FIG. 5 shows a sample architecture for the asset life cycle optimization system when deployed with a secondary on-premises system to accommodate site authentication concerns according to an embodiment of the disclosure.

FIG. 6A shows a sample asset life cycle optimization configurable dashboard according to an embodiment of the disclosure.

FIG. 6B shows a sample asset life cycle optimization configurable dashboard according to an embodiment of the disclosure.

FIG. 7 shows a sample modal dialog on the asset life cycle optimization dashboard for adding new widgets to the dashboard that can be expanded and configured according to an embodiment of the disclosure.

FIG. 8A shows a workflow to set up the system according to an embodiment of the disclosure.

FIG. 8B shows a secondary workflow to use the already configured system according to an embodiment of the disclosure.

FIG. 9 shows an illustration of the primary functions of the asset life cycle optimization system and its dynamic and continuously learning nature according to an embodiment of the disclosure.

FIG. 10 shows a sample output of the systems and methods described herein, showing a damage-centric 3D digital twin for the asset life cycle optimization system.

FIG. 11A shows a simplified view of an example probabilistic, causal network according to an embodiment of the disclosure.

FIG. 11B shows a detailed view of the example probabilistic, causal network of FIG. 11A with no evidence set.

FIG. 12A shows a simplified view of an example causal network according to an embodiment of the disclosure.

FIG. 12B shows a detailed view of the sample causal network of FIG. 12A illustrating all core components including random-variable nodes with evidence set or not set, decision nodes, and utility nodes.

FIG. 13A shows a workflow or process for using a probabilistic causal network including compilation operations according to an embodiment of the disclosure.

FIG. 13B shows a workflow or process for using a probabilistic causal network including updating evidence operations according to an embodiment of the disclosure.

FIG. 13C shows a workflow or process for using a probabilistic causal network including alternate inference operations according to an embodiment of the disclosure.

FIG. 14A shows a sample causal network for predicting corrosion rate due to sulfidation corrosion according to an embodiment of the disclosure.

FIG. 14B shows a sample causal network for predicting corrosion rate due to naphthenic acid corrosion according to an embodiment of the disclosure.

FIG. 15A shows a simplified view of a probabilistic causal network according to an embodiment of the disclosure.

FIG. 15B shows a detailed view of the probabilistic causal network of FIG. 15A that predicts the failure time probability distribution of some asset based upon a predicted damage (corrosion) rate and other variables that represent the initial damage state, the damage rate, and the critical damage state at which failure is assumed to occur.

FIG. 16A shows a simplified view of a sample network according to an embodiment of the disclosure.

FIG. 16B shows a detailed view of the sample network of FIG. 16A illustrating how the predictive corrosion rate and failure time are used to determine the optimal choice for the replacement time as well as how the physics-based model predictions are blended with an expert opinion and a measured thickness.

FIG. 17 shows an illustration representing blending of the three main sources of knowledge that needs to happen in order to arrive at a single source of truth for any observable quantity.

FIG. 18 shows a schematic representation of a general-purpose probabilistic causal network used for blending one or more model predictions, one or more expert opinions, and one or more measurements (or other observations).

FIG. 19A shows a simplified view of a sample causal network according to an embodiment of the disclosure.

FIG. 19B shows a detailed view of the sample causal network of FIG. 19A illustrating the blending of multiple knowledge sources (model predictions, measurements, and expert opinions) to arrive at a sole source of truth for the corrosion rate.

FIG. 20 shows a schematic for a general-purpose probabilistic, causal network used to pool data together from different facilities operating under nearly identical conditions to arrive at a single, universal source of truth for whatever random-variable is desired.

FIG. 21A shows a probabilistic, causal network used for optimal decision making for inspection and replacement according to an embodiment of the disclosure.

FIG. 21B shows a probabilistic, causal network used for optimal decision making for inspection and replacement according to an embodiment of the disclosure.

FIG. 21C shows a probabilistic, causal network used for optimal decision making for inspection and replacement according to an embodiment of the disclosure.

FIG. 21D shows a probabilistic, causal network used for optimal decision making for inspection and replacement according to an embodiment of the disclosure.

FIG. 21E shows a probabilistic, causal network used for optimal decision making for inspection and replacement according to an embodiment of the disclosure.

FIG. 21F shows a probabilistic, causal network used for optimal decision making for inspection and replacement according to an embodiment of the disclosure.

FIG. 22A shows a sample network illustrating a temperature measurement process with no evidence set according to an embodiment of the disclosure.

FIG. 22B shows a sample network illustrating a temperature measurement process with evidence set according to an embodiment of the disclosure.

FIG. 23A shows a simplified view of a modified sizing inspection network according to an embodiment of the disclosure.

FIG. 23B shows a detailed view of the modified sizing inspection network of FIG. 23A.

FIG. 23C shows a graph of probability distribution function using the modified sizing inspection network of FIG. 23B to account for the scenario where multiple measurements are taken in the field but only the minimum value is recorded.

FIG. 24A shows a simplified view of a sample network for outlier detection according to an embodiment of the disclosure.

FIG. 24B shows a detailed view of the sample network of FIG. 24A for outlier detection according to an embodiment of the disclosure.

FIG. 25 shows a sample network illustrating how to account for probability of detection for various inspection techniques according to an embodiment of the disclosure.

FIG. 26A shows a simplified view of a sample network according to an embodiment of the disclosure.

FIG. 26B shows a detailed view of the sample network of FIG. 26A for calculating the various probability of correct and false detections needed to quantify a given inspection technique.

FIG. 26C shows a simplified view of a sample networking according to an embodiment of the disclosure.

FIG. 26D shows a detailed view of the sample network of FIG. 26C for calculating the various probability of correct and false detections needed to quantify a given inspection technique.

FIG. 27 shows a sample illustration of a long section of pipe with one area of damage and six randomly placed spot inspections.

FIG. 28A shows a sample coverage area network to calculate the probability of finding damage.

FIG. 28B shows a sample coverage area network to infer the probability of the damaged area given that no damage was found in 10 inspections.

FIG. 29 shows a sample network illustrating converting the probability of finding damage network into the probability of finding some number of damaged regions.

FIG. 30A shows a sample illustration of a long section of pipe with one area of damage and three randomly placed area-based inspections.

FIG. 30B shows a graphic depiction of the illustration in FIG. 30A for a long section of pipe with one area of damage and three randomly placed area-based inspections.

FIG. 31A shows a sample causal network for determining the number of damaged regions for area-based inspections.

FIG. 31B shows a sample causal network for determining the number of damaged regions for area-based inspections.

FIG. 32A shows a graph of sample probability distributions for the failure time before an event/action and the failure time after an event/action.

FIG. 32B shows a graph of a sample probability distribution for resulting life extension distribution.

FIG. 33 shows a sample causal network to determine the probabilistic life extension distribution from the failure time distributions before and after some random event occurs (like an accident, storm or human error) or some deliberate action is taken (like planned inspection or maintenance).

FIG. 34A shows a simplified view of a sample decision causal network according to an embodiment of the disclosure.

FIG. 34B shows a detailed view of the sample decision causal network of FIG. 34A to illustrate determining the optimal maintenance strategy when the failure time distributions before and after each event are known.

FIG. 35 shows a sample network illustrating multiple failure modes or damage mechanisms (DMs) per component, multiple components per asset, multiple assets per unit, and multiple units per plant.

FIG. 36 shows a simplified decision network for intrusive inspections that is used to illustrate methods for creating decision maps according to an embodiment of the disclosure.

FIG. 37A shows a decision map created using the network of FIG. 36 for the cost of inspection versus the cost of failure when the prior probability of having local corrosion is 50% and failure costs up to $400,000 are considered.

FIG. 37B shows a decision map created using the network of FIG. 36 for the cost of inspection versus the cost of failure when the prior probability of having local corrosion is 50% and the upper bound for failure costs is reduced to $5,000.

FIG. 38A shows a decision map created using the network of FIG. 36 for the cost of inspection versus the cost of failure when the prior probability of having local corrosion is 25%, and failure costs up to $400,000 are considered.

FIG. 38B shows a decision map created using the network of FIG. 36 for the cost of inspection versus the cost of failure when the prior probability of having local corrosion is 25%, and the upper bound for failure costs is reduced to $5,000.

FIG. 39A shows output of a causal extreme value analysis (EVA) method according to an embodiment of the disclosure for partial coverage inspections applied to a heat exchanger showing the resulting minimum thickness distribution function plotted on linearized Gumbel paper.

FIG. 39B shows output of a causal EVA method according to an embodiment of the disclosure for partial coverage inspections applied to a heat exchanger showing the resulting maximum wall loss cumulative distribution function plotted on linearized Gumbel paper.

FIG. 40 shows output of a causal EVA method according to an embodiment of the disclosure for partial coverage inspections applied to a heat exchanger showing the resulting maximum wall loss cumulative distribution function plotted as probability vs wall loss, and including the resulting hierarchical causal method output table with summary statistics for model parameters.

FIG. 41A shows a sample output from a causal updating methodology according to an embodiment of the disclosure applied to pressure relief devices.

FIG. 41B shows a sample output from a causal updating methodology according to an embodiment of the disclosure applied to pressure relief devices.

FIG. 42A shows a sample output from the causal updating method according to an embodiment of the disclosure for pressure relief devices (PRDs) with a single overhaul event at 6 years.

FIG. 42B shows a sample output from the causal updating method according to an embodiment of the disclosure for PRDs with a single overhaul event at 6 years.

FIG. 43A shows a sample causal network according to an embodiment of the disclosure for predictive sulfidation method with prediction of corrosion rate.

FIG. 43B shows a sample causal network according to an embodiment of the disclosure for predictive sulfidation method with prediction of asset/component failure time.

FIG. 44A shows a sample output from predictive sulfidation causal network methods according to embodiments of the disclosure, namely the thickness projection.

FIG. 44B shows a sample output from predictive sulfidation causal network methods according to embodiments of the disclosure, namely the probability of failure (POF) curve.

FIG. 45A shows input sensor data samples for sulfidation corrosion from a temperature process sensor.

FIG. 45B shows input sensor data samples for sulfidation corrosion from an ultrasonic thickness (UT) inspection sensor.

FIG. 46 shows a sample causal network method according to an embodiment of the disclosure for ammonium chloride corrosion.

FIG. 47 shows a sample causal network according to an embodiment of the disclosure for learning the corrosion rate from a thickness measurement.

FIG. 48A shows a simplified view of a sample CML optimization network according to an embodiment of the disclosure.

FIG. 48B shows a detailed view of the sample CML optimization network of FIG. 48A.

FIG. 49 shows a model flowchart illustrating the probabilistic causal network method according to an embodiment of the disclosure developed for determining the damage rate and failure time distribution of the spent nuclear fuel (SNF) canisters subject to stress-corrosion-cracking (SCC).

FIG. 50A shows a simplified view of a sample replacement only life cycle decision network according to an embodiment of the disclosure.

FIG. 50B shows a detailed view of the sample replacement only life cycle decision network of FIG. 50A, wherein the network is for SNF application showing the failure time predicted from the core variables of the model.

FIG. 51A shows a simplified view of a corrosion under insulation (CUI) core causal network according to an embodiment of the disclosure.

FIG. 51B shows a detailed view of the CUI core causal network of FIG. 51A illustrating the four primary causal factor nodes needed to predict the component failure time.

FIG. 52 shows a simplified view of a CUI jacketing failure time causal network according to an embodiment of the disclosure illustrating the large collection of contextual information that can be used to predict and update the jacketing failure time.

FIG. 53 shows a sample stage 1 of 2 probabilistic network according to an embodiment of the disclosure used to perform maintenance strategy simulations and determine the resulting life extension and failure time before/after maintenance for all possible maintenance times.

FIG. 54 shows a sample stage 2 of 2 probabilistic decision network according to an embodiment of the disclosure used to determine the optimal maintenance strategy, for the strategy being considered, with the outputs from stage 1 used as inputs here.

FIG. 55 shows a sample causal network according to an embodiment of the disclosure for performing automated inspection grading given the key rule-based factors defined by the local thinning inspection effectiveness table.

### DETAILED DESCRIPTION

A need exists for systems and methods that overcome the many limitations of traditional methods of aging asset life cycle. As described herein, the present disclosure is directed to systems and methods which are fully probabilistic, dynamic, and continuously learn to provide real-time responses to challenges for the aging asset. Because the systems and methods continuously learn, share the learned knowledge across all facilities, and adapt to changing circumstances, the systems and methods allow for optimizing the expected return on investment (ROI) at every stage of the aging asset life cycle.

Traditional asset management methods typically use arbitrary static limits to trigger inspection and maintenance activities. Such methods are not dynamic and do not account for all sources of uncertainty (i.e., they are deterministic, qualitative, and not fully probabilistic). Moreover, traditional methods do not consider the costs of inspection and maintenance balanced against the risk reduction they provide to make cost-benefit based decisions. Further complicating the issue, each asset experiences unique internal and external damage mechanisms that are dynamically evolving. Without continuously learning real-time systems, industrial facilities often operate under conservative limits to prevent unexpected failures, leading to reduced asset utilization, unrealized profits, and more frequent costly shutdowns.

Some of the many factors that complicate this problem include: facilities have thousands of degrading assets of all types (e.g., vessels, tanks, pipes, pumps, compressors, machinery, structures, etc.); facilities have thousands of supplemental degrading systems (e.g., relief devices, insulation, coatings, cathodic protection systems, catalyst, etc.); each asset is subject to one or more damage mechanisms, many of which are dynamic and evolve over the asset life cycle (e.g., internal corrosion, external corrosion, cracking, etc.); companies have massive collections of operations/process and inspection/maintenance data that are not being fully utilized (i.e., sensor data is not connected to the predictive system and maintenance data is not digitized); there are many operations/process changes that can be made to manage and/or mitigate excessive damage where the effects of the changes are not holistically understood (e.g., temperature controls, feedstock selection, inhibitor and chemical injections, contaminant monitoring, etc.); material selection and mitigation strategies are unique to the specific system and how the facility operates; traditional code-based solutions are insufficient and result in excess spending for the user and/or unexpected failures/shutdowns; traditional code-based inspection and maintenance planning strategies do not correctly model inspection effectiveness and inspection coverage area; and traditional code-based inspection and maintenance planning strategies do not properly assess the financial benefits of inspection/maintenance in terms of their risk reduction (i.e., inspections and maintenance are only financially worthwhile if providing a risk reduction greater than the cost of the inspections and maintenance).

A prevalent traditional approach for prioritizing inspections of aging assets is Risk Based Inspection (RBI), with RBI typically implemented according to API RP 581. Although providing some benefit, RBI according to API RP 581 is not an effective solution, due to many known limitations and a high administrative overhead. Known limitations of traditional API RP 581 include: having an arbitrary risk target assigned as a threshold for triggering inspection activities; having a financial risk option that does not include the costs of inspection and maintenance, nor quantify the financial benefits of inspection and maintenance (i.e., risk reduction via variance reduction and life extension); being static in time and only evaluated at fixed turn-around frequencies; using crude damage factor-based probability of failure (POF) calculations that are not fully probabilistic; being a stand-alone inspection planning methodology with static inputs; and using arbitrary and subjective inspection effectiveness tables, while not being prescriptive enough with regards to inspection and maintenance recommendations per asset and per damage mechanism.

Other methods for asset management (i.e., primarily for inspection planning) traditionally rely on simpler approaches, such as API RP 580, API RP 510, American Society of Mechanical Engineers Post Construction Committee (“ASME PCC”) such as ASME PCC-3 Inspection Planning Using Risk Based Methods, and custom time or condition-based programs. Though such alternate approaches may provide companies with more flexibility, those approaches are not as effective as a full RBI implementation. These shortcomings highlight the need for a dynamic, probabilistic, and financially integrated approach to asset management and life cycle optimization.

The present subject matter is directed to a dynamic, probabilistic, and financially integrated approach for asset management and life cycle optimization that is rooted in probabilistic, physics-based, causal methods. The present approach offers a holistic solution to asset life cycle optimization that overcomes the shortcomings of traditional asset management methods. The present approach is a risk-based approach that is compliant with the less-restrictive codes such as API RP 580, API RP 510, and ASME PCC-3 and is more effective than traditional asset management methods, with less burden on company users.

The present approach also provides a solution that closes a critical gap in the industry due to the disjoint nature of life cycle management when it comes to design, operations, and maintenance. With traditional approaches, design, operations, and maintenance are often implemented as separate programs (i.e., separate from inspection prioritization of aging assets). In contrast, the present methods recognize design, operations, and maintenance as interrelated problems that are addressed holistically. As such, the present subject matter is directed to asset management and life cycle optimization systems and methods that are fully probabilistic and that perform financial-based facility-wide asset life cycle optimization for all life cycle stages.

The present asset management and life cycle optimization systems and methods integrate diverse data sources (e.g., process sensors, inspection sensors, lab samples, drone monitoring data, periodic inspection scans, maintenance events, etc.) with physics-based probabilistic models of all damage mechanisms, blended with subject matter expertise, to enable better automated decision-making. The system promotes proactive and informed industrial asset life cycle decision-making that optimizes Integrity Operating Windows (IOWs) and back-end maintenance functions to improve facility-wide reliability, safety, and profitability.

Value in using the present systems and methods for asset management and life cycle optimization is measured in terms of increased financial ROI (i.e., how much additional money the end-users are able to make, or save, by implementing the present systems and methods). In general, the ROI is defined as the total benefit minus the total cost. By using probabilistic, physics-based, causal methods for all aspects of financial-based life cycle optimization, the present systems and methods allow for end-users to receive the highest ROI for all asset integrity actions/decisions by maximizing production, reducing failure frequencies, improving inspection effectiveness, identifying and mitigating risks more accurately, connecting process data to the integrity management system (which are traditionally kept separate), and, overall, determining optimal operational strategies. Supplemental benefits, such as reducing insurance premiums, are also possible. The present systems and methods for asset management and life cycle optimization cover all aspects of the facility life cycle, from cost of ownership down to specific inspection coverage and device selection needs for a given asset at a turn-around and everything in-between. The present systems and methods allow a facility to maximize production while also maintaining mechanical integrity.

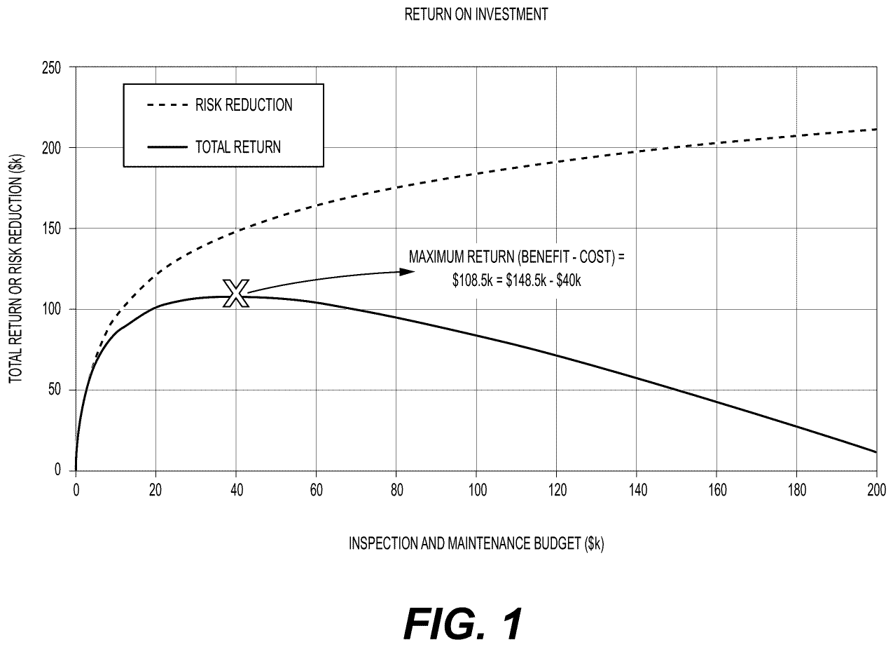

FIG. 1 shows a graph illustrating the determination of optimal spend on inspection and maintenance to maximize the total ROI (total benefits minus total costs). This illustrative example for generally finding the optimal inspection and maintenance budget that yields the maximum ROI, which is represented in FIG. 1 as the difference between the risk reduction resulting from inspection and maintenance and its cost. The risk reduction (dashed line) and total return (solid line) are measured along the y-axis (with units depicted in thousands of USD) while the budget for inspection and maintenance is measured along the x-axis (with units depicted in thousands of USD). In general, more risk reduction is achieved by a larger spend on inspection and maintenance, but there is a point of diminishing returns, as shown by the leveling off of the risk reduction curve at the largest spends. As indicated by the X marker, the maximum ROI of $108,500 is achieved with an inspection and maintenance budget of $40,000.

### Asset Life Cycle Optimization

All industries manage the integrity of their aging assets to prevent unexpected failures. Examples of such industries include, but are not limited to, refining, upstream oil and gas, petrochemical, chemical, fertilizer, pharmaceutical, wind energy, pulp and paper, nuclear, other power, manufacturing, automotive, transportation, aviation, naval, defense, and public infrastructure. Unexpected failures may result in significant negative consequences such as, but not limited to, financial loss, environmental impact, personnel injury, equipment damage, production loss, legal actions, and reputation.

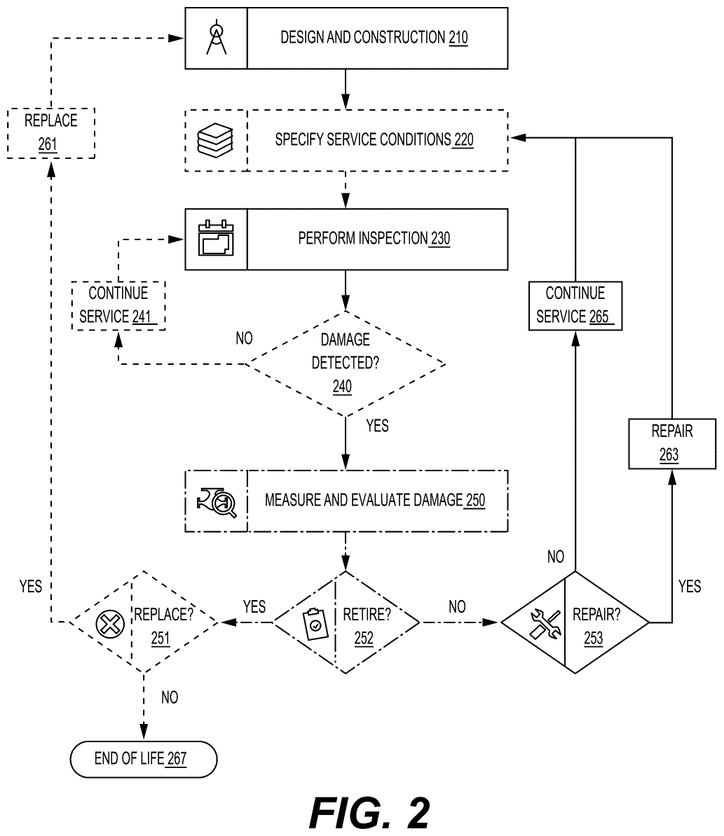

FIG. 2 shows a diagram illustrating the various stages of an aging asset life cycle. In particular, FIG. 2 illustrates a life cycle management process for aging assets according to embodiments of the disclosure. The primary stages of the life cycle of an aging asset comprise design, operation, inspection, maintenance, and end of life. Damage occurring during operation may be found by inspections and mitigated by maintenance. In the detailed life cycle management process shown in FIG. 2, the life cycle begins with the design and construction stage 210, during which the shape and material of all the asset components are selected and configured to perform the desired function, taking into consideration any anticipated damage that might arise while making these selections. This stage also includes procurement, licensing, and installation. After design and construction, the service conditions are established in the specify service conditions stage 220, including both operations (e.g., pressure, temperature, flow rate, etc.) and process (e.g., fluid chemistry, inhibitor injection, water wash injection, etc.). After this, the asset is put into service, at which point the primary potential for damage begins. This necessitates the stage of planning and performing inspections 230 at scheduled intervals with the intention of detecting any damage that might arise before it leads to serious consequences, thus leading to the damage detected stage 240. The timing and location of the inspections is based upon the anticipated rate and morphology of damage accumulation, which depends on the specific damage mechanism(s) expected as well as on the underlying risk of asset failure due to damage. If damage is not detected during the inspections, then the asset is allowed to continue service 241 until the next scheduled inspection. However, if damage is detected, then the method progresses to the measure and evaluate damage stage 250 where the damage may be measured via follow-up inspections and evaluated via a Fitness-For-Service (FFS) assessment (e.g., this FFS assessment is typically conducted according to the industry standard ASME/API RP 579-1). Depending on the result of this assessment, a decision is then made to replace 251 the asset and continue service (i.e., opting to replace 261 the asset and sending the process back to the design and construction stage 210), to repair 263 the damage and send the process back to the specify service conditions stage 220, opting not to repair the damage but continue service 265 with no further action (i.e., typical strategy if the damage is minimal), or retire 252 and not replace the asset and discontinue service (i.e., if this venture is no longer sufficiently profitable) leading to end of life 267. These decisions are often based on financial considerations, but when using traditional methods, there is no assurance that the best financial decision will be made.

The present systems and methods for asset management and life cycle optimization allow for users to make financially optimal decisions at every stage of the life cycle by either maximizing the ROI over a fixed period (e.g., yearly or between scheduled turnarounds) or over the asset's entire lifetime, which is variable and ends with the condition-based decision to either replace or retire the asset. Optimal decision strategies strike the right balance between increasing product yield (i.e., increasing revenue) without excessively increasing the damage rate. Nonlimiting examples of life cycle decision strategies include designating where to inspect, what inspection technique(s) to use, when to inspect, when to perform maintenance, what maintenance to perform, when maintenance is no longer viable and a replacement is more cost-effective, and when it is better to do nothing (i.e., make no changes and run the asset to failure).

### Asset Life Cycle Optimization Method

An embodiment of the disclosure is directed to a probabilistic, physics-based, causal method for predicting the evolution of damage and failure time of an aging asset. The method comprises: providing a probabilistic, physics-based, causal network, comprising a plurality of random-variable nodes, wherein the nodes represent at least one of: damage initiation time, damage state, damage rate, damage causal factors, observations, human expert knowledge, failure state, and failure time; applying the probabilistic physics-based causal network to an aging asset; and predicting the evolution of damage and failure time of the aging asset.

In an aspect of the method, each node in the plurality of random-variable nodes comprises one or more probabilistic states representing discrete numerical values, continuous numerical ranges, or categorical values.

In an aspect of the method, the aging asset comprises: one or more aging components; and zero or more aging damage barriers that are used to inhibit aging of the components.

In an aspect of the method, the aging asset, aging components, and aging damage barriers are aging due to the evolution of damage over time from one or more damage mechanisms resulting in one or more damage defects.

In an aspect of the method, the evolution of damage over time is represented by a time-dependent, spatial distribution of damage comprising one or more damage-state nodes at one or more locations on the aging components.

In an aspect of the method, wherein time-dependent state probabilities of one or more damage-state nodes depend on one or more damage-initiation-time nodes and one or more damage-rate nodes.

In an aspect of the method, wherein the one or more damage-initiation-time nodes and the one or more damage-rate nodes depend on zero or more damage causal factor nodes.

In an aspect of the method, the failure time node comprises an aging asset failure time node, an aging component failure time node, or an aging damage barrier failure time node, wherein the failure time node comprises states representing discretized time intervals with the probability of each state being the probability that failure occurs during that time interval.

In an aspect of the method, the probability of failure (POF) of the aging asset, aging component, or aging damage barrier during a time interval is the probability that a failure state condition is met during the time interval, wherein the failure state condition depends on the state probabilities of one or more damage-state nodes.

In an aspect of the method, the failure time of the aging asset comprises a minimum failure time selected from failure times of the aging components.

In an aspect of the method, the failure of the aging damage barrier influences the one or more damage-initiation time nodes and damage-rate nodes.

In an aspect of the method, the damage causal factor nodes comprise: physical, mechanical, chemical, and thermodynamic properties of the aging asset, aging components, and aging damage barriers; or physical, mechanical, chemical, and thermodynamic properties of an environment that the aging asset, aging components, and aging damage barriers are exposed to; or planned actions that alter physical, mechanical, chemical, or thermodynamic properties of the aging asset, aging components, aging damage barriers, or a combination thereof, or environment of the aging asset, aging components, aging damage barriers, or a combination thereof; or unplanned events that alter physical, mechanical, chemical, or thermodynamic properties of the aging asset, aging components, aging damage barriers, or a combination thereof, or environment of the aging asset, aging components, aging damage barriers, or a combination thereof; or any combination thereof.

In an aspect of the method, the observation nodes comprise observations of one or more damage causal factor nodes, one or more damage state nodes, or one or more failure time nodes.

In an aspect of the method, the observations are gathered using detection or measuring methods by a mechanical device or human, at one or more points in time.

In an aspect, the method further comprises a time node and an uncertainty node for each observation.

In an aspect of the method, the human expert knowledge nodes comprise knowledge about one or more damage causal factor nodes, one or more damage state nodes, one or more damage-initiation-time nodes, one or more damage-rate nodes, or one or more failure time nodes.

In an aspect, the method further comprises an error, variance, or confidence node representing a confidence in the human expert knowledge.

In an aspect of the method, the probabilistic, physics-based, causal network infers the state probabilities of nodes in the network from state probabilities set on other nodes in the network.

In an aspect, the method further comprises extending the probabilistic, physics-based, causal network to comprise a plurality of decision nodes representing decisions that affect the state probabilities of random-variable nodes in the network.

In an aspect of the method, the extended probabilistic, physics-based, causal network comprises a plurality of utility nodes representing conditional costs and benefits of decision nodes and random-variables nodes in the network.

In an aspect, the method further comprises using the extended probabilistic, physics-based, causal network for optimizing aging asset life cycle management decision strategies for future actions by maximizing a total expected utility or a time-averaged expected utility.

In an aspect, the method further comprises inspection effectiveness methods, comprising using one or more causal networks to account for measurement error, probability of detection, coverage area, or any combination thereof.

In an aspect, the method further comprises blending multiple knowledge sources, wherein multiple knowledge sources comprise two or more of: physics-based model predictions; observations; human expert knowledge; or any combination thereof.

In an aspect, the method further comprises sharing knowledge across a plurality of aging assets, from a plurality of facilities, from a plurality of industries, or any combination thereof.

In an aspect of the method, the aging asset further comprises: damage from one or more damage mechanisms; one or more flaws; failure due to one or more failure modes; or any combination thereof.

In an aspect of the method, the aging asset damage mechanisms comprise low temperature corrosion, high temperature corrosion, environmental corrosion, corrosion under insulation, contact point corrosion, microbiological corrosion, flow-induced corrosion, soil corrosion, low-cycle fatigue, high-cycle fatigue, vibration fatigue, crack initiation, crack growth, stress corrosion cracking, embrittlement, fracture, metallurgical attack, creep, high temperature hydrogen attack, other mechanical damage mechanisms, other chemical damage mechanisms, other electrochemical damage mechanisms, or any combination thereof.

In an aspect, the method further comprises extreme value analysis (EVA) methods comprising: using one or more causal methods to account for aging assets with complicated failure modes that have limited physics-based, predictive model availability.

In an aspect of the method, the EVA methods comprise: defining a POF of the aging asset in terms of an applicable EVA cumulative distribution function (CDF); defining a corresponding probability density function (PDF) in terms of physics-based damage causal factors; updating the PDF in real-time from observations comprising field data, inspection data, maintenance data, leaks, failures, other observations, or any combination thereof and from leveraging observation data from other aging assets; using the updated PDF to predict an aging asset damage state; and using the updated CDF to predict an aging asset failure-time.

In an aspect, the method further comprises analytical and numerical solution procedures, or any combination thereof, wherein the analytical and numerical solution procedures are used for compilation, inference, and prediction, or any combination thereof.

In an aspect, the method further comprises analytical and numerical solution procedures, or any combination thereof, wherein the analytical and numerical solution procedures are used for decision strategy optimization.

In an aspect of the method, the aging asset comprises: an insulated aging asset; an uninsulated aging asset; a piping system, one or more pipes, one or more piping components, or any combination thereof; a pressure vessel, a tower, a vessel, a drum, a tank, other fixed equipment, or any combination thereof; a heat exchanger, cooler, heater, boiler, other heat transfer equipment, or any combination thereof; a compressor, pump, turbine, other rotating equipment, or any combination thereof; a pressure relief system, pressure relief valve, pressure relief device, or any combination thereof; or any combination thereof.

In an aspect, the method further comprises using the extended probabilistic, physics-based, causal network for risk-based inspection and maintenance planning comprising: determining a consequences of failure (COF) including liquid fluid release and gas fluid release; defining the COF as financial or non-financial and as absolute cost or relative cost; calculating a time-dependent risk profile by multiplying the COF and POF; simulating all inspection and maintenance strategies to determine a corresponding risk reduction before and after each strategy, and at all possible times being considered; and performing facility-wide life cycle optimization to determine optimal asset inspection and maintenance decision strategies to maximize a facility-wide ROI.

In an aspect of the method, the risk-based inspection and maintenance planning methods comprise determining the optimal inspection frequency, inspection technique, inspection location, inspection coverage area, other prescriptive inspection guidance, maintenance frequency, maintenance technique, maintenance location, other prescriptive maintenance guidance, or any combination thereof.

In an aspect, the method further comprises using the extended probabilistic, physics-based, causal network for condition monitoring location (CML) optimization comprising: accounting for all CML inspection techniques including ultrasonic testing, radiographic testing, visual inspection, pulsed eddy current testing, magnetic flux testing, other non-destructive testing techniques, or any combination thereof; promoting CMLs to DMLs once damage is detected; further assessing a failure state of the detected damage via applicable fitness for service assessments; simulating all inspection strategies, at all CMLs, to determine corresponding risk reduction before and after each strategy, at all CMLs, and at all possible times being considered; and performing CML optimization to determine an optimal CML inspection strategy that maximizes a facility-wide ROI. In an aspect, the fitness for service assessments comprise finite element analysis, other advanced analysis, or any combination thereof.

In an aspect of the method, the CML optimization methods comprise determining optimal CML inspection frequency, CML inspection technique, CML inspection location, CML inspection coverage area, other prescriptive CML inspection guidance, or any combination thereof.

In an aspect, the method further comprises combining probabilistic, physics-based, causal methods with statistical and data analysis methods for artificial intelligence (AI), comprising: pre-processing raw data and observations by leveraging statistical and data analysis methods for AI for classification, clustering, trending, fitting, feature extraction, other data analysis techniques, or any combination thereof; and using the pre-processed raw data and extracted features as inputs to the probabilistic, physics-based, causal methods.

In an embodiment, the disclosure is directed to a system and method for asset life cycle optimization. The Asset Life Cycle Optimization Method described herein is probabilistic, financial-based, and accounts for all company, facility, and asset life cycle costs. The optimization is configurable to alternate non-financial units of measurement if necessary (e.g., to consider safety, environmental concerns, loss of human life, etc.). However, most business operations are financial in nature with the intention of operating the facility to maximize ROI. The present method is also configurable to perform constrained optimizations at any hierarchical asset level across the facility or organization. Examples of constrained optimization include: optimizing feedstock selection to maximize production throughput while minimizing asset integrity impact, assuming all other life cycle strategies are fixed; and conversely, optimizing asset inspection and maintenance activities without altering process or operations. Strategies and actions are prioritized based on cost versus benefit, taking into consideration any budgetary constraints. Regardless of whether the facility is interested in global unconstrained optimization or local constrained optimizations, the present methods provide a solution.

The present Asset Life Cycle Optimization Method overcomes the limitations of traditional asset management strategies such as qualitative methods that use condition-based or time-based inspection intervals and risk-based inspection. Specifically, the Asset Life Cycle Optimization Method is fully probabilistic; physics-based to account for all inherent uncertainties and the fundamental physical nature of aging asset damage and failure; removes arbitrary time or risk-based thresholds; performs full financial-based optimization, accounting for all decisions in the life cycle related to design, operations, inspections, maintenance, and mitigation; quantifies the effectiveness of inspection and maintenance activities; is dynamic and continuously learns as new data becomes available; accounts for multiple failure modes; allows for missing, incomplete, and uncertain input data; and blends knowledge from disparate sources.

As a subset of the present systems and method, in an embodiment, the disclosure is directed to a method of monitoring DMLs, which are locations where damage is detected after an inspection. The method expands upon the traditional concept of CMLs, which are locations that are monitored because damage is expected to arise at those locations but is not yet detected. The method comprises monitoring CMLs for damage. The method further comprises promoting a CML to a DML as soon as damage is detected. The presence of DMLs then comprises the method triggering the continued and recurrent use of FFS and other advanced assessments to determine a more accurate failure state for the aging asset, both at the present time and in the future.

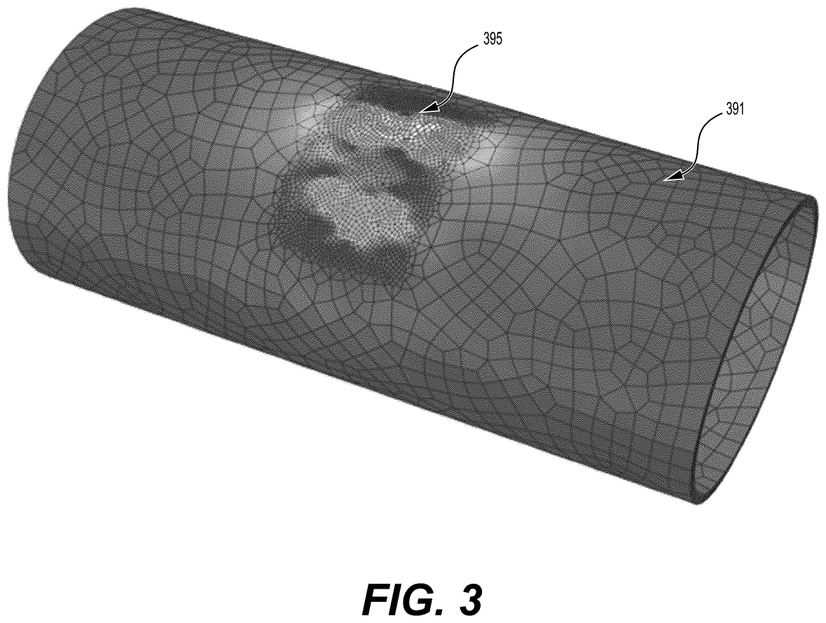

FIG. 3 shows an example of a result of the method of monitoring DMLs according to an embodiment of the disclosure, namely how local thinning damage 395 that is detected on a pipe 391 during a routine CML inspection is subsequently promoted to a DML. After the CML inspection promotes the DML, the method comprises further assessment. Here, the assessment comprised using a Level 3 FFS assessment that consists of a three-dimensional Finite Element Analysis (FEA), as defined by the industry standard approach in ASME/API RP 579-1 or similar. The local thinning damage 395 is illustrated by a greyscale gradient map representing the localized stresses in the pressurized pipe due to metal loss caused by corrosion (with the lightest grey indicating the highest stress and the darkest grey indicating the lowest stress). The numerical solution procedure involves sectioning the pipe geometry into a mesh of smaller elements, the boundaries of which are indicated by the black lines. To improve solution accuracy, the density of elements is increased in the more heavily damaged regions, which also coincides with the higher stresses. Some acceptance condition based on these elevated stresses is then used to determine whether this damage needs to be repaired right away or can be left alone until the next inspection, based upon predictions of how the damage might worsen over time.

### Asset Life Cycle Optimization System

The disclosure is directed to an enhanced Asset Life Cycle Optimization System for performing the Asset Life Cycle Optimization Method.

An embodiment of the disclosure is directed to a system for predicting the evolution of damage and failure time of an aging asset. The system comprises: an aging asset; a display output device for displaying output and visualization data for asset life cycle optimization of the aging asset; a user input device for receiving input from a user during analysis of the aging asset; and a remote web server in communication with the display output device and the user input device. The remote web server comprises: a processor; and a computer-readable memory in communication with the processor, the computer-readable memory storing instructions for generating probabilistic, physics-based, causal networks, that when executed by the processor, direct the processor to: provide a probabilistic, physics-based, causal network, comprising a plurality of random-variable nodes, wherein the nodes represent at least one of: damage initiation time, damage state, damage rate, damage causal factors, observations, human expert knowledge, failure state, and failure time; apply the probabilistic physics-based causal network to an aging asset; and predict the evolution of damage and failure time of the aging asset.

In an aspect of the system, the system comprises an application programming interface (API) and uses web-based cloud storage.

In an aspect of the system, the Application Programming Interface (API) is in communication with a user API for a local, on-premises user system.

In an aspect of the system, each node in the plurality of random-variable nodes comprises one or more probabilistic states representing discrete numerical values, continuous numerical ranges, or categorical values.

In an aspect of the system, the aging asset comprises: one or more aging components; and zero or more aging damage barriers that are used to inhibit aging of the components. In an aspect of the system, the aging asset, aging components, and aging damage barriers are aging due to the evolution of damage over time from one or more damage mechanisms resulting in one or more damage defects. In an aspect of the system, the evolution of damage over time is represented by a time-dependent, spatial distribution of damage comprising one or more damage-state nodes at one or more locations on the aging components. In an aspect of the system, time-dependent state probabilities of one or more damage-state nodes depend on one or more damage-initiation-time nodes and one or more damage-rate nodes.

In an aspect of the system, the one or more damage-initiation-time nodes and the one or more damage-rate nodes depend on zero or more damage causal factor nodes.

In an aspect of the system, the failure time node comprises an aging asset failure time node, an aging component failure time node, or an aging damage barrier failure time node, wherein the failure time node comprises states representing discretized time intervals with the probability of each state being the probability that failure occurs during that time interval.

In an aspect of the system, the POF of the aging asset, aging component, or aging damage barrier during a time interval is the probability that a failure state condition is met during the time interval, wherein the failure state condition depends on the state probabilities of one or more damage-state nodes.

In an aspect of the system, the failure time of the aging asset comprises a minimum failure time selected from failure times of the aging components.

In an aspect of the system, the failure of the aging damage barrier influences the one or more damage-initiation time nodes and damage-rate nodes.

In an aspect of the system, the damage causal factor nodes comprise: physical, mechanical, chemical, and thermodynamic properties of the aging asset, aging components, and aging damage barriers; or physical, mechanical, chemical, and thermodynamic properties of an environment that the aging asset, aging components, and aging damage barriers are exposed to; or planned actions that alter physical, mechanical, chemical, or thermodynamic properties of the aging asset, aging components, aging damage barriers, or a combination thereof, or environment of the aging asset, aging components, aging damage barriers, or a combination thereof; or unplanned events that alter physical, mechanical, chemical, or thermodynamic properties of the aging asset, aging components, aging damage barriers, or a combination thereof, or environment of the aging asset, aging components, aging damage barriers, or a combination thereof; or any combination thereof.

In an aspect of the system, the observation nodes comprise observations of one or more damage causal factor nodes, one or more damage state nodes, or one or more failure time nodes.

In an aspect of the system, the observations are gathered using detection or measuring methods by a mechanical device or human, at one or more points in time.

In an aspect, the system further comprises a time node and an uncertainty node for each observation.

In an aspect of the system, the human expert knowledge nodes comprise knowledge about one or more damage causal factor nodes, one or more damage state nodes, one or more damage-initiation-time nodes, one or more damage-rate nodes, or one or more failure time nodes.

In an aspect of the system, the system further comprises an error, variance, or confidence node representing a confidence in the human expert knowledge.

In an aspect of the system, the probabilistic, physics-based, causal network infers the state probabilities of nodes in the network from state probabilities set on other nodes in the network.

In an aspect, use of the system performs a method comprising extending the probabilistic, physics-based, causal network to comprise a plurality of decision nodes representing decisions that affect the state probabilities of random-variable nodes in the network.

In an aspect of the system, the extended probabilistic, physics-based, causal network comprises a plurality of utility nodes representing conditional costs and benefits of decision nodes and random-variables nodes in the network.

In an aspect, use of the system performs a method comprising using the extended probabilistic, physics-based, causal network for optimizing aging asset life cycle management decision strategies for future actions by maximizing a total expected utility or a time-averaged expected utility.

In an aspect, use of the system performs a method comprising inspection effectiveness methods, comprising using one or more causal networks to account for measurement error, probability of detection, coverage area, or any combination thereof.

In an aspect, use of the system performs a method comprising blending multiple knowledge sources, wherein multiple knowledge sources comprise two or more of: physics-based model predictions; observations; human expert knowledge; or any combination thereof.

In an aspect, use of the system performs a method comprising sharing knowledge across a plurality of aging assets, from a plurality of facilities, from a plurality of industries, or any combination thereof.

In an aspect of the system, the aging asset further comprises: damage from one or more damage mechanisms; one or more flaws; failure due to one or more failure modes; or any combination thereof.

In an aspect of the system, the aging asset damage mechanisms comprise low temperature corrosion, high temperature corrosion, environmental corrosion, corrosion under insulation, contact point corrosion, microbiological corrosion, flow-induced corrosion, soil corrosion, low-cycle fatigue, high-cycle fatigue, vibration fatigue, crack initiation, crack growth, stress corrosion cracking, embrittlement, fracture, metallurgical attack, creep, high temperature hydrogen attack, other mechanical damage mechanisms, other chemical damage mechanisms, other electrochemical damage mechanisms, or any combination thereof.

In an aspect, use of the system performs a method comprising extreme value analysis (EVA) methods comprising: using one or more causal methods to account for aging assets with complicated failure modes that have limited physics-based, predictive model availability.

In an aspect of the system, the EVA methods comprise: defining a POF of the aging asset in terms of an applicable EVA CDF; defining a corresponding PDF in terms of physics-based damage causal factors; updating the PDF in real-time from observations comprising field data, inspection data, maintenance data, leaks, failures, other observations, or any combination thereof and from leveraging observation data from other aging assets; using the updated PDF to predict an aging asset damage state; and using the updated CDF to predict an aging asset failure-time.

In an aspect, use of the system performs a method comprising analytical and numerical solution procedures, or any combination thereof, wherein the analytical and numerical solution procedures are used for compilation, inference, and prediction, or any combination thereof.

In an aspect, use of the system performs a method comprising analytical and numerical solution procedures, or any combination thereof, wherein the analytical and numerical solution procedures are used for decision strategy optimization.

In an aspect of the system, the aging asset comprises: an insulated aging asset; an uninsulated aging asset; a piping system, one or more pipes, one or more piping components, or any combination thereof; a pressure vessel, a tower, a vessel, a drum, a tank, other fixed equipment, or any combination thereof; a heat exchanger, cooler, heater, boiler, other heat transfer equipment, or any combination thereof; a compressor, pump, turbine, other rotating equipment, or any combination thereof; a pressure relief system, pressure relief valve, pressure relief device, or any combination thereof; or any combination thereof.

In an aspect, use of the system performs a method comprising using the extended probabilistic, physics-based, causal network for risk-based inspection and maintenance planning comprising: determining a COF including liquid fluid release and gas fluid release; defining the COF as financial or non-financial and as absolute cost or relative cost; calculating a time-dependent risk profile by multiplying the COF and POF; simulating all inspection and maintenance strategies to determine a corresponding risk reduction before and after each strategy, and at all possible times being considered; and performing facility-wide life cycle optimization to determine optimal asset inspection and maintenance decision strategies to maximize a facility-wide ROI.

In an aspect of the system, the risk-based inspection and maintenance planning comprises determining the optimal inspection frequency, inspection technique, inspection location, inspection coverage area, other prescriptive inspection guidance, maintenance frequency, maintenance technique, maintenance location, other prescriptive maintenance guidance, or any combination thereof.

In an aspect, use of the system performs a method comprising using the extended probabilistic, physics-based, causal network for CML optimization comprising: accounting for all CML inspection techniques including ultrasonic testing, radiographic testing, visual inspection, pulsed eddy current testing, magnetic flux testing, other non-destructive testing techniques, or any combination thereof; promoting CMLs to DMLs once damage is detected; further assessing a failure state of the detected damage via applicable fitness for service assessments; simulating all inspection strategies, at all CMLs, to determine corresponding risk reduction before and after each strategy, at all CMLs, and at all possible times being considered; and performing CML optimization to determine an optimal CML inspection strategy that maximizes a facility-wide ROI. In an aspect, the fitness for service assessments comprise finite element analysis, other advanced analysis, or any combination thereof.

In an aspect of the system, the CML optimization methods comprise determining optimal CML inspection frequency, CML inspection technique, CML inspection location, CML inspection coverage area, other prescriptive CML inspection guidance, or any combination thereof.

In an aspect, use of the system performs a method comprising combining probabilistic, physics-based, causal methods with statistical and data analysis methods for AI, comprising: pre-processing raw data and observations by leveraging statistical and data analysis methods for AI for classification, clustering, trending, fitting, feature extraction, other data analysis techniques, or any combination thereof; and using the pre-processed raw data and extracted features as inputs to the probabilistic, physics-based, causal methods.

In an embodiment, the present asset life cycle optimization system may be used as a standalone system, deployed at the time of installation of the asset in a facility. However, because nearly all facilities deploy an asset management system that serves as the master database for asset data (i.e., asset registry), it may be impractical to assume that the present Asset Life Cycle Optimization System would be considered for immediate replacement. This may be a future motivation, but not likely for initial installation of assets in a facility. In another embodiment, the present Asset Life Cycle Optimization System may be used as a layer on top of any such existing system(s), may be retrofittable to accommodate the plethora of existing system(s) available, and may be focused on providing enhanced probabilistic analysis and optimization rather than data management. The present system makes full use of all available knowledge and data and is fully dynamic to continuously update and learn as soon as new knowledge and data become available.

In an embodiment, the Asset Life Cycle Optimization System may be deployed on the cloud and may communicate with external systems via web-service application programming interfaces (APIs) to pull in data for analysis and optimization on-demand. Nonlimiting examples of common data that is pulled into the system for analysis and optimization include asset mechanical data, operating conditions, fluid properties, inspection and maintenance records, laboratory samples, and data from both process and inspection sensors.

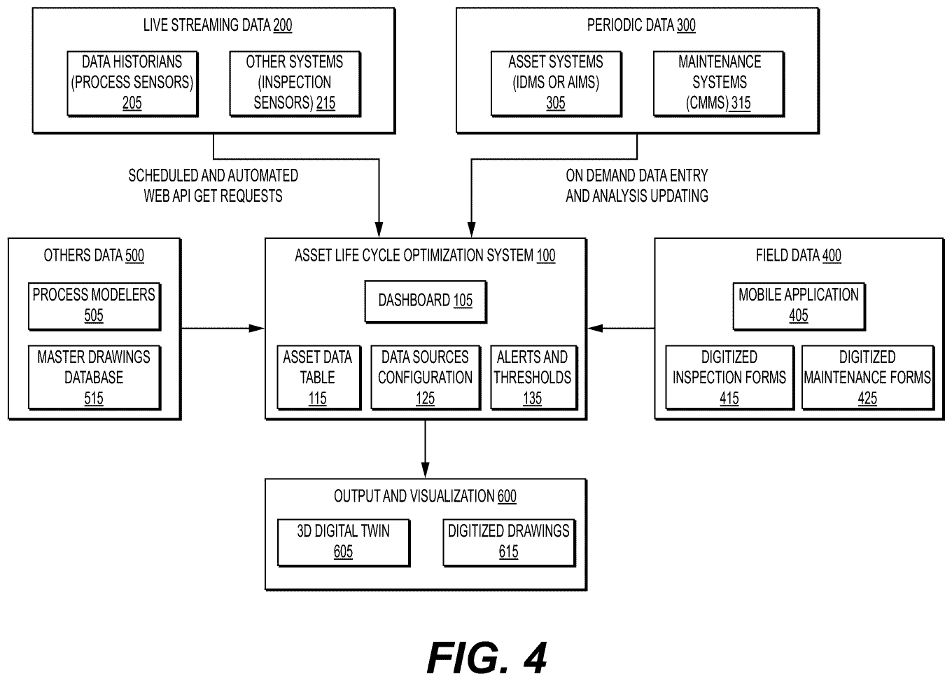

FIG. 4 shows a sample architecture for the Asset Life Cycle Optimization System, deployed as a fully cloud-native system according to an embodiment of the disclosure. FIG. 4 illustrates a sample architecture for the Asset Life Cycle Optimization System 100 according to an embodiment of the disclosure, which has inputs of live streaming data 200, periodic data 300, field data 400, and other data sources 500. The live streaming data 200 may be scheduled and automated via web-service API calls (i.e., Hypertext Transfer Protocol (HTTP) requests, such as a GET request). The periodic data 300 may be on-demand data entry for periodic analysis updating. The system 100 includes output and visualization 600, which may include three-dimensional (3D) digital twins 605 and digitized drawings 615. The system 100 may include a dashboard 105, asset data table 115, data sources configuration 125, and alerts and thresholds 135. The live streaming data 200 may include data historians such as process sensors 205, or other inspection sensors 215. The periodic data 300 may include third-party asset systems such as other Inspection Data Management System (IDMS) or Asset Integrity Management System (AIMS) 305, and third-party maintenance systems such as Computerized Maintenance Management System (CMMS) 315. The field data 400 may include data input systems such as mobile applications running on phones or tablets 405, digitized inspection forms 415, and digitized maintenance forms 425. The other data 500 may include third-party process modelers 505 and master drawings databases 515.

In an embodiment, the system may be a fully cloud-native architecture with individually optimized web-services to ensure performance, scalability, and integration of various features. As an example, the web services may operate on optimized cloud compute clusters (e.g., using Kubernetes) running inside of isolated containers (e.g., using Docker) with concurrently scaling node resource pools. This architecture is highly scalable and configurable as the system evolves.

In an embodiment, as an alternate deployment mechanism, the Asset Life Cycle Optimization System may communicate with on-premises computer systems to accommodate site authentication concerns.

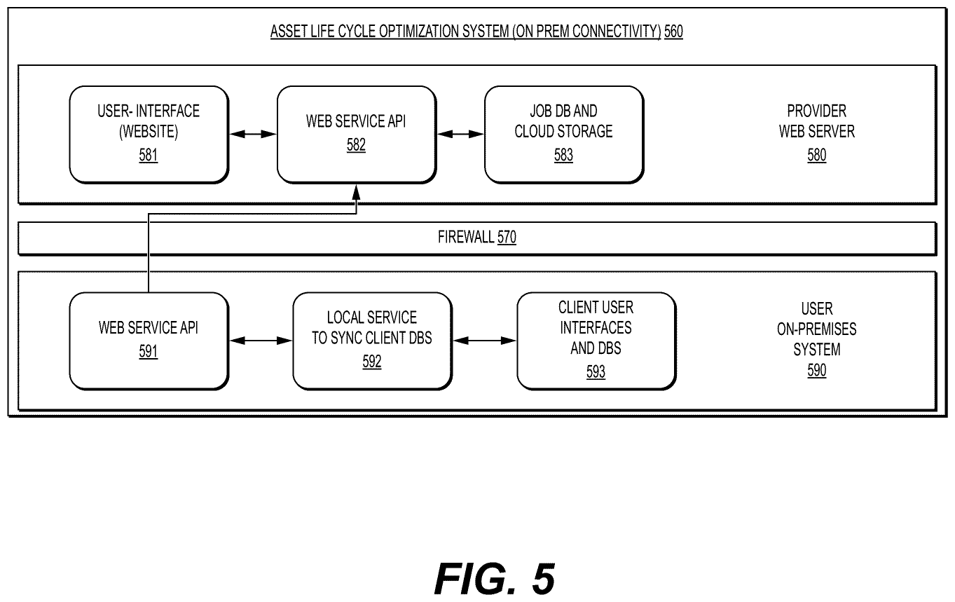

FIG. 5 shows a sample architecture for the Asset Life Cycle Optimization System when deployed with a secondary on-premises system to accommodate site authentication concerns according to an embodiment of the disclosure. FIG. 5 illustrates a sample architecture for the Asset Life Cycle Optimization System 560 according to an embodiment of the disclosure, wherein the system is deployed with a secondary on-premises system. As shown in FIG. 5, such systems include services behind the user's firewall to synchronize the user's database, handle authentication, and communicate with the cloud Asset Life Cycle Optimization System. The cloud system communicates with a copy of the user's systems and does not communicate with the user's systems directly, thus allowing accommodation with site authentication concerns. As shown in FIG. 5, the Provider Web Server 580 comprises a User Interface (UI) (i.e., website) 581, Web Service API 582, Job Database (DB) and Cloud Storage 583, each in communication with each other. The Provider Web Server 580 is provided outside of the User's Firewall 570 and the User On-Premises System 590 is provided inside of the User's Firewall 570. The User On-Premises System 590 comprises Web Service API 591, Local Service to Sync Client DBs 592, and Client UIs and DBs 593. All operations are two-way operations, such that information can be both received from, and sent back to, each component.

From a user experience perspective, the Asset Life Cycle Optimization System may comprise a web interface for the entire user workflow, which may be set up per user role. The interface may comprise various pages. A nonlimiting list of various pages includes a dashboard to monitor aging assets and summarize data/results across units, facilities, companies, and organizations; an asset analysis management table to run calculations against assets and schedule calculations with live sensor data to run automatically behind the scenes; a sensor connection configuration page to setup connections with third party sensor data sources; an alert notification management page to setup alerts against raw sensor data and/or calculation results (i.e., live integrity operation windows); and individual asset calculation interfaces for running calculations against assets.

A user may use the dashboard to monitor aging assets, optimize asset life cycles, respond to alerts, and plan for upcoming inspection and maintenance actions. Thus, the dashboard may be the first screen presented to the user upon logging in. Users may access and load existing dashboard configurations or create new ones. The dashboard may be fully configurable in that the content presented can be configured as desired. Widgets may be included in the dashboard for the user to select what to see per configuration, which may comprise options such as viewing sensor data, asset calculation results, unit calculation results, and alert notifications and recommendations, as an example. Each widget added to the dashboard may be resized and relocated per user request.

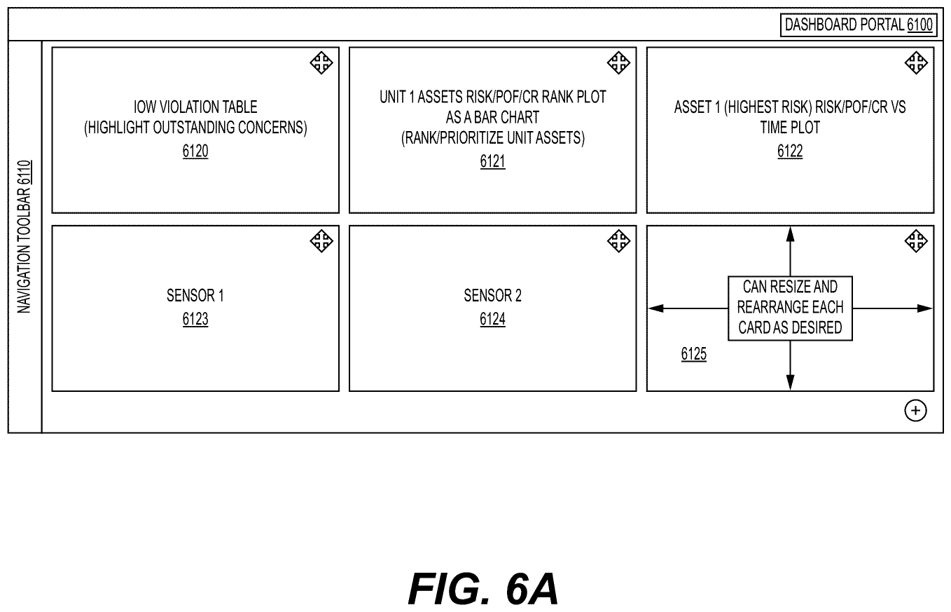

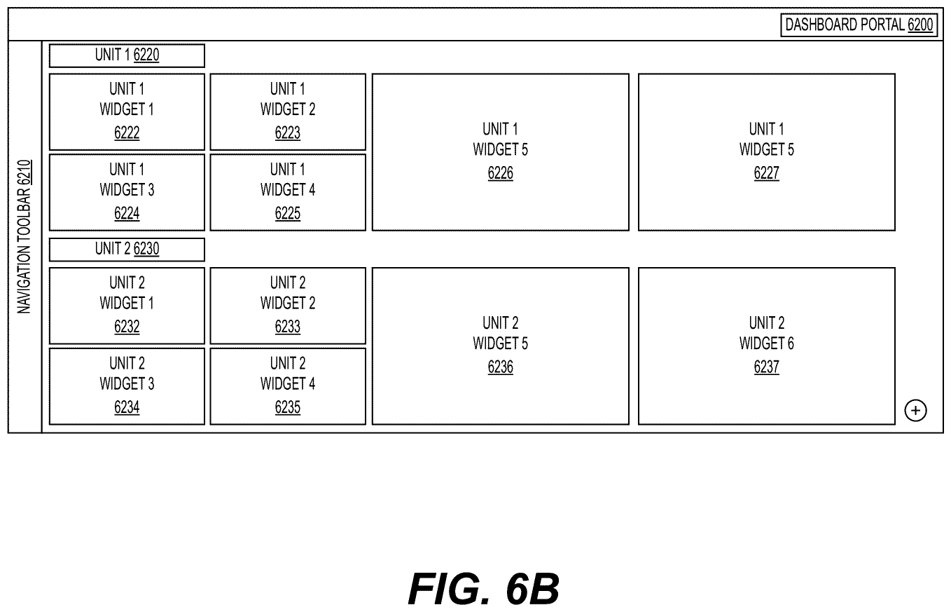

FIG. 6A and FIG. 6B show two sample dashboards of the Asset Life Cycle Optimization System according to an embodiment of the disclosure. FIG. 6A and FIG. 6B illustrate user configurability for a common workflow that includes alerts and notifications and the ability to find critical assets in the unit that can be drilled down into for more details. FIG. 6A shows six equal size widgets 6120, 6121, 6122, 6123, 6124, 6125. FIG. 6A shows an example of the types of data that may be visualized and monitored on the dashboard 6100 for a single unit in a plant. On the top left is a widget 6120 for the integrity operating window (IOW) violation table that highlights all violation exceedances that remain outstanding and unresolved. On the top middle is a widget 6121 for visualizing the latest calculation result for all assets in the unit using a bar chart sorted by severity. On the top right is a widget 6122 for visualizing the dynamic calculation results for a selected asset in the unit, presented as a time-history graph of the calculated value over time. On the bottom left is a widget 6123 for visualizing the dynamic raw sensor data for selected sensor 1 in the unit, and on the bottom middle is a widget 6124 for visualizing the dynamic raw sensor data for selected sensor 2 in the unit, each may be presented as time-history graphs of the measured values versus time. If there are IOW thresholds that would trigger alerts and notifications, they are overlaid on all applicable graphs (e.g., the top right, bottom left, and bottom middle graphs). The bottom right widget 6125 in FIG. 6A is intended to reflect the configurability of the dashboard and does not illustrate an additional or specific dashboard widget. FIG. 6A includes a navigation toolbar 6110 along the leftmost side of the dashboard portal 6100.

FIG. 6B shows twelve variable size widgets 6222, 6223, 6224, 6225, 6226, 6227, 6232, 6233, 6234, 6235, 6236, and 6237. Widgets 6222, 6223, 6224, 6225, 6226, and 6227 are shown for a first unit referred to as Unit 1 6220. Widgets 6232, 6233, 6234, 6235, 6236, and 6237 are shown for a second unit referred to as Unit 2 6230. All the widgets in FIG. 6B are intended to reflect the configurability of the dashboard and do not illustrate an additional or specific dashboard widget. FIG. 6B further includes a navigation toolbar 6210 along the leftmost side of the dashboard portal 6200.

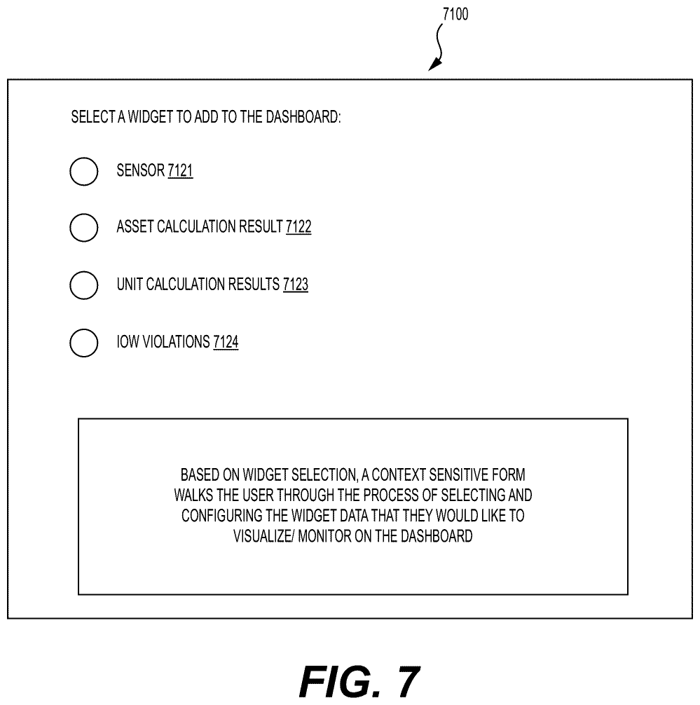

FIG. 7 illustrates a sample modal dialog form 7100 on the dashboard of the Asset Life Cycle Optimization System according to an embodiment of the disclosure that allows the user to add a new dashboard widget to the dashboard. Based on the selection, a context sensitive form guides the user through the process of selecting and configuring the required data for that particular widget. This example shows four sample widgets to choose from including widget 7121 a dynamic time series graph for raw sensor data (Sensor), widget 7122 a dynamic time series graph for asset calculation results (Asset Calculation Result), widget 7123 a bar chart sorted by severity for the latest asset calculation results across the unit (Unit Calculation Results), and widget 7124 an IOW violations table to summarize outstanding violation exceedances (IOW Violations).

Prior to using the dashboard, an engineer, subject matter expert, or consultant with an appropriate user role first configures the system by connecting to sensor data sources, pulling in asset data, and running calculations against the assets. Once this configuration is complete, all users within the organization may create and/or view dashboard configurations. User roles may be configurable per company or organization and may include personnel such as administration, plant managers, operations engineers, process engineers, inspectors, and mechanical integrity engineers. In some instances, certain users may only have access to view pre-configured dashboards shared by authorized users in the organization. A robust notification and alerting system may be in place, such that users are not required to continuously monitor the dashboard in person and instead may rely on a notification or alert that is sent out on-demand to inform the user when an event has occurred that requires immediate or near-term attention. The user may then use the dashboard to view, diagnose, and resolve the event or alert.

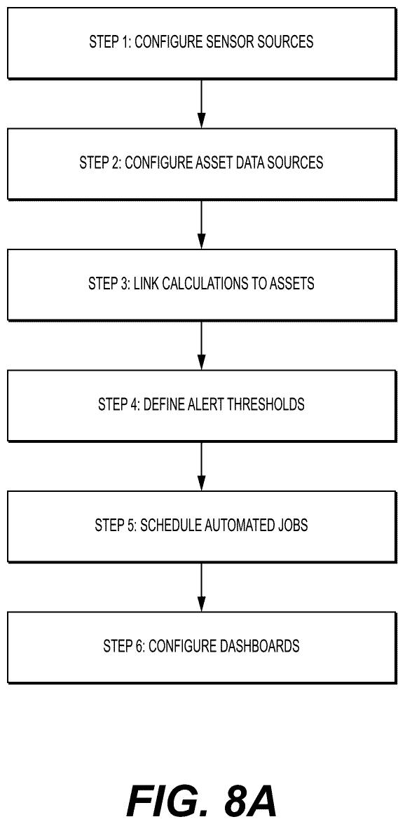

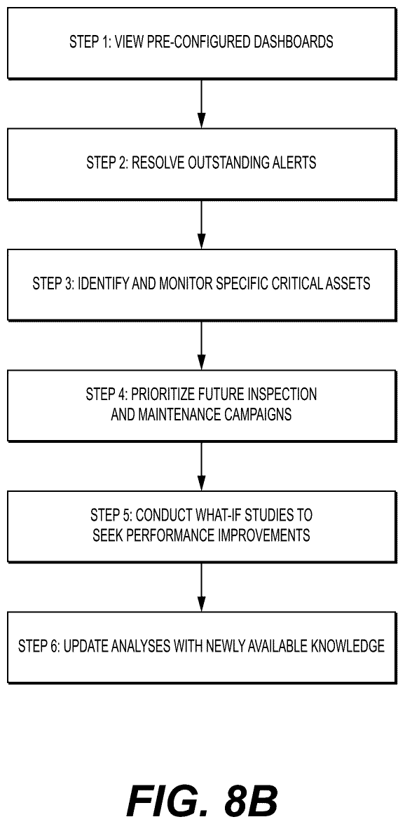

FIG. 8A and FIG. 8B illustrate common workflows performed by the Asset Life Cycle Optimization System according to embodiments of the disclosure. FIG. 8A shows a workflow that may be used to set up the system after creating a new company account and setting up proper authentications for all desired users. As shown in FIG. 8A, the set-up workflow or method may comprise Step 1 for configuring sensor sources, Step 2 for configuring asset data sources, Step 3 for linking calculations to assets, Step 4 for defining alert thresholds, Step 5 for scheduling automated jobs, and Step 6 for configuring dashboards. FIG. 8B shows a secondary workflow that may be used for using an already configured system. As shown in FIG. 8B, the secondary workflow or method may comprise Step 1 for viewing pre-configured dashboards, Step 2 for resolving outstanding alerts, Step 3 for identifying and monitoring specific critical assets, Step 4 for prioritizing future inspection and maintenance campaigns, Step 5 for conducting what-if studies to seek performance improvements, and Step 6 for updating analyses with newly available knowledge.

The Asset Life Cycle Optimization System as described in embodiments herein include many benefits. For example, the Asset Life Cycle Optimization System is live, dynamic, and continuously updated as soon as new data and knowledge are gathered. As nonlimiting examples, alerts may constantly be evaluated against raw sensor data streaming in, periodic damage-related (or other) calculations may automatically be run and evaluated, optimization opportunities may constantly be searched, and recommendations for improvement may constantly be presented to the end user.

Furthermore, the Asset Life Cycle Optimization System may be tightly integrated with industry-accepted and user-specific best practices and guidelines as well as subject matter expertise. Such best practices documentation may encompass all aspects of life cycle management from cradle-to-grave, resulting in an outcome of prescriptive recommendations and guidance tightly coupled to the predictions and optimization. An artificial intelligence (AI) chatbot may be embedded for additional process and mechanical integrity support. The AI chatbot may be pretrained from in-house subject matter expertise, collections of past engineering work, public literature, in-house technical reports and bulletins, and other relevant sources. The AI chatbot may learn as new future data, observations, and knowledge are gathered.

An embodiment of the disclosure is directed to a system and method for Live-IOWs that differs from traditional methods. In the aging energy and hydrocarbon production industries, alert thresholds are referred to as integrity operation windows (IOWs). Traditionally, IOWs are static limits, established by a subject matter expert, that are placed on key process/operations variables with existing sensors or sample stations in place. Control room operators reference the IOWs to maintain asset integrity. IOW criticality is informational (i.e., the exceedance can either be documented without further action), standard (i.e., attention is needed but there is considerable time before action needs to be taken), or critical (i.e., immediate action or intervention is required to prevent failure). While IOWs have been proven valuable to the industry, IOWs still have many limitations.

In contrast, the system and method for Live-IOWs according to an embodiment of the disclosure comprises linking the IOWs to asset life cycle optimization calculation results, instead of just raw sensor data. By linking the IOWs to the calculation results, the present system and method evolve the traditional static IOWs towards being fully dynamic and adapting to the dynamics of the process, based on the facility's short-term and long-term needs. Additionally, the system and method may comprise IOW exceedance response time that is not static. The IOW exceedance response time may be determined probabilistically by running FFS assessments of the failure state and remaining life of the asset.

In the present Asset Life Cycle Optimization System, a dashboard widget may be added to show an IOW exceedance table to monitor exceedances, evaluate mitigation strategies, and manage resolution status. Additionally, a separate IOW management page may be added to fully manage the creation, editing, and deletion of each IOW. IOWs may be set on raw sensor data or calculation results, as IOWs are thresholds with user-defined criticalities. Each asset may have an unlimited number of IOWs defined. IOW evaluations may be automatically scheduled for periodic checking, depending on the variable of interest and its criticality. As an example, if an IOW is set on a raw sensor parameter, then it may be checked as frequently as every second (i.e., checking more frequently than every second is possible but impractical for most situations). As another example, IOWs set on a calculation result parameter may be checked less frequently (i.e., if an asset has significant corrosion allowance and is only losing metal at a typically small corrosion rate, then the frequency of checking may be hourly, daily, or weekly). IOW management may be automated in the system.

The Asset Life Cycle Optimization System according to embodiments of the disclosure are customizable for organizations, facilities, and users. The Asset Life Cycle Optimization System is designed for managing all aging assets, across all facilities in an organization. However, it is common for organizations to have multiple independently operating companies and facilities. As such, the overarching system and authentication protocols according to embodiments of the disclosure may be organization-specific or company-scoped. The system allows for various configuration levels for both facility and user scoping. For example, the sensor data source configurations, IOW threshold configurations, and asset linked calculations may be facility scoped. In such a facility-scoped configuration, all users in the facility may have access to the same data, and if any one authorized user edits a property in any of the pages, then all other users in that facility may see that change. In contrast, some features in the system may not be facility-scoped and instead may be user-scoped. Such user-scoped configurations may include the dashboard view configurations and the individual calculations that are commonly used for what-if studies and are not linked to the assets. Since both the individual calculation jobs and dashboard configurations are user-scoped, both may be saved and shared with others across the organization. Authorized administrators may set default dashboard configuration for other users in the organization and may limit the access restrictions to various features. For example, users with the most limited restrictions may only be able to view pre-configured dashboards, whereas users with the most unlimited restrictions may be able to edit all system configurations and run any calculations.

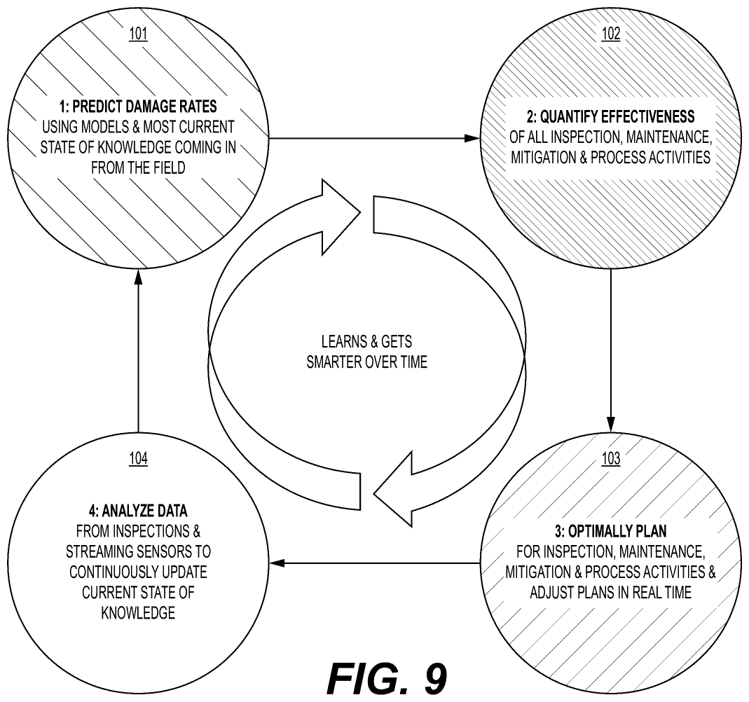

FIG. 9 illustrates the primary functions of the Asset Life Cycle Optimization System according to an embodiment of the disclosure. The primary functions comprise predicting damage rates 101 (top left), quantifying inspection effectiveness 102 (top right), optimally planning life cycle decision strategies 103 (bottom right), and analyzing data for continuous learning 104 (bottom left). The function for predicting damage rates 101 comprises using physical probabilistic models and all historical field data that is currently available at the time of analysis. The function for quantifying inspection effectiveness 102 comprises modeling and simulation to explicitly quantify the effect (benefit or cost) associated with each life cycle activity that may include inspection, maintenance, mitigation, and monitoring. The function for optimally planning life cycle decision strategies 103 applies to any life cycle decision strategies related to inspection, maintenance, mitigation, and monitoring, and comprises determining the ROI for each strategy independently, with the globally optimal strategy being the one that maximizes the total ROT. The function for analyzing data for continuous learning 104 comprises connecting the present system to third-party systems to retrieve periodic inspection data and live-streaming sensor data for automated updating of all analyses. The entire system is dynamic and automatically updates as soon as new data and knowledge arrive.

Thus, according to an embodiment of the disclosure, the Asset Life Cycle Optimization System may be used in methods to carry out the primary functions. In no particular order, such methods comprise identifying damage mechanisms, predicting damage rates, and predicting remaining life and risk; quantifying the effectiveness of all inspection and maintenance actions that can be taken; determining optimal life cycle decision strategies; and analyzing historical and future inspection, maintenance, and sensor data or observations to update predictions.

Furthermore, such methods may further comprise carrying out secondary functions. Secondary functions may be included in the Asset Life Cycle Optimization System to further enhance input/output processing, usability, and value. A nonlimiting example of a secondary function comprises a mobile application. The mobile application may be used on a phone or tablet, such as by field personnel to fill out inspection and maintenance forms digitally. Digital completion of such inspection and maintenance forms may automatically retrigger calculations and inform the field personnel of the updated analysis results and recommendations in near real time, thereby eliminating delays in response to incidents and critical situations. Another nonlimiting example of a secondary function comprises digitized drawings. Nonlimiting examples of the digitized drawings comprise process flow diagrams, process instrumentation diagrams, and piping isometric drawings that are navigational and allow input/output asset data overlays to better inform site personnel. Another nonlimiting example of a secondary function comprises retrofitability with third-party systems, especially data acquisition systems capable of assembling disparate data into a common interface and process modeling software. Such retrofitability solves the common industry problem of having vast amounts of data in non-digital format that needs to be processed and digitized so that it can be used for analysis. Another nonlimiting example of a secondary function comprises 3D digital twins with input/output asset data overlays for navigation and to inform site personnel of the current state of equipment damage and locations with varying susceptibility requiring attention.

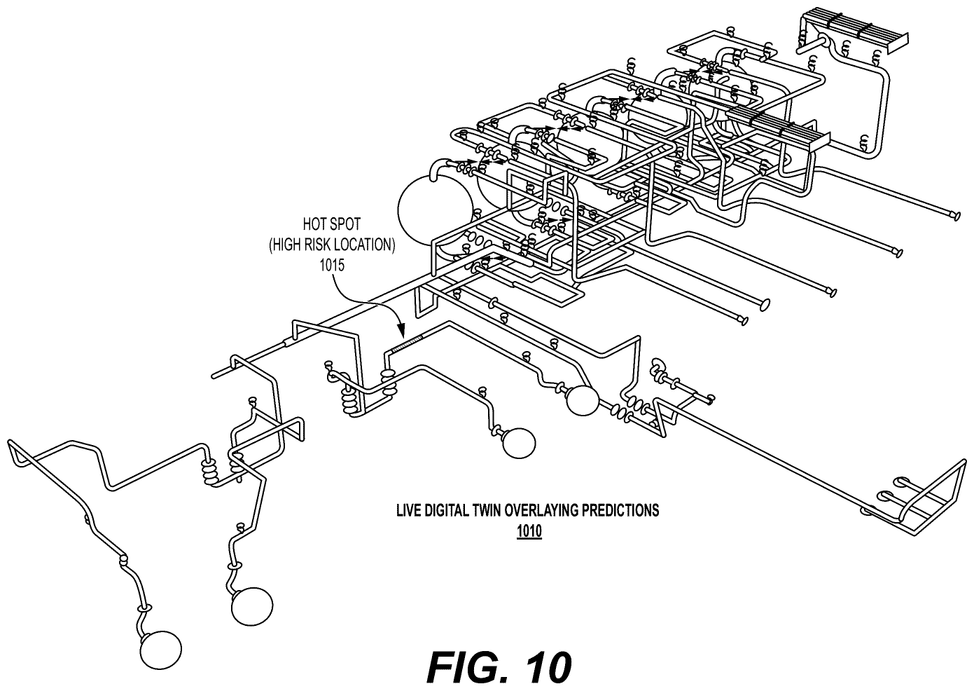

FIG. 10 is an example of a secondary function according to an embodiment of the disclosure. FIG. 10 shows a damage-centric 3D digital twin 1010 within the Asset Life Cycle Optimization System for a representative unit consisting of many piping assets, four small spherical assets, and five larger spherical assets. The calculated risk is overlaid onto the 3D digital twin geometry to easily identify locations of highest concern. In this example, the highest-risk location is called out and referred to as a hot spot 1015. This may have been due to operations or process deviations specific to this location, or perhaps a recent inspection detected damage at this location. These 3D digital twins may be used for subsequent FEA, thermal modeling, process modeling, or other modeling functions.

In an embodiment, the system may be all-encompassing, providing all frontend and backend functionality and workflows. In an embodiment, users may desire having access to the data, analyses, and optimizations via web-service APIs to pull the data into third-party systems for alternative User Interface/User Experience (UI/UX) purposes (e.g., dashboards, asset systems, maintenance systems, etc.). When used in this way, the system may serve as a central hub for advanced analysis and optimization.

Further nonlimiting supplemental benefits of the Asset Life Cycle Optimization System according to embodiments of the disclosure comprise: determining required asset inspection and maintenance intervals; determining optimal inspection locations, coverage area, and sensor placement; refining and refocusing traditional on-line non-destructive inspection methods to reduce costs and improve their effectiveness; and reducing manpower support for mechanical integrity program implementation and maintenance through increased automation.

### Probabilistic, Physics-Based, Causal Methods

The disclosure is directed to systems and methods for asset management and life cycle optimization. The asset life cycle optimization methods leverage probabilistic, physics-based, causal methods that account for all inherent uncertainties (i.e., every uncertain variable is treated probabilistically), model all physical cause-effect relationships explicitly, fully utilize and properly blend all knowledge/data currently available (i.e., models, experts, lab data, field data, operator experience, etc.), are dynamic and continuously learn as soon as new data/knowledge becomes available, and are used for both prediction and optimization. The causal methods may use any combination of mathematical modeling, probability theory, numerical simulations, Markov Chain Monte Carlo sampling, causal theory, causal networks, hierarchical causal statistics, and traditional Artificial Intelligence (e.g., image processing, feature identification, classification, natural language processing, etc.) to solve all aging asset prediction and optimization problems. Since all included probabilistic methods are rooted in causal relationships having a physical basis, all predictions are explainable (i.e., inputs, outputs, and intermediate variables/relationships, as well as the probabilities/strengths of each). Even when the result is unknown, the method will explain it as such (i.e., the output will be uniformly distributed). While the graphical nature of causal networks makes the networks easy to interpret and comprehend, the underlying probabilistic relationships the networks represent are the real power of the present approach.

An embodiment of this disclosure is directed to hybrid-AI methods for blending traditional AI methods with probabilistic, physics-based, causal methods. Probabilistic, physics-based, causal methods are not black box algorithms like traditional artificial intelligence (AI) or machine learning—instead, probabilistic, physics-based, causal methods are rooted in the true physics and/or cause-effect relationships such that the predictions and recommendations are fully explainable with less risk of misclassification and unexplainable false positives/negatives that traditional AI algorithms suffer from. The present probabilistic methods described herein leverage causal networks, but the methods are not limited to only causal networks. For example, for many data pre-processing and post-processing methods, hybrid-AI methods are employed that blend traditional AI with causal networks. In such hybrid-AI methods, traditional AI may first be used to extract key features from data such as text records, signals, and images. The extracted features may then be input as evidence into the causal networks, which then make physical predictions and determine optimal decisions.

Since the present methods are rooted in probabilistic, causal relationships in accordance with known principles of science, physics, and engineering, predictions of the present methods are fully explainable and always lead to a result, even when no information is available or when the available information is plagued by uncertainty. Though more uncertainty in the inputs of the present methods results in more uncertainty in the outputs, decisions can always be made using the present methods, regardless of the level of uncertainty.

In an embodiment, the present systems and methods may serve as a central repository of evolving knowledge. Such a central repository of evolving knowledge is encoded in one or more prior probability distributions for key variables, as updated prior probability distributions embed all past historical data/knowledge for key variables up to that point in time. Knowledge from multiple sources may be properly blended and processed with the present algorithms based on the relative confidence in each source. The present systems and methods are dynamic and continuously learn over time as soon as new data or knowledge becomes available, with the knowledge gained through the learning process encoded in the ever evolving prior and posterior probability distributions.

### Probabilistic, Physics-Based, Causal Networks

In an embodiment, the disclosure is directed to probabilistic, physics-based, causal methods that leverage probabilistic, physics-based, causal networks. Probabilistic, physics-based, causal networks are directed graphical representations of causal relationships between random-variables that are comprised of some combination of random-variable nodes, decision nodes, utility nodes, and arrows connecting any two nodes in the direction of causality (from cause to effect). Each random-variable is discretized into one or more probabilistic states that represent either a list of discrete numerical values (e.g., 5, 6, 7, etc.), numerical ranges of a continuous variable (e.g., from 5 to 10), or categorical values (e.g., Yes or No).

If two nodes are connected by an arrow, the node at the start of the arrow is referred to as the parent node (i.e., the cause) and the node at the end (i.e., tip) of the arrow is the child node (i.e., the effect). The conditional probability of any state of a child random-variable node depends on every possible combination of states of all its parent nodes. All these conditional probabilities are organized into a multi-dimensional table of conditional probabilities known as the conditional probability table (CPT) for that node. The dimensions of this table depend on how many parents there are and how many states each parent node has (i.e., the total number of entries is the product of the number of states for each parent node and the number of states of the child node itself). If a random-variable node has no parents, then its CPT represents the prior probabilities of that node's states (i.e., the state probabilities before any other information is known).

The discrete states of decision nodes are a list of all possible decisions that can be made. No prior probabilities are set on decision nodes, only on random-variable nodes. The effect of these decisions is to make the conditional probabilities of all child node states dependent upon each possible decision. Decision nodes do not have CPTs or any parents other than, possibly, other decision nodes, as a means of ordering sequential decisions. If an arrow points from one decision node to another, it indicates a sequence of decisions with the one at the start of the arrow being first, followed by the second.

Each utility node is assigned a positive or negative value, referred to as the utility, that conditionally depends on the states of all its parent nodes, which can be either decision nodes or other random-variable nodes. Generally, positive utilities are regarded as beneficial (e.g., revenue), whereas negative utilities are not (e.g., costs). If there is more than one utility node in a network, the total utility is the sum of all these utilities. When decision nodes are present, the total utility is displayed next to each choice on the first decision node, and on subsequent decision nodes after previous decisions have been made. The decision, or sequence of decisions, leading to the highest expected total utility is regarded as the best decision or decision strategy when there are multiple sequential decisions. This process of finding the optimal decision strategy that maximizes the total utility is referred to as decision optimization. To find the optimal decision strategy, a rational decision maker is assumed, meaning at each decision point, it is assumed that the decision maker selects the decision leading to the highest expected utility. Any random-variable nodes that are linked to utility nodes introduce uncertainty that results in a total expected, or averaged, utility found by applying the law of total probability (i.e., summing over all possible states, with each term weighted by its probability of occurrence).

Observations in the real-world are represented in the network by setting the probability of the observed state to 100% if the observation is precise, referred to as hard evidence, or as a set of multiple observations with non-zero probabilities that all sum to 100% if the observation is not precise, referred to as soft evidence. Setting evidence in this manner updates the beliefs (i.e., state probabilities) of other nodes in the network according to the specific probabilistic relationships represented by the network structure and its nodal CPTs. This process is referred to as probabilistic inference. When one is updating the beliefs of some effect node from evidence set on one of its causal nodes, this is a special case generally referred to as prediction, although this could also be referred to as inference (i.e., inferring the beliefs of one node from evidence set on another).

Nodes as described in this disclosure and shown in the figures may be used with systems and methods according to embodiments of this disclosure. Random-variable nodes that have evidence set are depicted in the networks shown in the present figures by using a long dashed border or outline. Random-variable nodes that do not have evidence set are depicted in the networks shown in the present figures by using a solid border or outline. Decision nodes are depicted in the networks shown in the present figures by using a short dashed line border or outline. Utility nodes are depicted in the networks shown in the present figures by using a hexagon shaped outline.

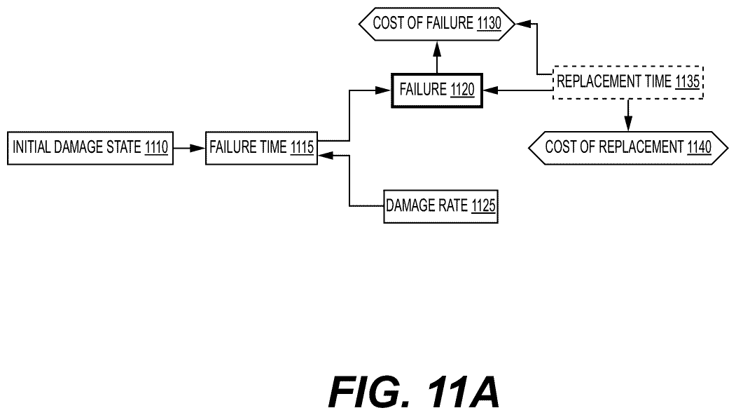

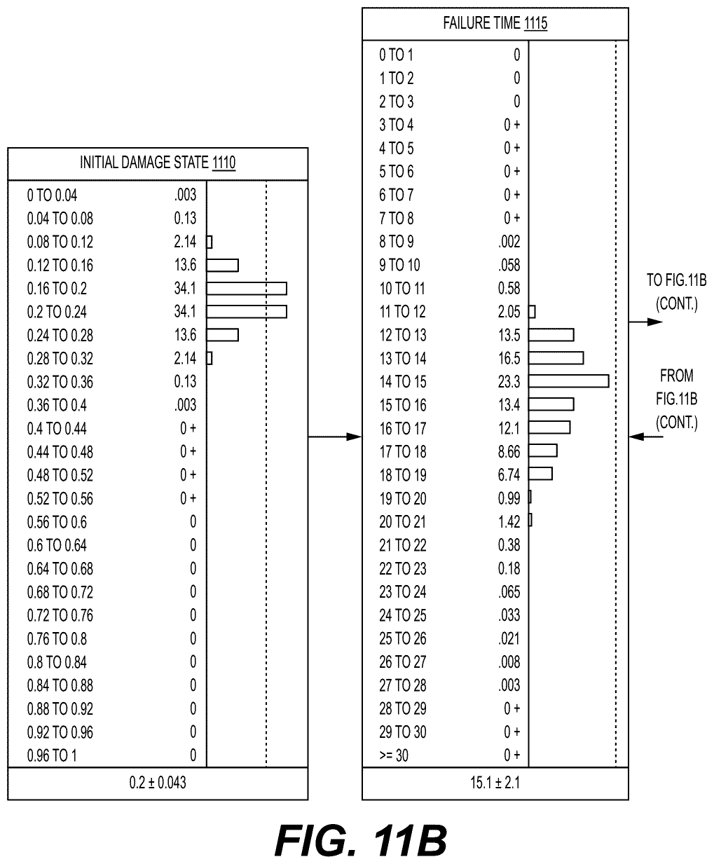

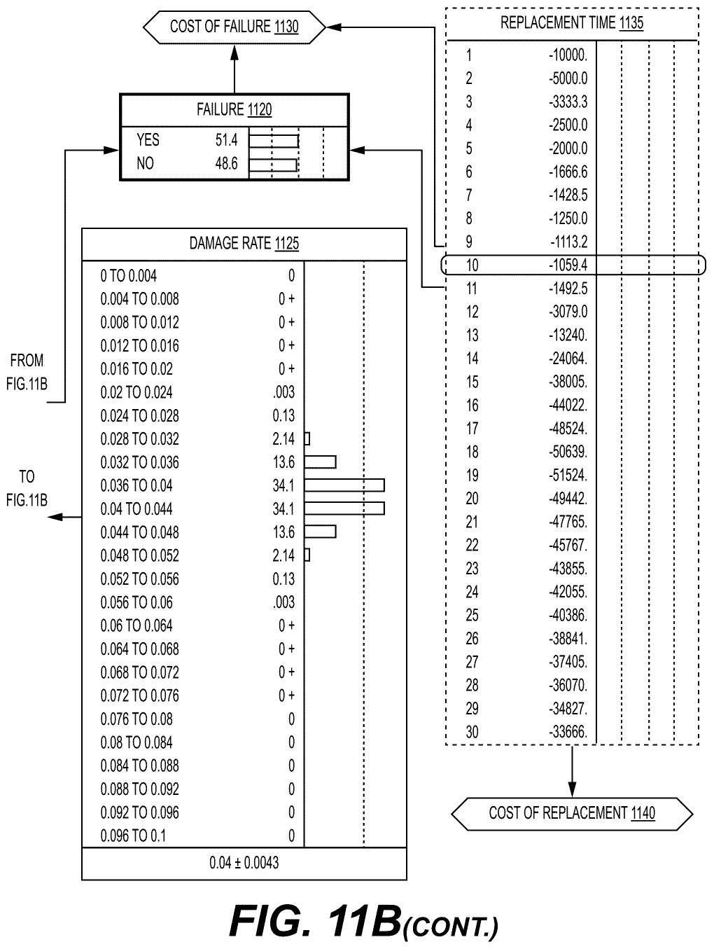

FIG. 11A shows a simplified view of an example probabilistic, causal network according to an embodiment of the disclosure. FIG. 11B shows a detailed view of the example probabilistic, causal network of FIG. 11A with no evidence set. FIG. 11A and FIG. 11B show an illustration of a simple probabilistic causal network used in systems and methods according to embodiments of the disclosure. The four solid line rectangular outline nodes 1110, 1115, 1120, and 1125 are random-variable nodes, the single dashed line outline node 1135 is a decision node, and the two hexagon outline nodes 1130 and 1140 are utility nodes. The three random-variable nodes Initial Damage State 1110, Damage Rate 1125, and Failure Time 1115 are continuous variables that have been discretized into a finite number of states representing numerical ranges that collectively cover some desired total range. The discrete random-variable node Failure 1120 has only two categorical states, Yes or No. The probability of each state of a random-variable node is represented graphically by the length of the bar displayed next to each state and numerically by the value displayed just to the left of each bar. For example, the respective probabilities of the Yes and No states for the Failure 1120 node are equal to 51.4% and 48.6% as shown. The mean and standard deviation are displayed at the bottom of each continuous random-variable node. For example, the Failure Time 1115 node has a mean value of 15.1 years with a standard deviation of 2.1 years. The Failure Time 1115 and Failure 1120 nodes have conditional probability tables that depend on the states of their parent nodes. The Initial Damage State 1110 and Damage Rate 1125 random-variable nodes have no parents, but their prior probabilities are set directly as shown, leading to a prior mean and standard deviation of 0.2 and 0.043 for the Initial Damage State 1110 node and 0.04 and 0.043 for the Damage Rate 1125 node. The single Replacement Time 1135 decision node has a list of discrete choices that can be made. The two utility nodes account for the Cost of Failure 1130 and the Cost of Replacement 1140 but only if those events or actions occur.

Given the network in this current state (i.e., initial compilation), with no evidence set or inference performed, the total expected utility for each possible choice of the replacement time is displayed next to each choice on the Replacement Time 1135 node. All the values are negative, because only costs are considered, and costs are considered to be negative utilities. The highest total expected utility (i.e., lowest cost) of −$1059.4 corresponds to a replacement time of 10 years (i.e., this is the optimal choice).

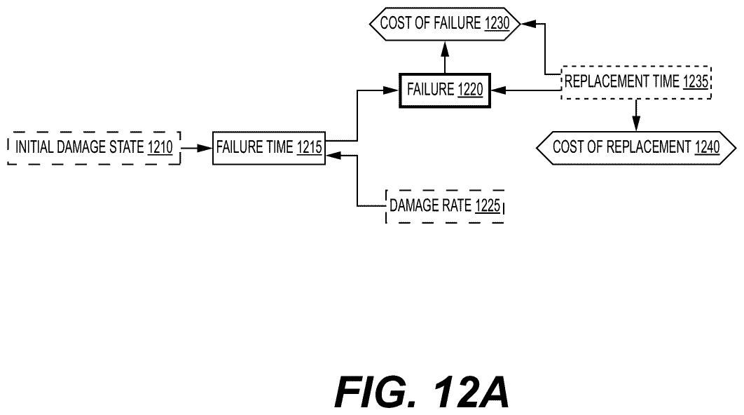

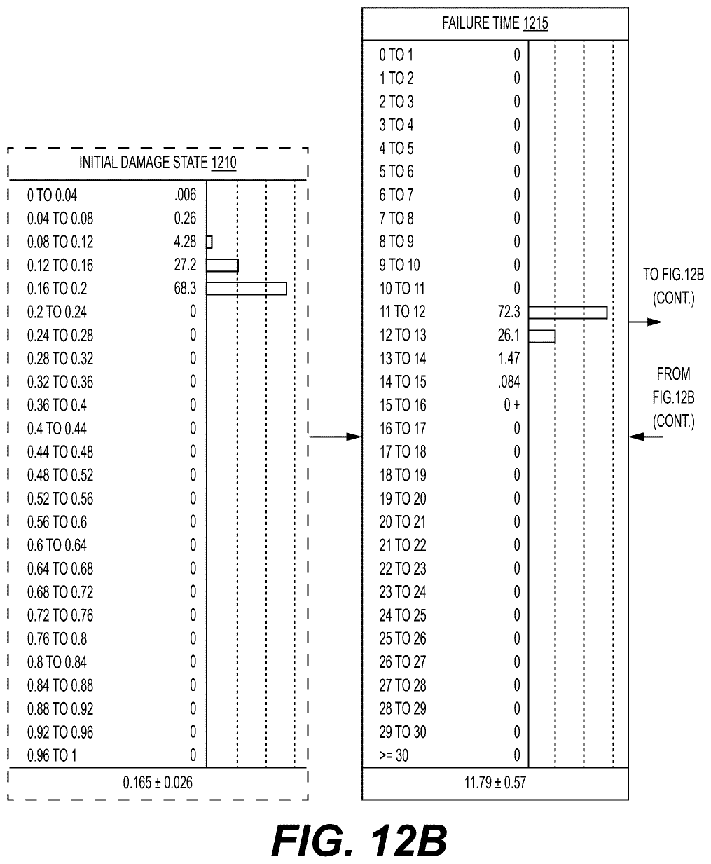

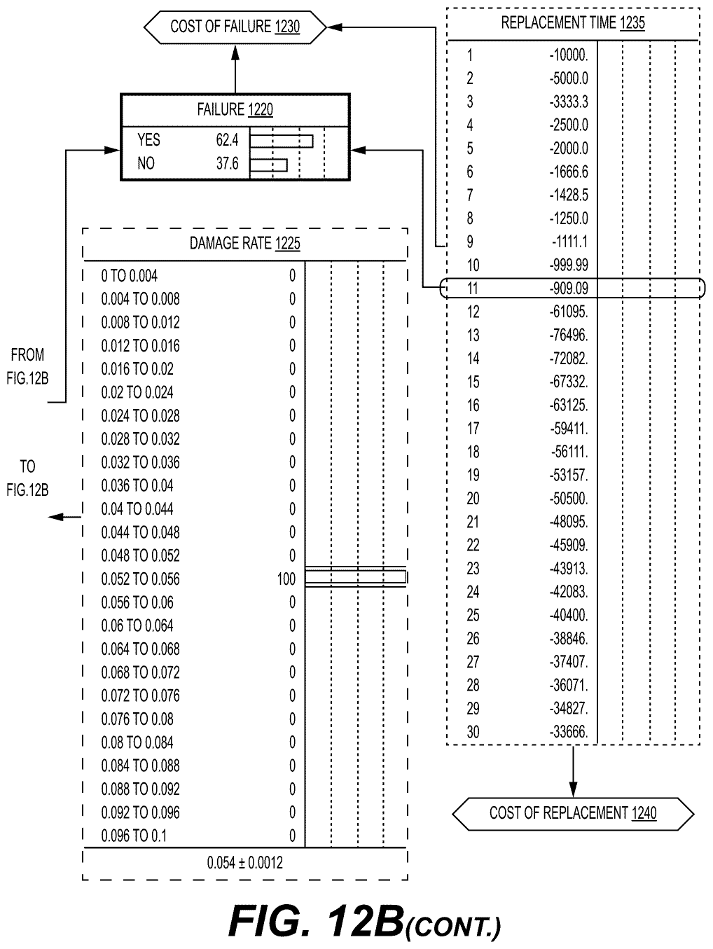

FIG. 12A shows a simplified view of an example causal network according to an embodiment of the disclosure. FIG. 12B shows a detailed view of the sample causal network of FIG. 12A illustrating all core components including random-variable nodes with evidence set (long dashed line rectangular outline) or not set (solid line rectangular outline), decision nodes (short dashed line rectangular outline), and utility nodes (hexagon shaped outline). FIG. 12A and FIG. 12B show a network similar to that shown in FIGS. 11A and 11B with Initial Damage State 1210, Failure Time 1215, Failure 1220, Damage Rate 1225, Cost of Failure 1230, Replacement Time 1235, and Cost of Replacement 1240 nodes, but with hard evidence set on the Damage Rate 1225 node (i.e., only one state is selected with probability 100%) and soft evidence set on the Initial Damage State 1210 node (i.e., five states set to non-zero probabilities adding up to 100%) to reflect the current state of knowledge. The outline of these two nodes is now a long dashed line rectangular outline to reflect this setting of evidence. The belief probabilities on the two remaining random-variable nodes, Failure Time 1215 and Failure 1220, are updated through the operation of probabilistic inference, and the expected utilities next to each replacement time on the Replacement Time 1235 node change as a result. The highest total expected utility is now −$909 at a replacement time of 11 years (i.e., this is now the optimal choice).

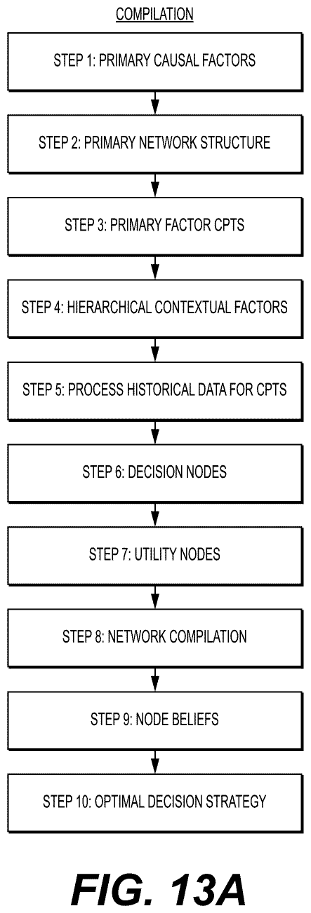

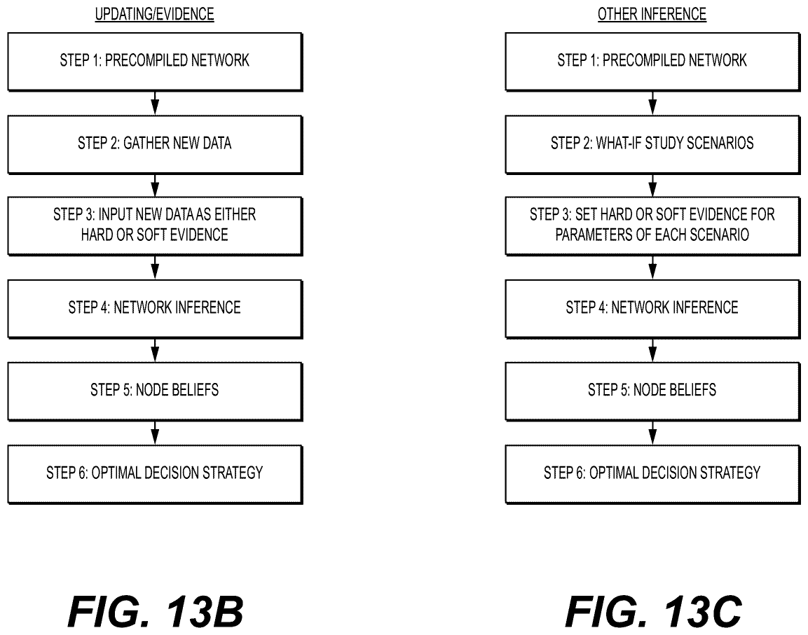

FIG. 13A, FIG. 13B, and FIG. 13C illustrate common workflows for the probabilistic causal networks used in systems and methods according to embodiments of the disclosure. FIG. 13A shows a workflow or process for using a probabilistic causal network including compilation operations. In particular, FIG. 13A shows the primary workflow for constructing the probabilistic causal network, compiling it, and using it in the forward direction of information propagation for both prediction and optimization. The various steps for this workflow may comprise: Step 1) identifying primary causal factors (i.e., direct parents of the desired primary result node), Step 2) establishing the primary network structure with arrows set in the proper directions, Step 3) defining CPTs explicitly for primary causal factor nodes, Step 4) expanding the network to include additional hierarchical contextual information (i.e., more causal factor nodes) to calculate CPTs for any primary causal factors that are not known explicitly, Step 5) processing historical knowledge and data to further calculate prior CPTs for contextual causal factor nodes, Step 6) adding decision nodes for any decisions in the decision strategy that need optimized, Step 7) adding utility nodes to account for the costs associated with any decisions or events, where applicable, Step 8) compiling the network to generate all of the CPTs, Step 9) predicting the probabilistic beliefs of all random-variable nodes, and Step 10) determining the baseline optimal decision strategy with no evidence set. There are many options for generating/defining the CPTs that include explicitly defining each entry of the entire CPT manually, calculating it analytically or numerically outside of the causal network, or by using a deterministic or probabilistic equation to generate it, among others.

FIG. 13B shows a workflow or process for using a probabilistic causal network including updating evidence operations. In particular, FIG. 13B shows the secondary workflow for updating the probabilistic causal network via setting evidence to get updated probabilistic beliefs and updated optimal decision strategies. The various steps for this workflow may comprise: Step 1) starting from a precompiled network that has already completed the workflow steps outlined in FIG. 13A, Step 2) gathering new data that has not previously been incorporated into the network, Step 3) inputting all of this new data into the network as either hard or soft evidence depending on the type of data and the confidence in the data, Step 4) performing probabilistic inference on the network to propagate the evidence throughout the network, Step 5) predicting the updated probabilistic beliefs of all random-variable nodes, and Step 6) determining the updated optimal decision strategy.

FIG. 13C shows a workflow or process for using a probabilistic causal network including alternate inference operations. In particular, FIG. 13C shows the tertiary workflow for conducting what-if-scenarios using the probabilistic causal network. The steps of this workflow may be identical to the steps shown in FIG. 13B except for the second and third steps which comprise entering evidence for all parameters of interest to be varied, rather than entering evidence from actual field data. The various steps for this workflow may comprise: Step 1) starting from a precompiled network that has already completed the workflow steps outlined in FIG. 13A, Step 2) conducting what-if study scenarios, Step 3) setting hard or soft evidence for parameters of each what-if study scenario, Step 4) performing probabilistic inference on the network to propagate the evidence throughout the network, Step 5) predicting the updated probabilistic beliefs of all random-variable nodes, and Step 6) determining the updated optimal decision strategy. Examples of such what-if studies include but are not limited to inferring improved designs, retrofitting existing designs, conducting gap assessments, justifying the need for improved technologies, and conducting sensitivity studies. Nodal discretization studies to test convergence of the posterior probabilities are also important and can be conducted in the same manner as what-if studies.

Like any probabilistic method, performance is a key factor for consideration and discussion. In the causal networks used in present methods and systems, there are two expensive operations. The first is due to large CPTs that require large volumes of RAM to store in memory and operate on. The number of entries for the CPT of any node is the product of the number of states of each of its parent nodes and the number of its own states. Thus, if a node has 10 states and 5 parent nodes, each with 10 states themselves, then there are 106 (1 million) total entries in its CPT. An array with 1 million entries, assuming 32 bits are used for each floating-point entry, will require approximately 4 MB of memory to store and operate on. If this node had 10 parent nodes instead of 5, there would be 10¹¹ (100 billion) entries, requiring approximately 400 GB of memory. Similarly, if there were only the 5 parent nodes, but all nodes had 20 states instead of 10, then the CPT would have 206 entries (64 million) requiring approximately 256 MB of memory. Not only is more memory required to store larger arrays, but the computational time also increases.

The systems and methods according to embodiments of the disclosure comprise a dynamically scalable cloud infrastructure that pre-calculates the amount of RAM required and ensures that the virtual machines performing compilation and inference of the causal networks are large enough to accommodate the RAM requirements. This brute force mode of operation allows the present systems and methods to always output a solution, even though it may be financially and computationally expensive. This is analogous to finite element analysis, where the resource requirements are a function of the total degrees of freedom.

As an embodiment of the disclosure, an alternative solution procedure method may comprise further reducing the random access memory (RAM) resource requirements, as the entire CPT array may not be loaded into memory at once. Instead, the CPTs may be loaded into memory in small chunks at a time, with each chunk operated on iteratively. This keeps the resource requirements (i.e., RAM) low, even though the computational time might increase (without distributed computing). The size of each chunk may be user-controlled and can be as small or as large as desired, with the minimum size being the number of states of the current node of interest (i.e., the size of one row in the CPT, which is 10 or 20 in this example). Increased computational time to perform a compilation or inference operation typically balances out the reduced cost of decreasing the RAM requirements, as cloud computational costs are a function of both the requested RAM and computational time. However, this time may be reduced by making use of distributed computing across a cluster of computational resources. Chunking the CPT in this manner also allows for these methods to be performed on local computers or PCs with limited RAM, if desired. In an embodiment, methods of the disclosure are also provided wherein intermediate nodes are introduced in between the parents and some child node to further reduce the size of the child node's CPT.

In other embodiments, the disclosure may comprise other alternate solution methodologies. Nonlimiting examples of other alternate solution methodologies comprise calculating CPTs outside of the network, using offline calculations, and using sparse matrix operations when applicable. When performing offline calculations, other probabilistic sampling techniques such as Monte Carlo may be used. Properties of the underlying prior probability distributions of each parent node may be considered to reduce dimensionality. For the latter method, sparse matrix operations are not always feasible and depend on the prior probabilities of parent nodes and the joint probability of the child node's CPT. However, there are many physical systems that result in sparse CPTs.

In another embodiment of the disclosure, a brute force method to determine optimal decision strategies may be provided. The method may comprise determining the total expected utility of each decision strategy from the set of decisions and corresponding random-variable nodes after the network is built. Determining the total expected utility of each decision strategy may comprise a two-stage process for each. The first stage may be the forward direction and may comprise iterating through all combinations of decisions and conditionally dependent random-variable nodes to get the final belief probabilities of the independent random-variable nodes. The second stage may be the inverse operation, working backwards to the first decision node, and may comprise calculating the total expected utility along the way using the law of total probability.

In an embodiment, the disclosure is directed to a method wherein the causal network is broken into separate networks for every possible decision strategy. The method comprises solving each possible decision strategy for each separate network independently to get the corresponding total expected utilities, and then ranking the total expected utilities after the fact to find the strategy that results in the maximum total expected utility. The maximum total expected utility may be regarded as the optimal one. Such a strategy is especially important when RAM is limited, as solving decision networks with many independent decision strategies is much more computationally expensive than solving networks having only random-variable nodes (i.e., no decision nodes).

### Prediction

Systems and methods of the present disclosure comprise archetypal patterns developed for designing causal networks for use in the present systems and methods. The present systems and methods may predict the evolution of damage over space and time for an aging asset, which then allows for the prediction of the failure time when coupled with some model of failure that depends on reaching some critical level of damage. Optimal decisions may be made once the failure time is predicted and its dependence on certain life cycle related decisions is known.

Systems and methods according to embodiments of the disclosure are directed to determining the failure or failure time for an aging asset. Failure often occurs when damage exceeds some critical level, at which time some undesirable state is reached (e.g., significant loss of production, loss of containment, an explosion, etc.). Predicting the failure time of an asset is an important objective, as many life cycle decisions depend on the failure time. For example, if the failure time is predicted to be far in the future, then taking no action now or in the near term is likely the best choice. However, as the failure time approaches, actions such as inspection and maintenance may be recommended. When one takes into consideration the cost of such actions versus the benefits provided in terms of risk reduction or life extension, then the time at which such actions are recommended is determined by performing global financial optimization (e.g., minimizing the total cost of ownership, maximizing the ROI, etc.). To achieve this, the present systems and methods comprise augmenting the predictive causal network with additional decision and utility nodes.

An asset is anything of value that performs some desirable, beneficial function for its owner when it is operating as designed. Often, the value is financial. If the performance of the asset degrades over time, it is said to be aging. Such aging is normally due to the progressive accumulation of damage from one or more damage mechanisms that can be quantified by one or more damage-state variables. The instantaneous rate at which each of these damage-state variables is evolving over time is known as its damage rate. Each damage-state variable may have a potentially separate damage rate associated with it. Failure is said to occur when one or more of these damage-state variables reaches or exceeds some critical limit. Failure may be catastrophic and lead to loss of life, loss of property, or a harmful environmental event, among other events. When such a failure event occurs, its consequence is the cost incurred by the event, which could include loss of production due to the inability of the asset to operate as designed.

The prediction of damage evolution from all possible damage mechanisms and the eventual failure of an asset is a complex process plagued by many uncertainties, necessitating a fully probabilistic approach. Often, the most important variable to predict is the failure time, but failure time can rarely be predicted precisely. As such, the failure time is treated as a random-variable with a probability distribution that is predicted by using one or more methods of probabilistic analysis.

Methods described herein comprise constructing specially designed probabilistic, causal networks, according to certain archetypal patterns, to predict the failure time of an asset by creating random-variable nodes for the failure time and all of its suspected causes. Since the primary cause of failure is the accumulation of damage over time, the method comprises adding random-variable nodes for each damage state variable and its associated damage rate. These could come from one or more damage mechanisms that may or may not be independent. Additional random-variable nodes may be added for all the causes of each damage state and damage rate variable in a hierarchical cause-effect structure with many possible levels. Random-variable nodes may also be added for the initial damage state, the damage initiation time, the critical damage state at which failure occurs, the consequence of failure, and many other causal factors, depending on the application. This assemblage of nodes and their interconnectivity is referred to as the core prediction network. Having knowledge of the failure time, even if it is not known exactly, allows for the best decisions regarding the management of the asset to be made.

The random-variable nodes with the most uncertainty are usually those related to damage, such as the damage initiation time and damage rate. To improve the prediction of these uncertain variables, present systems and methods comprise adding additional nodes to the network for any known physical causes of these, referred to as damage causal factors. For example, the creep damage rate of a high strength alloy depends on both temperature and stress, so nodes can be added for these variables as causes of the creep damage rate node. As another example, nodes can be added to estimate the number of cycles to fatigue failure for a material operating under cyclic load via its loading cycle histories and a thorough mechanical stress analysis of the material's response.

Nonlimiting examples of how the present systems and methods carry out the step of determining pertinent damage causal factors comprise interviewing subject matter experts with extensive prior knowledge and experience in the industry, conducting laboratory experiments, importing from fundamental physics-based models, importing from observations in the field through inspections or sensor readings, or importing from any other relevant source of knowledge.

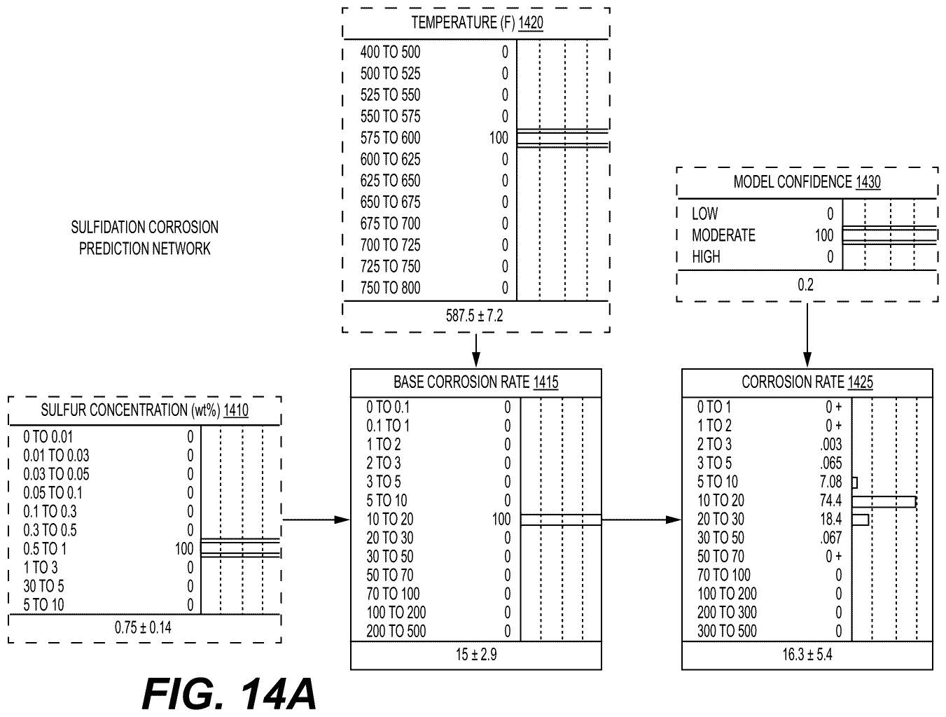

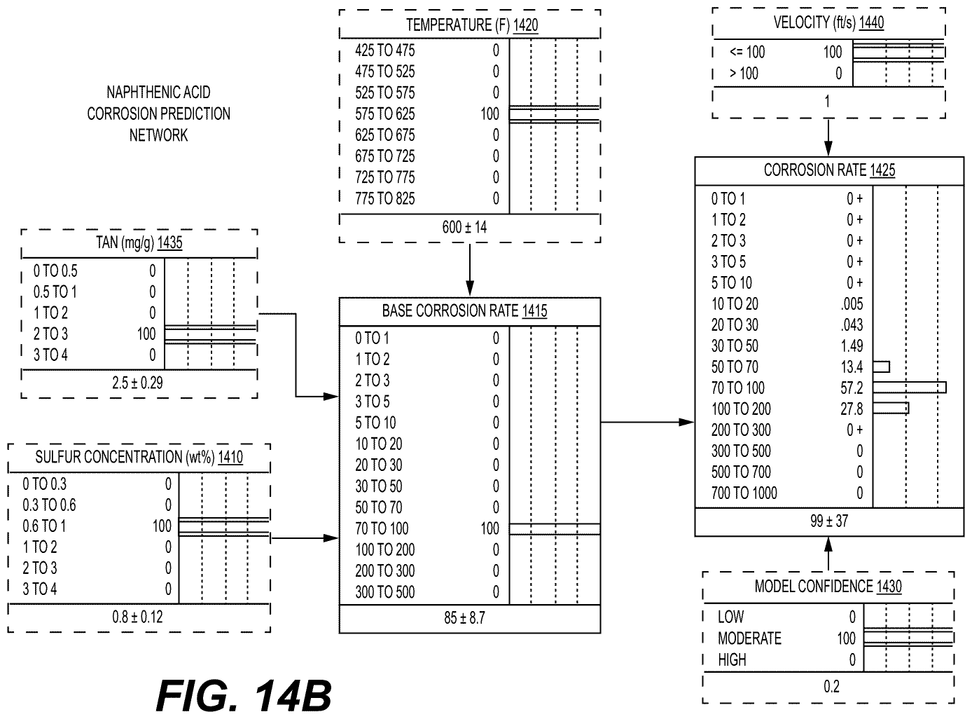

FIG. 14A and FIG. 14B illustrate sample predictive networks according to embodiments of the disclosure. FIG. 14A shows a sample predictive network for sulfidation corrosion. FIG. 14B shows a sample predictive network for naphthenic acid corrosion. The networks shown are simplified for the purpose of illustration (i.e., many additional causal factors may be included in a hierarchical fashion to further enhance predictability). The purpose of both networks is to predict the state probabilities of the Corrosion Rate node (i.e., the damage rate associated with corrosion) from some number of input damage causal nodes. FIG. 14A comprises nodes for Sulfur Concentration (wt %) 1410, Base Corrosion Rate 1415, Temperature (F) 1420, Corrosion Rate 1425, and Model Confidence 1430. In FIG. 14A the primary damage causal nodes (long dashed line rectangular outline) are Sulfur Concentration 1410 and Temperature 1420. FIG. 14B comprises nodes for Sulfur Concentration (wt %) 1410, Base Corrosion Rate 1415, Temperature (F) 1420, Corrosion Rate 1425, Model Confidence 1430, TAN (mg/g) 1435, and Velocity (ft/s) 1440. In FIG. 14B there are two additional damage causal nodes (long dashed line rectangular outline) added: TAN 1435 and Velocity 1440. In both networks, hard evidence is set on all input random-variable nodes (long dashed line rectangular outline), resulting in updated beliefs for the Base Corrosion Rate 1415 and Corrosion Rate 1425 nodes. A Model Confidence 1430 node is used in both networks to account for additional uncertainty in the predicted corrosion rate, with the final Corrosion Rate 1425 node depending directly on both the Base Corrosion Rate 1415 node, which depends directly on the other damage causal factor nodes, and the Model Confidence 1430 node. The magnitude of the additional uncertainty depends on whether one has low, moderate, or high confidence in the model. In FIGS. 14A and 14B, a moderate confidence is selected on the Model Confidence 1430 node. The additional uncertainty in the final predicted corrosion rate is evident by the multiple number of additional states of the Corrosion Rate 1425 node that have non-zero probabilities, as compared to the single predicted state of the Base Corrosion Rate 1415 node.

To predict the failure time, systems and methods according to embodiments of the disclosure comprise expanding the probabilistic causal networks like that shown in FIG. 14A and FIG. 14B by adding one or more nodes for the initial damage states, the failure damage states, and the failure time. The nature and number of nodes added is problem specific and depends on how many damage mechanisms are accounted for, how many damage state variables are required to define each damage mechanism, and how many failure modes there are. Each of these may have other causes, which can lead to a complex, hierarchical network of interconnected nodes.

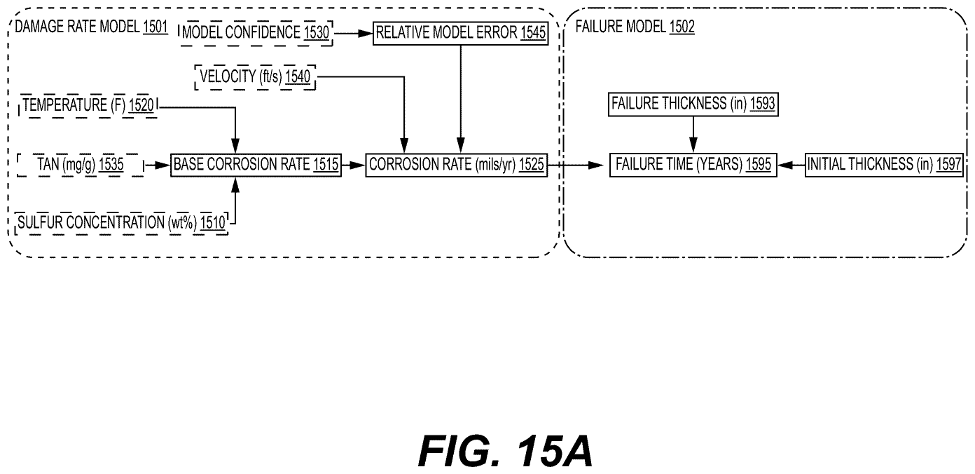

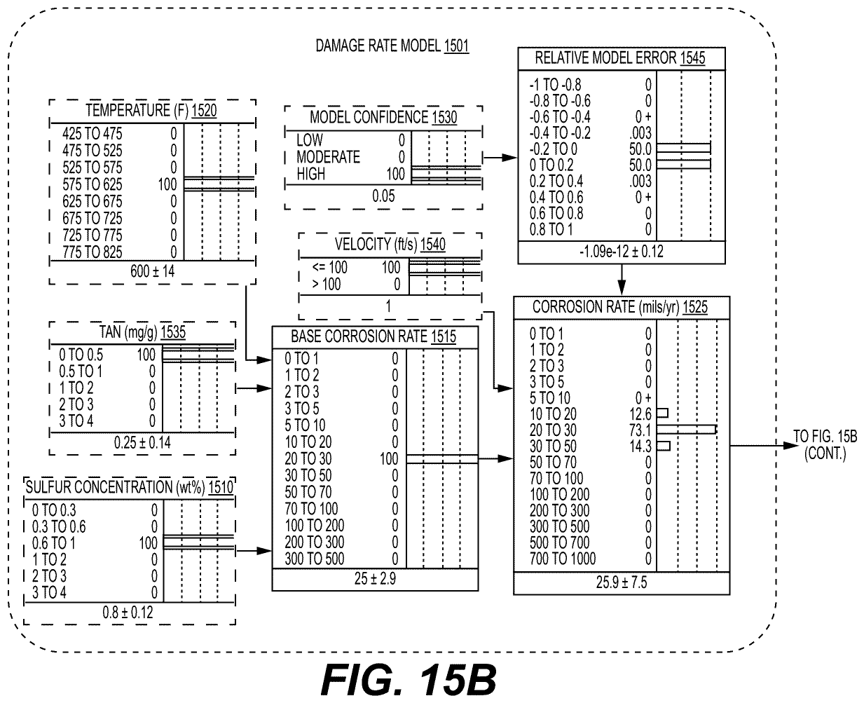

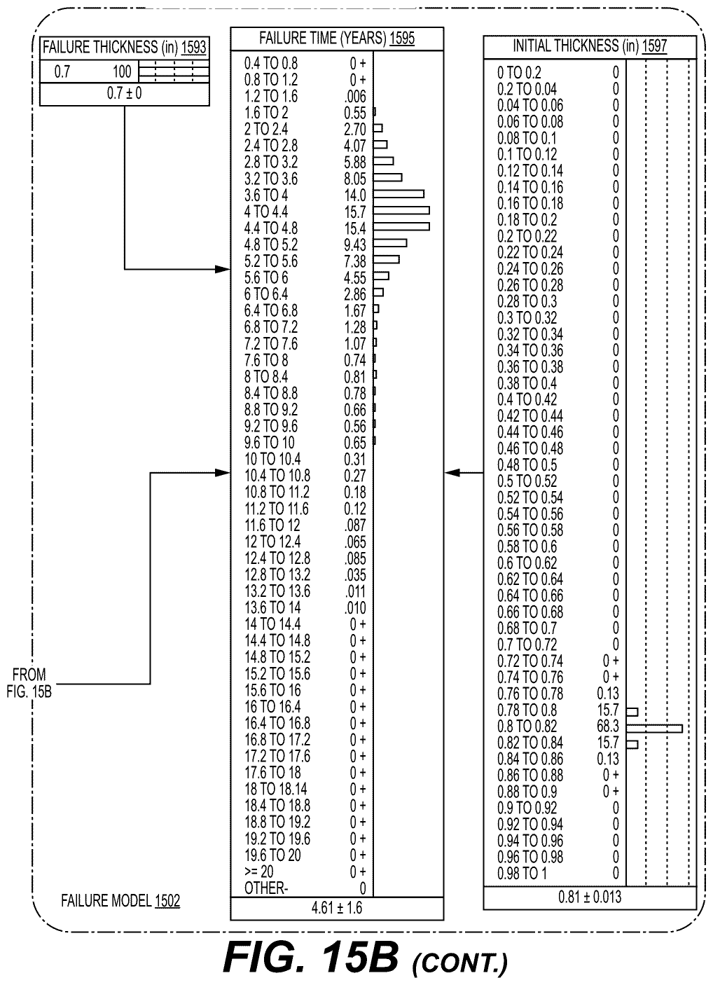

FIGS. 15A and 15B illustrate a sample extension of the probabilistic causal network in FIG. 14B according to an embodiment of the disclosure. The probabilistic causal network of FIG. 14B is expanded in FIGS. 15A and 15B in order to predict the asset failure time by adding three additional random-variable nodes (solid line rectangular outline) for the Initial Thickness 1597, Failure Thickness 1593, and Failure Time 1595. The network of FIG. 15A and FIG. 15B comprises nodes for Sulfur Concentration (wt %) 1510, Base Corrosion Rate 1515, Temperature (F) 1520, Corrosion Rate (mils/yr) 1525, Model Confidence 1530, TAN (mg/g) 1535, Velocity (ft/s) 1540, Relative Model Error 1545, Failure Thickness (in) 1593, Failure Time (years) 1595, and Initial Thickness (in) 1597. The nodes in the network are organized so that the original predictive portion is on the left and identified by the short dashed line grouping for the Damage Rate Model 1501, while the new failure portion is on the right and identified by the alternating dash-dot line grouping for the Failure Model 1502. The new random-variable nodes do not have evidence set on them, but their prior probabilities are set to reflect some uncertain past knowledge about them. This is a simplified example of the general situation where the failure time depends on the damage rate (i.e., represented here as corrosion rate), the initial damage state (i.e., represented here as initial thickness), and the critical damage state at which failure occurs (i.e., represented here as the failure thickness).

The structure and nodal CPTs of the network are set up in such a way that the accumulated metal loss at any time is the product of the corrosion rate and time (i.e., assuming a corrosion rate that is constant over time). For any particular, precise values of the initial thickness, failure thickness, and corrosion rate, the failure time is calculated as the time at which the initial thickness minus the metal loss equals the failure thickness. Since these are all random-variable nodes, this calculation is repeated many times by performing probabilistic sampling of the initial thickness, failure thickness, and corrosion rate nodes. This leads to a large sample of calculated failure times, from which the probability of each state on the Failure Time 1595 node is estimated by the fraction of calculated values that end up within each of the discretized ranges. The final failure time distribution has a mean value of 4.61 years with a standard deviation of 1.6 years, as displayed at the bottom of the Failure Time 1595 node in FIGS. 15A and 15B.

The present systems and methods may further comprise improving predictions by incorporating nodes for observations of any of the predicted variables made at one or more times. These are referred to as observation nodes. An observation may be a quantitative measurement using some mechanical or electrical device (e.g., ruler or transducer), a visual observation made by a human of some qualitative characteristic (e.g., color), or even an observation that some event (e.g., failure) has occurred or not.

The archetype developed for representing any uncertain observation of some observable quantity (e.g., thickness) is to realize that the observation is caused by the true value plus any error associated with the observation. To account for this in a network, the present systems and methods comprise adding additional nodes for the true value, the observed value, and the error of the observation. The direction of causality is indicated by arrows pointing from the true value and the observation errors to the observed value nodes. Additional supplemental nodes may be added for the time of the observation or any other information that needs to be accounted for. Problem-specific equations may be used to add the observation error to the true value to obtain the observed value, which may be encoded in the CPT of the observed value node.

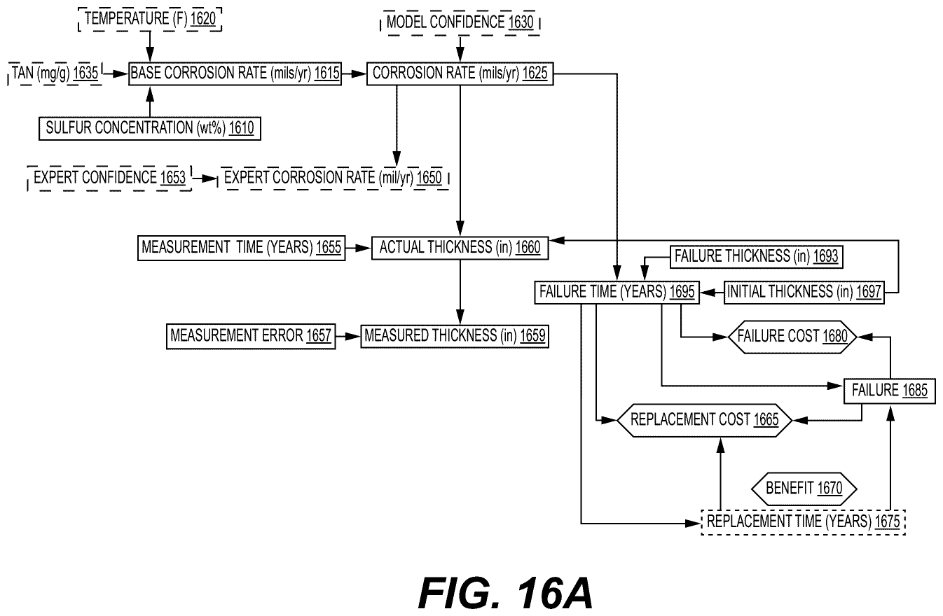

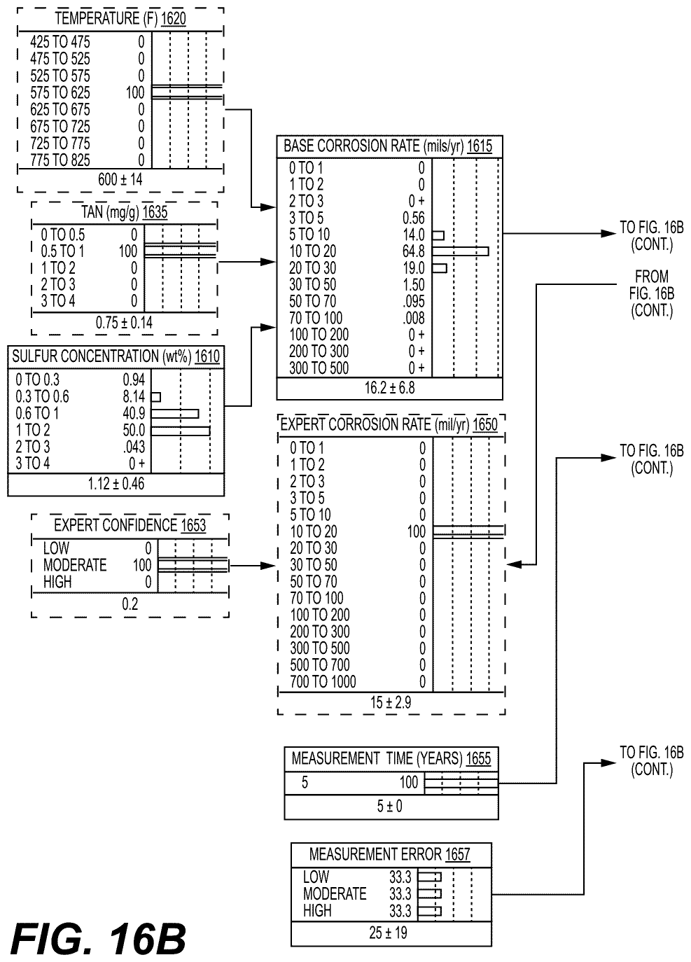

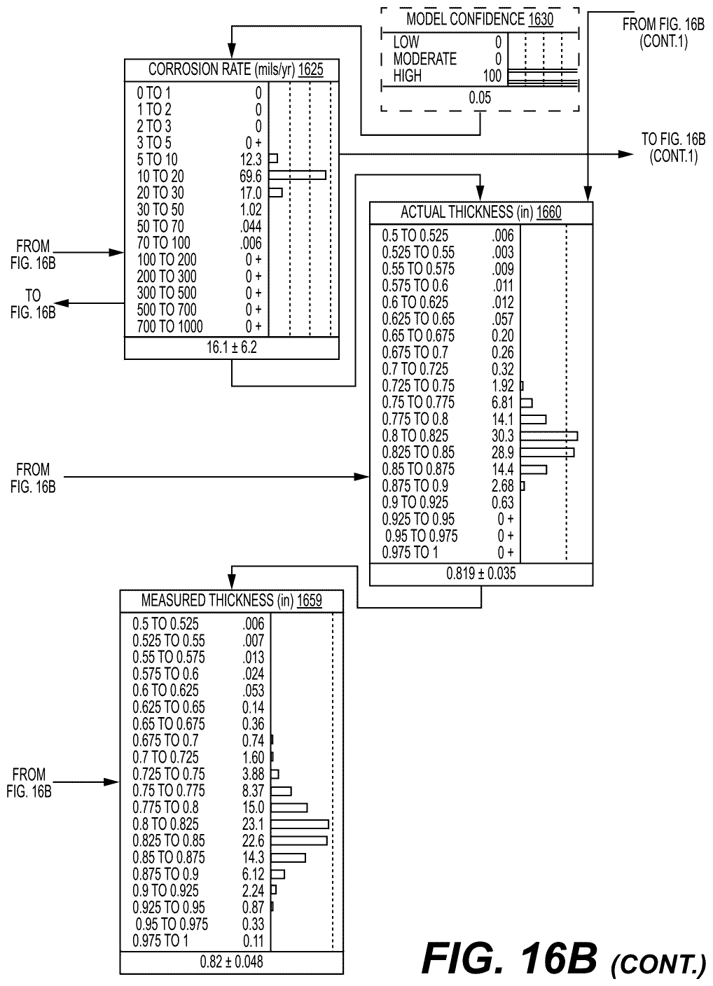

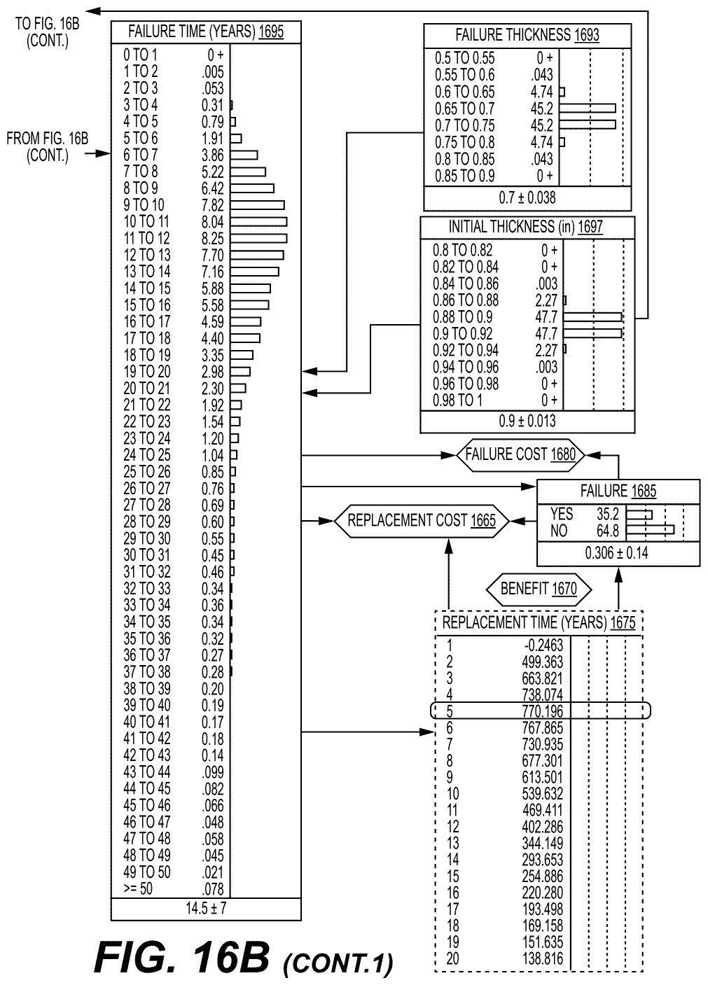

FIG. 16A shows a simplified view of a sample network according to an embodiment of the disclosure. FIG. 16B shows a detailed view of the sample network of FIG. 16A illustrating how the predictive corrosion rate and failure time are used to determine the optimal choice for the replacement time as well as how the physics-based model predictions are blended with an expert opinion and a measured thickness. FIG. 16A and FIG. 16B illustrate a further sample extension of the probabilistic causal network in FIGS. 15A and 15B used in systems and methods according to an embodiment of the disclosure. The network comprises nodes for Sulfur Concentration (wt %) 1610, Base Corrosion Rate (mils/yr) 1615, Temperature (F) 1620, Corrosion Rate (mils/yr) 1625, Model Confidence 1630, TAN (mg/g) 1635, Expert Corrosion Rate 1650, Expert Confidence 1653, Measurement Time (years) 1655, Measurement Error 1657, Measured Thickness (in) 1659, Actual Thickness (in) 1660, Replacement Cost 1665, Benefit 1670, Replacement Time (years) 1675, Failure Thickness (in) 1693, Failure Time (years) 1695, Initial Thickness (in) 1697, Failure Cost 1680, and Failure 1685. The network of FIGS. 15A and 15B is extended in FIGS. 16A and 16B to show how predictions can be improved by accounting for a single observation of the measured thickness. This comprises adding additional nodes for the observation, the time at which the observation is made, and any uncertainty in the observation (i.e., represented here by the Measured Thickness 1659, Measurement Time 1655, and Measurement Error 1657 nodes). There is also a single decision node for the Replacement Time 1675 and nodes that account for an expert opinion and the confidence in that expert opinion (i.e., represented here by the Expert Corrosion Rate 1650 and Expert Confidence 1653 nodes), but these will not be discussed in detail until later. The actual thickness predicted at the measurement time is accounted for by the Actual Thickness 1660 node. To represent the measurement process, the state on the Measured Thickness 1659 node whose range contains the measured thickness value is the one selected as hard evidence (not shown here). Through probabilistic inference, this information propagates back up through the network to update the other random-variable nodes, most importantly the Corrosion Rate 1625 node. Knowing the corrosion rate allows one to predict future metal loss and the time of failure. Since no evidence is currently set on the Measured Thickness 1659 node, the network as shown here predicts what the future measured thickness will be by displaying the probabilities of each possible value. Note, additional nodes may be added for more than one measurement, all of which may be blended together to get an updated final prediction for the corrosion rate.

### Blending Multiple Sources of Knowledge

An embodiment of the disclosure is directed to a method for blending multiple sources of knowledge together to arrive at a single probabilistic representation of whatever observable random-variable is desired, regarded as the single source of truth of that variable. The method comprises using the probabilistic, causal networks described herein and by realizing that the single source of truth is caused by certain factors (e.g., predictive physics-based model) while, on the other hand, it also causes other sources of knowledge (e.g., real-world observations or expert opinions). The various patterns developed for building the appropriate network structure as described herein allow for the network to be set up properly for any number of sources of knowledge. In essence, the single source of truth may be represented by a single node in the network with arrows branching in or out of it, accordingly, to represent the other sources of knowledge that either inform or are informed by that variable. The particular network representation may differ depending on the context, but the essence remains the same.

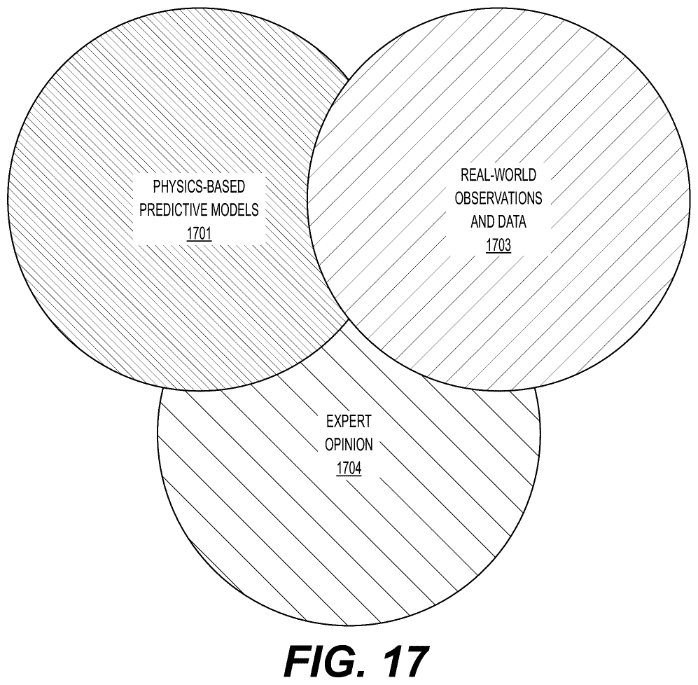

FIG. 17 illustrates an abstract blending of three primary sources of knowledge (i.e., physics-based predictive models 1701, real-world observations/data 1703, and the opinion of human experts 1704) to arrive at a single source of truth for any observable quantity using systems and methods according to embodiments of the disclosure. There may be multiple instances of each source of knowledge (i.e., more than one model, observation, or expert) and not every type needs to be included (i.e., there may be no model, observations, or expert opinion). To always be most predictive, this blending needs to be done dynamically as soon as any new information becomes available. As an example, the network shown previously in FIGS. 16A and 16B represents one way of blending together all three sources of knowledge. There are nodes for predicting the corrosion rate from a physics-based model (i.e., the Base Corrosion Rate 1615 node and all of its causes), nodes that account for real-world observations and data (i.e., the Measured Thickness 1659 node and related nodes), and nodes for the expert opinion (i.e., the Expert Corrosion Rate 1650 and related nodes). The network of FIGS. 16A and 16B is structured such that the nodes related to prediction are considered to be the causes of the single source of truth represented by the Corrosion Rate 1625 node. The two other sources of knowledge are represented by additional nodes regarded as the effects of this single source of truth. These are the Actual Thickness 1660, Expert Corrosion Rate 1650, and Failure Time 1695 nodes.

Though such a process is referred to as blending the sources of knowledge, this is not arbitrary blending, as sometimes is done without using probabilistic causal networks by simply averaging all the observations. Instead, the blending used in the present systems and methods is blending that is probabilistically correct, based on the relative confidence one has in each observation or other source of knowledge. To explain this blending process in more detail using the previously described network for updating the corrosion rate, consider that evidence is not typically set on the Actual Thickness 1660 node itself but rather on the Measured Thickness 1659 node, which differs from the actual value due to measurement error. Thus, the measurement error is the origin of uncertainty for this type of observation. The expert opinion has its own source of uncertainty, as represented by the Expert Confidence 1653 node with the categorical choices of Low, Moderate, and High confidence. Selecting one of these values sets particular numerical parameter values for the probability distribution assumed for the difference (i.e., error) between the Expert Corrosion Rate 1650 and the true value represented by the Corrosion Rate 1625 node. These two sources of knowledge (i.e., measurement and expert opinion) are then automatically blended based on their relative error to update the Corrosion Rate 1625. That is, if there is high confidence in the expert opinion and low confidence in the measured value (high measurement error), then more weight is given to the expert opinion (it has a greater influence on the corrosion rate). On the other hand, if the measurement error is small and the confidence in the expert is low, then more weight is given to the measured value. This is all blended with the model predicted corrosion rate, which comes from the Base Corrosion Rate 1615 node and its associated confidence, as represented by the Model Confidence 1630 node that acts similarly to the Expert Confidence 1653 node. The final result is the blending together of all three sources of knowledge based on the specified relative confidence in each to arrive at an updated single source of truth for the Corrosion Rate 1625.

Furthermore, the present systems and methods also allow for entering evidence about observed events, such as failure, to update the Corrosion Rate 1625 node. For example, since the corrosion rate is used to predict the failure time in this network, an observation about when failure actually occurs, if failure does occur, will also update the corrosion rate. Such evidence would be entered by selecting the observed failure time on the Failure Time 1695 node, and then weighing that observation along with the other observations and predictions to once again update the single source of truth on the Corrosion Rate 1625 node. The source of uncertainty for the failure time is represented here by uncertainty in the failure thickness, which is not normally known precisely. Note, this may not be the only source of uncertainty. This can be regarded as the error of the failure time observation, which then may be used to blend this observation together along with the other sources of knowledge and their respective errors.

By using slightly modified network designs, these sources of knowledge may be represented in the network used in the present systems and methods in different ways. As a nonlimiting example, if the predicted corrosion rate came from a separate, disconnected network, or from a more sophisticated numerical model of corrosion that involves the solution of differential equations representing reactions, diffusions and other sources of complexity that cannot be readily represented by a simple network structure, then the external methods may be used to obtain the prior corrosion rate distribution separately outside of this network. Such prior corrosion rate may then be applied to the Corrosion Rate 1625 node by specifying its CPT directly with no other causal nodes added (i.e., no nodes pointing to the Corrosion Rate 1625 node). Alternatively, if there is only an expert opinion and observations and there is no predictive physics-based model, then the expert corrosion rate may be set as the prior distribution of the Corrosion Rate 1625 node directly in an analogous manner, without using the additional nodes shown here.

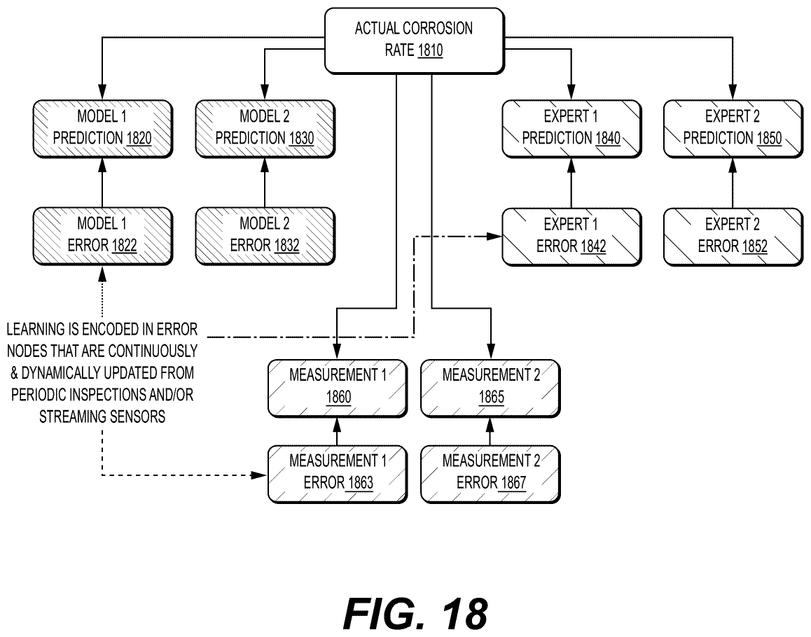

FIG. 18 shows a schematic representation of a general-purpose probabilistic causal network used in systems and methods according to an embodiment of the disclosure. The shown network is used for blending one or more model predictions (narrow spaced upper left to lower right slant background) depicted by nodes for Model 1 Prediction 1820, Model 1 Error 1822, Model 2 Prediction 1830, and Model 2 Error 1832; one or more expert opinions (wide spaced upper left to lower right slant background) depicted by nodes for Expert 1 Prediction 1840, Expert 1 Error 1842, Expert 2 Prediction 1850, and Expert 2 Error 1852; and one or more measurements (wide spaced upper right to lower left slant background) depicted by nodes for Measurement 1 1860, Measurement 1 Error 1863, Measurement 2 1865, and Measurement 2 Error 1867, or any other type of observation. The basis of this blending method is assuming there is a single source of truth node (i.e., represented here by the Actual Corrosion Rate 1810 node, but it may be any other desired quantity) that causes all these predictions, observations, and opinions. By entering evidence on any of the effect nodes, one learns more about the single source of truth. Any knowledge gained through this learning process is encoded in the posterior probabilities of this single source of truth node. A prior distribution may also be set on the single source of truth node to represent all past cumulative knowledge (i.e., before any of the new predictions, observations, or opinions are accounted for) to properly blend past and present knowledge. It should be noted that none of these effect nodes are required (the only required node is the single source of truth node). For example, if there is no expert opinion, then none of the wide spaced upper left to lower right slant background nodes related to the expert opinion are included.

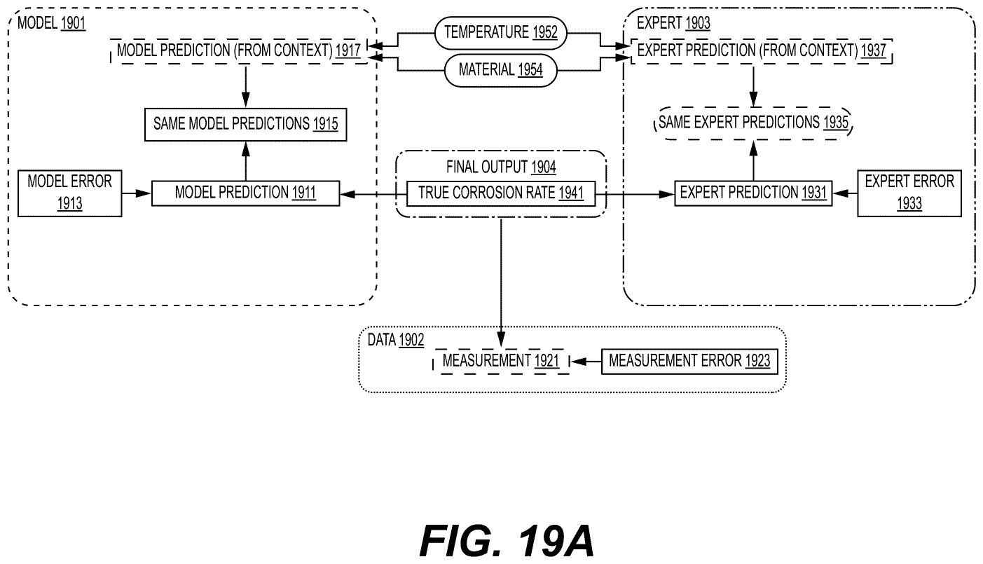

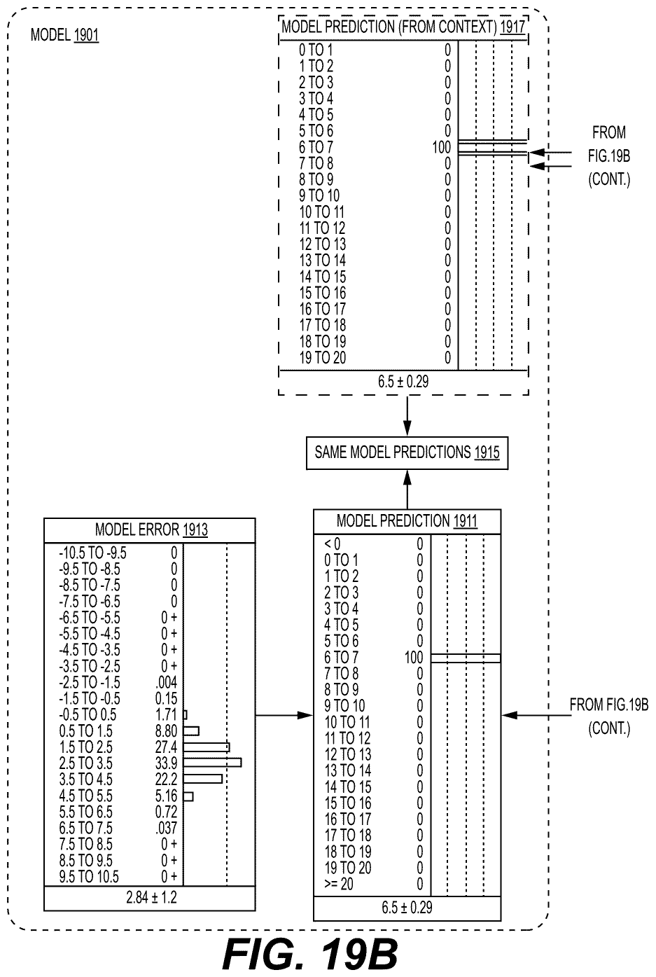

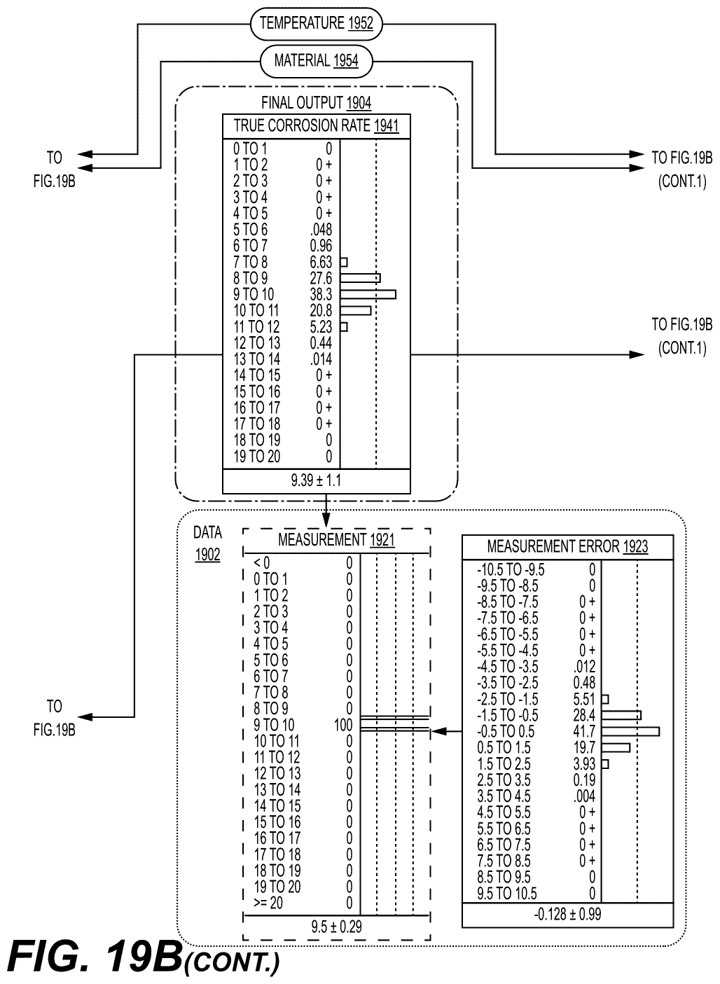

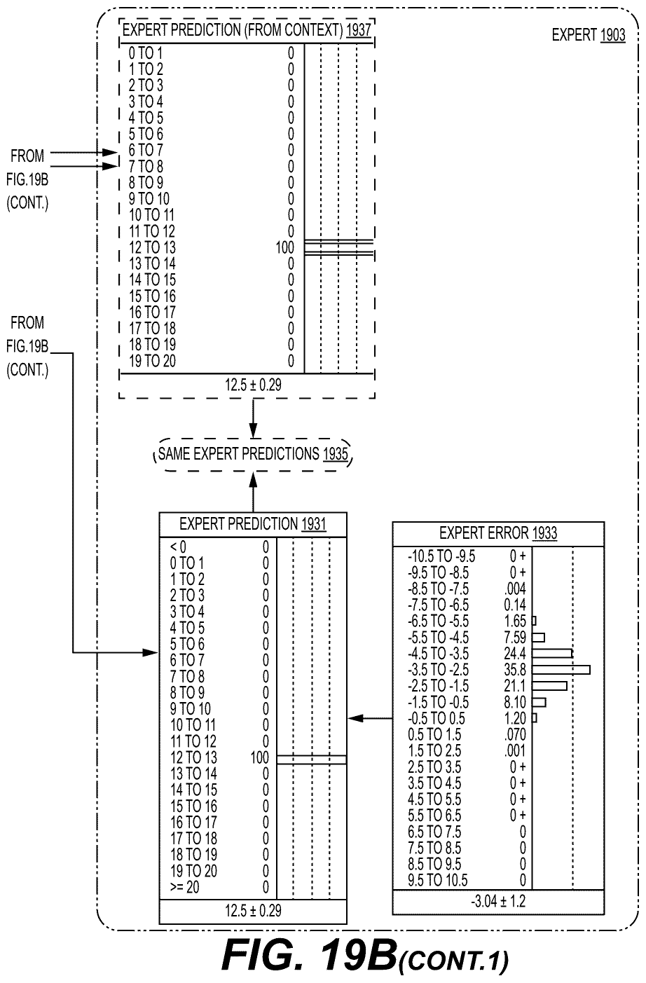

FIG. 19A shows a simplified view of a sample causal network according to an embodiment of the disclosure. FIG. 19B shows a detailed view of the sample causal network of FIG. 19A illustrating the blending of multiple knowledge sources (model predictions, measurements, and expert opinions) to arrive at a sole source of truth for the corrosion rate. In particular, FIG. 19A and FIG. 19B illustrate a specific example of the conceptual probabilistic causal network in FIG. 18. The network of FIGS. 19A and 19B comprises nodes for Model Prediction 1911, Model Error 1913, Same Model Predictions 1915, Model Prediction (From context) 1917, Temperature 1952, Material 1954, True Corrosion Rate 1941, Measurement 1921, Measurement Error 1923, Expert Prediction 1931, Expert Error 1933, Same Expert Predictions 1935, and Expert Prediction (From context) 1937. In this example, there is one model prediction contained within the Model bubble 1901, one measurement contained within the Data bubble 1902, and one expert opinion contained within the Expert bubble 1903. All three are blended together probabilistically to get a single updated prediction for the True Corrosion Rate 1941 node (in the Final Output bubble 1904).

### Sharing Knowledge Learned

In an embodiment, the disclosure is directed to methods of sharing knowledge across assets of similar metallurgy, process, and expected damage rate and extent. This knowledge may come from different assets in a single facility or even from different assets across different facilities.

As knowledge is learned and built up over time in such a manner, the knowledge may be shared across facilities by applying the same prior distribution on the single source of truth node across different networks for each facility. The prior distribution on the single source of truth node always represents the most up-to-date state of knowledge about that observable quantity from past observations. Likewise, measurements or other observations taken at different facilities operating under nearly identical conditions may also be pooled together and used to update a single network for the single source of truth for multiple measurements. The same principle applies to any source of knowledge. Once again, learning occurs automatically though the updating of the model error node as new measurement nodes are added.

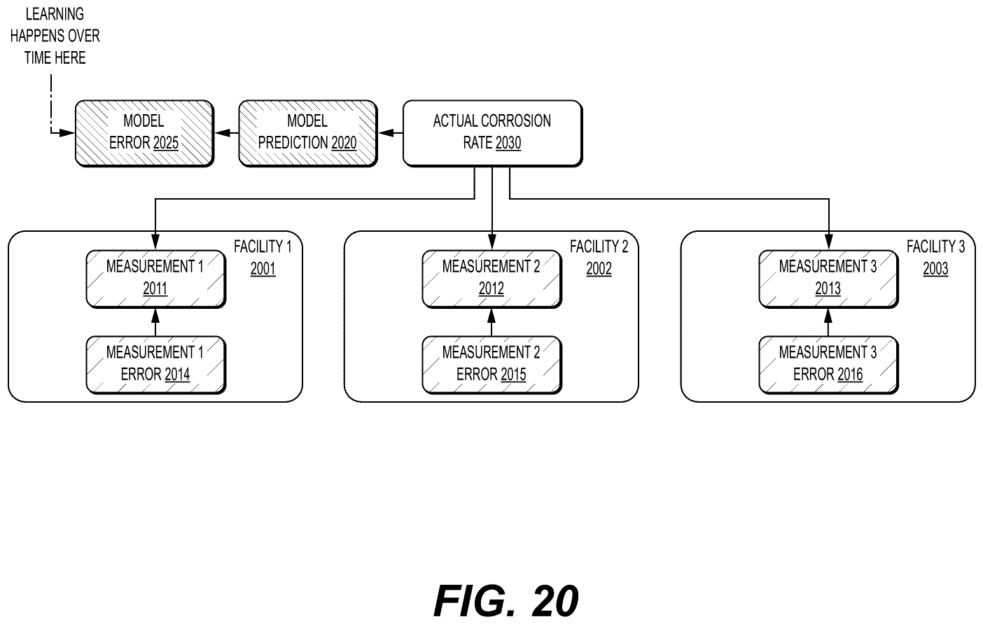

FIG. 20 shows a schematic for a general-purpose probabilistic, causal network used in systems and methods according to embodiments of disclosure. FIG. 20 blends one or more model predictions (narrow spaced upper left to lower right slant background) and one or more measurements (wide spaced upper right to lower left slant background). The network comprises nodes for Actual Corrosion Rate 2030, Model Prediction 2020, Model Error 2025, Measurement 1 2011, Measurement 1 Error 2014, Measurement 2 2012, Measurement 2 Error 2015, Measurement 3 2013, and Measurement 3 Error 2016. The network shown is used to pool data together from different facilities (Facility 1 2001, Facility 2 2002, and Facility 3 2003) operating under nearly identical conditions to arrive at a single, universal source of truth for whatever quantity is desired. Such a process of sharing knowledge, by using a probabilistic causal network, is consistent with the previously illustrated process in FIG. 18, FIG. 19A, and FIG. 19B for updating and learning the Actual Corrosion Rate node from observations at a single facility. The observations (i.e., Measurements 1 through 3) may come from different facilities, plants, units, or assets. Sharing knowledge in such a way is only possible if the assets within each facility have similar characteristics and are expected to be damaged at similar rates, so that the assumption of a single corrosion rate is valid.

### Decision Optimization

As an embodiment of the disclosure, methods are directed to using predictive networks that blend together multiple sources of knowledge to help make optimal life cycle related decisions. The methods comprise adding additional utility and decisions nodes. An example of such a network is shown in FIGS. 16A and 16B. Three utility (cost/benefit) nodes (hexagon shaped solid outline) are added for the benefit of operation, the failure cost, and the cost of replacement. In this simplified example, the positive benefit of operation (e.g., revenue acquired from normal operation) is assumed to be proportional to the time of operation up to the replacement time. More complex benefit models may be used. The negative costs of failure and replacement are one-time costs that are incurred only at the time these events occur, if the events do occur. Only a single decision node (short dashed line outline) is added for the replacement time.

There is a new Failure node added as well, with two categorical states, Yes and No, with probabilities that represent the cumulative failure probability at the selected replacement time. Failure may either occur before replacement (Yes), or not at all (No) if the replacement is made before failure. The probability of Failure=Yes is then the same as the probability of failing before replacement. The total lifetime of the asset, which is variable, is the minimum of the failure time or the replacement time.

The optimization problem for this example is stated as finding the optimal replacement time that either maximizes the difference between the total accumulated benefit and cost over the lifetime of the asset, also known as the total ROI, or that maximizes the total ROI divided by the lifetime (i.e., to make the most amount of money in the shortest amount of time), also referred to as the lifetime-averaged ROI. If the asset is always replaced after failure, then the highest long-term benefit after many back-to-back life cycles is often obtained by finding the replacement time that solves the second optimization problem (i.e., maximizing the lifetime-averaged ROI). This is the problem solved by the network in FIGS. 16A and 16B. However, if there is no replacement (i.e., just a one-time usage), there may be situations where maximizing just the total ROI by itself is desired. The networks can be set up to solve either optimization problem, depending on the need.

The network solves this optimization problem by essentially cycling through every possible replacement time, and for each replacement time, probabilistically sampling the failure time from the failure time node and then comparing the sampled failure time to the replacement time to determine the fraction of time that failure occurred before the planned replacement to estimate the probability of failure. If the sampled failure time is less than the replacement time, then failure occurs (i.e., Failure=Yes), and the full cost of failure is incurred. If the sampled failure time is greater than the replacement time, then there is no failure (i.e., Failure=No) and, of course, no cost of failure. The replacement cost is always incurred, because replacement occurs whether there is failure or not. The benefit of operation is obtained by multiplying the constant benefit rate by the lifetime (i.e., the minimum of the failure time and the replacement time), which is not fixed because failure occurs randomly.

Adding all these costs and benefits up and dividing by the lifetime leads to a single sample of the lifetime-averaged ROI. Repeating this process many times leads to a large sample of lifetime-averaged ROIs that is then used to find the expected lifetime-averaged ROI for that replacement time. This is done for every possible replacement time, and the expected lifetime-averaged ROI is displayed next to each choice on the Replacement Time node. For this example, the replacement time with the highest expected lifetime-averaged ROI of about $770,000/yr is 5 years, which is the optimal choice found by the network.

### Analytical Solutions for a Simplified Intrusive Only Casual Network

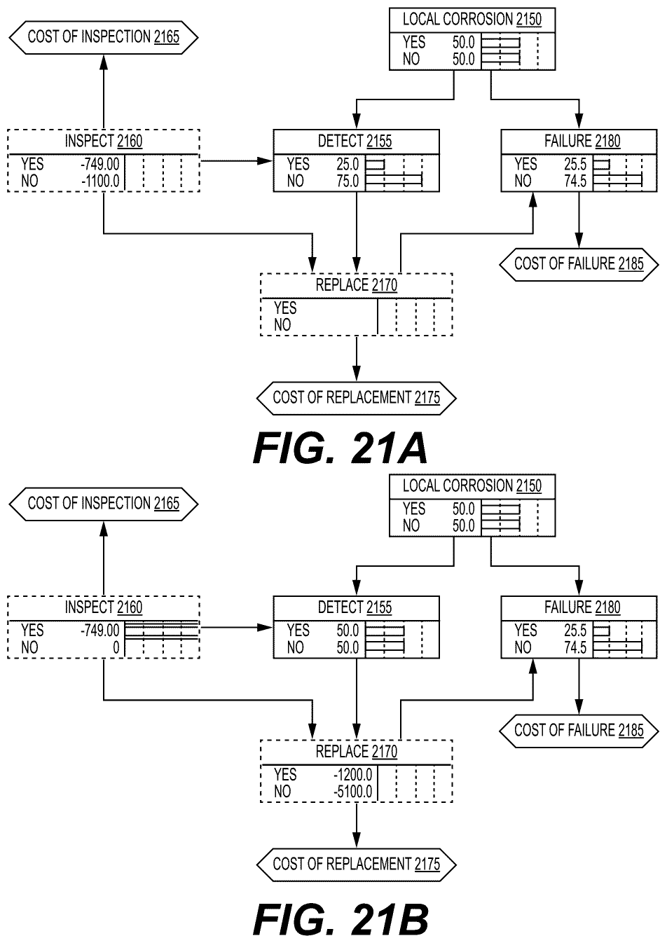

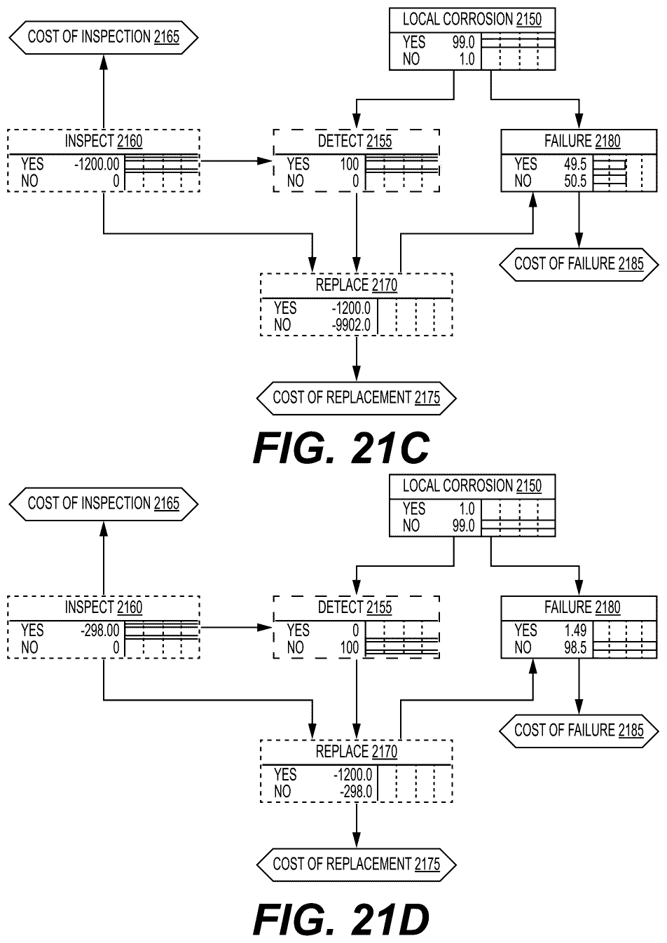

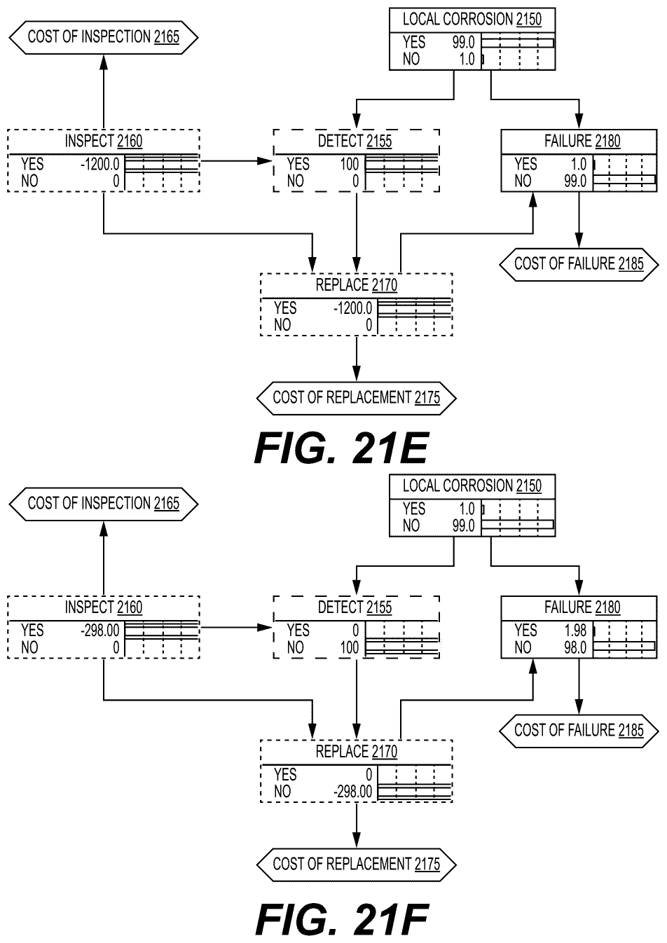

In an embodiment, the disclosure is directed to systems and methods comprising analytical solution methodologies. A simple decision network is presented in FIG. 21A-21F to illustrate how the belief probabilities and expected utilities may be verified analytically. The simplified network in FIG. 21A-21F is provided for conceptual demonstration only, since analytical methods are not typically feasible (due to complexity and inefficiency), as most practical situations normally require numerical approaches. The network comprises nodes for Local Corrosion 2150, Detect 2155, Inspect 2160, Cost of Inspection 2165, Replace 2170, Cost of Replacement 2175, Failure 2180, and Cost of Failure 2185.

FIG. 21A-21F show a probabilistic causal network that may be used in present systems and methods to determine the optimal decision strategy about whether to inspect or not and then whether to replace or not depending on whether any damage was detected or not during the inspection. In FIG. 21A-21F, the random-variable nodes (solid line rectangular outline for no evidence set and long dashed line rectangular outline for evidence set) are Local Corrosion, Detect, and Failure, the two decision nodes (short dashed line rectangular outline) are whether to Inspect or Replace, and the utility nodes (hexagon shaped solid outline) are the Cost of Inspection, Cost of Replacement, and Cost of Failure. FIG. 21A-FIG. 21F illustrate the various steps of setting evidence in a certain way to find the optimal decision strategy analytically.

The inspection method is assumed to be only partially effective, meaning it is subject to both false positive (i.e., declaring damage is there when it really is not) and false negative (i.e., not finding damage that really is there) errors. Replacing the asset brings it back to its initial, nearly-damage-free state, but at a cost. The optimal decision strategy is the one that minimizes the total expected cost of inspection, replacement, and failure over the life cycle.

The two decision nodes (short dashed line rectangular outline), Inspect 2160 and Replace 2170, each have only two categorical states (i.e., Yes and No) that are selected depending on whether these actions took place or not. Since an arrow points from the Inspect 2160 node to the Replace 2170 node, the decision to inspect is made first, followed by the decision to replace, after the inspection results are assessed.

A Local Corrosion 2150 node accounts for how likely it is that local corrosion damage is present or not. Its prior probability distribution, encoded in its CPT, is set so that it is equally likely of having or not having local corrosion before any inspection is performed, as shown in Table 1. These probabilities will be updated based upon whether damage is detected or not during the inspection, through the rules of probabilistic inference encoded in the network structure and nodal CPTs assumed here.

TABLE 1
Prior Probabilities for the Local Corrosion node states

| Local Corrosion = Yes | Local Corrosion = No |
|---|---|
| 0.5 | 0.5 |

The Detect 2155 node is added to account for the probability of detecting damage during the inspection. This probability depends on whether or not there actually is damage (i.e., the state of the Local Corrosion 2150 node), the effectiveness of the inspection method at detecting damage, and whether an inspection is performed at all. The CPT assumed for the Detect 2155 node that expresses all of this is shown in Table 2. The numbers listed in Table 2 are conditional probabilities that reflect a slightly imperfect detection method that has equivalent false positive and false negative rates of 1%. Here, no detection is possible unless there is an inspection.

TABLE 2
Conditional Probability Table for the Detect Node

| Local Corrosion | Inspect | Detect = Yes | Detect = No |
|---|---|---|---|
| Yes | Yes | 0.99 | 0.01 |
| Yes | No | 0 | 1 |
| No | Yes | 0.01 | 0.99 |
| No | No | 0 | 1 |

The Failure 2180 node is used to indicate how likely failure is over some fixed period following the inspection, depending on whether or not there actually is damage (i.e., the state of the Local Corrosion 2150 Node), and whether or not the asset was replaced (i.e., the state of the Replace node). The CPT assumed for the Failure node is shown in Table 3. It is assumed that there is a 99% chance of failure if there is damage and no replacement. There is a small 1% probability of failure assumed even when there is no detectable damage from, perhaps, currently undetectable damage that might worsen over time. This failure probability may have been determined from a separate predictive network, such as the one shown previously in FIGS. 15A and 15B.

TABLE 3
Conditional Probability Table for the Failure node

| Local Corrosion | Replace | Failure = Yes | Failure = No |
|---|---|---|---|
| Yes | Yes | 0.01 | 0.99 |
| Yes | No | 0.99 | 0.01 |
| No | Yes | 0.01 | 0.99 |
| No | No | 0.01 | 0.99 |

Three cost nodes (hexagon shaped solid outline) account for the costs of inspection, replacement, and failure, but only if these actions are taken or events occur. The assumed costs for the network in FIG. 21A-21F are listed in Table 4. Because these values are costs, they are entered into the network as negative utilities.

TABLE 4
Assumed Costs

| | Inspection | | Replacement | | Failure |
|---|---|---|---|---|---|
| Inspect | Cost | Replace | Cost | Failure | Cost |
| Yes | $100 | Yes | $1,000 | Yes | $10,000 |
| No | $0 | No | $0 | No | $0 |

The optimization problem here, as usual, is to find the combination of inspection and maintenance decisions that minimizes the total overall cost, or maximizes the total return if benefit were included. The expected cost for the first decision about whether or not to inspect, given all the previous assumptions, is displayed on the Inspect 2160 node next to each choice. Here, costs are displayed as negative returns. Since the Inspect=Yes choice has the lowest expected cost of $749, or largest utility of −$749, as shown in FIG. 21A, it is the best first choice. Taking this action is represented in the network by selecting the Yes choice on the Inspect node.

After selecting Inspect=Yes, but before any inspection result is recorded, the probabilities next to the Detect=Yes and Detect=No states reflect the probabilities of getting those results based on the prior probabilities assumed for the Local Corrosion 2150 node and the false positive and false negative rates assumed for the detection method. This results in it being equally likely that damage will or will not be detected, as shown in FIG. 21B.

If damage is detected during the inspection, it is entered in the network by selecting Yes as evidence on the Detect 2155 node, as shown in FIG. 21C. The expected costs on the Replace 2170 node are updated, revealing that the next best decision is to replace, since this choice has the lowest expected cost of $1,200, or the largest utility of −$1,200. Replacement is now worth it, because otherwise, the probability of failure would go up to 98% (i.e., not shown here), and the expected cost of failure would be higher than the replacement cost. By going through with the replacement when damage is found, by selecting Replace=Yes, the failure probability goes down to 1% as shown in FIG. 21E.

If no damage is detected during the inspection, as shown in FIG. 21D, then not replacing is the best choice, since it has the lowest expected cost of $298, or largest utility of −$298. Likewise, when damage is not detected and there is no replacement, the probability of failure goes down to 1.98%, as shown in FIG. 21F. Even though this is a simple example, it has all the basic elements of more complex probabilistic, causal networks that recommend optimal life cycle decisions for more realistic scenarios.

To understand how the network arrives at all these recommendations, a table like that shown in Table 5 may be constructed that goes through every possible combination of decisions and events, weighted by the probability of them occurring, to determine the expected cost of that combination. At every possible decision point, a rational decision maker is assumed, meaning the choice with the lowest expected cost is the one selected. These best choices are depicted in Table 5 by having underlined text.

TABLE 5
Possible Combinations of Decisions and Events and Associated Expected Costs

| | | | | | | | Expected | Expected |
|---|---|---|---|---|---|---|---|---|
| | | | | | | | Cost for | Cost for |
| | | | | | | | Replace | Inspect |
| Inspect | Detect | P(Detect) | P(Damage) | Replace | Fail | P(Fail) | Decision | Decision |
| Yes | Yes | 50% | 99% | Yes | Yes | 1% | $1200 | $749 |
| | | | | | No | 99% | | |
| | | | | No | Yes | 98.02% | $9902 | |
| | | | | | No | 1.98% | | |
| | No | 50% | 1% | Yes | Yes | 1% | $1200 | |
| | | | | | No | 99% | | |
| | | | | No | Yes | 1.98% | $298 | |
| | | | | | No | 98.02% | | |
| No | N/A | | 50% | Yes | Yes | 1% | $1100 | $1100 |
| | | | | | No | 99% | | |
| | | | | No | Yes | 50% | $5000 | |
| | | | | | No | 50% | | |

As shown in Table 5, there are twelve (12) total possible unique outcomes. One can decide to inspect or not. If there is no inspection, one can still decide whether to replace or not, and for each choice, failure may or may not occur. That results in four possible outcomes. If one decides to inspect, then damage will either be detected or not, and for each possibility, one can either replace or not replace, and for each of these combinations, failure may or may not occur. That results in another eight outcomes, leading to a total of twelve (12) possible outcomes.

For each possible outcome, the expected cost is added up based upon what particular decisions were made and what events occurred and then weighed by the probability of that outcome happening. For example, for the particular outcome sequence Inspect=Yes, Detect=Yes, Replace=Yes, and Fail=Yes, the total cost would be $100 (i.e., inspection cost)+$1,000 (i.e., replace cost)+$10,000 (i.e., failure cost)=$11,100. This may be marginalized over the failure event by noting that this outcome only occurs 1% of the time, since that is the failure probability, leading to a total expected cost of $11,100*0.01=$111. For the outcome sequence Inspect=Yes, Detect=Yes, Replace=Yes, and Fail=No, the total cost would be $100+$1,000=$1,100 (i.e., no failure cost). Since the probability of not failing is 99%, the expected cost of this outcome is $1,100*0.99=$1,089. Adding these two together for both failure and no failure yields the marginalized expected cost of $1,089+$111=$1,200 for the outcome Inspect=Yes, Detect=Yes, Replace=Yes, regardless of the failure event. This is the first row in the Expected Cost for Replace Decision column. All the other expected costs in that column are determined in a similar manner.

Once all these expected costs for every path leading to a replacement decision have been determined, the next step is to find the total expected cost for each choice of the inspection decision. This is done by first realizing that whenever a rational decision maker is faced with a replacement decision, it is assumed that they will always choose the outcome having the lower expected cost. This means the three choices with underlined text in the Expected Cost for Replace Decision column of Table 5 are assumed to be the only ones a rational decision maker would ever make, and so the other choices are not considered when determining the expected cost of the inspection decision.

The next step is to determine the probability of reaching each of these replacement decision points. For the Inspect=Yes choice, there are only two possibilities: Detect=Yes with an expected cost of $1,200 and Detect=No with an expected cost of $298. Both occur with probability 50%. Therefore, the total expected cost for Inspect=Yes is 0.5*$1,200+0.5*$298=$749. This is the same cost displayed next to the Yes choice on the Inspect node in FIG. 21A.

Likewise, for Inspect=No, the expected cost for the optimal Replace=Yes choice is $1,100 with probability 100% of occurring since there is no other reasonable choice. This is also the same cost displayed next to the Inspect=No choice in FIG. 21A. All other combinations of decisions and events in the network shown in FIG. 21B-21F agree with the values hand calculated in Table 5.

This shows the value of setting up a probabilistic, causal network such as described for the present systems and methods, namely that all of these calculations are performed automatically, and the optimal decisions are immediately apparent. The present systems and methods allows for many more complex networks to be built where it is intractable to perform hand calculations, and yet the best decisions may be found when using the present systems and methods.

In an embodiment, the disclosure is directed to methods for analytical and numerical solution procedures for probabilistic inference of the probabilistic causal networks. Probabilistic inference is an important property demonstrated by the probabilistic causal networks. The method comprises that where evidence is set on one node, the state probabilities of all the other nodes are updated accordingly. In this example, setting evidence on the Detect 2155 node updates the state probabilities of the Local Corrosion 2150 node (i.e., opposite to the indicated direction of causality), which then updates the probabilities on the Failure 2180 node in the direction of causality.

For a simple network, mathematical consistency may be checked by using the rules of probability theory. As an example, checking the mathematical consistency for the simple two-variable context is equivalent to using Bayes Theorem. The relationship between conditional probabilities is written as Equation 1, where LC stands for Local Corrosion, and D stands for Detect.

$$P ( LC = Yes \vert D = Yes ) = \frac{P ( D = Yes \vert LC = Yes ) \cdot P ( LC = Yes )}{\begin{matrix}P ( D = Yes \vert LC = Yes ) \cdot P ( LC = Yes ) + \\ P ( D = Yes \vert LC = i ) \cdot P ( LC = No )\end{matrix}} \qquad ( Equation 1 )$$

From the specified CPT of the Detect 2155 node, it is assumed that the probability of correct detection is P(D=Yes|LC=Yes)=0.99 and the probability of a false positive is P(D=Yes|LC=No)=0.01. From the prior probabilities set on the Local Corrosion 2150 node, P(LC=Yes)=0.5 and P(LC=No)=0.5. Using these particular values in Equation 1 leads to the probability of:

$$P ( LC = Yes \vert D = Yes ) = \frac{0.99 \cdot 0.5}{0.99 \cdot 0.5 + 0.01 \cdot 0.5} = 0.99$$

This is the same probability shown next to the Yes state on the Local Corrosion 2150 node in FIG. 21C for this same circumstance.

### Other Specific Causal Methods

As a subset of the probabilistic, physics-based, causal methods and their representation as causal networks, systems and methods described herein further comprise supplemental methods that include specific causal methods and causal networks. Such systems and methods address specific applications relevant to the overarching systems and methods applied to aging assets and asset life cycle optimization. Nonlimiting examples comprise specific methods for inspection effectiveness, maintenance, decision strategies, multiple failures, extreme value analysis, probability of failure sequential updating, and uninspectable damage mechanisms.

### Inspection Effectiveness

In an embodiment, the disclosure is directed to methods for inspection effectiveness. For inspection effectiveness, there are three key quantifiable measures: measurement error, probability of detection (POD), and coverage area. Some inspection techniques are better at detecting damage due to higher POD and larger coverage area per test, while other inspection techniques are better at sizing (e.g., measuring thickness or crack depth) due to lower measurement error but at the expense of having less coverage area. There are also modern inspection techniques that attempt to bridge the gap between the two, providing both expansive coverage areas for detecting damage with higher confidence, while also measuring thickness more accurately. The present methods are directed to probabilistic causal methods, which may use a network, to predict damage and failure time.

For sizing inspections, the inspection result is often either a measured thickness (i.e., for thinning) or crack depth (i.e., for cracking). Each inspection method has a measurement error that can vary between inspections for any number of reasons. The measured thickness or crack depth is expected to be centered around the predicted thickness or crack depth (i.e., if there is no bias) with an additional variance due to measurement error. The present methods may be used to predict damage rate, failure, and damage state at any future time using causal networks. The present methods may further use predictive networks to account for measurement error from any sizing inspection.

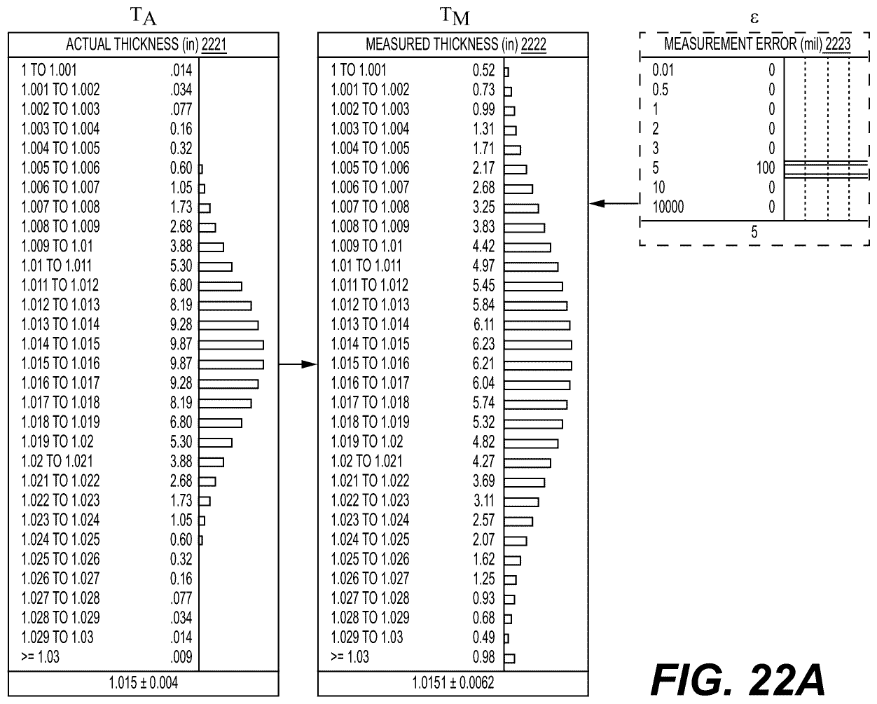

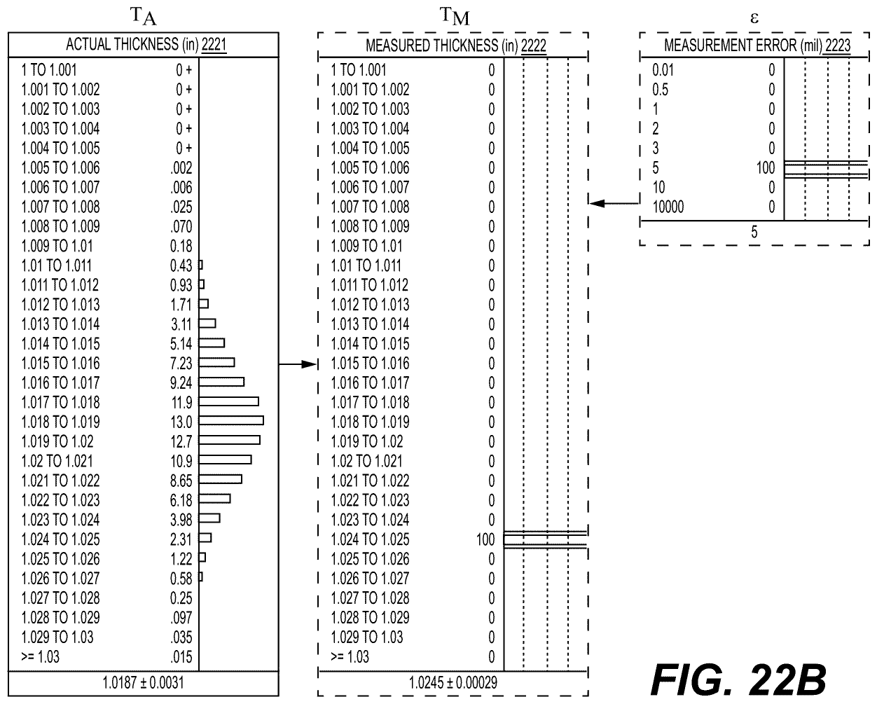

FIG. 22A and FIG. 22B show sample networks for probabilistically modeling any single measurement process of an observed variable (i.e., shown here as a measured thickness) with an imperfect measurement technique according to embodiments of the disclosure. Both networks have the same nodal structure and nodes (i.e., Actual Thickness 2221 node, Measured Thickness 2222 node, and Measurement Error 2223 node). FIG. 22A illustrates the prediction of the Measured Thickness 2222 given a prior probability for the Actual Thickness 2221 and a Measurement Error 2223 of 5 mils. FIG. 22B illustrates the updated belief for the Actual Thickness 2221 node given an observed measured thickness of 1.0245 inches that is set as evidence on the Measured Thickness 2222 node. The probabilistic relationship for the measurement process represented by this network is expressed mathematically as Equation 2.

$$P ( {T}_{M} \vert {T}_{A} , ε ) = 𝒩 ( {T}_{A} , ε ) \qquad ( Equation 2 )$$

where T_{A} is the actual, or true, thickness, T_{M} is the measured thickness, and ε is the standard deviation of the normal distribution that characterizes the measurement error.

A non-uniform prior distribution is assumed for the actual thickness, which may come from some prior knowledge about what the actual thickness might be. This may come from previous measurements or from some knowledge about what the nominal thickness might be, considering some manufacturing undertolerance. Before any measured value is accounted for, this results in a predicted measured thickness distribution that has the same mean as the actual thickness distribution but with a greater variance due to the measurement error of 5 mil/yr that is selected. No measured thickness is entered yet, so this network is simply predicting what the measured thickness will likely be based on these assumed relationships.

FIG. 22B shows the impact of recording a single measurement and how it updates the beliefs about the actual thickness. The measurement process is simulated by selecting the one state on the Measured Thickness 2222 node whose numerical range contains the measured value (i.e., here assumed to lie between 1.024 and 1.025 inch). This is an example of hard evidence, since only one state is selected (i.e., 100% probability that the measured value lies within this range). This updates the belief about the actual thickness, as represented by its shifted and scaled probability distribution. It shifts the actual thickness distribution towards the measured value, but there is still some remaining variance due to the measurement error and also because it blends this with its prior distribution. Here, the mean values are no longer equivalent.

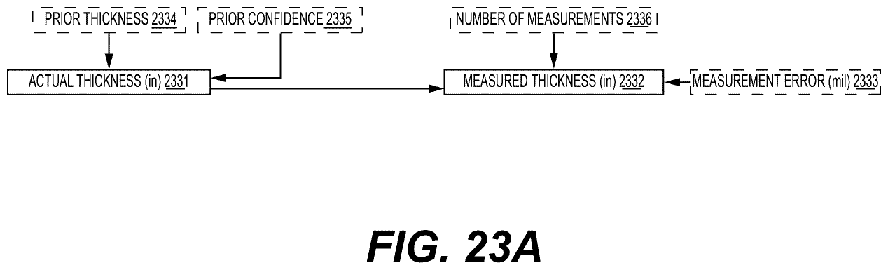

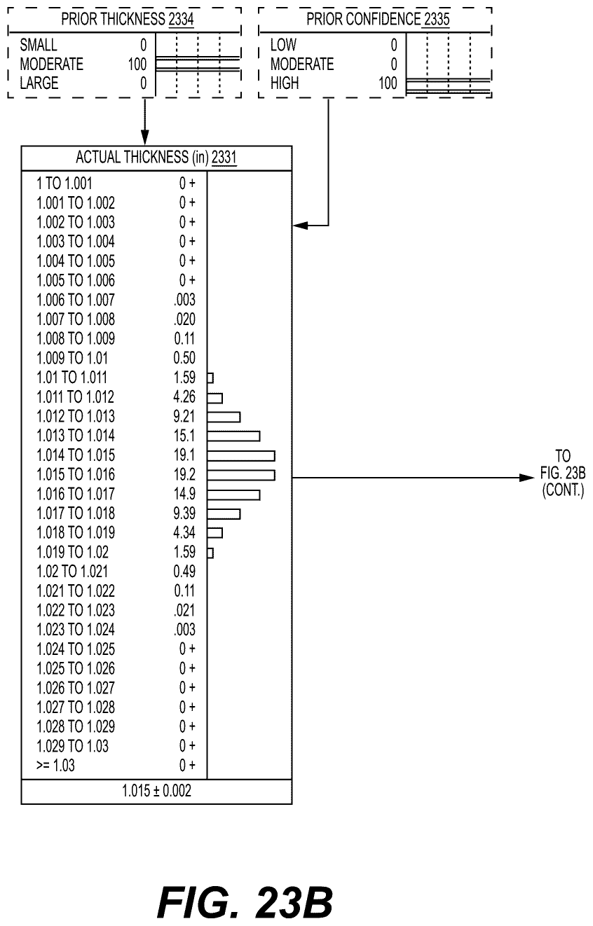

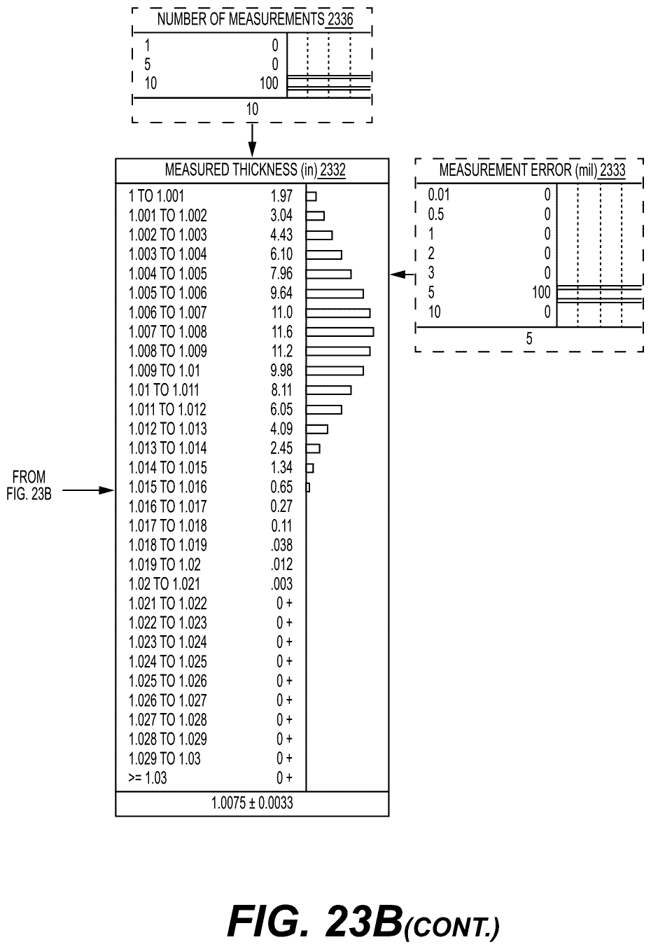

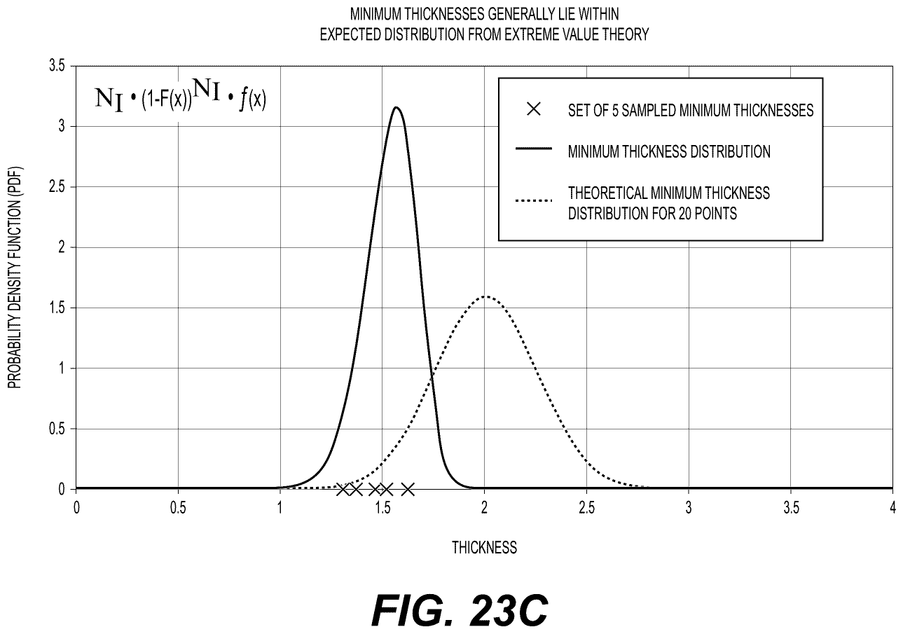

FIG. 23A shows a simplified view of a modified sizing inspection network according to an embodiment of the disclosure. FIG. 23B shows a detailed view of the modified sizing inspection network of FIG. 23A. FIG. 23C shows a graph of probability distribution function using the modified sizing inspection network of FIGS. 23A and 23B to account for the scenario where multiple measurements are taken in the field but only the minimum value is recorded. The network shown comprises nodes for Actual Thickness (in) 2331, Measured Thickness (in) 2332, Measurement Error (mil) 2333, Number of Measurements 2336, Prior Thickness 2334, and Prior Confidence 2335.

In particular, FIG. 23A, FIG. 23B, and FIG. 23C show a sample extension of the previously illustrated probabilistic causal networks in FIG. 22A and FIG. 22B to account for the scenario where multiple measurements are taken in the field but only the minimum value is recorded, as described in embodiments of the disclosure. The mathematical representation of this distribution of minimum values, assuming the minimum is taken out of N_{I} total measurements, derived from extreme value analysis (EVA), is shown by Equation 3.

$${f}_{min} ( x ) = {N}_{I} \cdot {( 1 - F ( x ) )}^{{N}_{I}} \cdot f ( x ) \qquad ( Equation 3 )$$

where f(x) and F(x) are the probability distribution function (PDF) and cumulative distribution function (CDF) of the general thickness distribution. To account for this modification, the extended network in FIG. 23A includes an additional Number of Measurements 2336 node. The two nodes for Prior Thickness 2334 and Prior Confidence 2335 are added for convenience to set a nontrivial prior probability for the Actual Thickness node. The EVA expression of Equation 3 is used to calculate the CPT of the new Measured Thickness node, since this now represents the minimum thickness. The predicted probability distribution for the Measured Thickness node is shifted to lower thicknesses when compared to the Actual Thickness node, since the minimum value out of ten measurements is naturally expected to be much less than the average.

FIG. 23C is a plot of the EVA expression in Equation 3. Also shown in FIG. 23C is a sample minimum thickness distribution with a mean of 2.0 inches and a standard deviation of 0.25 inches (i.e., the solid line curve), the corresponding expected theoretical minimum thickness distribution for 20 measured thicknesses assumed to come from that minimum distribution (i.e., the dotted line curve), and 5 randomly sampled minimum thicknesses (i.e., the X markers) to show that these sampled values are all contained within the theoretical minimum thickness distribution as expected.

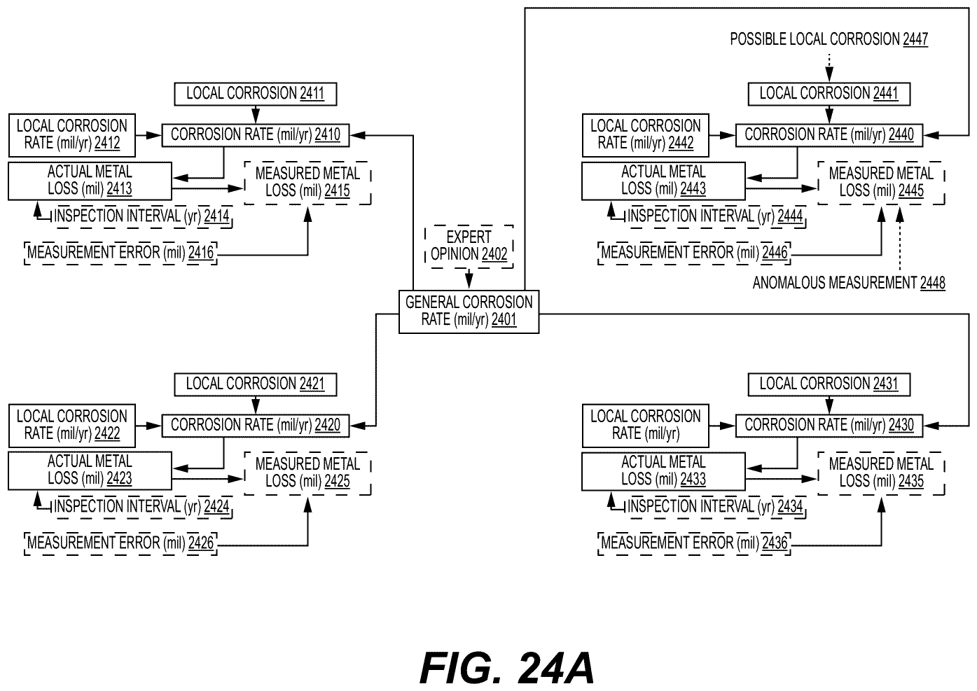

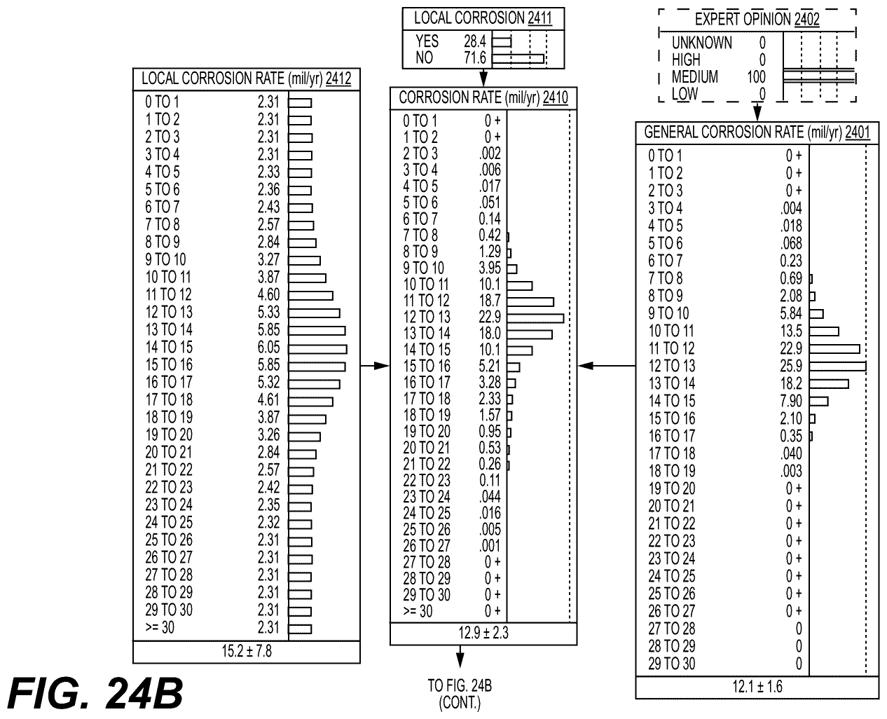

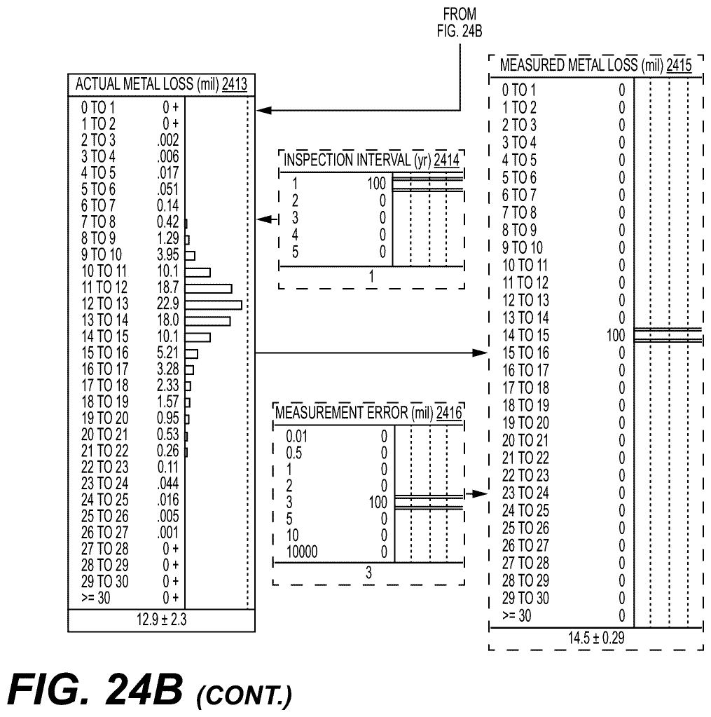

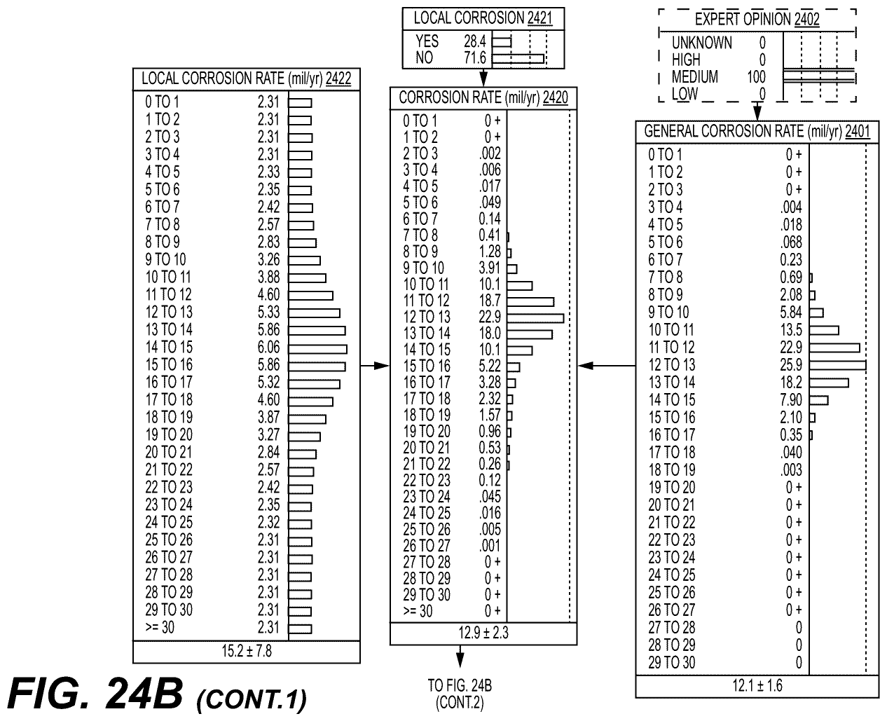

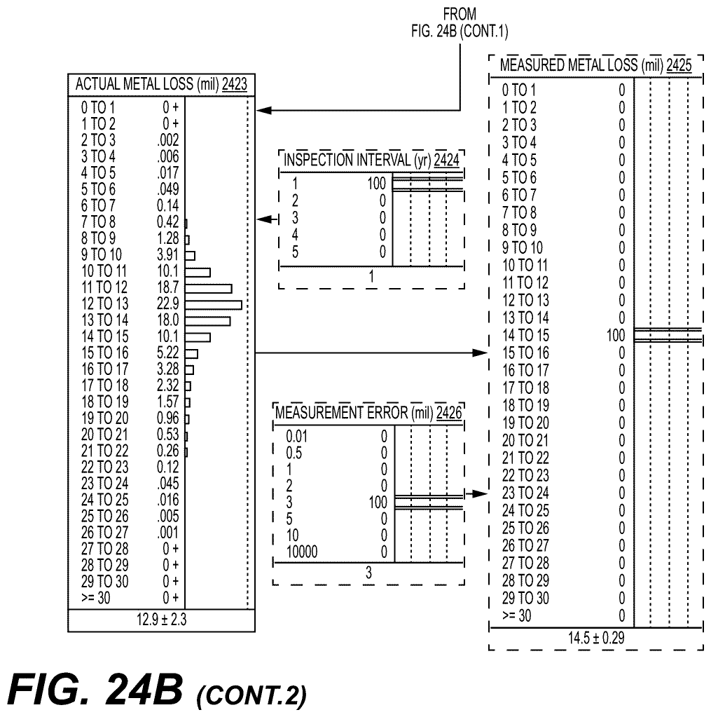

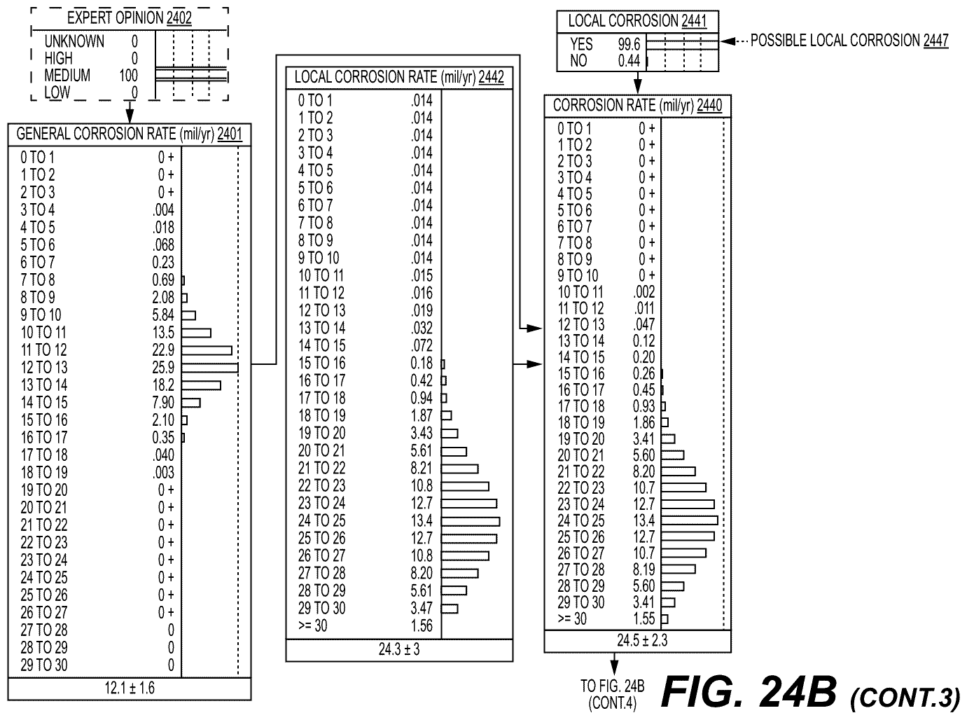

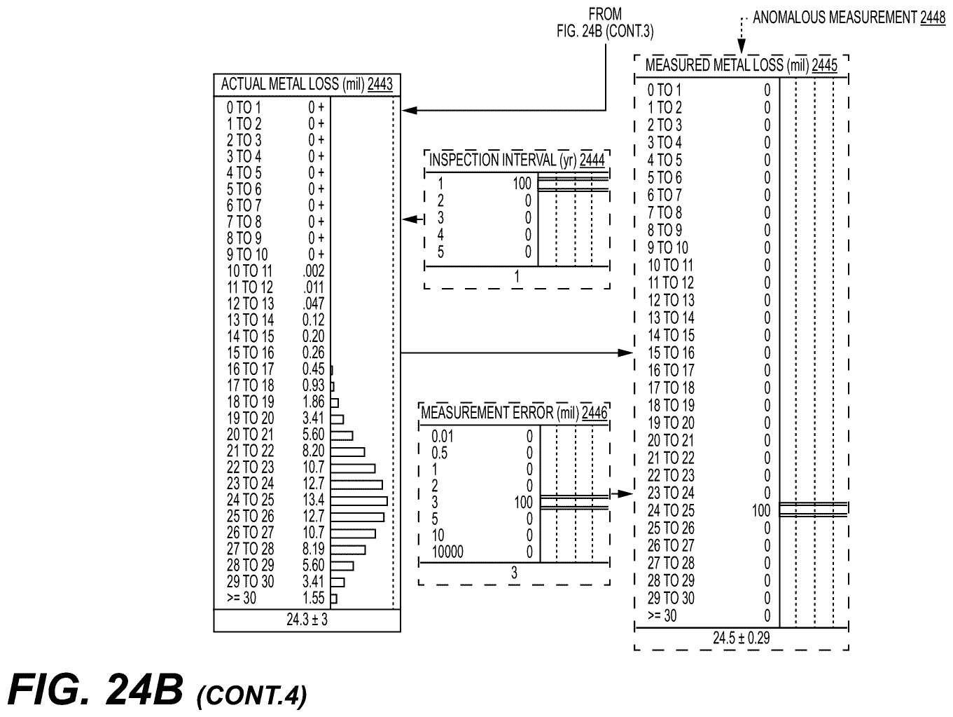

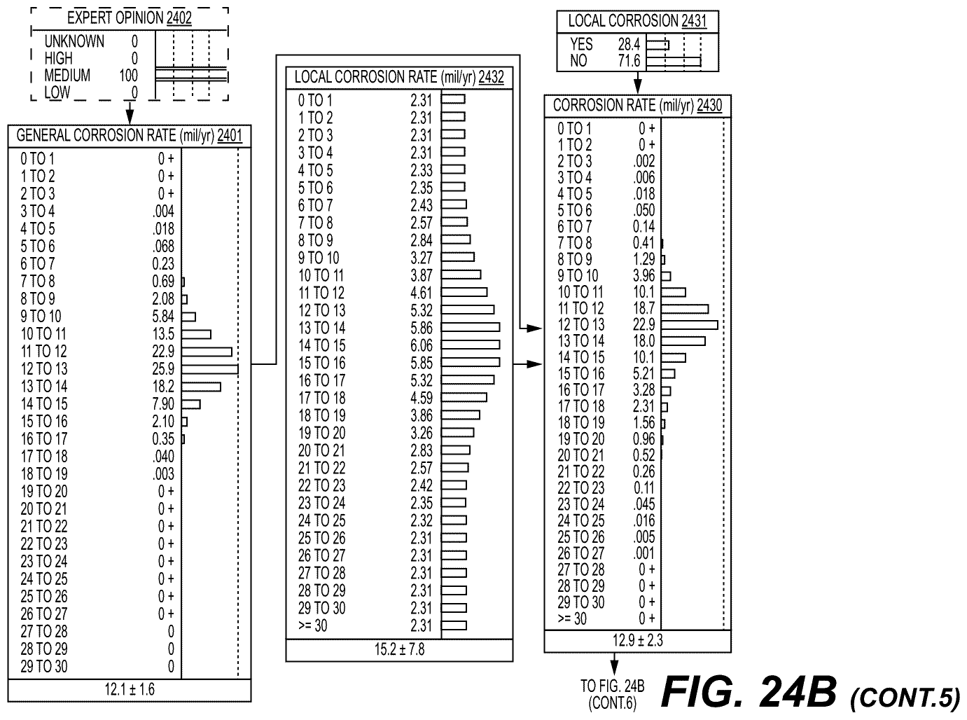

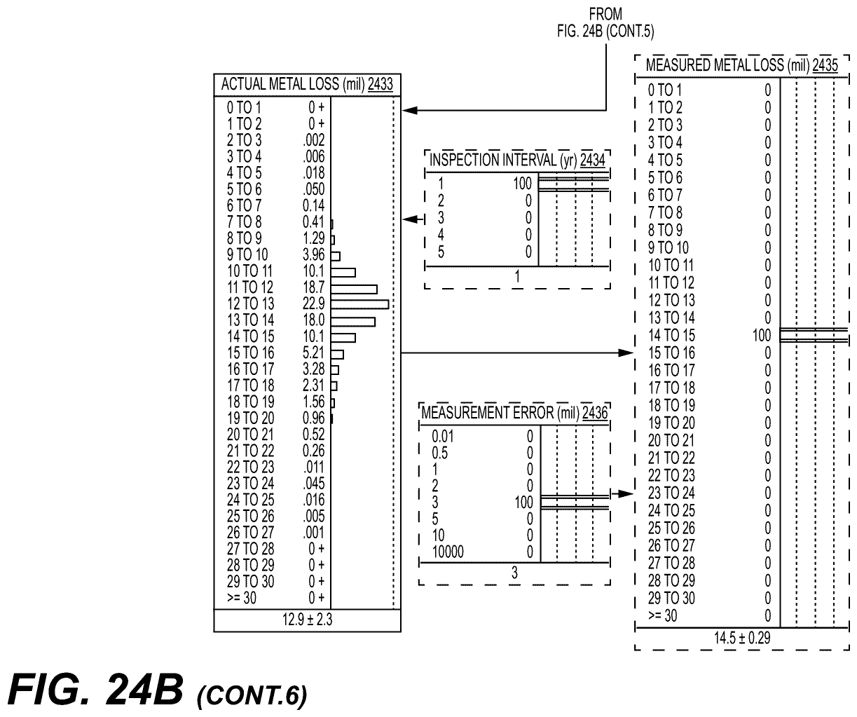

FIGS. 24A and 24B show a sample network for outlier detection (i.e., specifically whether any metal loss reading is thought to be behaving differently from the rest) according to embodiments of the disclosure. The network comprises a plurality of nodes, wherein the nodes in the plurality of nodes are for General Corrosion Rate 2401, Expert Opinion 2402, Corrosion Rate 2410, Local Corrosion 2411, Local Corrosion Rate 2412, Actual Metal Loss 2413, Inspection Interval 2414, Measured Metal Loss 2415, Measurement Error 2416, Corrosion Rate 2420, Local Corrosion 2421, Local Corrosion Rate 2422, Actual Metal Loss 2423, Inspection Interval 2424, Measured Metal Loss 2425, Measurement Error 2426, Corrosion Rate 2430, Local Corrosion 2431, Local Corrosion Rate 2432, Actual Metal Loss 2433, Inspection Interval 2434, Measured Metal Loss 2435, Measurement Error 2436, Corrosion Rate 2440, Local Corrosion 2441, Local Corrosion Rate 2442, Actual Metal Loss 2443, Inspection Interval 2444, Measured Metal Loss 2445, and Measurement Error 2446. The network may further comprise Possible Local Corrosion 2447 and Anomalous Measurement 2448. In particular, the probabilistic causal network illustrated in FIG. 24A and FIG. 24B demonstrates how one can identify potentially anomalous inspection metal loss measurements that could be indications of either local corrosion or invalid data (i.e., a method for outlier detection). This network structure comprises entering four separate metal loss measurements. The network can be expanded to account for however many measurements there are. For each measurement there is a node called Local Corrosion that has only two categorical states, Yes or No. If set to No, this measurement is assumed to be caused by a single general, common corrosion rate distribution (i.e., the General Corrosion Rate node). If set to Yes, then this measurement is assumed to come from a local corrosion rate distribution (i.e., the Local Corrosion Rate node). This is accomplished by using Equation 4 to calculate the CPT for the Corrosion Rate node associated with each measurement:

$$( Equation 4 )$$

$$Corrosion Rate = \{ \begin{matrix}Local Corrosion Rate & Local Corrosion = Yes \\ General Corrosion Rate & Local Corrosion = No\end{matrix}$$

By then leaving the Local Corrosion node unspecified (i.e., no value set), the probability of Yes or No is determined from the network automatically, through probabilistic inference, based upon the actual metal loss measurements that are entered. If one of the measurements leads to a high probability of Local Corrosion=Yes, then that measurement is likely behaving differently from the rest and should be reexamined by a follow-up inspection. Even though this network is used for metal loss measurements, the same network structure can be used for outlier detection of any measurable quantity.

In the example shown here, three of the four metal loss measurements are about the same, but the fourth is quite different. The causal network properly flags it as likely being caused by local corrosion (i.e., as an anomalous measurement), since there is a 99.6% probability of having Local Corrosion=Yes (i.e., the nodes encircled by a bold rectangle), whereas the remaining three measurements only have a 28.4% probability of this being true. For detection inspections, the result merely indicates whether damage was detected or not, typically without any indication of its size or extent. There may be some semi-quantitative or categorical indication of damage as being either minor, moderate, or severe, but it is not usually expressed numerically.

The effectiveness of a detection inspection is usually expressed in terms of its POD. The POD can be defined in a number of different ways, namely the probability of correctly detecting damage when damage is actually present, as well as the probability of correctly not detecting damage when damage is not actually present. These can be expressed equivalently in terms of its false positive (i.e., incorrectly detecting damage when it is not actually there) or false negative (i.e., incorrectly not detecting damage when it is actually there) rates. There are several types of inspection methods, each with a different effectiveness, and often a combination of methods works best (e.g., using a less effective method with more coverage area first, followed by a more effective method with less coverage area).

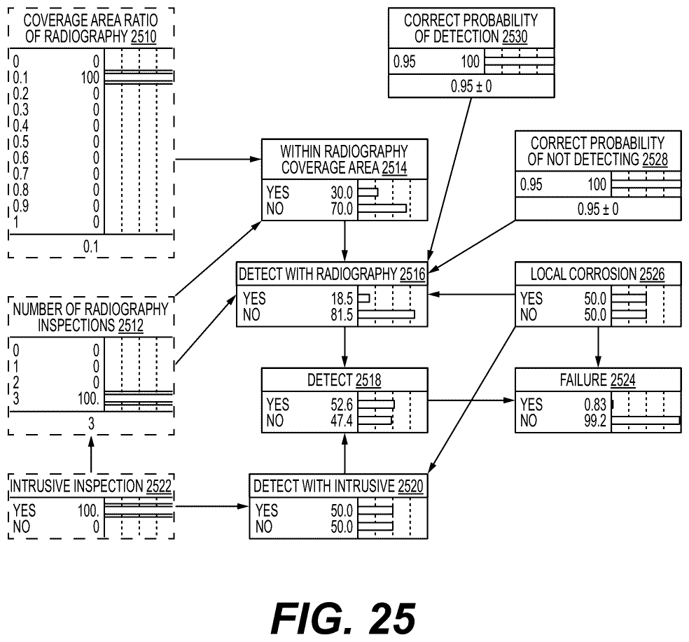

FIG. 25 shows a sample network illustrating how to account for the POD of various inspection techniques according to embodiments of the disclosure. The network comprises nodes for Coverage Area Ratio of Radiography 2510, Number of Radiography Inspections 2512, Within Radiography Coverage Area 2514, Detect With Radiography 2516, Detect 2518, Detect with Intrusive 2520, Intrusive Inspection 2522, Failure 2524, Local Corrosion 2526, Correct Probability of Not Detecting 2528, and Correct Probability of Detection 2530. The probabilistic, causal network in FIG. 25 combines two inspection methods, intrusive inspection and radiography, to increase the probability of detection. If either method detects damage (i.e., local corrosion), then the overall chance of detection increases. The prior probability of damage being present is assumed to be 50%. If damage goes undetected, it is assumed that failure is imminent. If it is detected, it is assumed that a repair is made and that failure will be highly unlikely.

Here, the first inspection method is an intrusive inspection that can inspect 100% of the inspectable surface area with a 99% probability of correctly detecting damage if damage is there and a 99% probability of correctly not detecting it if damage is not there. Here, the second inspection method is radiography, which can only inspect a smaller fraction of the total inspectable surface area per inspection (i.e., specified by the Coverage Area Ratio of Radiography 2510 node) with a 99% probability of correctly detecting damage if damage is there and a 99% probability of correctly not detecting it if damage is not there.

More than one radiography inspection can be used to increase the inspected coverage area fraction, as specified by the Number of Radiography Inspections 2512 node. However, unless enough inspections are performed to achieve total coverage, there is always some chance that the damage lies within the uninspected area. If there are only a small number of inspections and the per inspection coverage area is small, then this is like finding a needle in a haystack, and the POD will be low simply because not enough of the surface area is inspected.

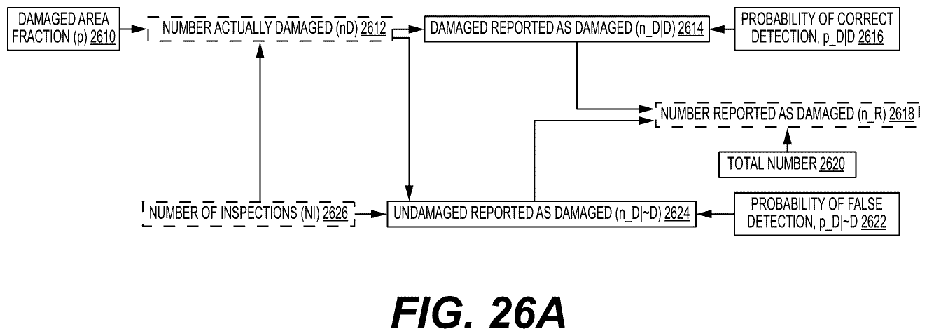

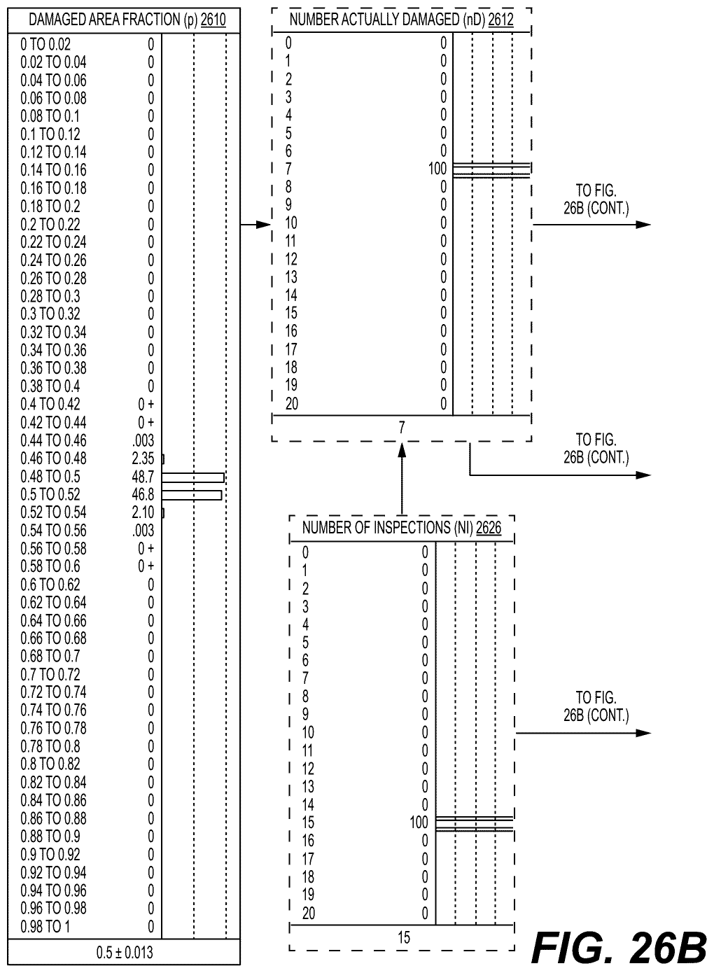

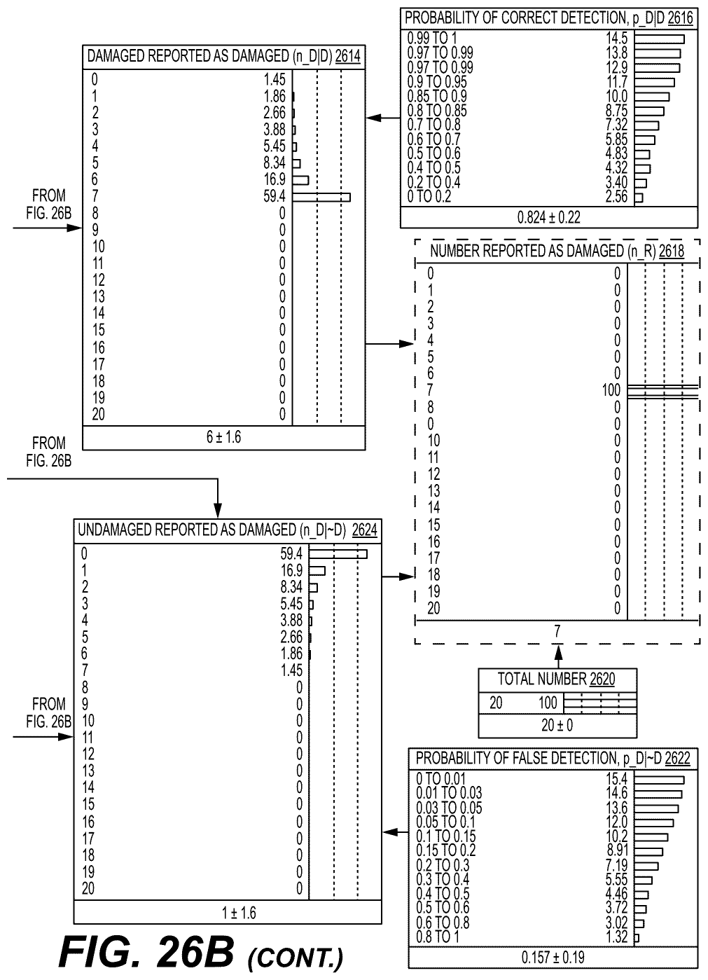

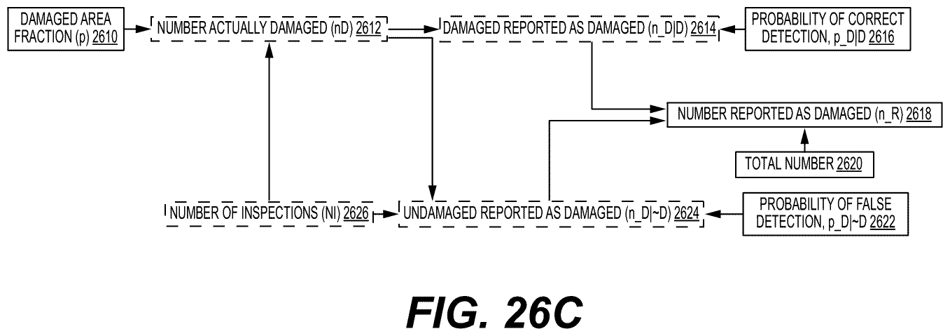

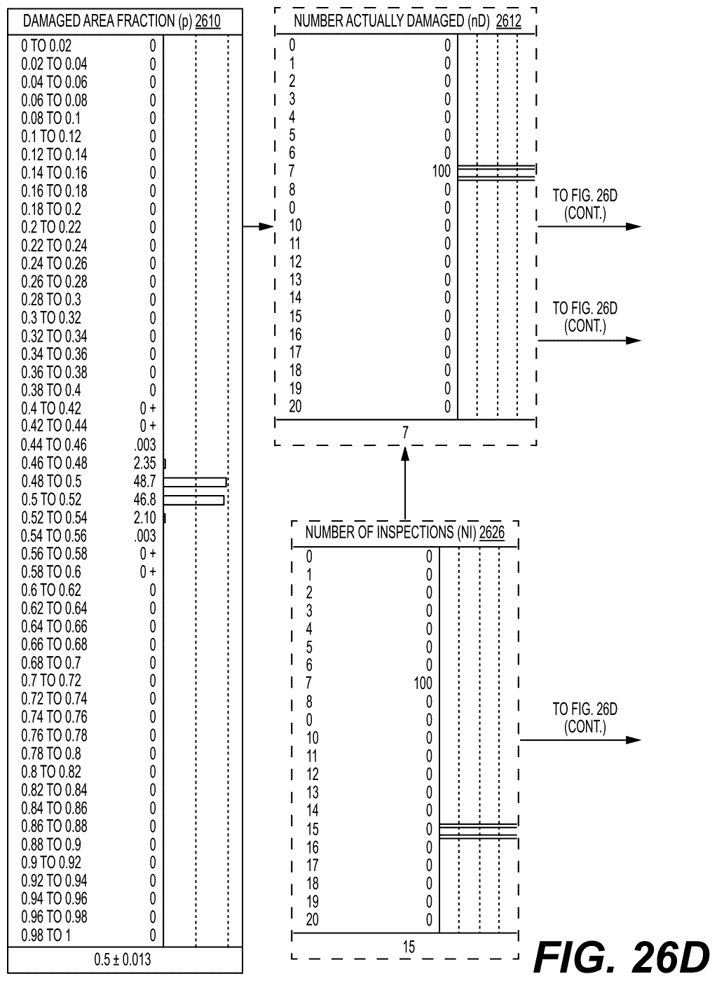

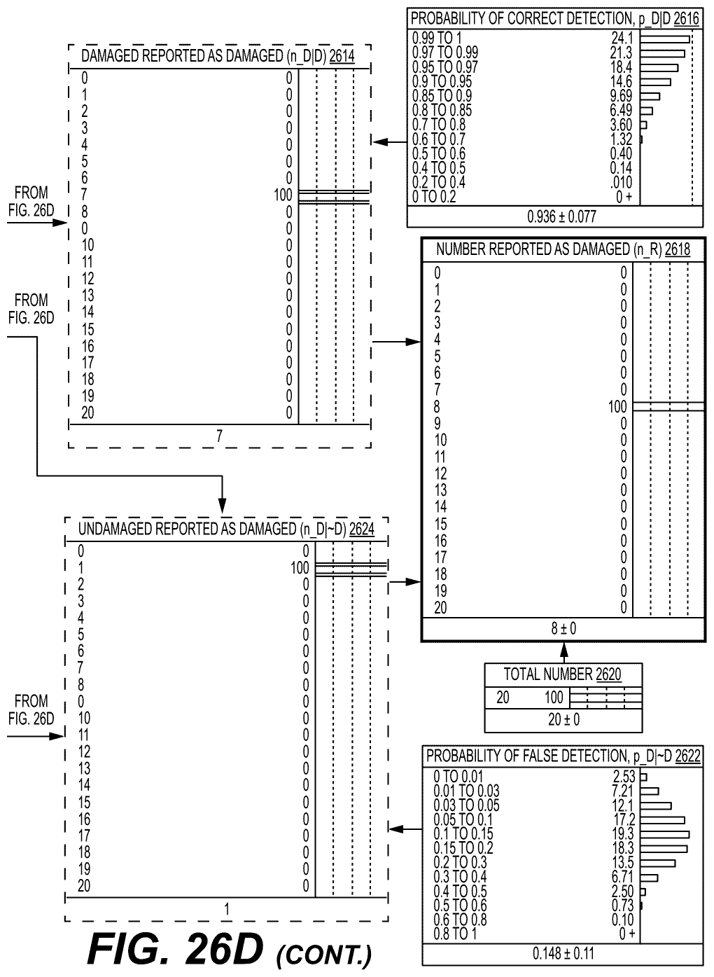

FIG. 26A shows a simplified view of a sample network according to an embodiment of the disclosure. FIG. 26B shows a detailed view of the sample network of FIG. 26A for calculating the various probability of correct and false detections needed to quantify a given inspection technique. FIG. 26C shows a simplified view of a sample network according to an embodiment of the disclosure. FIG. 26D shows a detailed view of the sample network of FIG. 26C for calculating the various probability of correct and false detections needed to quantify a given inspection technique. The network comprises nodes for Damaged Area Fraction 2610, Number Actually Damaged 2612, Damaged Reported as Damaged 2614, Probability of Correct Detection 2616, Number Reported as Damaged 2618, Total Number 2620, Probability of False Detection 2622, Undamaged Reported as Damaged 2624, and Number of Inspections 2626. FIGS. 26A and 26B and FIGS. 26C and 26D show sample networks for calculating the various probabilities of correct and false detection needed to quantify a given inspection technique according to embodiments of the disclosure. For both networks, there is some total inspectable surface area that is divided into 20 individual sections, of which it is nearly certain that 50% of the total area has detectable damage. Here, 15 of the 20 sections are randomly selected for inspection. In FIGS. 26A and 26B, the resulting probabilities of detection are shown if all that is known from the inspection is that 7 regions were reported as damaged. Note the moderately high PODs of 82.4% and 15.7%, however the resulting variances are also quite high, indicating a significant degree of uncertainty. In FIGS. 26C and 26D, instead of just reporting the total number damaged, the method reports the total number actually damaged that were reported as damaged and the total number actually undamaged that were falsely reported as damaged. FIGS. 26C and 26D shows much higher PODs of 93.6% and 14.8%, and the greatly reduced variances. The more inspections that are conducted, the more the POD variances will be reduced, since the variances are proportional to the inverse of the square root of the number of samples.

This causal network POD method is general. As such, it may be applied to all types of damage and inspection methods that can be characterized by their coverage area per inspection and by their false positive and false negative errors. This is true even in situations where the total inspected area fraction is small, which is often the case with spot ultrasonic thickness (UT) measurements at a small number of point locations.

Additional methods may be included to account for various inspection coverage area effects for any type of detection inspection. Nonlimiting examples of detection inspection types comprise spot (i.e., point) inspections and area (i.e., grid) inspections. In both situations, one of two questions is considered (i.e., what is the probability of finding damage with varying levels of inspection and some prior probability for the expected extent of damage, or what is the probability that damage is present in uninspected areas if partial coverage inspections find no damage).

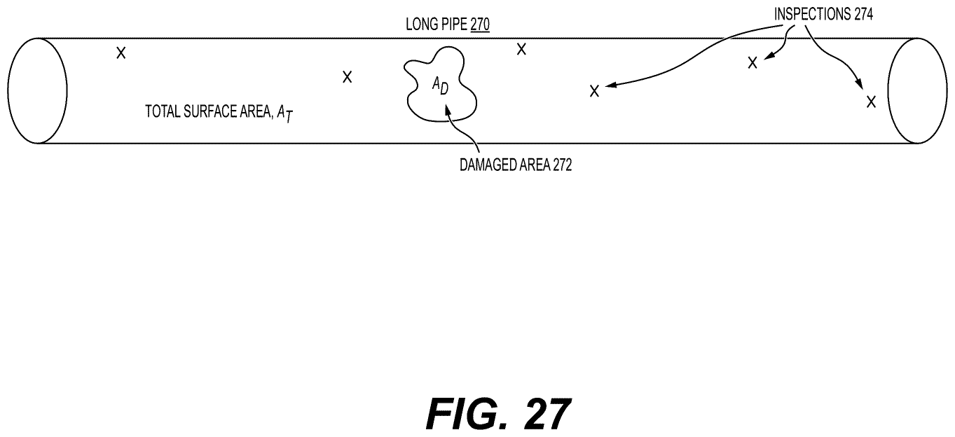

FIG. 27 shows a sample illustration of a long section of pipe 270 with one small area of damage 272, six randomly placed spot inspections 274, and the location of each inspection indicated with X markers. Note that none of these inspections land within the damaged area, visually demonstrating the ineffectiveness of these small number of spot inspections at detecting such a small area of localized damage on a large total surface area. This ineffectiveness is demonstrated mathematically by noting that the probability of finding damage (i.e., D=Yes) with N_{I} randomly placed spot inspections and a damaged surface area ratio of p is calculated by Equation 5.

$$P ( D = Yes \vert {N}_{I} , p ) = 1 - {( 1 - p )}^{{N}_{I}} \qquad ( Equation 5 )$$

The ratio p is calculated by Equation 6, where A_{D} is the damaged surface area and A_{T} is the total surface area.

$$p = {A}_{D} / {A}_{T} \qquad ( Equation 6 )$$

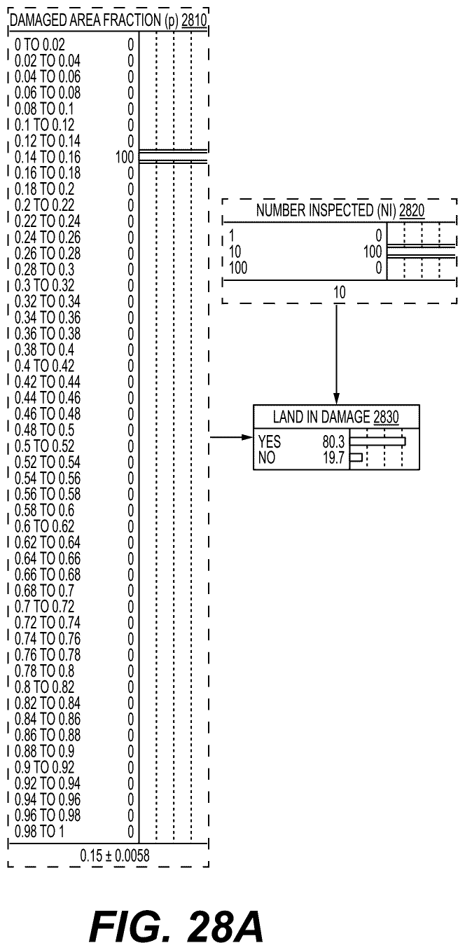

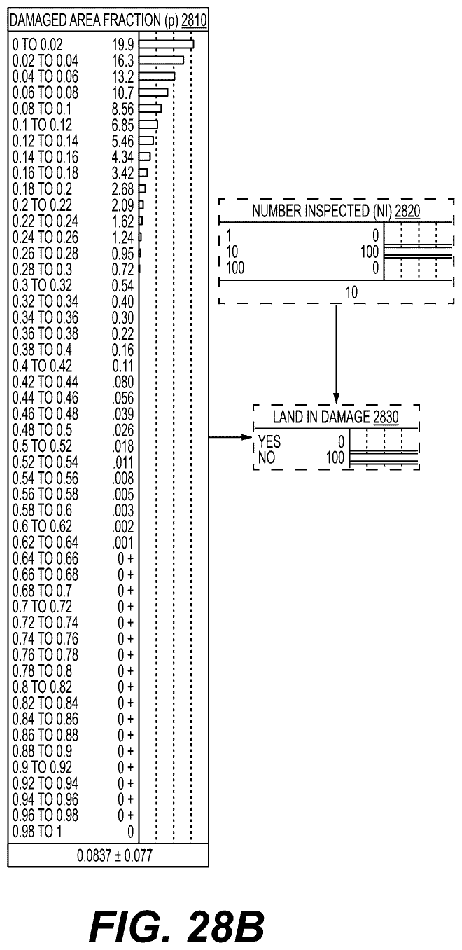

FIG. 28A) and FIG. 28B show sample networks according to embodiments of the disclosure. The network shown in FIG. 28A may be used for calculating the probability of finding damage with some number of perfectly effective spot inspections (i.e., specified by the Number Inspected (NI) 2820 node) by using Equation 5 to calculate the CPT of the Land in Damage 2830 node. The Damaged Area Fraction 2810 node represents the discretized probability distribution for p. For this particular example, there are 10 randomly placed inspections and a specified value of p that uniformly lies somewhere within the range between 0.14 and 0.16, as indicated by this selected state, leading to an 80.3% probability that at least one of the inspections lands within the damaged area.

FIG. 28B uses the network of FIG. 28A in a different way to infer the posterior probability distribution of p given the knowledge that no damage was found with 10 inspections. This knowledge is entered as evidence into the network by selecting the option No on the Land in Damage 2830 node. This posterior probability can also be calculated analytically by using a single iteration of Bayes theorem, which represents an inverse probability of sorts, as in Equation 7.

$$( Equati \text{?}$$

$$f ( p \vert D = No , {N}_{I} ) = \frac{P ( D = No \vert p , {N}_{I}}{{\int }_{0}^{1} P ( D = No \vert p , {N}_{I} ) \cdot f ( p ) dp} = \frac{{( 1 - p )}^{{N}_{I}} \cdot f ( p )}{{\int }_{0}^{1} {( 1 - p )}^{{N}_{I}} \cdot f ( p ) dp}$$

$$\text{?} \text{indicates text missing or illegible when filed}$$

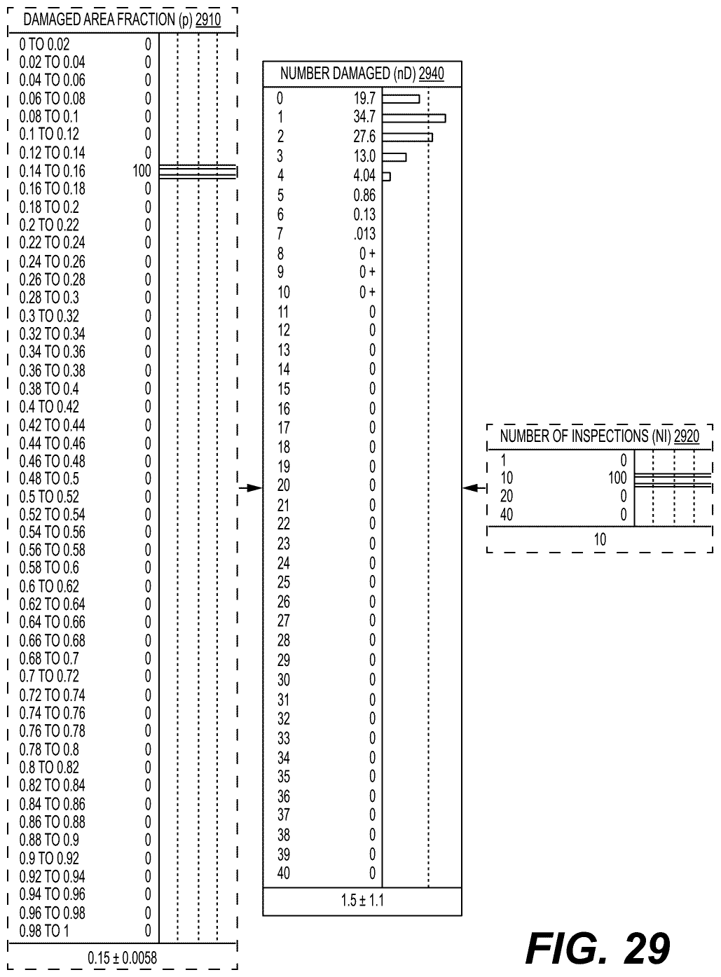

FIG. 29 illustrates a sample extension of the previously illustrated network in FIG. 28A and FIG. 28B according to embodiments of the disclosure. The network comprises nodes for Damaged Area Fraction 2910, Number Damaged 2940, and Number of Inspections 2920. The extended network in FIG. 29 determines the probability that some specific number of the spot inspections will land within the damaged area rather than just the probability that one or more will. This is done by replacing the categorical Land in Damage node with the discretely numerical Number Damaged 2940 node and using the binomial distribution in Equation 8 to set the CPT for each state n_{D} of the Number Damaged 2940 node.

$$P ( {n}_{D} \vert {N}_{I} , p ) = ( \begin{matrix}{N}_{I} \\ {n}_{D}\end{matrix} ) {{p}^{{n}_{D}} ( 1 - p )}^{{N}_{I} - {n}_{D}} \qquad ( Equation 8 )$$

The network in FIG. 29 may also be solved in the inverse direction to determine the posterior probability distribution of the damaged area ratio p given that some specific number n_{D} of the inspections is known to have landed within the damaged area.

These simple examples illustrate ideal scenarios that assume perfect inspections having a 100% probability of detecting damage if it is present at the location of the inspection. In practice, there is no perfect inspection, and there is always some chance that damage actually present will not be detected, especially if it is below some detectable threshold, or that the inspection will believe there is damage when none is actually there. To account for this, the present systems and methods may comprise adding additional nodes to the network to represent false positive and false negative errors.

The present systems and methods may further comprise expanding inspection networks by adding utility nodes for the cost of inspection and linking the inspection networks to other predictive networks like the ones shown previously to predict damage rates and the failure time in order to determine optimal decision inspection strategies that minimize cost or maximize the total ROI.

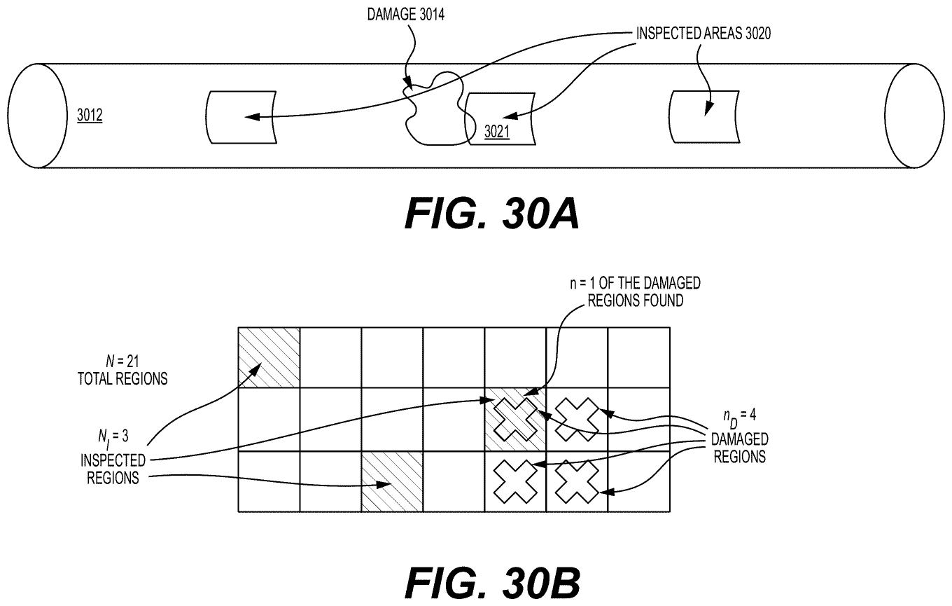

FIG. 30A and FIG. 30B illustrate a sample extension of the spot inspection network to area-based inspections, such as radiography-based methods or similar, according to embodiments of the disclosure. FIG. 30A illustrates a long pipe having a large inspectable surface area 3012, one small region of localized damage 3014 randomly located somewhere on that pipe, and three randomly placed rectangular inspection areas 3020. The middle inspection area 3021 slightly overlaps the area of damage. When such overlap occurs, it is assumed that the inspection correctly detects the damage (i.e., true only for a perfectly effective inspection). FIG. 30B illustrates the total inspectable pipe surface area being flattened and subdivided into a regular two-dimensional 7×3 grid of 21 smaller rectangular inspectable regions. Each smaller region can be inspected by a single area-based inspection. Three such randomly selected inspections are shown here as the diagonal striped shaded regions. Separately, four of these randomly selected regions are assumed to contain damage as indicated by the X markers. By chance, one of these damaged regions is shown to also be one of the four selected for inspection, which means the damage in that region would have been detected, assuming a perfectly effective inspection (i.e., 100% probability of detecting damage if it is there).

The general expression for the probability of finding some number n of the n_{D} total number of such damaged regions out of a total of N possible regions, given that some number N_{I} of them are randomly selected for inspection, is given by the hypergeometric distribution defined by Equation 9.

$$( Equation 9 )$$

$$P ( n \vert N , {N}_{I} , {n}_{D} ) = \{ \begin{matrix}\frac{{N}_{I} !}{n ! ( {N}_{I} - n ) !} \cdot \frac{( N - {N}_{I} ) !}{N !} \cdot \frac{( N - {n}_{D} ) !}{\begin{matrix}( N - {n}_{D} - \\ {N}_{I} + n ) !\end{matrix}} \cdot \frac{{n}_{D} !}{( {n}_{D} - n ) !} & \begin{matrix}n \leq {n}_{D} , n \leq {N}_{I} , \& \\ {N}_{I} - n \leq N - {n}_{D}\end{matrix} \\ 0 & otherwise\end{matrix} = ( \begin{matrix}{n}_{D} \\ n\end{matrix} ) ( \begin{matrix}N - {n}_{D} \\ {N}_{I} - n\end{matrix} ) {( \begin{matrix}N \\ {N}_{I}\end{matrix} )}^{- 1}$$

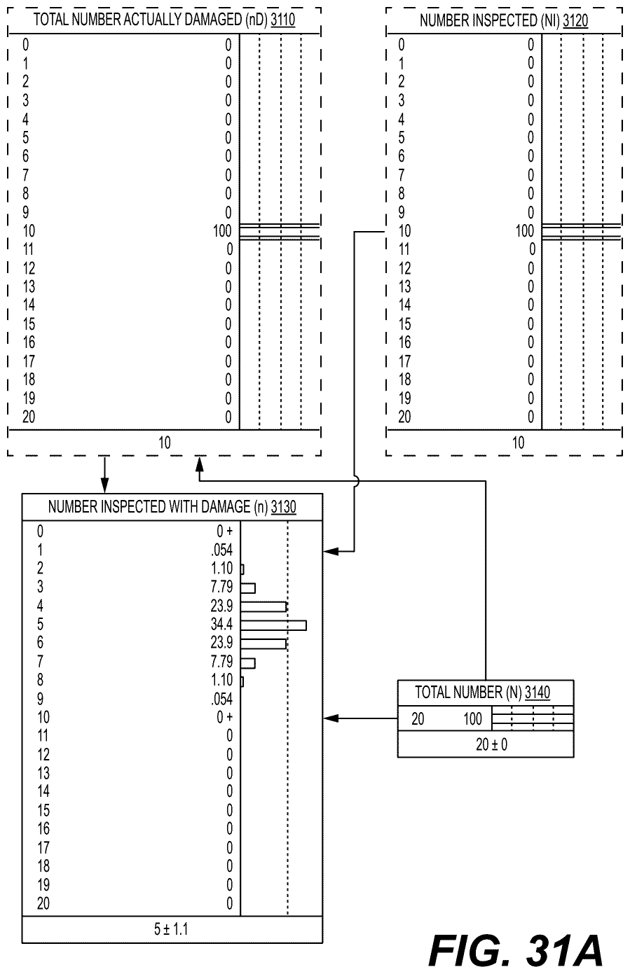

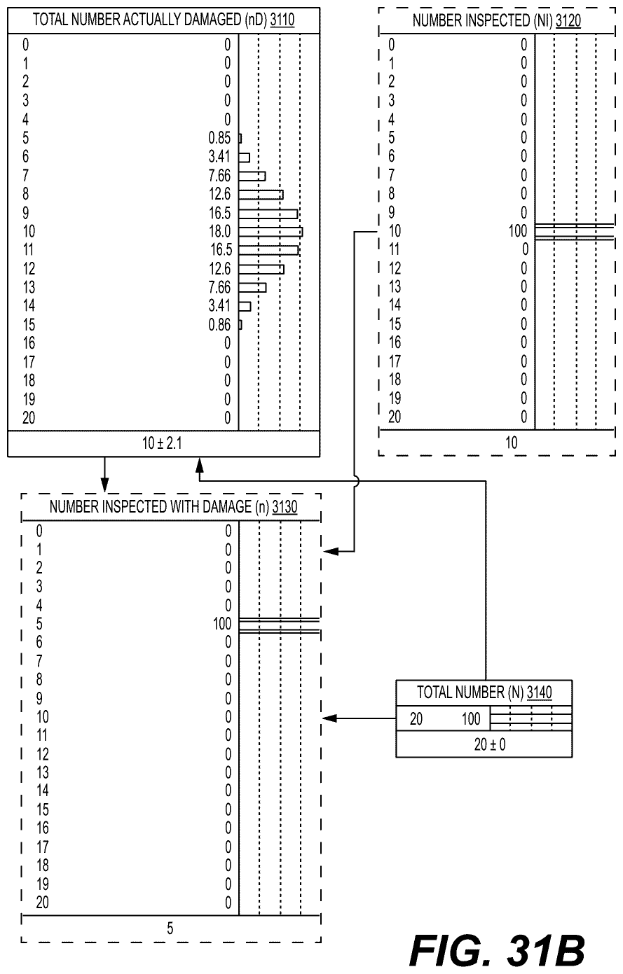

FIG. 31A and FIG. 31B show sample networks for these area-based inspections according to embodiments of the disclosure. Both networks have identical structures and nodal CPTs but are used for different purposes. The networks comprise nodes for Total Number Actually Damaged 3110, Number Inspected (NI) 3120, Number Inspected with Damage 3130, and Total Number 3140. The hypergeometric distribution in Equation 9 is used to set the CPT of the Number Inspected with Damage (n) node for each combination of states of the Total Number (N), Number Inspected (N_{I}), and Total Number Actually Damaged (n_{D}) nodes. In FIG. 31A, the probability distribution for the Number Inspected with Damage node is predicted based upon evidence set on all the other nodes, whereas in FIG. 31B, the knowledge that half of the inspections detected damage is set as evidence in order to update the probability distribution on the Total Number Actually Damaged node. Note, this is the scenario of most practical interest and would agree with the analytical result obtained by using Bayes Theorem in an analogous fashion to Equation 7 but with the likelihood obtained from Equation 9. As in the previous networks for spot inspections, the imperfect probability of detection is accounted for in the method by adding additional nodes to these area-based inspection networks representing false positive and false negative errors, and then linking all this with other prediction networks for decision optimization purposes.

Updating Failure Time from Events and Actions

In an embodiment, the disclosure is directed to methods of analyzing any event or maintenance action via probabilistic causal networks. The method comprises requiring the failure time distributions before and after the event or action. Separate probabilistic causal networks, or other completely independent numerical solution methods outside of any network, may be used in the method to determine these distributions. Given the before and after failure time distributions, the method comprises determining the life extension random-variable and calculating the final benefit (i.e., the risk reduction). Each strategy may be analyzed separately, via a separate causal network, and the method comprises choosing the strategy with the highest total expected utility as the optimal one. The life extension t_{LE} of any action is defined generically in Equation 10 as the difference between the failure time after the event, t_{F,A}, and that before, t_{F,B}.

$${t}_{LE} = {t}_{F , A} - {t}_{F , B} \qquad ( Equation 10 )$$

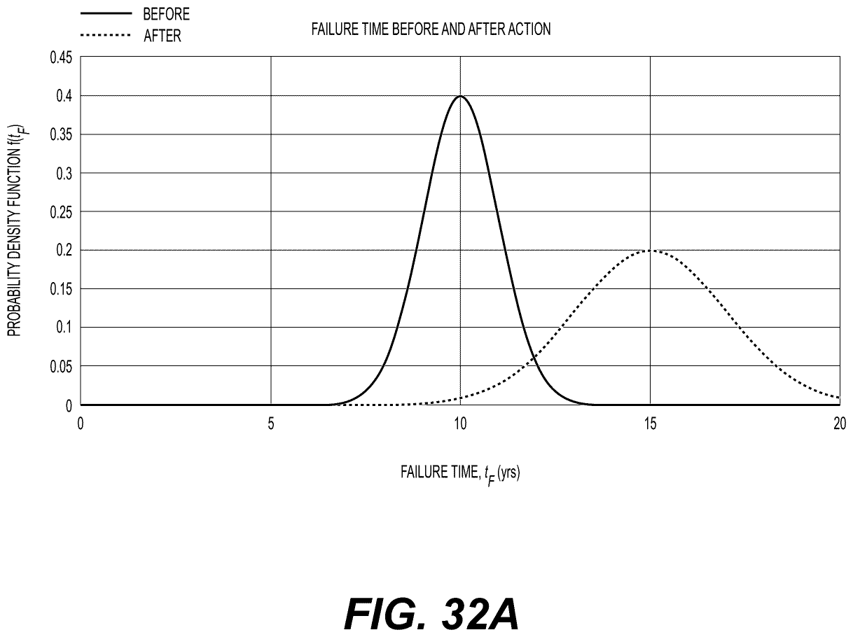

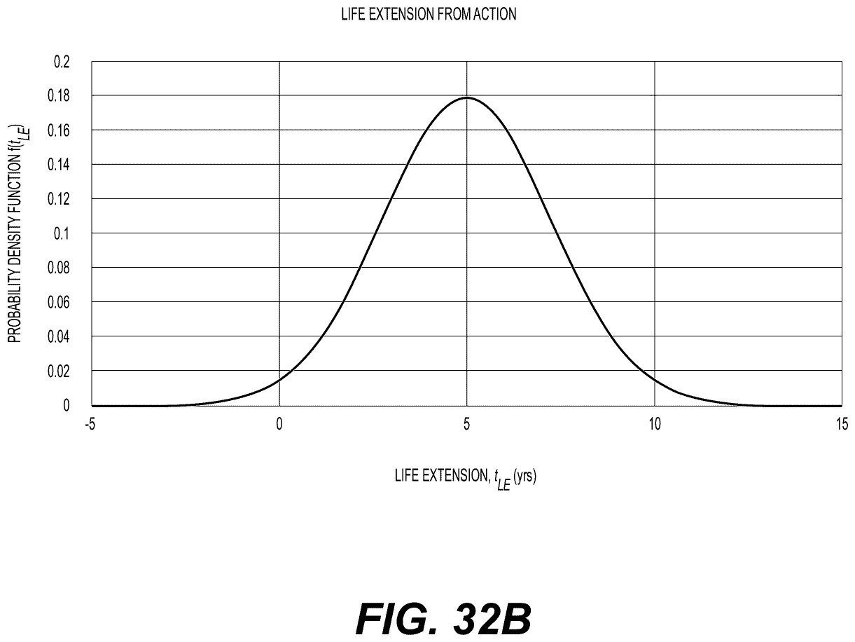

FIG. 32A and FIG. 32B show sample probability distributions as used by methods according to embodiments of the disclosure. The probability distributions show the failure time before and after some action or event occurs and the corresponding life extension in order to quantify any beneficial or negative effect this action or event might have. FIG. 32A shows the failure time distribution predicted before and after the action or event occurs. The before distribution has a mean of 10 years with a standard deviation of 0.75 years, while the after distribution has a mean of 15 years with a standard deviation of 1.5 years. FIG. 32B shows that this leads to a life extension distribution having a mean of 5 years and a standard deviation of 2 years, according to the relationship in Equation 10. Whatever this action or event was, it had a beneficial effect, since it has extended the predicted life of the asset by an average of 5 years. However, this would normally come at some cost (e.g., the cost of inspection, repair, replacement, etc.), and it takes more analysis to determine if this action or event is worth it by evaluating the benefit versus this cost.

Present methods allow for representing the effect of any action or event in this general way, in terms of some probabilistic life extension. Thus, the present methods provide a way to normalize all such possible actions or events so that they may be compared with each other and relatively weighed against their cost to determine which action or event is the most beneficial one. This allows the present methods and system to be designed with a general approach to finding optimal decision strategies for any asset subject to any set of arbitrary actions or events.

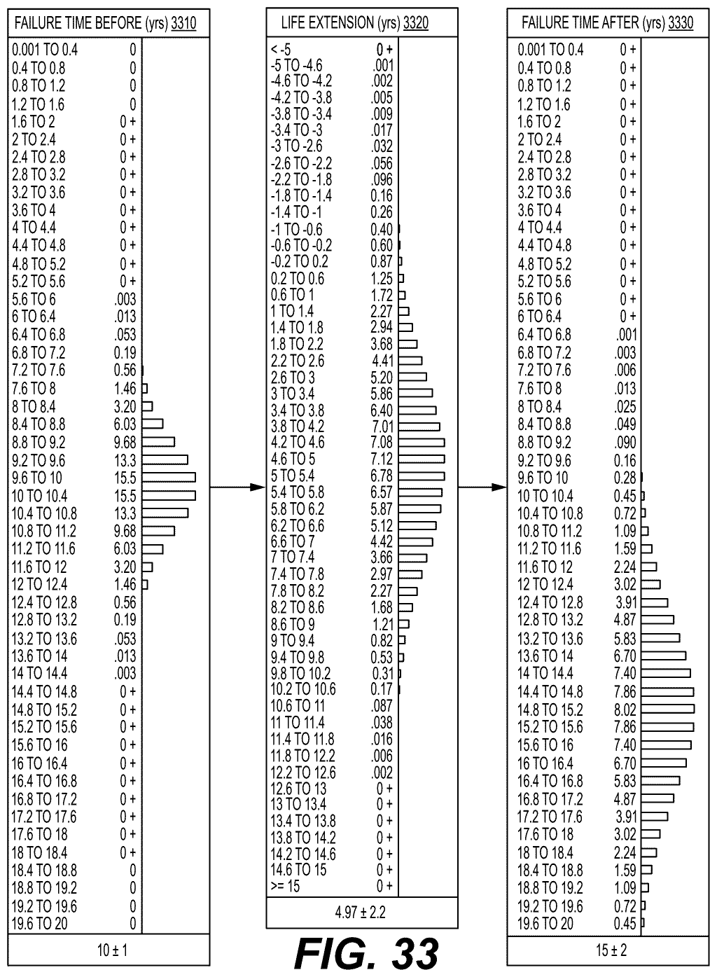

FIG. 33 shows the equivalent life extension calculation using a causal network according to embodiments of the disclosure. FIG. 33 shows a sample causal network that determines the probabilistic life extension distribution from the failure time distributions before and after some random event occurs (e.g., an accident, storm or human error) or some deliberate action is taken (e.g., planned inspection or maintenance). Random-variable nodes are added for the Failure Time Before (t_{F,B}) 3310, Failure Time After (t_{F,A}) 3330, and Life Extension (t_{LE}) 3320. The CPT of the Life Extension node is set by using Equation 10. Note, the analytical and network-based solution methods provide consistent results.

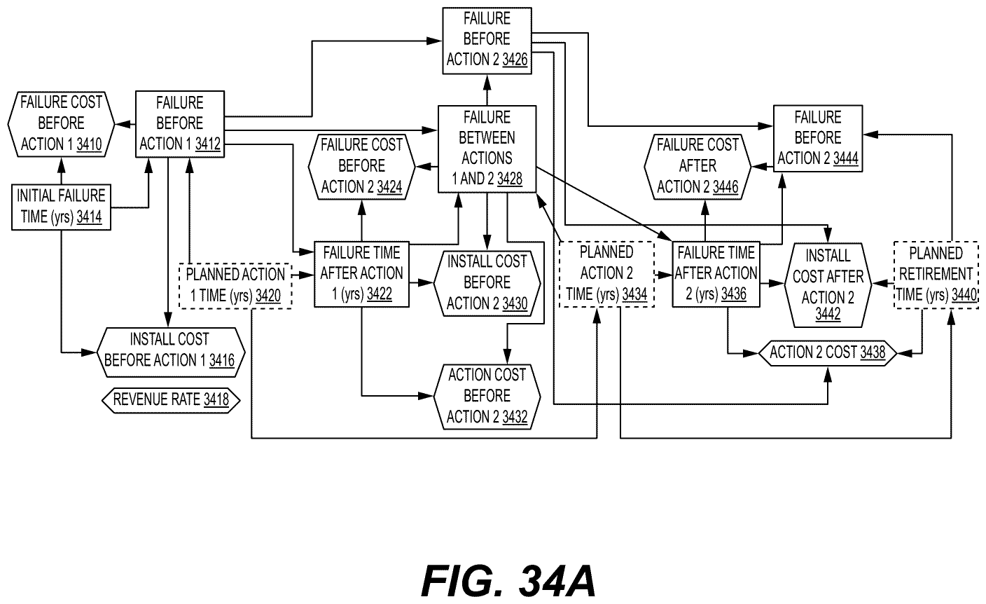

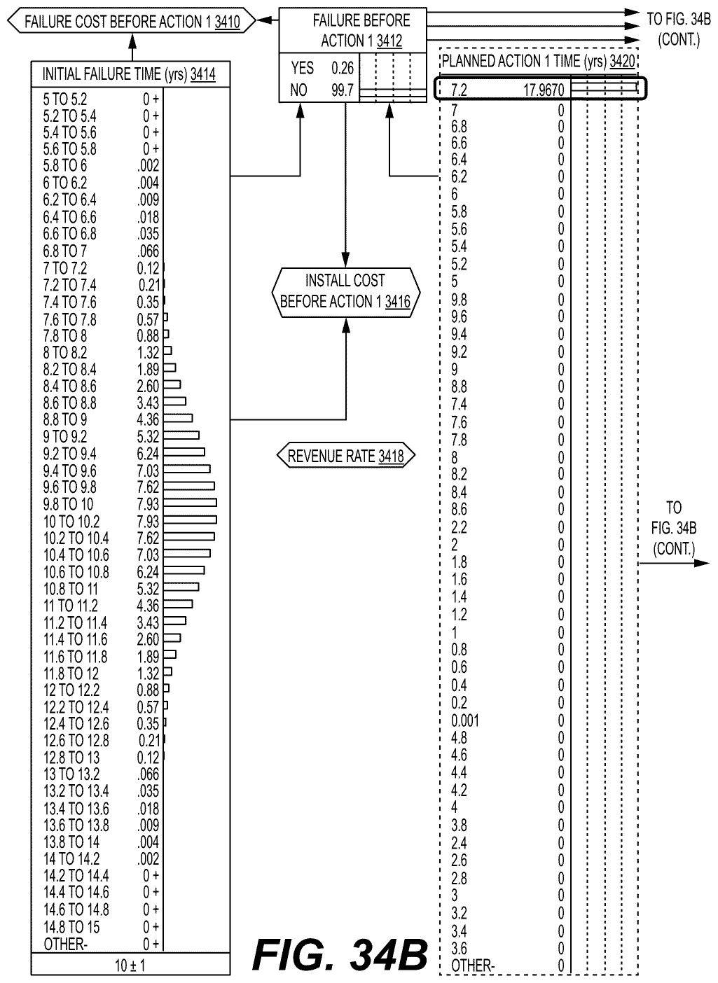

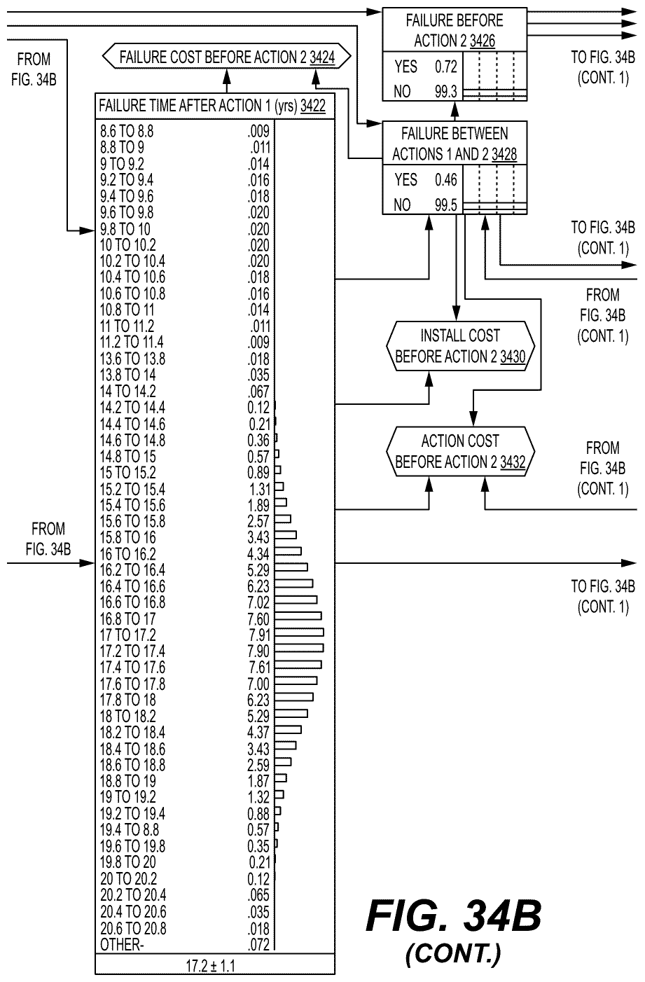

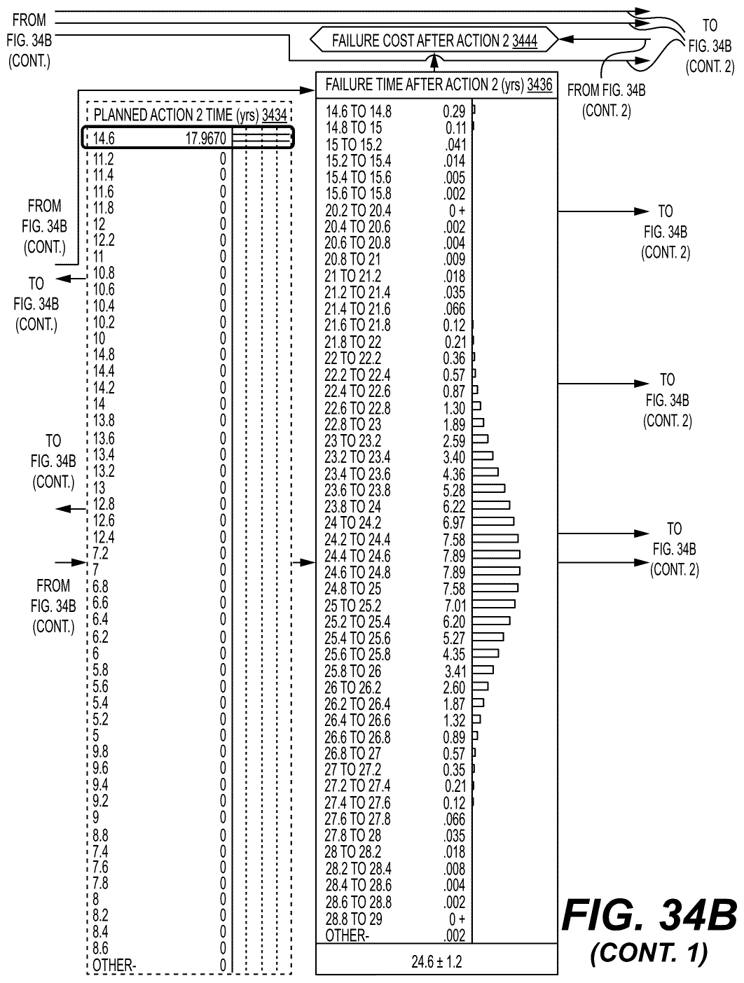

FIG. 34A shows a simplified view of a sample decision causal network according to an embodiment of the disclosure. FIG. 34B shows a detailed view of the sample decision causal network of FIG. 34A to illustrate determining the optimal maintenance strategy when the failure time distributions before and after each event are known. The network comprises nodes for Failure Cost Before Action 1 3410, Failure Before Action 1 3412, Initial Failure Time 3414, Install Cost Before Action 1 3416, Revenue Rate 3418, Planned Action 1 Time 3420, Failure Time After Action 1 3422, Failure Cost Before Action 2 3424, Failure Before Action 2 3426, Failure Between Actions 1 And 2 3428, Install Cost Before Action 2 3430, Action Cost Before Action 2 3432, Planned Action 2 Time 3434, Failure Time After Action 2 3436, Action 2 Cost 3438, Planned Retirement Time 3440, Install Cost After Action 2 3442, Failure After Action 2 3444, and Failure Cost After Action 2 3446. The network illustrates the determination of the optimal decision strategy for two possible actions (e.g., maintenance or something else) followed by a final retirement, assuming the failure time distributions before and after each action are known. The before and after failure time distributions may be determined by using some other predictive probabilistic causal network like the ones shown previously or by any other method, such as a Monte Carlo sampling methodology. The times at which each action and retirement can be taken are represented by three decision nodes in the network. Once it is properly set up, this network finds the optimal decision strategy by determining the best combination of times for all three decisions. A rational decision maker is assumed such that the optimal choice of precursory decisions is always selected. The network results show that the optimal time for the first action is 7.2 years, the optimal time for the second action is 14.6 years, and the optimal time for retirement is 22 years. The total expected utility is $17.967 million.

Failure from Multiple Failure Modes

Industrial facilities and plants typically have many complex equipment and piping systems comprised of a hierarchy of interconnected units, assets, and components, any of which might fail at any time from one or more failure modes. If a critical asset or component fails, the entire facility/plant may fail. For example, a plant may have an upstream and downstream unit, each with two or more utility units providing various water and steam services for critical heating and cooling functions. If any of these fails, such failure may halt operation of the whole plant.

If a component is subject to failure by more than one independent damage mechanism, it fails when the damage from any of these mechanisms reaches some critical threshold. The component is said to have multiple failure modes, one for each such damage mechanism. Once the failure time distribution for each independent failure mode has been determined, such as by using any of the previously presented methods described herein, the failure time of the component may be determined. Such a method comprises finding the probability P_{i,j}^{f} of component i failing from failure mode j over some time period of interest by integrating the corresponding failure time PDF over that time period, which can be done easily in terms of the corresponding CDF. The method further comprises finding the probability that this component fails from any of the N_{D} possible failure modes by using Equation 11.

$${P}_{i}^{f} = 1 - {\prod }_{j = 1}^{{N}_{D}} ( 1 - {P}_{i , j}^{f} ) \qquad ( Equation 11 )$$

Equation 11 states that the probability of failing by one or more failure modes is the complement of the probability that it does not fail by any of the failure modes. Since Pᵢ^{f} is the CDF distribution for the component failure time, the failure time PDF is found by differentiating Pᵢ^{f} with respect to time.

Assuming the facility/plant fails if any of its critical components fail, the probability of total facility/plant failure P_{f} depends on all of the N_{c} critical component failure probabilities according to Equation 12.

$${P}^{f} = 1 - {\prod }_{i = 1}^{{N}_{C}} ( 1 - {P}_{i}^{f} ) \qquad ( Equation 12 )$$

Components are often grouped together in a hierarchical manner based on some representative logical structure. For example, an entire plant might be comprised of one or more units, each unit comprised of one or more assets, and each asset comprised of one or more components. Different hierarchies and naming conventions are possible.

Methods as described herein may account for multiple failure modes of a component; multiple components of an asset; multiple assets of a unit; multiple units in a plant; or any combination thereof.

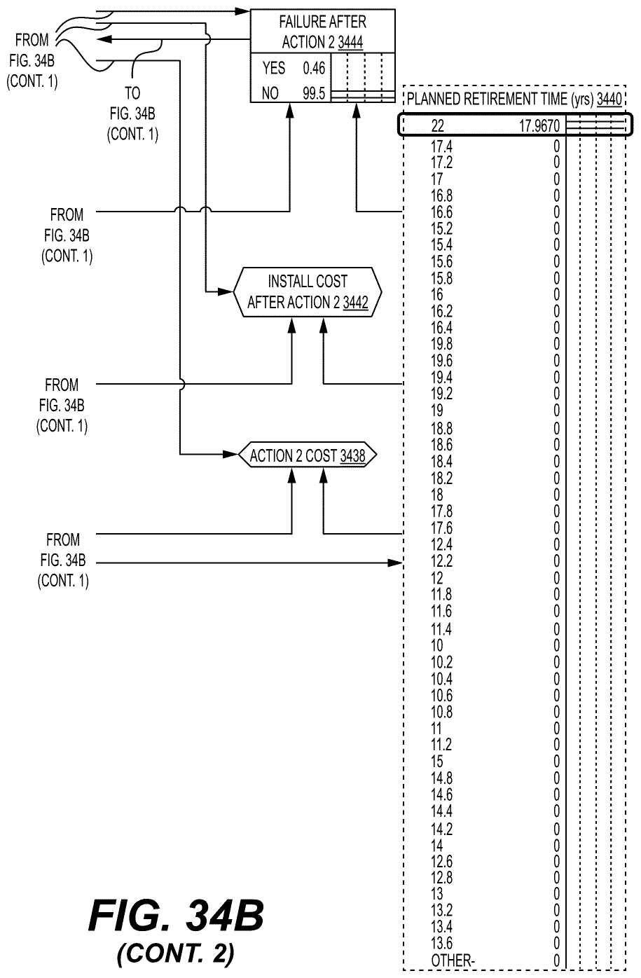

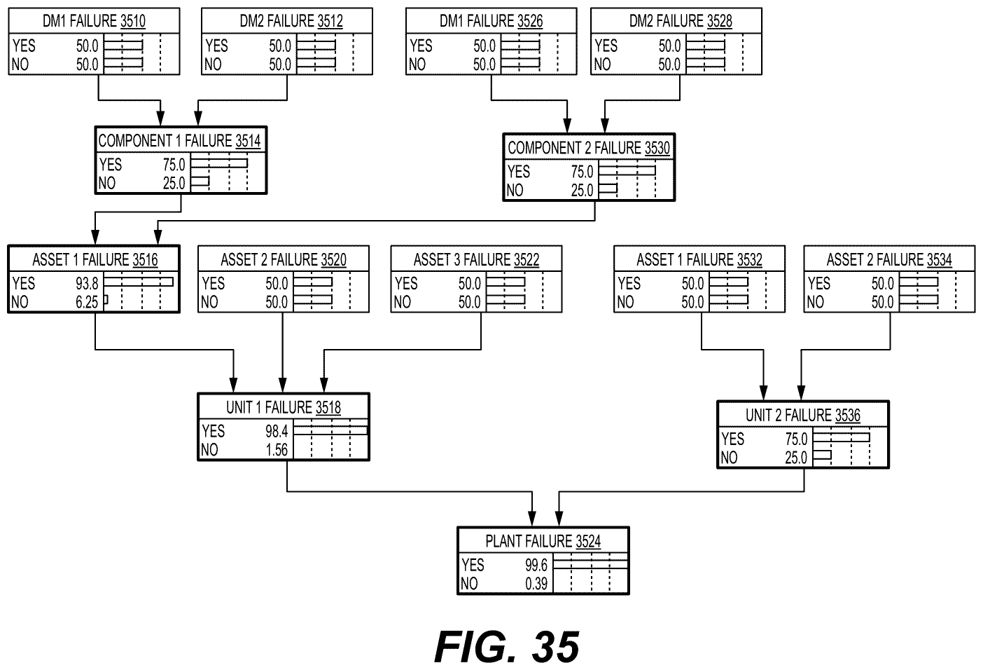

FIG. 35 shows a sample network according to embodiments of the disclosure. The network comprises nodes for DM1 Failure 3510, DM2 Failure 3512, Component 1 Failure 3514, Asset 1 Failure 3516, Unit 1 Failure 3518, Asset 2 Failure 3520, Asset 3 Failure 3522, Plant Failure 3524, DM1 Failure 3526, DM2 Failure 3528, Component 2 Failure 3530, Asset 1 Failure 3532, Asset 2 Failure 3534, and Unit 2 Failure 3536. The network shown in FIG. 35 illustrates multiple failure modes or damage mechanisms per component, multiple components per asset, multiple assets per unit, and multiple units per plant, at some point in time. The probability of failure for each node is determined by evaluating the CDF of its associated failure time distribution at that time. The network is set up so that failure of any node occurs if any of its child nodes (i.e., constituents) fail. For example, the plant fails if any of its units fail. A unit fails if any of its assets fail. An asset fails if any of its components fail, and the component fails if it fails by any of its failure modes (i.e., damage mechanisms).

By setting up a network in this way, the mathematical structure shown in Equations 11 and 12 is replicated, it is much easier to explain and construct, it can be linked with other predictive and decision networks, and it can be expanded to provide a more comprehensive solution to the plant-level failure problem. This network may be applicable to all failure modes and defect states before and after any event or action occurs. Thus, after performing all maintenance actions, the updated failure time distributions are used to get the updated probability of failure for each relevant node in this network.

### Decision Maps

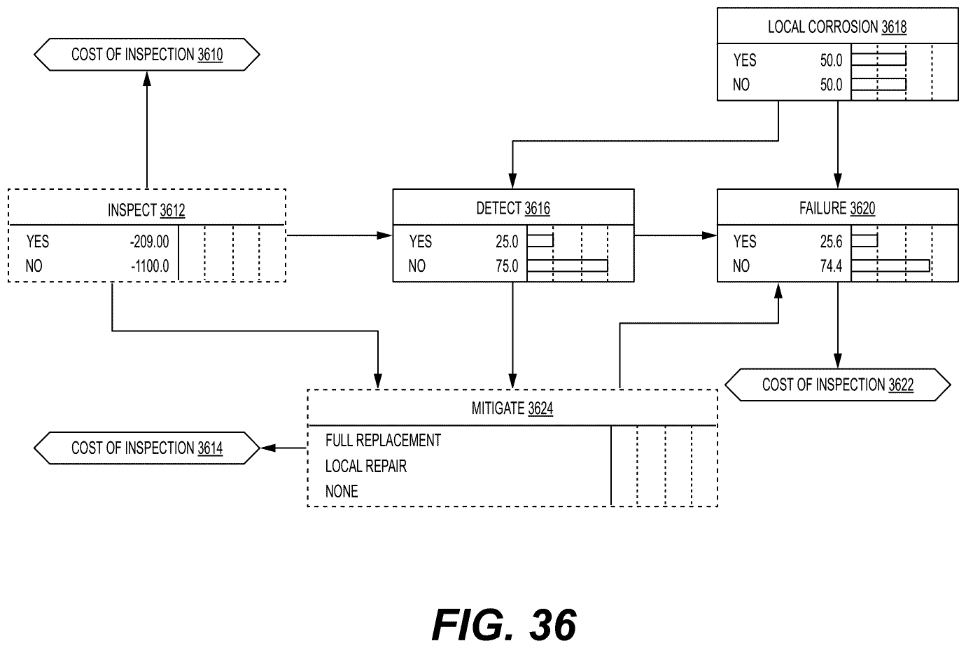

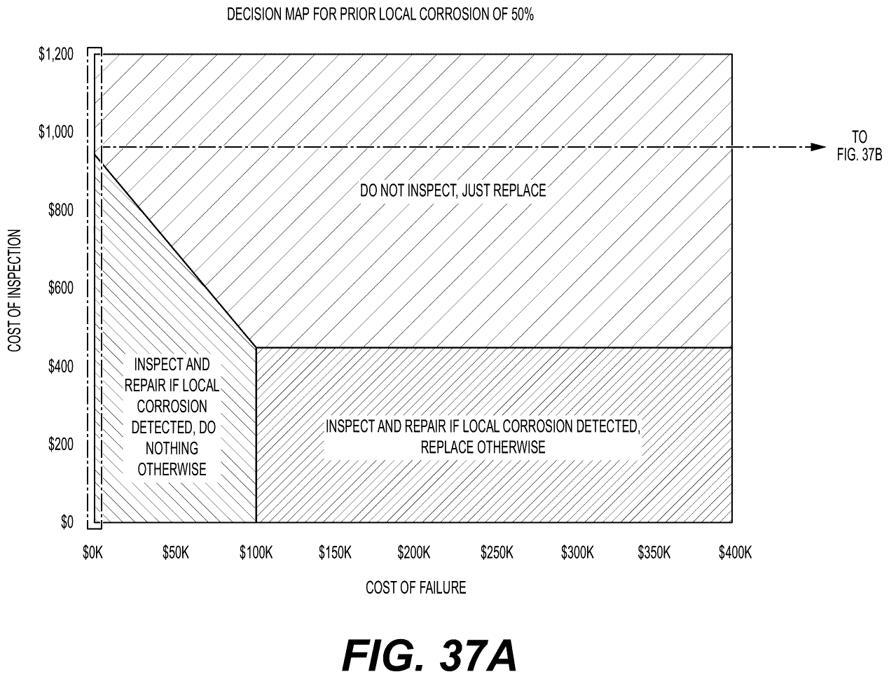

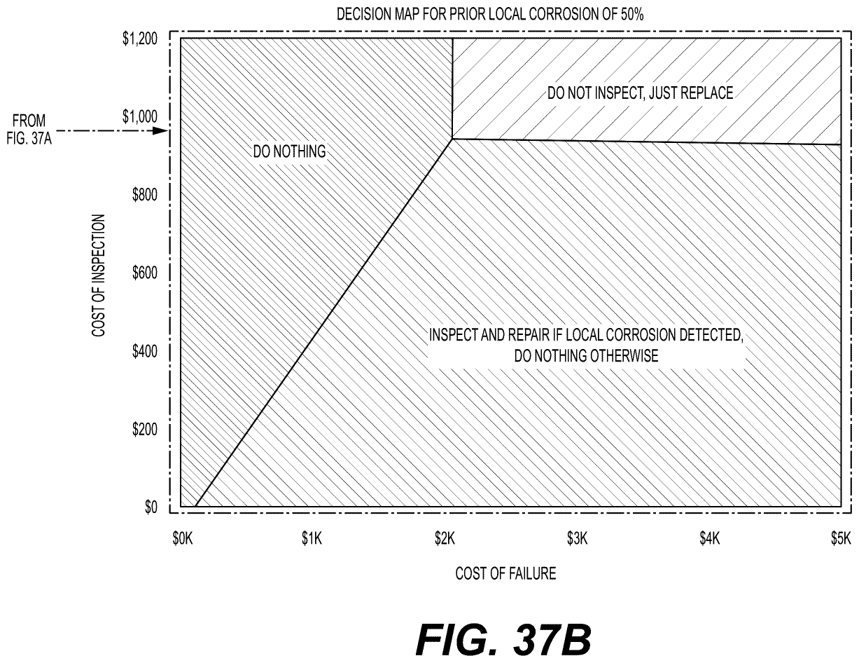

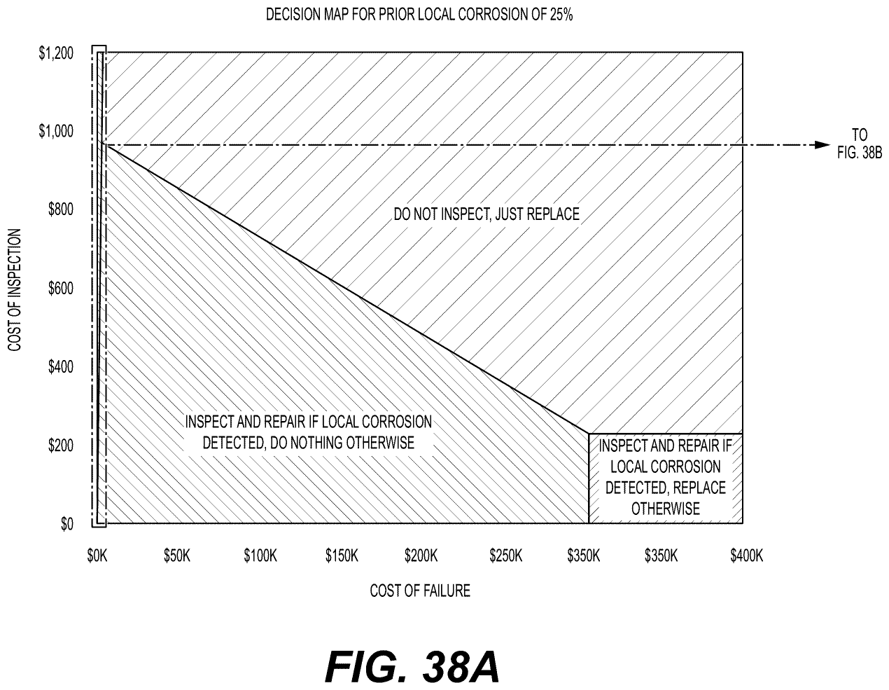

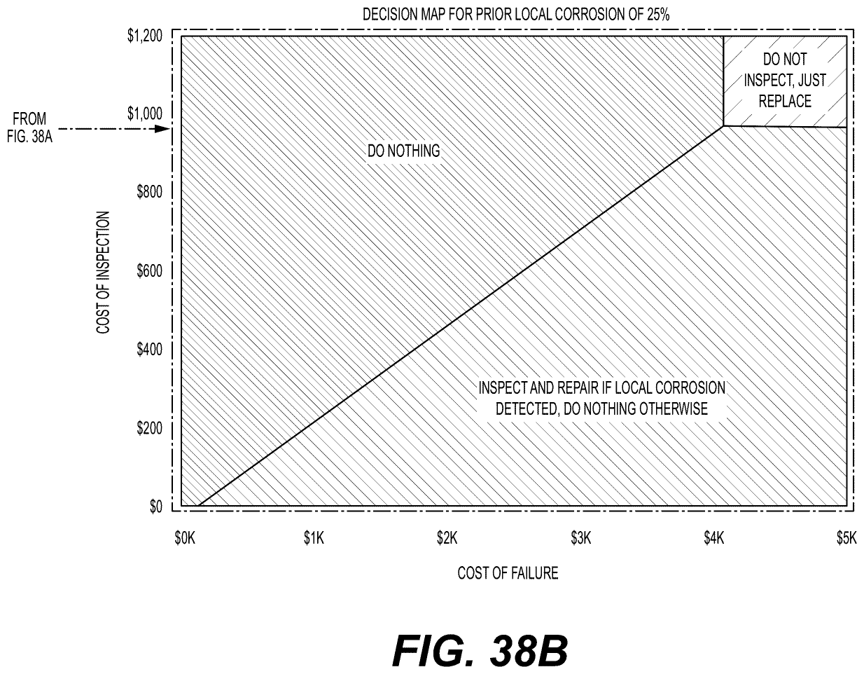

In an embodiment, the disclosure is directed to systems and methods that implement and use decision maps. The decision maps may be used for visualizing the optimal decision strategies coming from probabilistic causal networks in terms of the most pertinent causal factors, leading to enhanced usability and interpretability of the results. Examples shown in FIG. 36, FIG. 37A, FIG. 37B, FIG. 38A, and FIG. 38B illustrate an intrusive inspection only network. The decision map displays the optimal decision strategy resulting from the network for each combination of the cost of inspection and the cost of failure, assuming a fixed probability of local corrosion.

FIG. 36 shows a sample probabilistic causal network according to an embodiment of the disclosure used to determine the optimal decision strategy about whether to inspect or not and then whether to mitigate or not depending on whether any damage was detected or not during the inspection. The network comprises nodes for Cost of Inspection 3610, Inspect 3612, Cost of Mitigation 3614, Detect 3616, Local Corrosion 3618, Failure 3620, Cost of Failure 3622, and Mitigate 3624. In FIG. 36, the random-variable nodes are Local Corrosion, Detect, and Failure, the decision nodes are Inspect and Mitigate, and the utility nodes are Cost of Inspection, Cost of Mitigation, and Cost of Failure. This network sample is similar to the networks illustrated in FIG. 21A-F, except here the Replace decision node is modified to be a Mitigate node with three decision strategy options for mitigation that include Full Replacement, Local Repair, and None (i.e., no mitigation).

FIG. 37A and FIG. 37B show a decision map according to an embodiment of the disclosure. The decision map corresponds to the causal network illustrated in FIG. 36. The decision maps show the optimal decision strategy for varying Cost of Inspection versus Cost of Failure when the prior probability of having local corrosion is 50%. FIG. 37A considers failure costs up to $400,000, whereas in FIG. 37B the upper bound is reduced to $5,000 to see more detail at the lower Cost of Failure. There are four different decision strategies identified in this map based on the costs of inspection versus failure that include: 1) do nothing (i.e., only visible on the upper left side of FIG. 37B); 2) do not inspect, replace only (i.e., shown on the upper right sides of both graphs); 3) inspect and repair if damage is found, otherwise do nothing (i.e., shown on the bottom left side of both graphs); and 4) inspect and repair if damage is found, otherwise replace (i.e., only shown on the bottom right side of FIG. 37A).

FIG. 38A and FIG. 38B show a decision map according to an embodiment of the disclosure. The decision map corresponds to the causal network illustrated in FIG. 36. The decision map is similar to the one previously shown in FIG. 37A and FIG. 37B, by having the same four decision strategies, except here the prior probability of local corrosion is reduced to 25%. FIG. 38A considers failure costs up to $400,000, whereas in FIG. 38B the upper bound is reduced to $5,000 to see more detail at the lower Cost of Failure. Comparing this decision map to the one in FIG. 37A-B reveals that the boundaries separating different optimal decision strategies have generally shifted to higher costs of failure. This is due to the fact that since local corrosion is less likely, the risk at any particular cost of failure is reduced, and inspections have less value until the cost of failure is high enough to make up for the lower probability of failure (i.e., the transitions are based more on risk than just cost, and risk depends on the probability of failure as well as the cost).

To generate such decision maps, the total axis range for each causal factor is first discretized into a finite number of values, and then the probabilistic, causal network is evaluated for every possible combination of these causal factors to find the optimal decision for each. This has the effect of partitioning the entire causal factor space into separate regions. Within each region, only one of the possible decision strategies is the optimal choice. These regions are shaded differently, and the boundaries between them are clearly indicated. Since there are only two axes on a two-dimensional decision map, when there are more than two pertinent causal factors, a separate decision map is created for each pairwise combination of causal factors.

### Causal EVA Method for Partial Coverage Inspections

In an embodiment, the disclosure is directed to a hierarchical causal method for evaluating partial coverage thickness inspections of large surface area assets or assets with many sub-components (e.g., heat exchanger bundles, tank bottoms, large piping sections, etc.). The minimum thickness of the entire asset may be represented as an extreme value distribution, such as the Gumbel Distribution.

Nonlimiting examples of required inputs comprise initial thickness, total asset surface area, recorded measured minimum thickness per inspected sample region, area of each inspected sample region, failure thickness, the EVA minimum thickness distribution of the last inspection and the date of that inspection, and a prior estimate for the expected minimum thickness that can then be used to infer the prior parameters in the model.

The primary outputs comprise the posterior fit parameters and the expected minimum thickness distribution in the remaining uninspected area. This minimum thickness distribution may be determined using a return function that is the ratio of the inspection area to the total area. Once the distribution for minimum thickness is determined, the distribution may be fed into the probabilistic damage rate and failure time networks for causal updating. While the method illustrated here is for thinning (i.e., in terms of thickness), the method may be applied to other damage mechanisms such as cracking (i.e., in terms of crack depth).

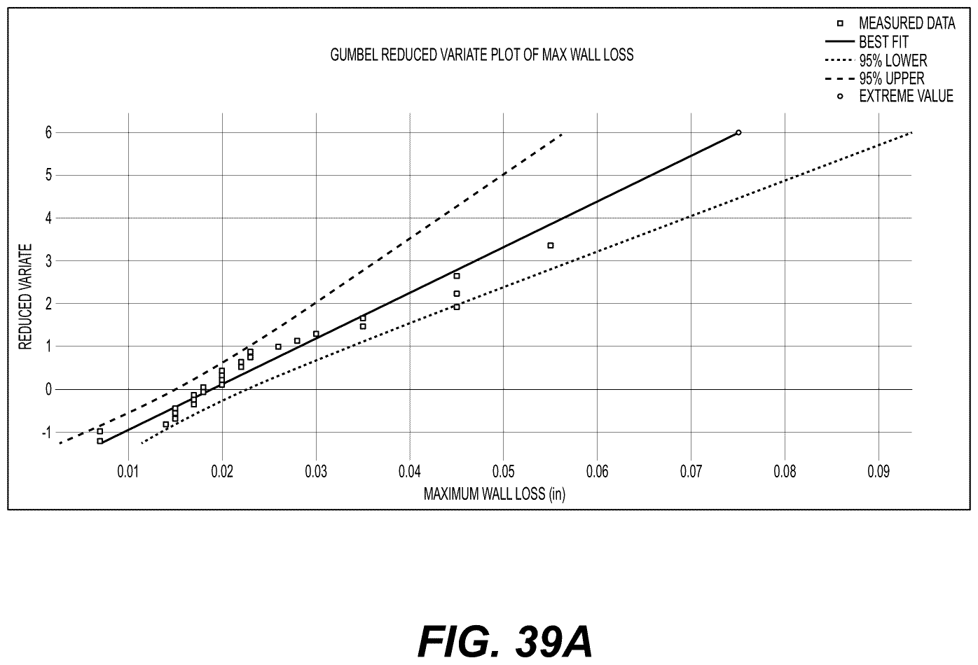

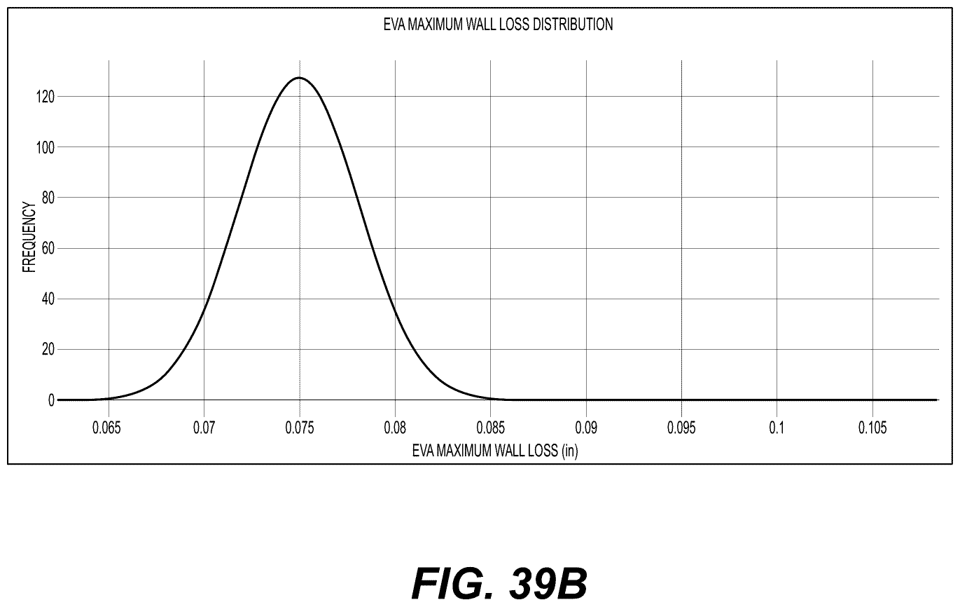

FIG. 39A and FIG. 39B illustrate common outputs from the hierarchical causal method analysis of partial coverage thickness inspection data according to an embodiment of the disclosure. FIG. 39A shows the minimum thickness data plotted as the Gumbel distribution reduced variate, or linearized cumulative distribution, versus the maximum wall loss that has been normalized with respect to the nominal thickness. The best fit, upper and lower 95% confidence bounds, and the projected mean extreme value are overlaid for convenience. FIG. 39B shows the resulting predicted probability distribution for the maximum wall loss expected in the uninspected regions. For this example, approximately 10% of the metallic surface was inspected and the projected maximum wall loss is applicable to the remaining 90% of the metallic surface that was not inspected.

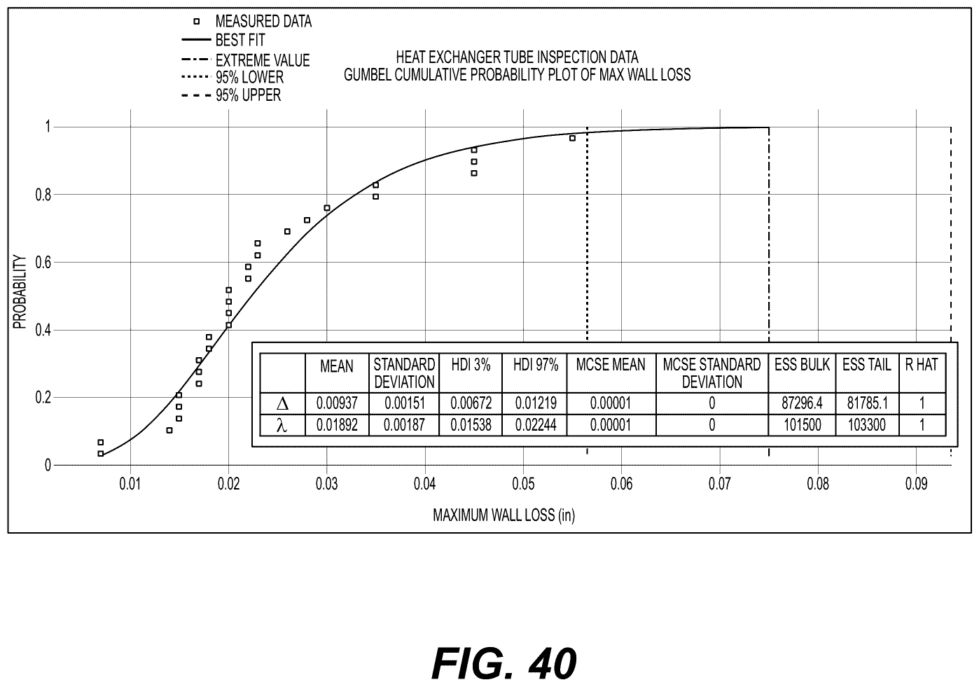

FIG. 40 illustrates supplemental outputs from the hierarchical causal method analysis of partial coverage thickness inspection data according to an embodiment of the disclosure. The underlying graph is consistent with the graph illustrated in FIG. 39A except it is plotted as the cumulative probability on the y-axis instead of the linearized reduced variate. The overlying table data is a sample of the statistical outputs produced from the analysis for the Gumbel distribution parameters delta (i.e., location parameter) and lambda (i.e., scale parameter). The first two data columns for the mean and standard deviation of each parameter are of most importance.

Causal Updating for Assets with EVA Probability of Failure Curves

In an embodiment, the disclosure is directed to systems and methods comprising a causal method for updating the POF for assets as an alternative to modeling the individual damage mechanisms and failure modes explicitly. This is highly valuable for complex systems of piping and equipment where developing predictive models of damage is difficult. If the POF is described by a Weibull distribution (i.e., a common EVA distribution), then the Fréchet PDF distribution (i.e., inverse Weibull distribution) is the only consistent choice for the damage ratio (e.g., pop pressure ratio for pressure relief devices or the thickness/loss ratio for pipe/tube corrosion) distribution that yields a Weibull POF distribution.

This method may be applied to any system, simple or complex, but it is typically most suited for complex systems where the physical/causal relationships defining when and how the system will fail based on first principles is not well understood. However, over time these relationships are learned and inferred as data is gathered. Typical data includes failures, leaks, maintenance events, inspection events, field observations, and the most important field tests (e.g., PRD pop tests or bundle/pipe hydrotests).

Similarly, for thinning and cracking failure modes, when the component is removed from service for replacement, destructive testing can be performed to quantify the damage state, whether it was fit for service or not, and how much remaining life it has. This destructive test data may be input into the model as events to update the parameters and relationships of the failure distribution. Nonlimiting examples of other applications where this approach may be used comprise structures (i.e., for structural integrity), machinery, manufacturing, wind farms, rotating equipment, etc. For these methods, on-demand causal updating procedures may be coupled with live-streaming monitoring data for real-time asset health monitoring. As stated previously, hybrid-AI approaches may be used for pre-processing to extract features used as inputs for the causal updating procedures.

In an embodiment, the disclosure is directed to methods characterized by using EVA distributions with causal methods as described herein to address aging assets with complicated failure modes. There are many aging assets with complicated failure modes that are too difficult to characterize by reliable predictive damage models or where the information necessary to predict past failures has not been well documented. Thus, many times all that is known are in-service durations, a select few observations about the service conditions, the initial state of the asset, and the time of failure or condition of the asset at time of maintenance. Under these circumstances, the POF vs. time can be quantified and predicted via an applicable EVA distribution. Classes of these distributions include Weibull, Gumbel, and Fréchet distributions.

The methods comprise defining the overall POF of the asset in terms of an applicable EVA distribution, quantifying the corresponding probability density function (PDF) in terms of the inspection/maintenance driving variables such as damage state, defect extent, condition, process/fluid severity, etc. The methods comprise updating the PDFs in real time because of inspections, observations, or maintenance in the field. The methods comprise the PDFs learning the rate of damage and relationship between what is observed in the field and when the asset is likely to fail. Thus, the methods are causal updating methods that may be illustrated by using a causal network. Use of a causal network is not required for a solution, as the problems may be iteratively solved, analytically or numerically, as new data/knowledge are gathered.

Three common sample asset applications of interest for such methods are pressure relief devices, heat exchanger tube bundles, and tank bottoms. All three fail, have lots of past failure data, and have complicated failure modes. For pressure relief devices, the POF may be related to pop pressure data and fluid severity. For bundles and tank bottoms, the POF may be related to metal loss and process corrosivity. As inspections and maintenance are conducted, these relationships are updated along with the resulting POE

In an embodiment, the disclosure is directed to methods described herein characterized in that the methods are applied to pressure relief devices. An example of such a method is illustrated here for relief devices, but the method may be applied to other problems mentioned herein. For relief devices, the probability of failure on demand may be described by the Weibull distribution as shown in Equation 13.

$${P}_{fod} = 1 - exp [ - {( η / t )}^{- β} ] \qquad ( Equation 13 )$$

In the POF expression, η is an indication of fluid severity while β is a fixed constant that is dependent on the material of construction and the relief device type. Failure is commonly defined for a relief device, somewhat arbitrarily, to be when the inspected pop pressure exceeds 1.3 times the set pressure of the device, as shown by Equation 14.

$${P}_{fod} = P ( p > 1.3 \cdot {p}_{set} ) = 1 - F ( 1.3 \cdot {p}_{set} ) \qquad ( Equation 14 )$$

The PDF corresponding to the pop pressure ratio r=(p/pₛₑₜ) is naturally defined via the Fréchet distribution, i.e., the inverse Weibull, and written as Equation 15.

$$( Equation 15 )$$

$$f ( r \vert η , t ) = \frac{β}{r - {r}_{min}} \cdot {( \frac{{r}_{f , s} - {r}_{min}}{r - {r}_{min}} \cdot \frac{t}{η} )}^{β} \cdot exp [ - {( \frac{{r}_{f , s} - {r}_{min}}{r - {r}_{min}} \cdot \frac{t}{η} )}^{β} ]$$

The posterior distribution for the fluid severity parameter η can then be determined via Bayes theorem, iteratively, after each pop pressure test result, where f(η) is its prior probability before any tests are performed, as in Equation 16.

$$f ( η \vert {r}_{i} , {t}_{i} ) = \frac{f ( {r}_{i} \vert η , {t}_{i} ) \cdot f ( η )}{{\int }_{0}^{∞} f ( {r}_{i} \vert η , {t}_{i} ) \cdot f ( η ) \cdot d η} \qquad ( Equation 16 )$$

This two-stage process is repeated sequentially for all pop pressure tests results, where the resulting posterior probability for η after each test is used as the prior probability for the next test. This pop pressure ratio can be replaced by a loss ratio for a heat exchanger bundle or tank bottom application, and the fluid severity can be regarded as a corrosivity indicator that can then be related to corrosion rate. The same approach can be applied to any aging asset.

Separate expressions for inspection results, such as a pass/fail inspection where the precise pop pressure is not recorded, can also be used to update η. Additionally, maintenance can be accounted for in terms of either age reductions or life extensions. For relief devices, maintenance events may include cleaning the device, damaging the device on transit, unclogging the relief device during testing, and overhauling the device back towards its original state. Each one of these events provides an age reduction or life extension, such that they add or remove time to the intrinsic age of the device.

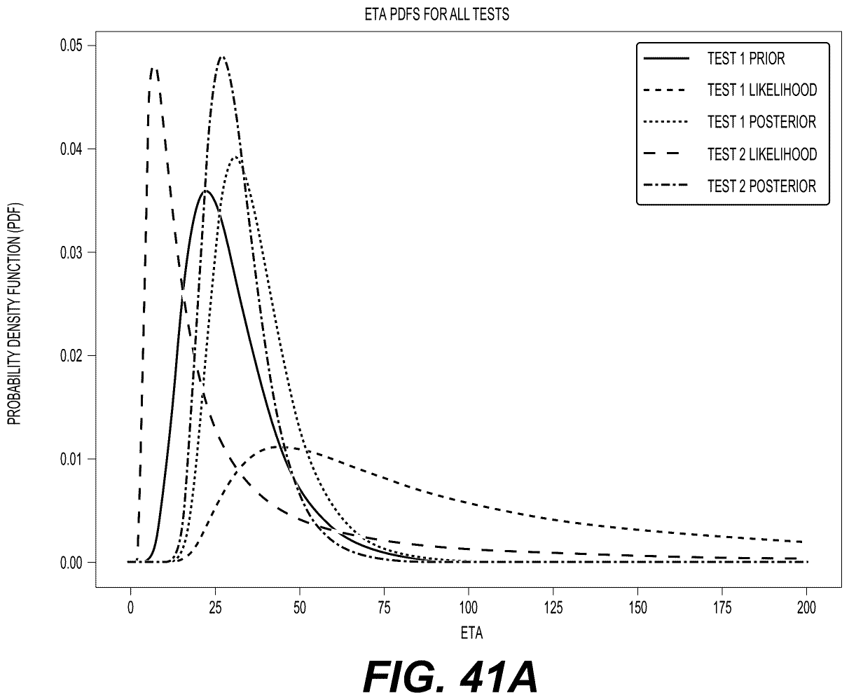

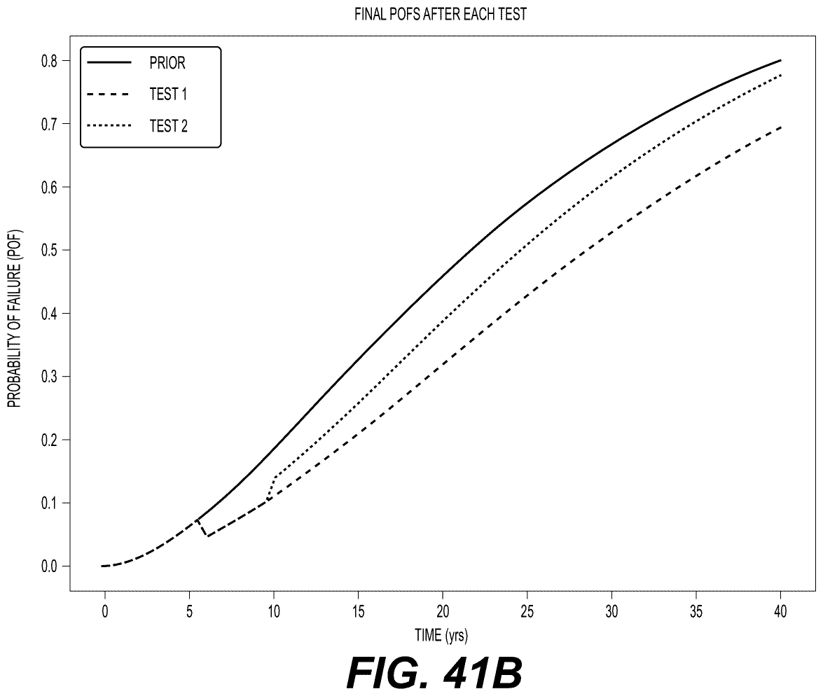

FIG. 41A and FIG. 41B show sample outputs for the causal updating analysis for a relief device according to an embodiment of the disclosure. Here, the relief device has been in service for 10 years with two prior inspections at years 6 and 10, measured from the time of installation. The pop pressure was reported for both inspections. The first inspection had a passing pop pressure, while the second inspection had a failing pop pressure. FIG. 41A shows the updated eta (q) distributions before and after each test. The likelihood distribution is also shown for convenience. FIG. 41B shows the updated POF versus time after each test. The first passed test at year 6 shifts the POF down, while the second failed test at year 10 shifts the POF back up.

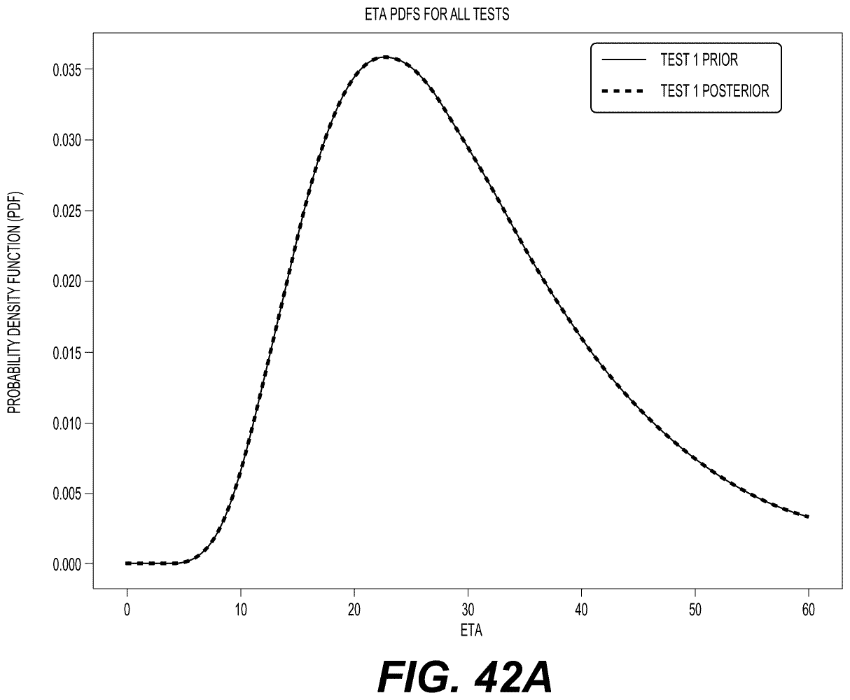

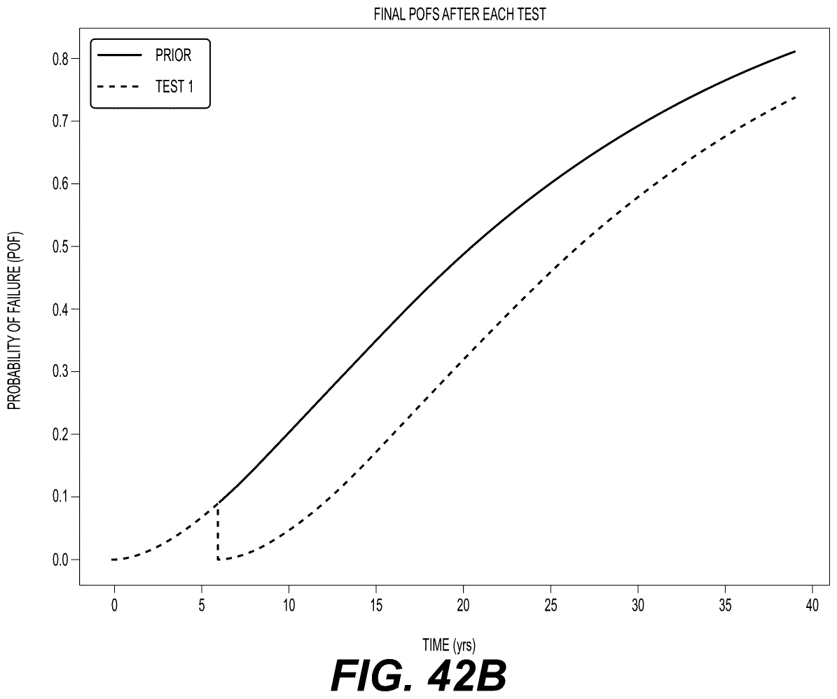

FIG. 42A and FIG. 42B also show sample outputs for the causal updating analysis for a relief device according to an embodiment of the disclosure. Here, the relief device has been in service for 10 years, has no past inspections recorded, and had a complete overhaul after 6 years in-service. An overhaul restores the relief device back to its original state and essentially resets its age to zero. In FIG. 42A, note that the overhaul did not affect the eta (q) distribution, as there was no inspection recorded to indicate the fluid severity. The effect of the overhaul is shown in FIG. 42B by the POF curve being reset back down to zero at year 6.

### Uninspectable Damage Mechanisms

In an embodiment, the disclosure is directed to methods comprising fully-predictive physical causal methods and networks for aging assets subject to uninspectable damage mechanisms. Certain damage mechanisms manifest as microstructural-level damage that are not easily detectable with the current inspection technologies available today. As a result, inspections cannot be used to monitor the state of damage to estimate when the asset will likely fail. Instead, purely physical models must predict failure time and ultimately decide when to act and replace the asset prior to failure. The more accurate the model, the more precisely timed this replacement decision can be.

Models that lack predictive power either result in unexpected failures or conservative replacements. Even predictive models require accurate and well-defined input data, as the input-data quality will be reflected in its predictive ability. For example, for the creep damage mechanism, the present methods may precisely monitor the temperature and pressure of the asset, and then continuously run an accurate FEA simulation to get the local stress profiles that can then be used to predict cumulative creep damage. The only uncertainty then becomes the predictive power of the model itself, which is accounted for by using a probabilistic causal network approach and validating the model with field observations. As failures occur and proactive replacements are made, each one of these field observations becomes a data point that is used to further train and refine the model.

### Sample Industrial Applications

### Hybrid Artificial Intelligence (AI)

Another advantage of the probabilistic, physics-based, causal method as described in embodiments herein is that the methods may be coupled with traditional AI approaches in what is referred to as the hybrid-AI approach. This allows the methods to leverage the strengths of both approaches in a single system. Traditional AI (i.e., data analysis and statistics based) methods may be used for pre-processing to get inputs for the causal methods. In the pre-processing steps, traditional AI (e.g., classification, clustering, signal analysis, feature identification, language processing, et cetera) may be used to automatically interrogate large volumes of raw data. The outputs of the traditional AI analyses may include information about key features that may then be used as inputs to the physics-based models. The raw data itself does not identify these features, and without human intervention, trained traditional AI must be relied upon. Once identified, these features can be used in the present causal methods for prediction and decision making.

The general approach for hybrid-AI according to methods described herein may be used to solve a vast array of aging asset problems. A nonlimiting example of hybrid-AI in the present methods comprises processing large volumes of time-series sensor data of process or environmental variables (e.g., measuring temperature, fluid composition, velocity, etc.) to extract statistical trends, identify clusters, and spot outliers. Another nonlimiting example of hybrid-AI in the present methods comprises processing large volumes of time-series inspection data (e.g., inspection sensors such as UT sensors reporting thickness or guided-wave sensors detecting corrosion defects) for similar statistical properties, clusters, and outliers. Another nonlimiting example of hybrid-AI in the present methods comprises visual inspection images and IR scans from either mobile devices or drones to extract features that directly or indirectly indicate the presence of corrosion damage or precursors to damage. Another nonlimiting example of hybrid-AI in the present methods comprises data and feature extraction from text-based inspection and maintenance records for input into causal networks to update predictions and quantify inspection effectiveness. Another nonlimiting example of hybrid-AI in the present methods comprises data and feature extraction from large volumes of incident reports for severity prioritization.

### Sulfidation Predictive Causal Network

In an embodiment, the disclosure is directed to systems and methods for sulfidation prediction using causal networks as described herein. Traditional RBI approaches (e.g., per API RP 581) rely on user-specified constant corrosion rates to calculate a damage factor that is then used to predict the POF and risk. Some guidance is provided by these methods for selecting conservative and upper bound corrosion rates per damage mechanism, but, overall, these methods lack predictability, are not fully probabilistic (i.e., they do not account for all inherent uncertainties), and do not continuously learn as new knowledge is gathered.

A better approach is to predict the full probability distribution for the corrosion rate and future metal loss, rather than a single deterministic value. The present methods predict the full distributions and then use these distributions to calculate the POF and risk more accurately. Additionally, when inspection and maintenance are performed, the present methods use the knowledge gained to update the predictive thickness projections explicitly, such that the inspection and maintenance effectiveness can be quantified in terms of risk reduction.

In refineries, particularly in the crude and Hydroprocessing units, common high temperature corrosion damage mechanisms that all refineries must manage include sulfidation, naphthenic acid corrosion (NAC), and high temperature H₂/H₂S corrosion. These mechanisms are a mix of general and local morphologies, such that properly placed CMLs have some effectiveness. The industry standard for predictability has been a series of works, referred to as the Modified McConomy curves and the Couper Gorman curves. These curves were fit from industry data gathered in the 1960s. These curves are statistical best fit curves without uncertainties and with many causal factors excluded or missing.

The present systems and methods improve upon such historical approaches by using probabilistic causal network methods for these mechanisms that account for more causal factors, are fully probabilistic to account for all inherent uncertainties, and have additional methods for sensor data input (i.e., from either process sensors like sulfur concentration and temperature or inspection sensors like spot UT thickness).

The functional form for the mechanistic model used in the present methods is shown by Equation 17, with the coefficients Cₛ, n, Aₛ, and ΔH depending on the various identified causal factors.

$${CR}_{sulfidation} = {C}_{s}^{n} \cdot {A}_{s} \cdot {e}^{- Δ H / RT} \qquad ( Equation 17 )$$

The data available in the literature mostly illustrates the overall trends between corrosion rate and sulfur, temperature, and velocity. In contrast, the present methods extend upon and improve the traditional predictions, due to processing of decades of past RBI consulting work to extract expert assigned corrosion rates and field observations from user inspection records. Other factors incorporated into the present predictive causal network include metallurgy, sulfur type, naphthenic acid type, velocity, fluid phase, etc.

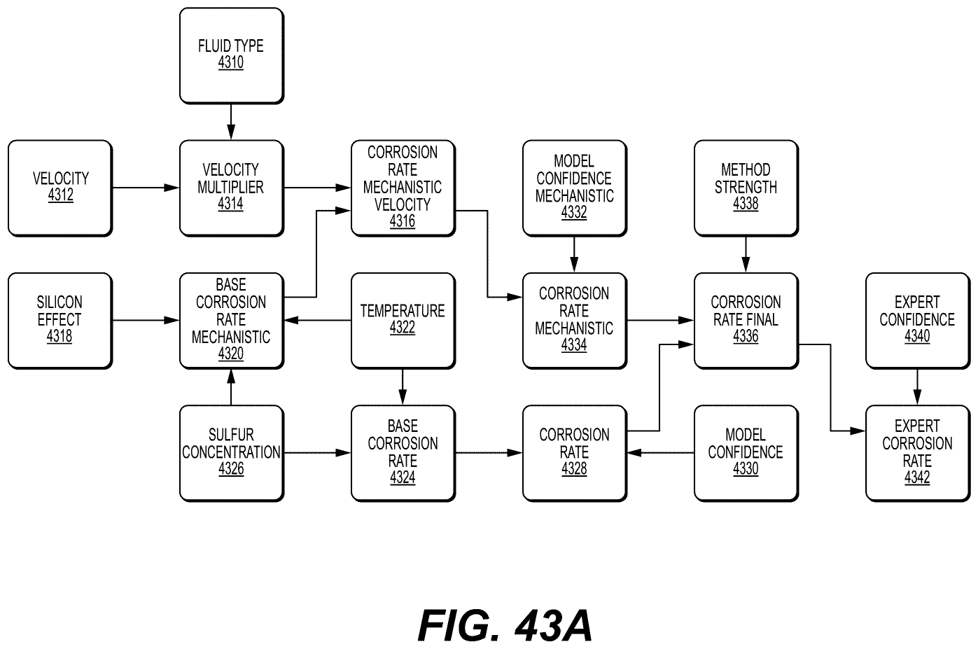

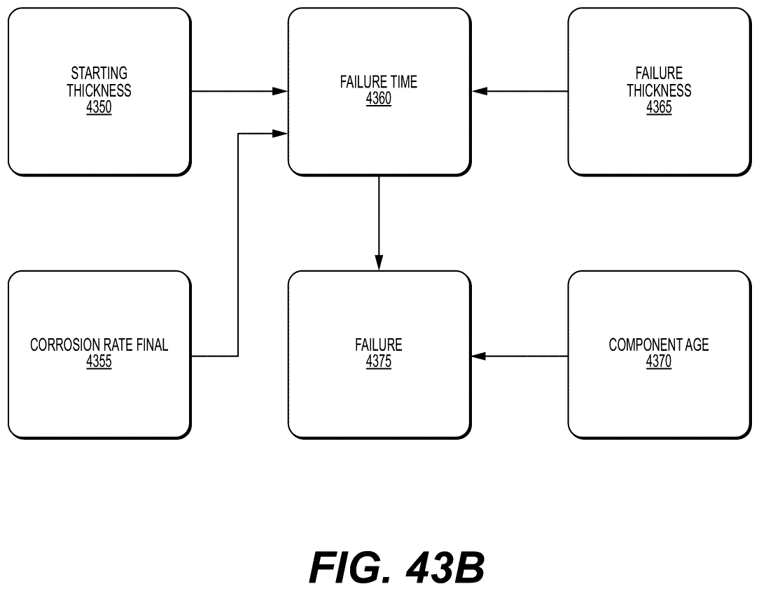

FIG. 43A and FIG. 43B show a sample network used for sulfidation corrosion of high-silicon carbon steel according to an embodiment of the disclosure. FIG. 43A illustrates the first step of the process for sulfidation corrosion, which is to determine the corrosion rate. As shown, the corrosion rate depends on many physical factors as represented by a plurality of nodes comprising the Fluid Type 4310, Velocity 4312, Velocity Multiplier 4314, Silicon Effect 4318, Base Corrosion Rate Mechanistic 4320, Corrosion Rate Mechanistic Velocity 4316, Sulfur Concentration 4326, and Temperature 4322, Base Corrosion Rate 4324, Corrosion Rate 4328, Corrosion Rate Mechanistic 4334, Model Confidence Mech 4332, Corrosion Rate Final 4336, Method Strength 4338, Model Confidence 4330, Expert Corrosion Rate 4342, and Expert Confidence 4340 nodes. In this example there are two model predictions, each with their own confidence/error term, and there is an expert opinion of the corrosion rate, also with an associated error/confidence term. The network shown in FIG. 43B comprises nodes for Starting Thickness 4350, Corrosion Rate Final 4355, Failure Time 4360, Failure Thickness 4365, Component Age 4370, and Failure 4375. FIG. 43B illustrates a second step of the process for sulfidation corrosion, which is to use the predicted corrosion rate distribution, along with the Starting Thickness 4350 and Failure Thickness 4365 nodes, to predict the Failure Time 4360 node distribution. The Failure 4375 node displays the cumulative probability of failure at a user-specified time of interest (i.e., Component Age).

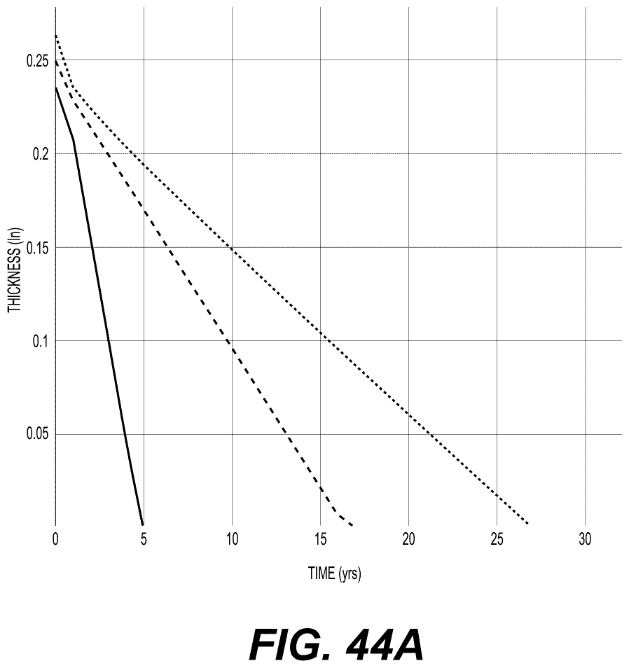

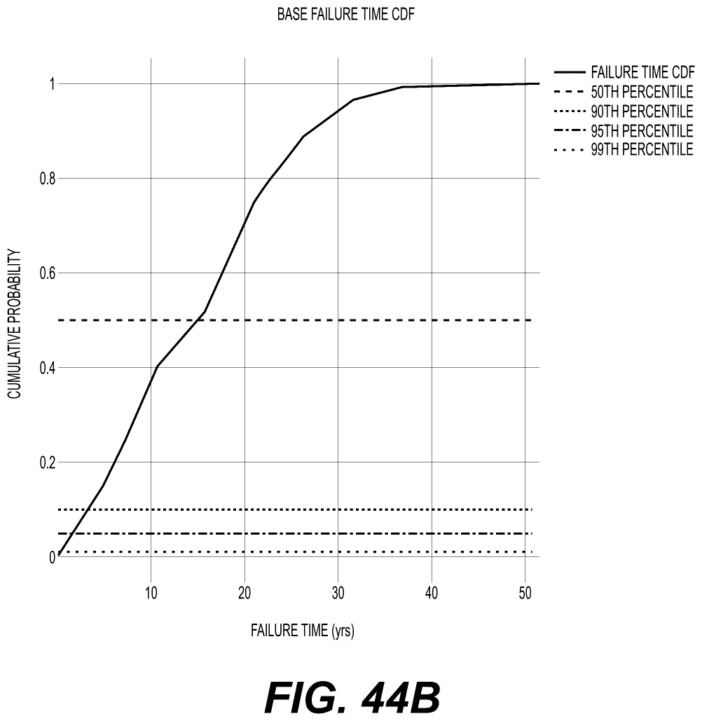

FIG. 44A and FIG. 44B illustrate the corresponding thickness projection graph and cumulative probability of failure for a sample sulfidation corrosion prediction, respectively, according to an embodiment of the disclosure. FIG. 44A shows the Median 50th percentile thickness projection along with the lower 10th percentile and upper 90th percentile. The thickness projection starts out at the Starting Thickness (i.e., shown here to be about 0.25 inches) with some minimal variance in thickness based on the manufacturer's undertolerance. To predict future metal loss, the corrosion rate is multiplied by time. Thus, the variance of the thickness projection increases in time as illustrated by the fanning out of the thickness projection curves. FIG. 44B shows the resulting cumulative probability of failure as a function of time and four overlaid horizontal lines representing thresholds for various percentiles of interest (i.e., shown here as the 50th through 99th percentiles).

This same approach may be followed for all damage mechanisms with predictive models (i.e., in the refining and petrochemical industry there are roughly one hundred such damage mechanisms), and even those mechanisms that are difficult to build a physics-based model for can have a predictive model built from just subject matter expertise and historical field data alone.

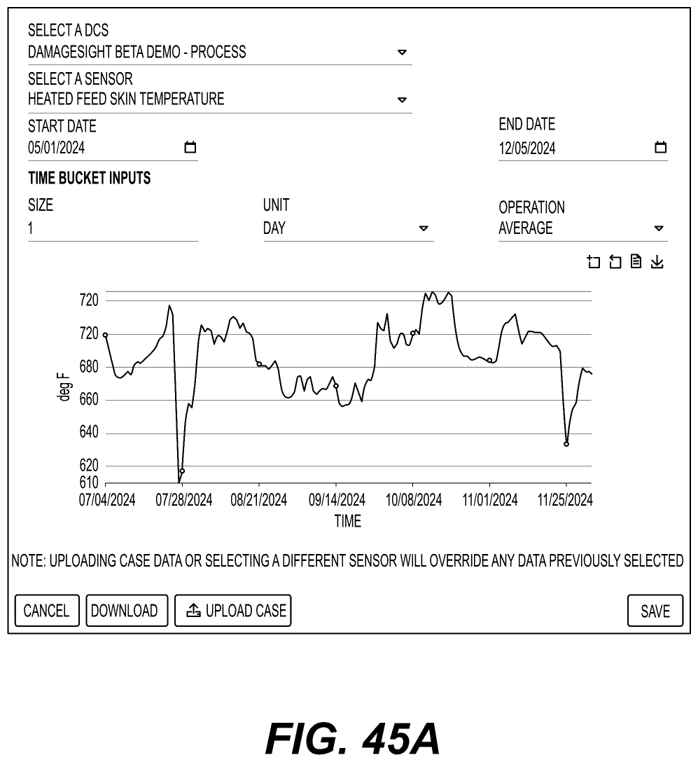

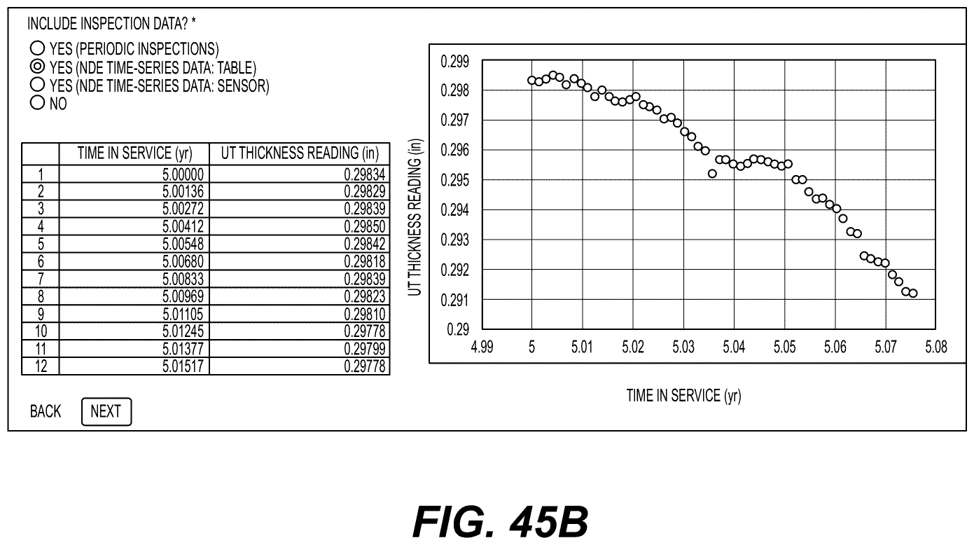

FIG. 45A and FIG. 45B illustrate sample time-series sensor data used as inputs into the predictive model for sulfidation corrosion according to an embodiment of the disclosure. FIG. 45A shows historical temperature data for a time period from Jun. 4, 2024 through Dec. 5, 2024 that is daily averaged and fluctuates between a minimum of 610° F. and a maximum of 725° F. FIG. 45B shows UT thickness data recorded daily over an approximately one-month period with an initial reading of about 0.298 inches and a final reading of about 0.291 inches. The temperature input data is used to calibrate the CPT for the Temperature node in the physical sulfidation corrosion model, while the UT thickness data updates the predicted thickness at the time of the sensor readings.

### Ammonium Chloride Predictive Causal Network

In an embodiment, the disclosure is directed to systems and methods for ammonium chloride corrosion using an ammonium chloride predictive causal network. Similar to the predictive model for sulfidation, which is representative of a high temperature damage mechanism, a probabilistic causal network for predicting ammonium chloride corrosion is provided, which is representative of an aqueous low temperature damage mechanism. This model is applicable to any aqueous corrosion mechanism with similar physical phenomena, such as ammonium bisulfide corrosion, hydrochloric acid corrosion, organic acid corrosion, CO₂ corrosion, and H₂S corrosion.

The method comprises given the partial pressures of ammonia and hydrochloric acid, determining if salt formation is thermodynamically stable at the process temperature of interest. For the determination where no salt formation is possible, then no corrosion is possible. For the determination where salt formation is possible, then the method further comprises using the stream's local relative humidity to determine if the dry salts can uptake moisture and deliquesce into droplets or if bulk condensation occurs due to the temperature operating below the water dew point (i.e., typically the relative humidity is low prior to water wash injection and high afterwards). If water is present, the method further comprises calculating the corresponding H+ concentration and pH, which drive the cathodic corrosion reactions. The method further comprises solving the electrochemical reactions to get the current density, flux, and corrosion rate of anodic dissolution for the iron alloy of interest.

Implementing the method as a probabilistic causal network that can learn from new data and properly blend disparate data from multiple knowledge sources is unique to the present systems and methods. Much less data (e.g., field or experimental) is available in the literature for this mechanism, and the physical model is more complicated than sulfidation corrosion (i.e., partly because the physical phenomena of low temperature aqueous corrosion is better understood than high temperature corrosion). Note that the core failure time network, thickness projection output, and POF curve output are of the same format as for sulfidation, even though the corrosion rate network is different.

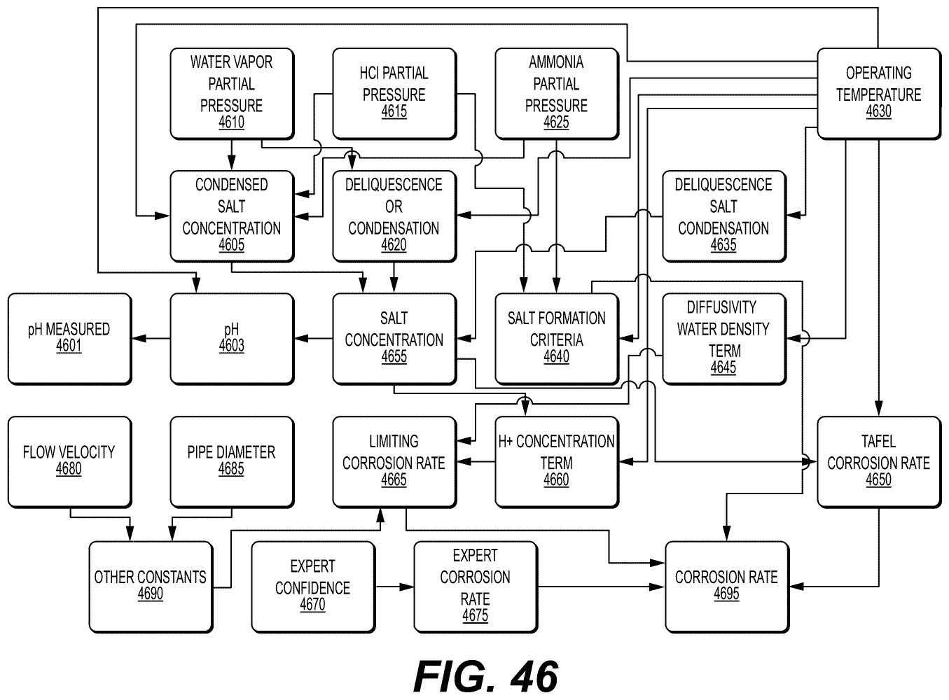

FIG. 46 shows a sample network used for ammonium chloride corrosion of carbon steel according to an embodiment of the disclosure. Unlike the previous example for sulfidation corrosion, this network is only used to predict the corrosion rate, since the causal network for determining failure time, given the corrosion rate, is identical to that for sulfidation corrosion. As shown, the corrosion rate depends on many physical factors as represented by a plurality of nodes comprising Water Vapor Partial Pressure 4610, HCl Partial Pressure 4615, Ammonia Partial Pressure 4625, Operating Temperature 4630, Flow Velocity 4680, Other Constants 4690, Pipe Diameter 4685, Condensed Salt Concentration 4605, Salt Concentration 4655, Salt Formation Criteria 4640, Diffusivity Water Density Term 4645, Deliquescence Salt Condensation 4635, H+ Concentration Term 4660, Limiting Corrosion Rate 4665, Expert Corrosion Rate 4675, Expert Confidence 4670, Tafel Corrosion Rate 4650, Deliquescence or Condensation 4620, pH 4603, pH Measured 4601, and Corrosion Rate 4695 nodes. There are also many intermediate calculated random-variables for physical factors represented by the Salt Formation, Deliquescence, Condensation, pH, Limiting Current Density, and Final Current Density nodes. Only a single model prediction is included for this damage mechanism, and an expert opinion with an associated error/confidence is also accounted for.

### Other Corrosion Predictive Causal Network

In an embodiment, the disclosure is directed to a causal network method for damage mechanisms without predictive models. This is referred to as Other Corrosion, but there is also one for Other Cracking. The only model input comprises one or many expert opinion(s) of the prior probability for the corrosion rate. This prior corrosion rate distribution may come from any source, including a separate black box software program. Without further historical data or new field observations, the corrosion rate distribution is used to predict failures. As inspection sensor data is gathered, it is fed into the network, along with data from periodic inspections and maintenance, to further learn and refine the corrosion rate distribution. Over time the corrosion rate distribution becomes more and more representative of reality. This is referred to as a data-driven corrosion rate, as it is being learned purely from data. Information from assets with similar metallurgies and corrosivities may be shared to improve predictability and learning.

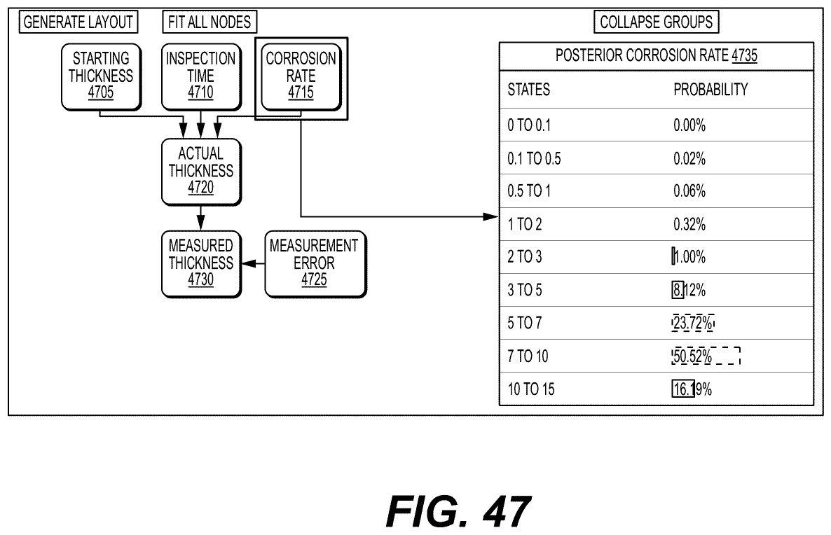

FIG. 47 illustrates a causal network for learning the corrosion rate probability distribution from UT thickness sensor data according to an embodiment of the disclosure. The network comprises nodes for Starting Thickness 4705, Inspection Time 4710, Corrosion Rate 4715, Actual Thickness 4720, Measured Thickness 4730, and Measurement Error 4725. The output from the Corrosion Rate 4715 node is a table showing the Posterior Corrosion Rate 4735 with values for the states and probability. This sample is for the Other Corrosion damage mechanism that does not have a physical model and relies on the combination of historical data and expert opinions to define the prior probability distribution for the corrosion rate. Here, the corrosion rate is most likely to be between 7 and 10 mils/yr with some smaller chance that it may be between 3 and 7 mils/yr or between 10 and 15 mils/yr.

### Condition Monitoring Location (CML) Optimization

Extending upon the above inspection effectiveness methods, an embodiment of the disclosure is directed to a specific causal network method for performing CML optimization. Here, the method optimizes the inspection technique or series of techniques and number of CMLs required (i.e., informing the user to add or reduce CMLs in certain circumstances). Inspection effectiveness and costs, for all methods, may be included.

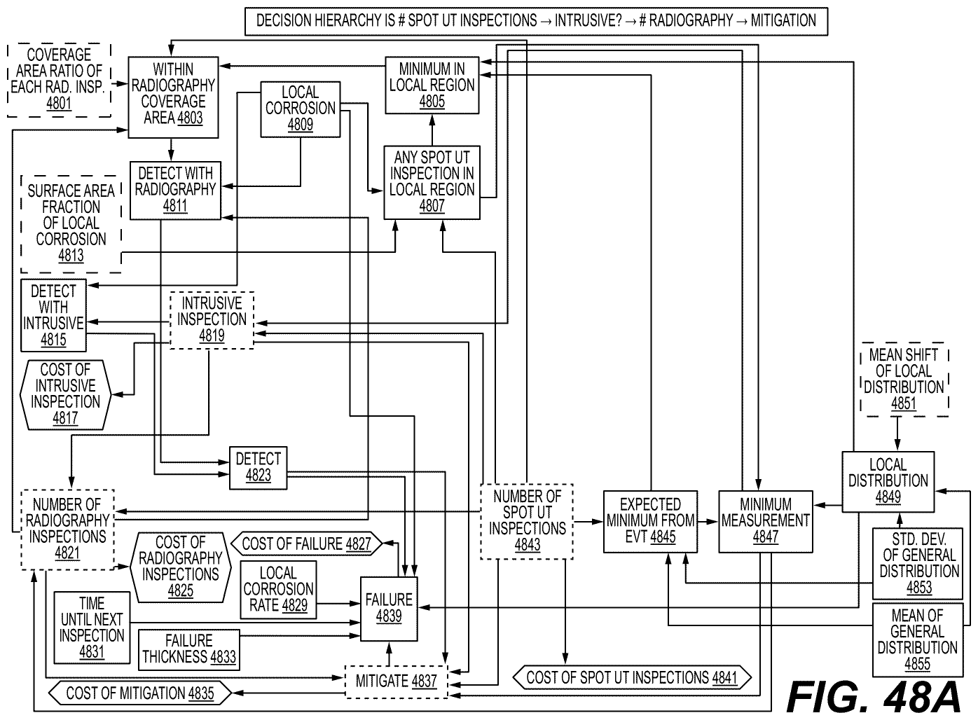

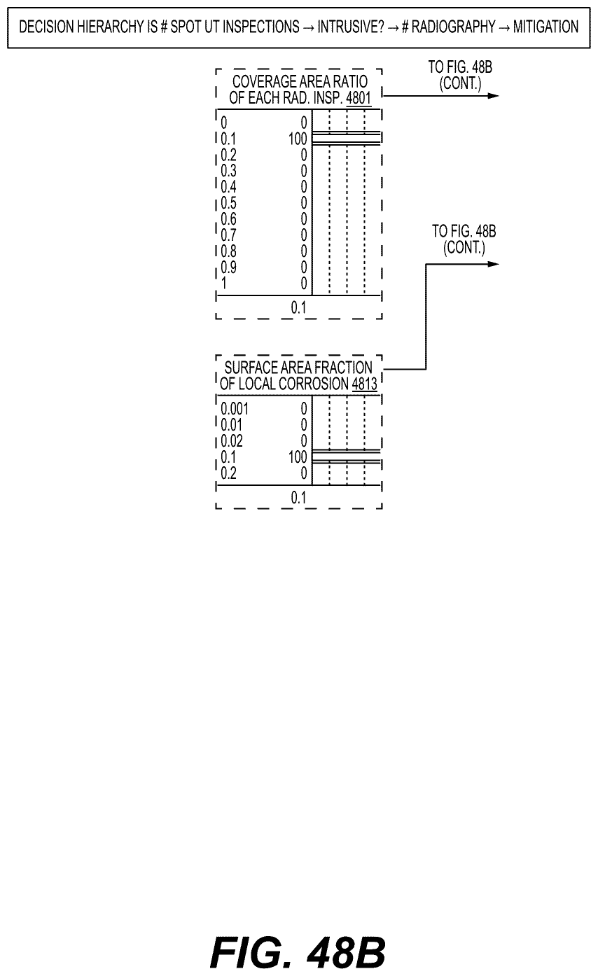

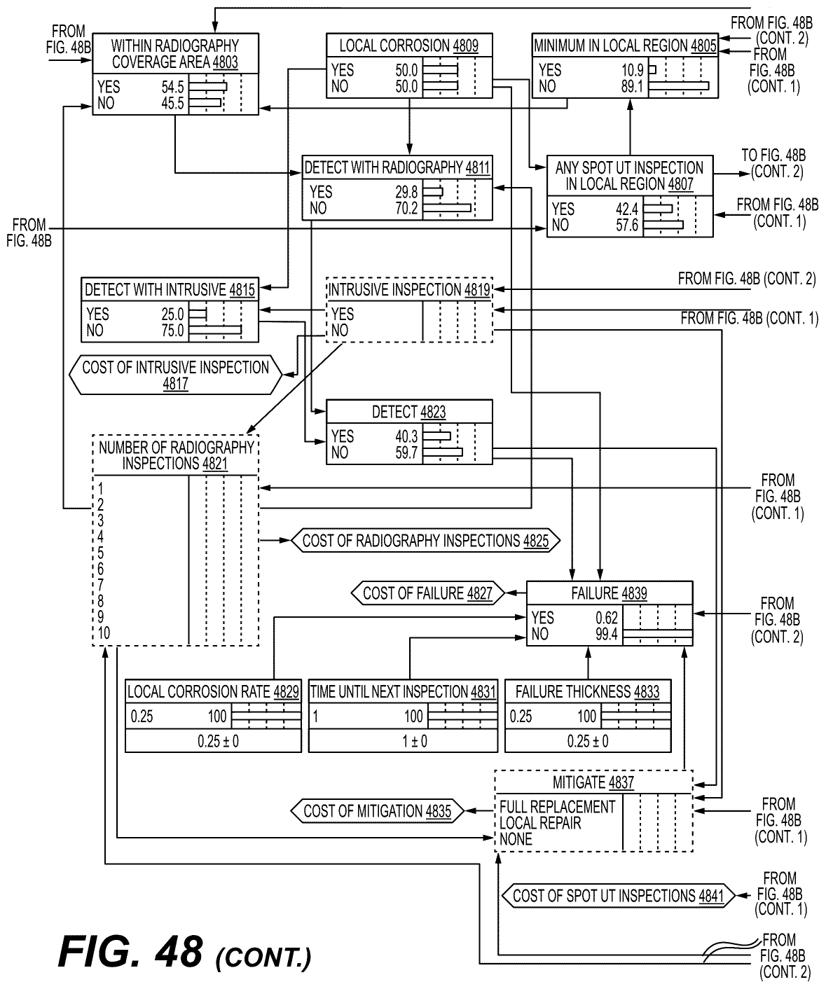

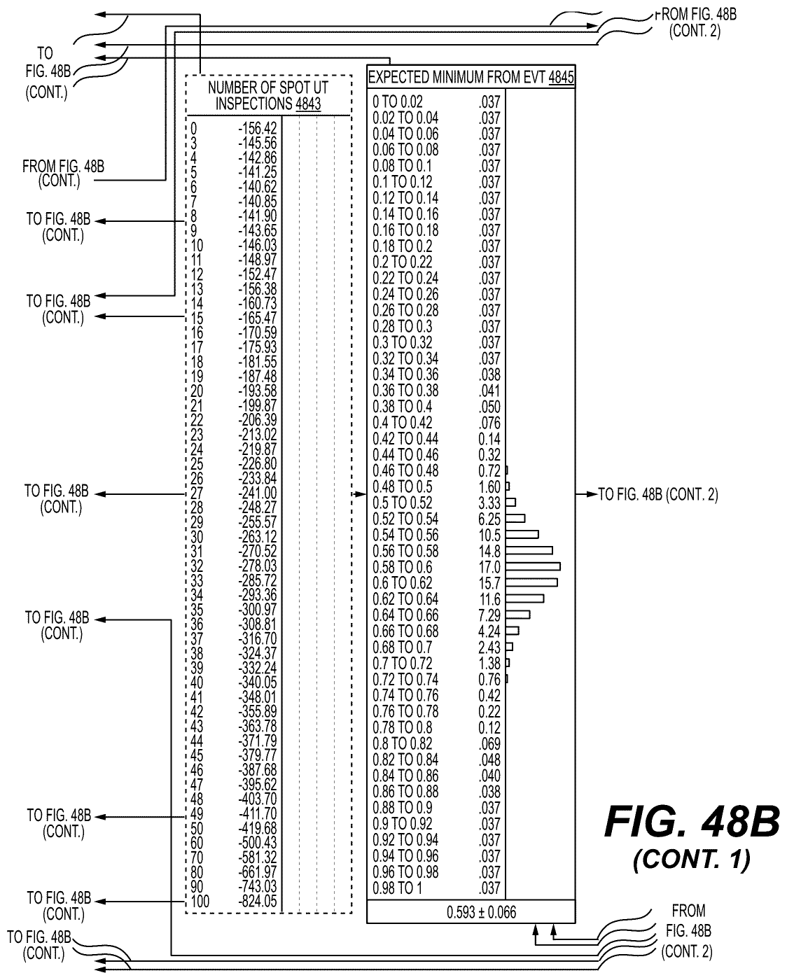

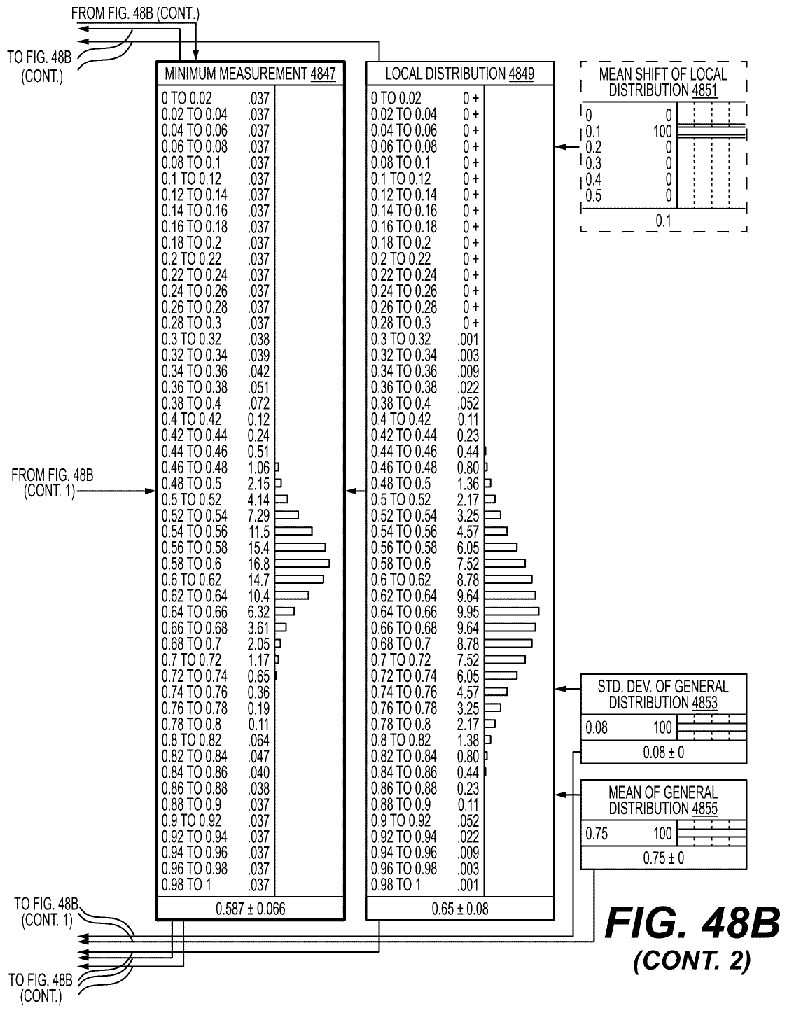

FIGS. 48A and 48B show a sample causal decision network for CML optimization according to an embodiment of the disclosure. FIG. 48A shows a simplified view of a sample CML optimization network according to an embodiment of the disclosure. FIG. 48B shows a detailed view of the sample CML optimization network of FIG. 48A. As shown in FIG. 48A-B, the network comprises nodes for Coverage Area Ratio of Each Rad. Insp. (Radiography Inspection) 4801, Within Radiography Coverage Area 4803, Detect with Radiography 4811, Surface Area Fraction of Local Corrosion 4813, Detect with Intrusive 4815, Cost of Intrusive Inspection 4817, Intrusive Inspection 4819, Costs of Radiography Inspections 4825, Number of Radiography Inspections 4821, Detect 4823, Local Corrosion 4809, Minimum in Local Region 4805, Any Spot UT Inspection in Local Region 4807, Number of Spot UT Inspections 4843, Cost of Spot UT Inspections 4841, Mitigate 4837, Cost of Mitigation 4835, Failure 4839, Cost of Failure 4827, Failure Thickness 4833, Time Until Next Inspection 4831, Local Corrosion Rate 4829, Expected Minimum From EVT 4845, Minimum Measurement 4847, Local Distribution 4849, Mean Shift of Local Distribution 4851, STD DEV of General Distribution 4853, and Mean of General Distribution 4855. It is assumed that the inspection time is fixed and that the goal of the CML optimization is to determine the best inspection strategy (i.e., combination of inspection techniques) at the specified inspection time. As shown in FIGS. 48A and 48B, the CML optimization network has a hierarchical structure representing a sequence of decisions in the order of Number of Spot UT Inspections→Intrusive Inspection→Number of Radiography Inspections→Mitigate, as noted in the box above the network (i.e., these are the decision nodes in the network). All other expanded nodes with probabilistic states are random-variable nodes, while the five remaining utility nodes are represented by collapsed hexagons. This is a simplified example that is expanded greatly in the Asset Life Cycle Optimization System to cover all possible inspection and maintenance strategies. The inspection effectiveness methods noted above are also tightly integrated with the probabilistic physics-based causal methods for predicting failure time, and the probabilities of local corrosion and failure come from those alternate predictive causal networks discussed previously.

The network shown in FIG. 48A-B illustrates a specific example and demonstrates the optimal solution. Here, the assumption is that the next inspection is at 2 years, the local corrosion rate is measured to be 50 mils/yr, the failure thickness is 0.1 inch, the likelihood of local corrosion is 50%, the expected total area of local corrosion is 3%, the thickness is expected to be 0.3 inch with a standard deviation of 0.04 inch in the areas with general corrosion, the thickness is expected to be half as small if there is local corrosion present, the cost of a single spot UT inspection is $1,000, the cost of a single Radiography inspection is $10,000, the cost of an intrusive inspection is $100,000, the replacement cost is $500,000, the local repair cost is $50,000, and the failure cost is $5 million.

Given these assumptions, the optimal strategy is to do zero spot UT inspections, no intrusive inspection, 10 Radiography scans (i.e., full coverage as the area ratio of each scan is 10% of the asset's surface area), perform a full replacement if no damage is detected, and perform a local repair if damage is detected. In this case, the cost of failure is high, the expected area of local corrosion is small and not easily detectable with UT, and the Radiography inspections are most cost-effective. The total expected utility here, prior to implementing the strategy, is −$166,000.

Similarly, if all input variables are kept the same, but the failure cost is reduced by two orders of magnitude to $50,000, then the resulting optimal strategy is to do absolutely nothing (i.e., conduct no inspections, do not repair or replace anything, and to let it fail, since the cost of failure is less than the cost of finding the damage with any technique). The total expected utility for this case is −$10,000.

Finally, if the original cost of failure of $5 million is used, and the expected area of local corrosion is increased to 20%, then spot UT inspections are justified, and the optimal number is 21. Here, it is recommended to do one follow-up inspection with Radiography at the location of the minimum reported thickness to verify the true minimum was found, then just like before, replace if it is not detected and locally repair if it is detected. The total expected utility for this case is −$105,000. There is not a simple fixed optimal decision strategy, as the best choice depends on the inputs and underlying assumptions. This is why simple rules do not suffice and a network like that used in the present methods is required. For the purpose of illustration, it was assumed that many of the inputs were known precisely, whereas in reality, such input values may not be so well known, and their uncertainties would have been accounted for.

### Life Cycle Optimization of Spent Nuclear Fuel Dry Storage Containers

In an embodiment, the disclosure is directed to probabilistic, causal network methods for predicting the time-evolution of damage, as well as life cycle decision optimization methods (i.e., also using causal networks) to optimize the vast array of decision strategies available. In an embodiment, the methods may be applicable to predicting optimal maintenance plans for these nuclear fuel dry storage containers. The development of this predictive model involved extensive research and laboratory experiments for model inputs, calibration, and validation.

In the nuclear industry, when spent nuclear fuel (SNF) is removed from the nuclear reactor it is initially placed into a wet storage pool for a few years until it cools sufficiently, such that it is not excessively generating heat as the nuclear fuel further decays. There are not enough wet storage pools to store SNF indefinitely, so at some point they must be removed from wet storage and sealed inside of a metallic canister for permanent long-term dry storage. The canisters are commonly made of welded stainless steel (i.e., SS304L and SS316L) and come in both horizontal and vertical storage configurations. The canisters are backfilled with inert gas and placed inside of a concrete cask for passive cooling from ambient air. The ambient air enters the cask near the bottom and rises through the cask and out of vents near the top due to natural convection.

When the SNF is first loaded into the dry canisters, it is too hot for condensation to occur, but after some duration of nuclear decay, it becomes cool enough for condensation to occur. Additionally, the passive ambient air that is used for cooling will deposit dust and salts on the canister if they are present in the air. These deposited salts increase the tendency for condensation due to moisture uptake (i.e., deliquescence). If excessive salts are deposited on the canister, near the high residual stress weld regions, and deliquescence forms highly concentrated salt droplets, then local corrosion (i.e., pitting) can initiate. If pitting continues to sufficient depths, and stress concentrates develop along the pit, then stress corrosion cracking can initiate.

As a result of all this complexity, a more predictive model was needed for the time-evolution of pitting initiation, pitting growth, stress-corrosion-cracking (SCC) initiation, and SCC growth on these canisters, so that remediation actions can be taken prior to through-wall penetrations. A through-wall crack will potentially result in the release of radioactive material to the environment, which would have a significant negative consequence to the environment, nearby public health, and industry reputation. Aside from predicting when failure will occur and reactively remediating the problem, the same predictive model may also be used for inferring improved design choices and justifying the need for future research and technology development.

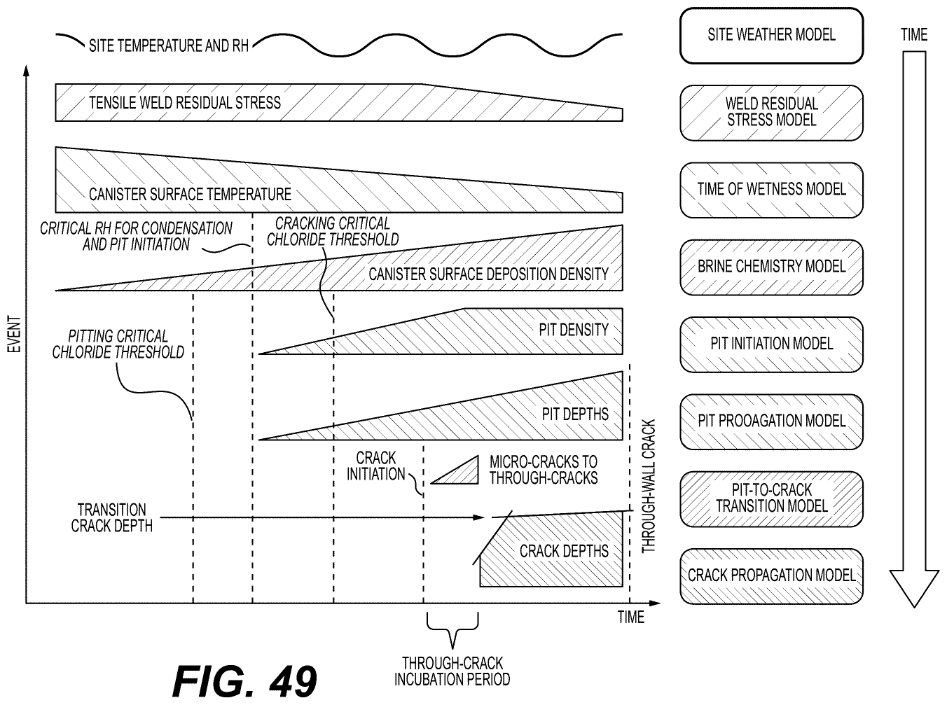

FIG. 49 shows a model flowchart illustrating the probabilistic causal network method developed for determining the damage rate and failure time distribution of the SNF dry storage canisters subject to chloride-induced SCC. The individual boxes in this diagram highlight the various stages of the model and the sequential ordering of the solution procedure. The relative time period associated with each model stage is reflected by the illustrated lengths. The precursory stages to damage progression include the Site Weather Model for temperature, relative humidity, and dew point, the Weld Residual Stress Model to get the stress state in the weld regions, the Time of Wetness Model to simulate salt deposition followed by deliquescence and condensation, and the Brine Chemistry Model to simulate the time-evolution chemistry of the condensed droplets. The damage progression stages include Pit Initiation, Pit Propagation, Pit-to-Crack Transitions, and subsequent Crack Propagation until a crack is either arrested or propagates to through-wall penetration. Failure for this application is defined as a through-wall penetration.

All inherent uncertainties are accounted for in the probabilistic causal network method. The numerical solution for the time-evolution of damage involved a Markov system for pit initiation and growth, followed by a differential equation system for SCC initiation and growth. For SCC growth the strain rate is related to the current density, leveraging experimental data. This complex numerical solution required a combined offline and online causal network approach, since it was too difficult to solve these systems of equations within the causal networks explicitly. Thus, a numerical algorithm was developed to solve these systems outside the networks that involved iterating through all input combinations via a Monte Carlo approach to generate the large CPT tables (i.e., offline approach) that are then fed back into the causal networks for decision optimization (i.e., online approach). In an embodiment, the present method may be directed to such a combined offline/online approach for solving complex problems via causal methods.

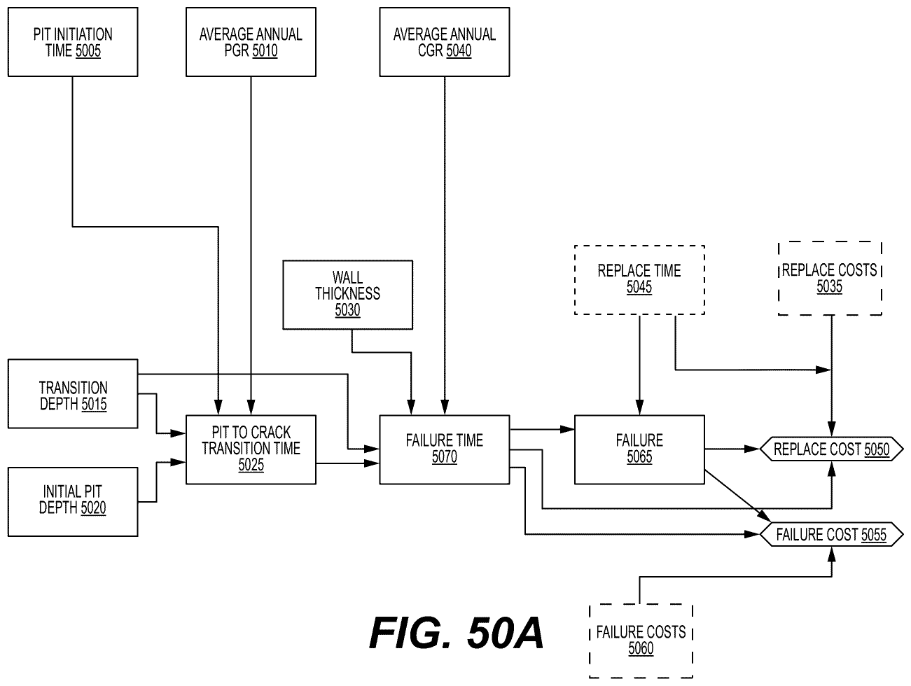

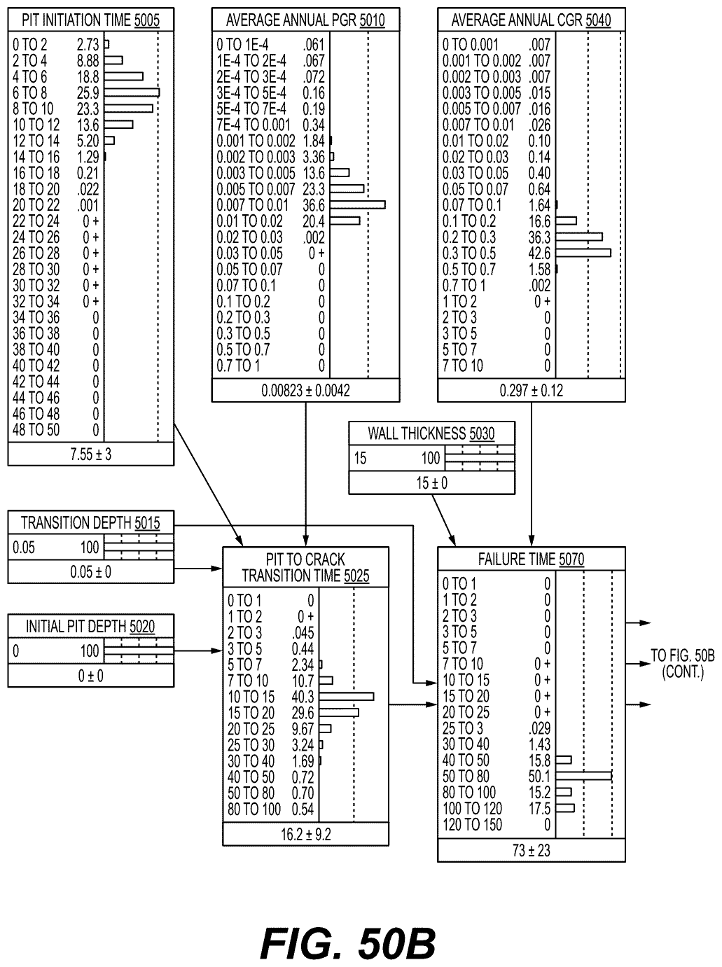

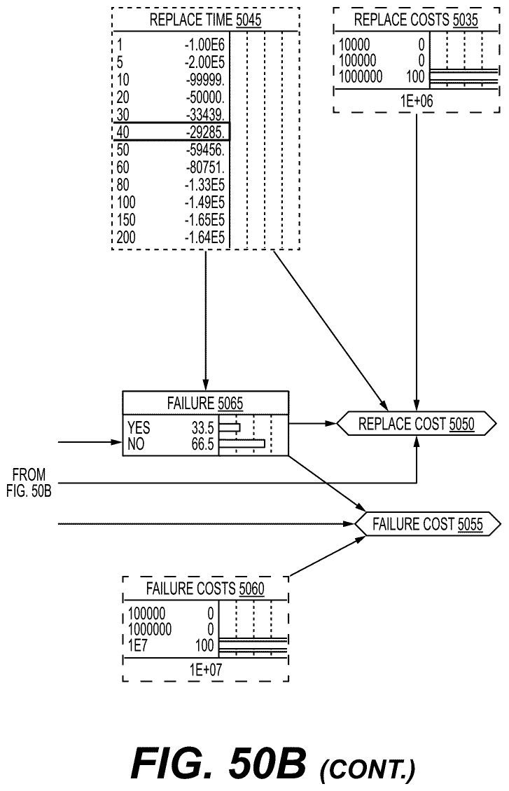

FIGS. 50A and 50B show a sample replacement only life cycle decision network for the SNF dry storage canister chloride-induced SCC application. FIG. 50A shows a simplified view of a sample replacement only life cycle decision network according to an embodiment of the disclosure. FIG. 50B shows a detailed view of the sample replacement only life cycle decision network of FIG. 50A, wherein the network is for the SNF application showing the failure time predicted from the core variables of the model. The network comprises nodes for Pit Initiation Time 5005, Average Annual PGR 5010, Pit to Crack Transition Time 5025, Transition Depth 5015, Initial Pit Depth 5020, Average Annual CGR 5040, Wall Thickness 5030, Failure Time 5070, Failure 5065, Replace Time 5045, Replace Costs 5035, Replace Cost 5050, Failure Cost 5055, and Failure Costs 5060. The only decision node in this network (i.e., the one being optimized) is Replace Time. The utility nodes are Replace Cost and Failure Cost. The remaining nodes are other intermediate random-variable nodes. The key random-variable for determining the total expected cost is the Failure Time. The concept of offline conditional probability table generation is introduced here, in which alternate probabilistic methods are used outside of the network to determine the probability distributions for the highest-level input parameters (i.e., offline calculations). This includes all the random-variable nodes shown to get the final Failure Time distribution. Here, the mean Pit Initiation Time is 7.55 years, the mean Average Annual Pit Growth Rate is 0.00823 mm/yr, the mean Average Annual Crack Growth Rate is 0.297 mm/yr, the mean Pit to Crack Transition Time is 16.2 years, and the mean Failure Time is 73 years. For this specific case, as shown by the highlighted value on the Replace Time node, the optimal Replace Time is 40 years.

The networks in FIG. 50A-B illustrate a single decision strategy for this application (i.e., replacement time), whereas in reality, there are a series of strategies that must be considered throughout the life cycle. For example, there are additional decision strategies such as when to inspect and with what technique, when to repair, if ever, and with what technique, when to perform mitigation or remediation, and with what technique, and when to replace the entire canister due to ineffective alternate strategies and/or a canister damaged beyond repair. Subsequently, these networks can be used to determine additional strategies for which they were not initially intended, such as inferring improved designs, retrofitting existing designs, conducting gap assessments, and justifying the need for future research and technology. These strategies are evaluated using the asset management and life cycle optimization systems and methods developed herein.

### Corrosion Under Insulation

In an embodiment, the disclosure is directed to systems and methods using causal networks and implemented for managing corrosion under insulation (CUI). The industry has previously lacked a robust, insightful solution for managing CUI effectively. The only existing quantitative method available is that in API RP 581 for RBI, which is overly simplistic, not very predictive, deterministic, does not include jacketing failure in initiation time, assumes a constant coating failure time, does not explicitly model time-of-wetness, and is limited by all the core API RP 581 limitations noted previously. All other available existing or conventional methods are qualitative and extremely limited in predictability, are not time dependent nor dynamically updated (i.e., more design based), cannot forecast, and do not predict a damage rate or failure time.

There are many reasons why CUI is such a widespread problem. For example, facilities have miles of insulated piping and massive surface areas of insulated metallic assets; damage is hidden beneath the insulation, and one cannot see it during routine visual inspections; damage is extremely local with regards to total metallic surface area (e.g., only 0.1% of piping may have CUI, and the extent of damage across that 0.1% varies greatly); it is extremely costly to remove insulation and inspect everything; many of the insulated piping systems are difficult or impossible to access, requiring scaffolding and specialty crews/equipment, making them even more expensive to inspect; current codes and standards provide minimal requirements or guidance on specific focused inspection locations and guidelines for more thorough inspections, and they leave it up to the site/inspectors, which is not good enough and a leading reason for undetected CUI causing unexpected failure; most insulation system designs are poor with minimal quality assurance/control and ineffective coating systems not designed for CUI exposure; most plant insulation systems are old and unmaintained, implying CUI is prevalent, and it is extremely difficult for sites to catch up on CUI inspection and maintenance programs when they get behind; there are no available adequate software solutions to effectively manage it, as the existing software solutions attempt to apply common internal process-side inspection and maintenance management methods to insulated assets, and they are too physically different—these attempts have proven to be ineffective.

As a result of the numerous reasons for widespread CUI, there is a high frequency of unexpected leaks and failures, with excess inspection costs (i.e., excessive coverage and frequency) trying to locate and detect active CUI without enough prescriptive guidance. Implementing the asset management and life cycle optimization systems and methods, as described herein, helps users better understand precisely where CUI is occurring, and how fast it is degrading, such that users can act prior to failure and implement more effective inspection and maintenance programs.

The causal network method implemented for CUI is considered a special emphasis method that is fully probabilistic and based on all known cause-and-effect relationships for CUI. It properly accounts for all uncertainties, blends many disparate sources of knowledge and data together, allows for missing information, and dynamically learns as it goes along (i.e., gets smarter over time). This approach includes an improved prediction of locations susceptible to CUI on insulated piping, and the subsequent corrosion rate once it initiates, by using a complex, multi-factor, physics-based probabilistic causal network. By coupling the damage model with some definition of failure (i.e., pipe gets too thin), the present method allows for the prediction of an uncertain failure time probability distribution per location.

The physics-based core model for the prediction of failure time due to CUI depends on four direct causal factors, each of which then depends on many other causal factors in a hierarchical manner. The four direct causal factors comprise: the starting pipe thickness; the thickness at which the pipe fails; the initiation time for CUI, which depends on the time of failure for both the jacketing system (i.e., allowing moisture to enter the system) and the coating system (i.e., allowing moisture to contact the bare metallic pipe); and the effective corrosion rate, which is a weighted average of the corrosion rate while wet with that when dry, which depends on the time of wetness.

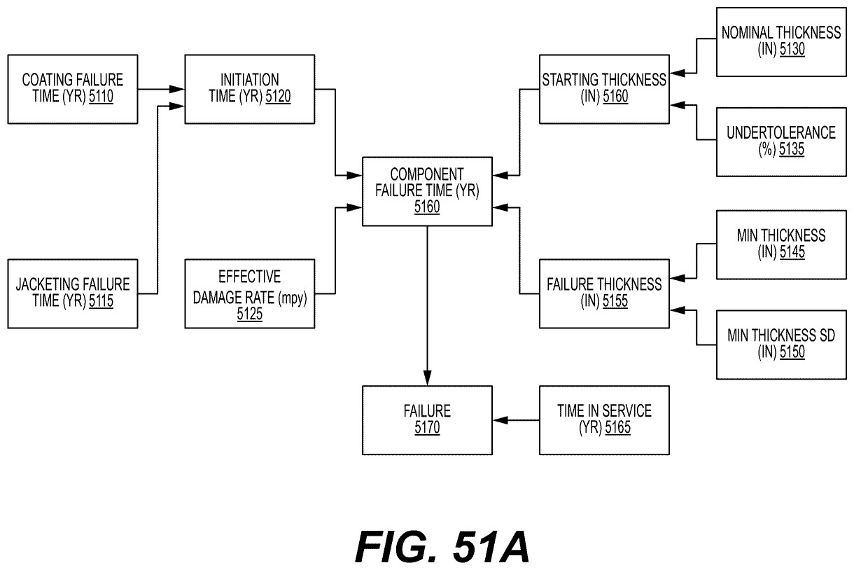

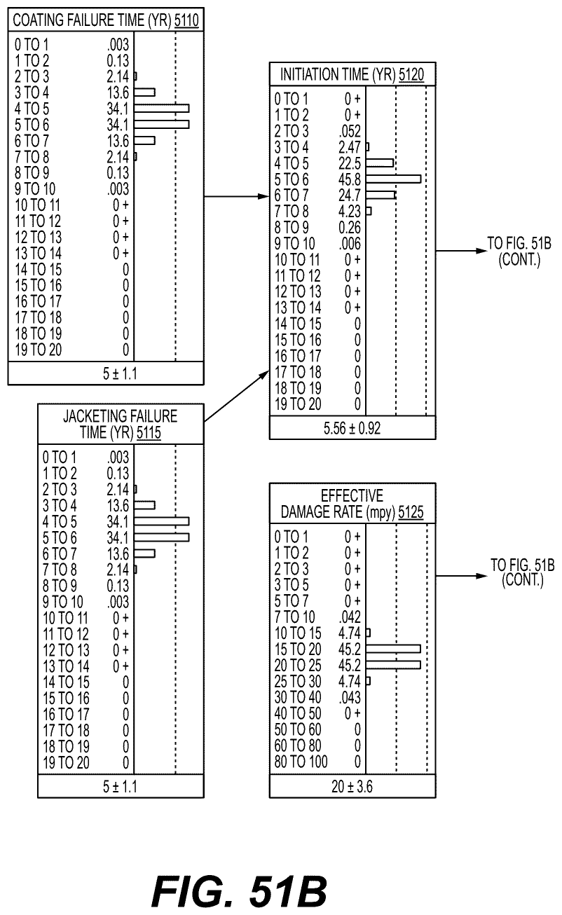

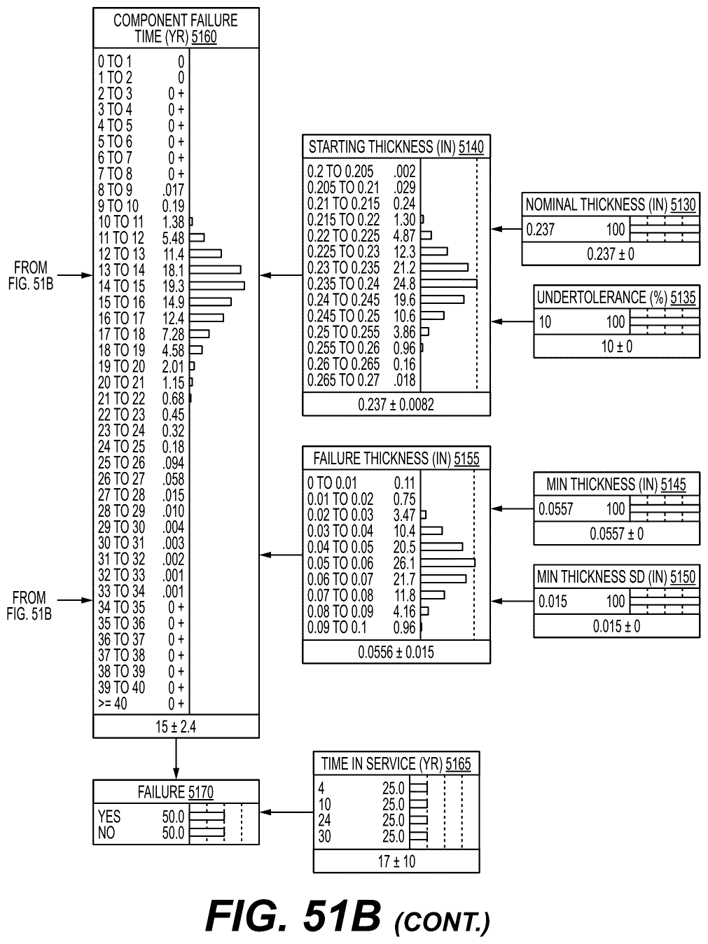

FIGS. 51A and 51B show a sample causal network for CUI according to an embodiment of the disclosure. FIG. 51A shows a simplified view of a CUI core causal network according to an embodiment of the disclosure. FIG. 51B shows a detailed view of the CUI core causal network of FIG. 51A illustrating the four primary causal factor nodes needed to predict the component failure time. The network comprises the nodes for Coating Failure Time (yr) 5110, Jacketing Failure Time (yr) 5115, Initiation Time (yr) 5120, Effective Damage Rate (mpy) 5125, Component Failure Time (yr) 5160, Failure 5170, Starting Thickness (in) 5140, Nominal Thickness (in) 5130, Undertolerance (%) 5135, Failure Thickness (in) 5155, Minimum Thickness (in) 5145, Minimum Thickness SD (in) 5150, and Time in Service (yr) 5165. The network illustrates the four primary causal factor nodes needed to predict the Component Failure Time, which are the Initiation Time, Effective Damage Rate, Starting Thickness, and Failure Thickness. The Effective Damage Rate is determined from a separate causal network and is driven primarily by the Time of Wetness and the Wet Corrosion Rate, both of which are heavily dependent on Temperature and Environmental Corrosivity. The Initiation Time is the maximum of the Coating Failure Time and Jacketing Failure Time, both of which are determined from separate causal networks with many hierarchical contextual nodes. The Starting Thickness and Failure Thickness are both random-variables input by the user. In this sample, the resulting mean Component Failure Time is 15 years with a standard deviation of 2.4 years. The mean Effective Damage Rate is 20 mils/yr, while the mean Initiation Time is 5.56 years.

The method further comprises suggesting the best possible actions to take at each CUI suspect location. The best possible actions are suggested by accounting for some combination of the following: the predicted failure time distribution at each location; the adjustment to the failure time distribution resulting from each possible action (e.g., visual inspection or non-destructive inspection, coating replacement, jacketing maintenance, local repair, etc.); the cost of failure; and the cost of each possible action.

The method may further comprise, when field data is available, using such field data to update various damage causal factors in the CUI predictive model. This may be done regardless of the time scale (e.g., moisture detection sensors update every second, operator rounds daily, drone monitoring monthly, external surveys yearly, prioritized follow-up inspections being scheduled and prioritized as needed, as well as system maintenance on an as-needed basis). This may be done via causal updating. The updating process for some types of field data may leverage a hybrid-AI solution methodology as described herein to extract features from the raw data that are then fed into and update the causal predictive networks.

Additionally, it is not likely that the coating failure time, jacketing failure time, initiation time, time of wetness, and corrosion rate will be precisely known. Thus, a plethora of hierarchical contextual information may be included in the network to predict the probability distributions for these random-variables, accounting for their inherent uncertainties. As such, the present methods blend disparate data that may either be consistent or conflicting.

A nonlimiting list of the majority of the contextual variables for prediction comprises coating type, coating designed for CUI or not, coating install quality, coating installed in the field or not, coating post install quality control, piping complexity, jacketing type, insulation type, jacket and insulation install quality, usage of high temperature silicon, protrusion design quality and ability to shed water, lap joint design quality, number of attachments, component type, UV exposure severity, pipe temperature, environment corrosivity, steam tracing presence and integrity, annual rainfall amount, steam vent exposure, cooling tower spray/mist, other direct exposures, insulation system design features allowing moisture to either accumulate or drain, etc.

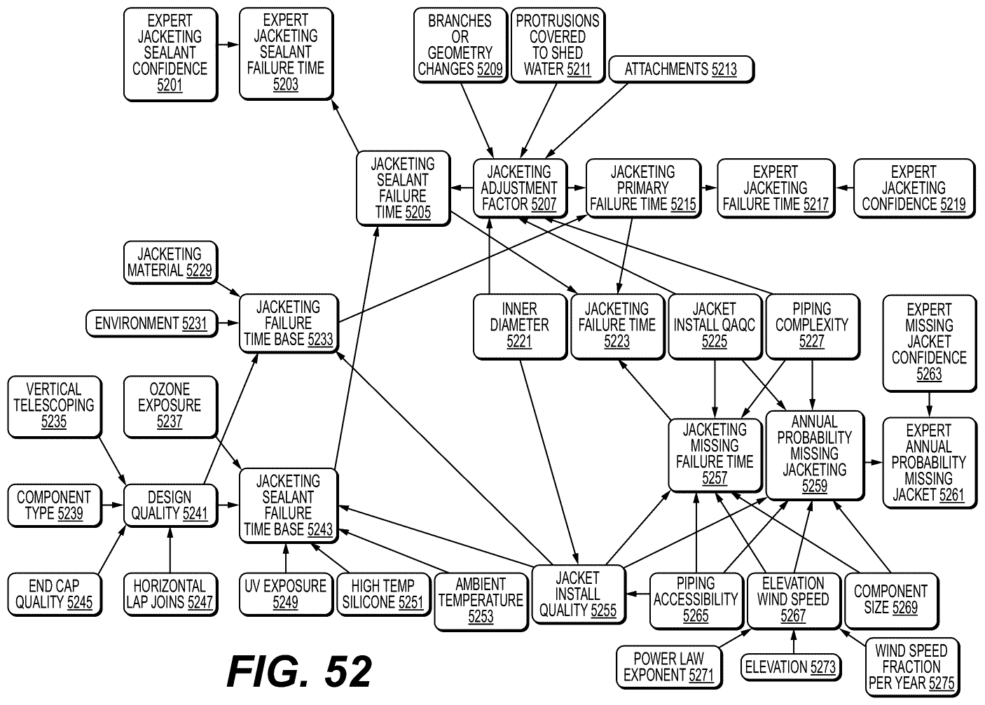

FIG. 52 shows a sample causal network with additional contextual information for predicting the Jacketing Failure Time distribution for CUI according to an embodiment of the disclosure. As shown in FIG. 52, contextual information comes from many variables that are either known from the system design or observed in the field during routine field inspections. The network comprises nodes for Expert Jacketing Sealant Confidence 5201, Expert Jacketing Sealant Failure Time 5203, Jacketing Sealant Failure Time 5205, Jacketing Adjustment Factor 5207, Branches or Geometry Changes 5209, Protrusions Covered to Shed Water 5211, Attachments 5213, Jacketing Primary Failure Time 5215, Expert Jacketing Failure Time 5217, Expert Jacketing Confidence 5219, Inner Diameter 5221, Jacketing Failure Time 5223, Jacket Install QAQC (quality assurance quality control) 5225, Piping Complexity 5227, Jacketing Material 5229, Environment 5231, Jacketing Failure Time Base 5233, Vertical Telescoping 5235, Ozone Exposure 5237, Component Type 5239, Design Quality 5241, Jacketing Selant Failure Time Base 5243, End Cap Quality 5245, Horizontal Lap Joins 5247, UV Exposure 5249, High Temp Silicone 5251, Ambient Temperature 5253, Jacket Install Quality 5255, Jacketing Missing Failure Time 5257, Annual Probability Missing Jacketing 5259, Expert Annual Probability Missing Jacket 5261, Expert Missing Jacket Confidence 5263, Piping Accessibility 5265, Elevation Wind Speed 5267, Component Size 5269, Power Law Exponent 5271, Elevation 5273, and Wind Speed Fraction Per Year 5275. The three failure modes for the jacketing are Jacketing Sealant Failure, Jacketing Primary Failure that includes corrosion and other design failure modes, and Jacketing Missing Failure that is primarily due to weather events and high wind conditions. Along with all the contextual information included to improve predictability of the various jacketing failure modes, there are also expert jacketing failure time nodes included for each mechanism to blend predictions with expert knowledge.

Separately, a nonlimiting list of the majority of the contextual variables for causal updating (i.e., via inspection and maintenance) comprises coating condition, jacket and jacket sealant condition, jacket missing or CML ports missing, IR hotspots detected before or after rain, wet insulation observed explicitly, local exposure sources noted, jacket design flaws, inspection POD, inspection finding, inspection measurement error, inspection measured thickness, other findings from either stripping insulation (i.e., intrusive inspection) or not stripping (i.e., non-intrusive inspection), past maintenance records for insulation system repair and replacement, coating repair and replacement, component repair and replacement, and other events noted (such as severe weather events, past port inspections, maintenance self-inflicted mechanical jacketing damage, past leaks/failures, and a historical clamp list).

In an embodiment, methods may further comprise providing a causal network for updating predictions via inspection and maintenance contextual information. The method may comprise predicting the expected damage state and extent at the time of the observation, and then entering evidence on the nodes for the observations to perform inference and get the updated and blended predictions.

These networks and the contextual information included may be used for baseline assessments but may dynamically evolve as new knowledge/data is gathered. The networks may be configured per-user based on specific CUI scenarios and the key factors that are impacting the CUI severities. Additionally, depending on the level of desired accuracy, methods may be implemented for CUI at varying levels of complexity that assume either a fixed average annual effective corrosion rate or a time-dependent effective corrosion rate. The time-dependence may be due to the progression of damage and the increase in the time-of-wetness due to increasing jacketing and coating damage extents.

Additionally, due to the massive surface area of insulated equipment in these aging facilities, the concept of circuitization and CMLs may also be used for CUI. While circuits are specific to CUI susceptibility, CMLs are grouped into circuits only if they have common susceptibilities and common root causes (e.g., similar pipe temperature histories, similar time of wetness, similar design and design quality, and similar environmental exposures). Such methods of using separate grouping methodologies for external damage versus internal process-side damage differ from traditional approaches. Historically, the industry has attempted to use a single grouping methodology for both internal and external damage with little success, as the basis for the grouping is internal process-side damage mechanisms and not for external damage mechanisms (e.g., CUI). The same approach and systems and methods described herein may be applied to external damage of uninsulated assets and supplementary components such as pipe supports, hangers, and valves.

The predictive causal network methods for CUI (i.e., used to get the predicted exposure fraction, jacket failure time, coating failure time, initiation time, component damage rate, and component failure time) are then used for subsequent life cycle decision optimization. Samples of the life cycle decision strategies considered are noted in the output summary table shown below in Table 6 (e.g., do nothing or run to failure, replace everything including the component and complete insulation system, replace just the complete insulation system, replace just the jacketing, replace just the coating, reseal the jacketing).

TABLE 6
Sample Output Table for Life Cycle Decision Optimization of CUI Maintenance Strategies

| | | Recoat | | Rejacket | | Reseal | Replace | Total |
|---|---|---|---|---|---|---|---|---|
| | | Time | | Time | | Time | Time | Return |
| Strategy | Recoat | (years) | Rejacket | (years) | Reseal | (years) | (years) | ($ USD) |
| Replace Only | N/A | N/A | N/A | N/A | N/A | N/A | 20.000 | 0.744 |
| Recoat Only | Yes | 10 | N/A | N/A | N/A | N/A | 25.000 | 1.046 |
| Rejacket Only | N/A | N/A | No | N/A | N/A | N/A | 20.000 | 0.743 |
| Reseal Only | N/A | N/A | N/A | N/A | No | N/A | 20.000 | 0.743 |
| Recoat and Rejacket | No | N/A | No | N/A | N/A | N/A | 20.000 | 0.743 |
| Recoat and Reseal | Yes | 10 | N/A | N/A | Yes | 10 | 25.000 | 1.071 |

For each maintenance action, the effect on the POF is simulated, and then the resulting failure time distributions before and after each action are used to determine the optimal time for performing the action.

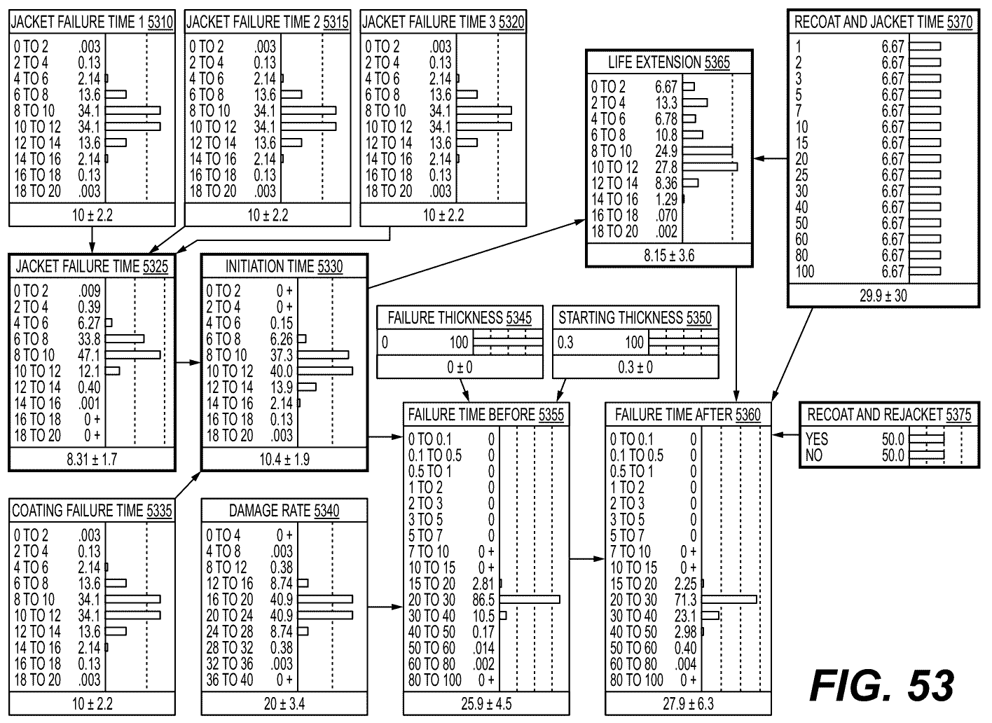

FIG. 53 shows a sample probabilistic causal network according to an embodiment of the disclosure for determining the Failure Time After and Life Extension probability distributions for any maintenance event. In particular, FIG. 53 shows a sample stage 1 of 2 probabilistic causal network according to an embodiment of the disclosure used to perform maintenance strategy simulations and determine the resulting life extension and failure time before/after maintenance for all possible maintenance times. Here, the network is illustrated for CUI, and the maintenance strategy being considered is the time to perform a Recoat and Rejacket. The network comprises the nodes for Jacket Failure Time 1 5310, Jacket Failure Time 2 5315, Jacket Failure Time 3 5320, Jacket Failure Time 5325, Coating Failure Time 5335, Initiation Time 5330, Damage Rate 5340, Failure Thickness 5345, Failure Time Before 5355, Starting Thickness 5350, Failure Time After 5360, Life Extension 5365, Recoat and Rejacket Time 5370, and Recoat and Rejacket 5375. To use this network, evidence is set iteratively for all states of the Recoat and Rejacket Time node, one by one. For each iteration, the resulting Life Extension and Failure Time After probabilities are determined and stored for future use in the subsequent decision network. This results in a CPT table for these nodes in which each row represents a separate Recoat and Rejacket time.

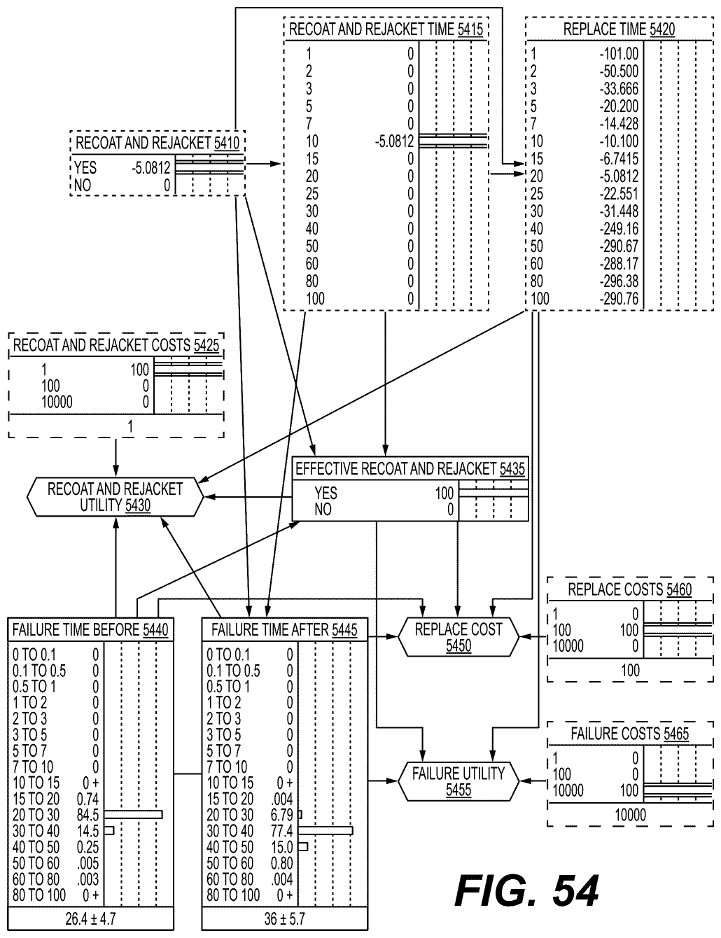

FIG. 54 shows a sample probabilistic causal network according to an embodiment of the disclosure for the second stage of decision optimization for the CUI example. In particular, FIG. 54 shows a sample stage 2 of 2 probabilistic causal decision network according to an embodiment of the disclosure used to determine the optimal maintenance strategy, for the strategy being considered, with the outputs from stage 1 used as inputs here. Here, the Failure Time Before and Failure Time After nodes have their CPTs calculated from the previous network illustrated in FIG. 53. The network comprises the nodes for Recoat and Rejacket 5410, Recoat and Rejacket Time 5415, Replace Time 5420, Recoat and Rejacket Costs 5425, Recoat and Rejacket Utility 5430, Effective Recoat and Rejacket 5435, Failure Time Before 5440, Failure Time After 5445, Replace Cost 5450, Failure Utility 5455, Replace Costs 5460, and Failure Costs 5465. The hierarchical decision strategy in this network is whether or not to Recoat and Rejacket, and then if so, when is the Recoat and Rejacket Time, and, regardless, what is the optimal Replace Time for the entire system. These are represented by three decision nodes in the network. The three utility nodes are Recoat and Rejacket Utility, Replace Cost, and Failure Utility. The remaining nodes are auxiliary random-variable nodes. In this example the optimal decision strategy is to Recoat and Rejacket at 10 years and then Replace 5 years later for a total of 15 cumulative years in-service, as illustrated by the circled utilities.

### Pressure Relief Devices

In an embodiment, the disclosure is directed to systems and methods described herein using causal networks and implemented for pressure relief devices and systems. Because predictive models are not currently available for damage to pressure relief devices and systems, the method defined previously for causal updating of EVA POF curves is used. However, the distribution parameters are still learned as new inspection, maintenance, and failure data is gathered. Also, note that the same approach used for CML optimization and circuitizing CMLs based on similar metallurgy, service, and corrosivity, can be used here for PRDs to group PRDs of similar types and similar services. This makes the priors more predictive, especially for PRDs without much inspection and maintenance data, and for new PRDs added to existing services. This same approach applies to any aging asset with an unknown or difficult to physically predict damage mechanism, e.g., for machinery, structures, rotating equipment, etc.

### Heat Exchanger Tube Bundles

In an embodiment, the disclosure is directed to systems and methods described herein using causal networks and implemented for heat exchanger tube bundles. The systems and methods comprise providing the causal POF updating method for mechanical integrity. The method further comprises accounting for another key feature of the bundle life cycle, which is fouling. It is common for units to be shut down to perform fouled tube cleaning operations regardless of mechanical integrity risk. When the bundle tubes become fouled, the unit cannot maintain temperatures, pressures, and flow rates necessary for production. Thus, the present life cycle optimization methods also address optimization of bundle cleaning operations and related maintenance.

This is a two-stage process, where inspection data is coupled with causal methods to determine the probability of each tube being fouled. Given this probability and associated risk, optimal decisions are recommended with regards to which tubes to clean and how to clean them (i.e., the cleaning procedure that makes the cleaning operation most effective). Prior to this, the methods determine the optimal time to shut down and perform bundle cleaning. After cleaning, subsequent inspection data is coupled with causal methods for assessing asset integrity, damage rate, and remaining life. These updated predictions are used to update life cycle decision optimization related to future operations, process, inspection, and maintenance strategies.

For predicting fouling, a probabilistic nonlinear fouling model is used with three types of fouling (i.e., gravitational, diffusive, and turbulent). Causal updating is used for probabilistically updating the fouling extent. For tube bundle life cycle optimization, all maintenance strategies are included, such as full bundle replacement, installing a spare bundle, full retube, single or multiple retubes, and plugging tubes. The life cycle decision networks for determining these optimal strategies are the same structure as the ones shown previously for CUI, but with alternate strategies and life extensions or age reductions.

For this example, there are many scenarios that result in excess error for all field operations including inspections for fouling, cleaning operations, inspections for asset integrity, and subsequent maintenance actions. The method may further comprise using image processing embedded within the method to detect geospatial locations of all tubes via visual imagery (e.g., from a phone/tablet) or via Augmented Reality (AR) or Virtual Reality (VR) technology (e.g., integrated into VR goggles) to facilitate the inspector conducting the field work. Additionally, the method may be used with robotic techniques to automate both inspection and cleaning operations.

### Tank Bottoms

In an embodiment, the disclosure is directed to systems and methods described herein using causal networks and implemented for tank bottom applications. The energy industry has vast tank farms for storing feedstocks and finished products that are typically metallic and all susceptible to damage (i.e., mostly thinning of the bottom and courses, cracking at the weld seams, and settlement in soil due to the weight of the filled tank and supplemental loads). Historically, the industry has relied on full coverage out-of-service tank bottom inspections. However, due to advances in robotic inspection technology and a growing interest to maximize availability of storage and minimize cost (i.e., due to both inspection and down time), the industry is transitioning towards partial coverage robotic in-service tank inspections. Such inspections are costly, especially for large tanks, so there is typically a compromise to limit the total time that the robot is inside the tank, resulting in limited inspection coverage. Moreover, the ultrasonic inspection techniques traditionally used have POD and measurement error limitations. As a result, the data retrieved from the inspection needs to be statistically analyzed to determine if the tank is fit for service or not.

The systems and methods described herein may be used for such tank bottom inspection analysis. In an embodiment, a method is provided comprising using a probabilistic causal network for the workflow of planning the optimal inspection coverage area for the inspection to either have confidence that no damage is in the uninspected areas given that damage was not found in the inspected areas, or that some number of damaged locations are found such that a follow-up EVA assessment can be performed.

In another embodiment, a method is provided comprising using a probabilistic causal network for the workflow of the post-processing statistical assessment of damaged regions that have been found using EVA to project the maximum expected damage in the uninspected regions from partial coverage inspection data. For such a method, the coverage area of the inspection depends on the tank size but typically ranges from 5-30%.

When performing a purely statistical EVA assessment, enough data points are required to ensure the resulting fit has low enough variance for extrapolation to the uninspected regions. The present systems and methods may further be used for such EVA. In contrast, when using the present methods and probabilistic causal networks for such EVA, prior probabilities are used for all the distribution parameters, such that the posterior probability can be inferred from even no inspection data. Also, the present systems and methods may allow for parameters to be in place for measurement error, POD, probability of local corrosion, and others to account for various aspects of the problem.

The above baseline assessment assumes that the entire metallic tank surface area being analyzed has a similar corrosion rate with similar statistical properties. To further extend these capabilities, the present systems and methods may use a hybrid-AI approach to identify clusters in the inspection data, define the individual clusters as separate regions to be analyzed, analyze each cluster separately, and then group the clusters all together hierarchically to see if any statistical knowledge can be shared across the clusters. Such analysis may be conducted using probabilistic causal networks according to methods described herein.

Additionally, if there is knowledge of the type/mode of corrosion that is occurring, due to the metallurgy, chemistry, and operations, the present method may further comprise building a physical predictive causal network for the damage rate as well, which will better inform the prior distribution and identify locations of varying damage extent. Nonlimiting examples of the type or mode of corrosion comprise microbiologically induced corrosion, under deposit corrosion, local cell corrosion, etc. Such models may also account for tank surfaces that are coated or lined, tank bottoms that are cathodically protected, and tanks that use inhibitors to either protect the metallic surfaces or reduce the corrosivity of the process.

A method like CML optimization may be used for tank applications. For example, such a method may be particularly helpful for tanks that have limited inspection data and/or facilities that have thousands of tanks. The method comprises circuitizing tanks of similar metallurgy, process, and operations, such that information may be shared across the tanks for determining the probability distributions of the model parameters. The method may further comprise grouping tanks and sharing knowledge across facilities. This is particularly useful for large organizations. By doing so, the method ensures that there are predictions for the entire life cycle of the tank, from design and new installation to end-of-life. Throughout the life cycle, the predictions continuously learn as new data is gathered and knowledge is shared across the organization.

### Structural Health Monitoring

In an embodiment, the disclosure is directed to systems and methods described herein using causal networks and implemented for structural health monitoring. Structural integrity is different from mechanical integrity in that the structure is not a pressure containing vessel or pipe and is, instead, supporting a load with different loads and boundary conditions applied at different locations. However, structures may still fail, and when that happens, catastrophic consequences are possible.

Nonlimiting example structures for structural integrity monitoring comprise space vehicle launch pads; fuel storage vessel support structures; dock piers; transportation crossing structures; and buildings. Such structures are susceptible to various damage mechanisms that, if left unaccounted for, may result in structural failure. However, given that such structures are complex and different from normally managed industrial assets, a predictive prior damage mechanism model is often unavailable (e.g., concrete or wood deterioration of piers) or the damage mechanism that is most likely is uninspectable until failure has occurred (e.g., fatigue of launch pad structures). In the scenario where a predictive prior damage mechanism model is unavailable, the present systems and methods may be used to develop a physical causal network model, using structural health sensor data to infer the state of damage and damage rate for predicting remaining life, or a combination thereof. In the scenario where the damage mechanism that is most likely is uninspectable until failure has occurred, the present systems and methods may be used to monitor key model input parameters to more precisely predict remaining life.

As an example, the present systems and methods may be used for structural health monitoring for fatigue of a space vehicle launch pad, such as a rocket launch pad. The method may comprise considering challenges for launch pad fatigue. The challenges may comprise: that fatigue damage that is uninspectable and rapidly progresses from initiation to failure such that models rely on predicting the time to initiation; that fatigue damage nucleates across the structure such that once fatigue initiates in one location, it is likely to initiate in others nearby soon after; and that geometric discontinuities, welds, and defects are initiation-prone locations for fatigue. The method may further comprise providing solutions. For example, proposed structural health monitoring solutions for fatigue may comprise leveraging existing fatigue models for low, high, and vibration-induced fatigue and extending them to be fully probabilistic with causal networks; training the model on historical failure data from similar assets; coupling with a FEA model to predict the drivers for fatigue across the entire asset; installation of inspection sensors for measurable variables like strain rate, temperature, and pressure; life cycle decision optimization methods for all possible life cycle strategies to prevent catastrophic failure and maximize total life cycle ROI; or any combination thereof.

### Automated Inspection Grading

In an embodiment, the disclosure is directed to systems and methods described herein using causal networks and implemented for automated inspection grading. In contrast to traditional methods, using the hybrid-AI methods described herein allows for performing immediate automated grading as soon as new inspection reports are uploaded. Traditionally, facility inspections are stored as text-based records or reports. Reviewing and then summarizing the raw inspection reports following established code-based rules for inspection grading is a time-consuming and tedious process. Additionally, there is human bias in the grading process due to engineers rushing the process, skimming the records, failing to interpret the comments, or not fully understanding or implementing the rules properly. Traditionally, it takes 3 minutes, on average, to review, summarize, and grade each inspection report. Every year, there are thousands of such reports in a single facility, resulting in over 3,000 minutes (i.e., a full business week) to grade them all. Additionally, a qualified engineer is required for grading, and hiring such engineers typically adds a cost of about $200/hr. This all results in a high per facility cost of about $8,000 per year.

In the present methods, all industry, corporate, and facility inspection records that were previously graded by a human are stored in a secure cloud database for training the first part of the hybrid-AI model. The training involves natural language processing (NLP) to extract key features as inputs to the causal network for automated inspection grading. The causal network encodes the inspection effectiveness grading rules, which involves many inputs defined by the rules as well as the probabilistic relationships to determine the grades.

Higher-level contextual information may be added to the causal networks to infer the unknown inputs, if there are any. The unknown inputs are simpler-to-answer inputs more common to the end user. Beyond automating the process, another benefit of such an approach is to properly account for uncertainty while not requiring all inputs to be specified precisely (i.e., the method is still predictive, even with missing or uncertain inputs).

As an example, such automated inspection grading may be applied for local thinning inspection effectiveness per API RP 581. A sample local thinning inspection effectiveness grading table is shown in Table 7. Assumptions for the table include percentage coverage in non-intrusive inspection includes welds; follow-up inspection can be UT, pit gauge, or suitable NDE techniques that can verify minimum wall thickness; and profile radiography technique is sufficient to detect wall loss at all planes.

TABLE 7
Sample Inspection Effectiveness Table for Local Thinning Inspections

| Inspection | | |
|---|---|---|
| Effectiveness | | |
| Category | Intrusive Inspection | Non-Intrusive Inspection |
| A | For the total surface area: | For suspect areas: |
| | 95-100% visual examination (with | 95-100% AUT or manual |
| | removal of internal packing, trays, etc.), | ultrasonic scanning, |
| | AND | or profile RT. |
| | 100% follow-up using UT/RT at locally | |
| | thinned areas | |
| B | For the total surface area: | For suspect areas: |
| | 75-94% visual examination, | 50-94% AUT or manual |
| | AND | ultrasonic scanning, |
| | 100% follow-up using UT/RT at locally | or profile RT. |
| | thinned areas | |
| C | For the total surface area: | For suspect areas: |
| | 50-74% visual examination, | 20-49% AUT or manual |
| | AND | ultrasonic scanning, |
| | 100% follow-up using UT/RT at locally | or profile RT. |
| | thinned areas | |
| D | For the total surface area: | For suspect areas: |
| | 20-49% visual examination, | <20% AUT or manual |
| | AND | ultrasonic scanning, |
| | 100% follow-up using UT/RT at locally | or profile RT. |
| | thinned areas | |
| E | Less than “D” effectiveness, no inspection, | Ineffective technique |
| | or ineffective inspection technique used. | used or no inspection. |

For implementation, the training inspection records are tagged with the input variables (i.e., features) in the causal network, rather than the grades themselves. If grades are available from past engineering work, these past grades are used for verification and validation. The method may be implemented not just for RBI, but for all asset integrity methods incorporated into the system. Different levels of inspection effectiveness imply different qualities of inspection for both sizing and detection with specific ranges of measurement error, POD, and coverage area. If the precise values corresponding to inspection effectiveness are known, these precise values may be used in the damage/failure methods directly.

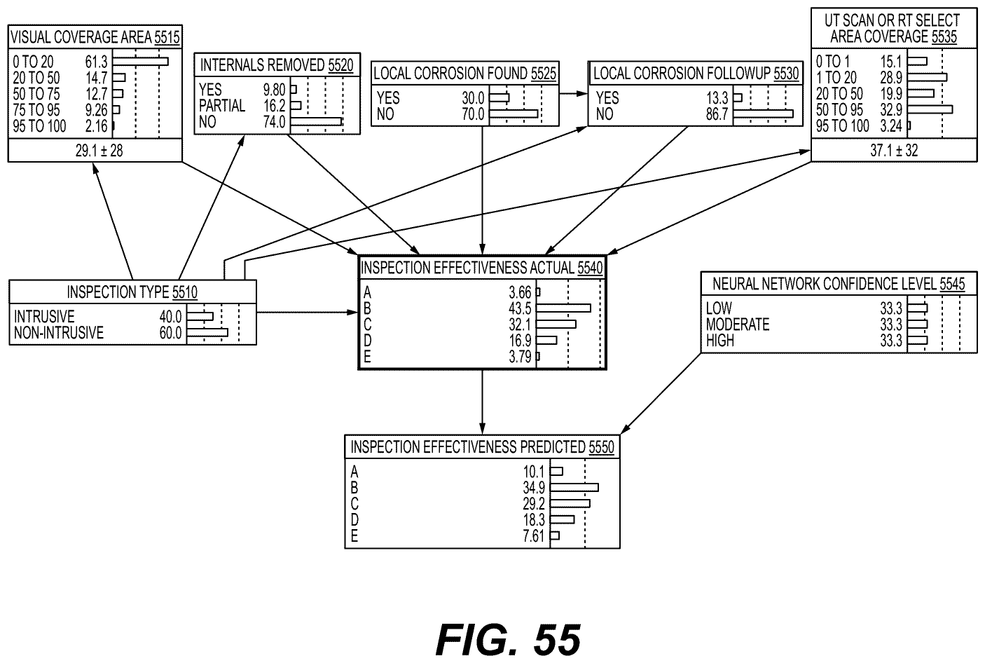

FIG. 55 illustrates a sample probabilistic causal network according to an embodiment of the disclosure. The network shown is for performing inspection grading that incorporates the inspection grading rules of Table 7. This specific network is for the standard local thinning inspection effectiveness table in API RP 581. However, any inspection effectiveness logic may be encoded into such a network. The nodes shown in FIG. 55 include Visual Coverage Area 5515, Internals Removed 5520, Local Corrosion Found 5525, Local Corrosion Followup 5530, UT Scan or RT Select Area Coverage 5535, and Inspection Type 5510, which feed into the node of Inspection Effectiveness Actual 5540, which then feeds into the Inspection Effectiveness Predicted 5550 node (i.e., the final result) along with the Neural Network Confidence Level 5545 node.

In an embodiment, systems and methods described herein may further comprise additional hierarchical nodes to account for other contextual information that may help predict the primary causal nodes if they are not readily known. The resulting Inspection Effectiveness Predicted is not a precise value as there are uncertainties in all of the model inputs. The most likely Inspection Effectiveness Predicted is a grade B with a probability of 34.9%.

In an embodiment, systems and methods described herein may further comprise additional higher level contextual questions to infer the inputs shown. For example, the inputs may be obtained from a hybrid-AI approach using NLP. The present systems and methods may comprise identifying the primary characteristics for NLP training and classification through review of past RBI consulting work and inspection record data typically provided by users. The primary characteristics may comprise: the likely damage mechanism; corresponding inspection effectiveness table to be used; inspection type or method; inspection extent or coverage area; if equipment internals were removed or not; if corrosion is detected or not; extent of detected corrosion and whether it is local or general; follow-up inspection results if it is local corrosion; measured minimum thickness; and additional inspection comments to include characteristics such as appearance, morphology, color, etc.

In an embodiment, the present systems and methods may comprise further enhancing the predictability of the network, through identifying additional questions and rules that may be considered, based on industry or subject matter expert experience. Nonlimiting examples of such questions and rules comprise: component type to ensure that the inspected component matches the modeled component and to identify coverage area and accessibility limitations; limited credit given for visual inspection through the manway without entering the vessel or removing internals; does the component even have internals or not, with regards to giving the user credit for removing them; is the vessel internally coated or lined, which would impact the ability to conduct an effective visual inspection; was scaffolding used, which would be required for large or elevated equipment; and is the service clean or dirty, which would also impact the ability to visually inspect the metallic surface.

Such primary and secondary questions may be automatically extracted from text-based inspection records using AI and NLP. The resulting extracted features may then be fed into the rule-based causal network to probabilistically grade the inspection and recommend actions. This generic workflow and process for grading inspections results in significant time-savings and improved accuracy and repeatability, while accounting for all inherent uncertainties.

### Incident Prioritization

In an embodiment, the disclosure is directed to systems and methods described herein using causal networks and implemented for incident prioritization. The incident prioritization method may automatically process, filter, and categorize facility incident reports with the aim of prioritizing actions taken in response to these incidents as well as developing appropriate key performance indicators (KPIs).

Facilities may have as many as 100,000 historical incident reports with hundreds or thousands of new incident reports received from operators every day. Manually processing and classifying all these reports is a very tedious, time-consuming, and labor-intensive process, and the present incident prioritization method improves upon such traditional approaches. In particular, the present system and incident prioritization method comprises providing a hybrid-AI tool that incorporates elements of NLP, and other techniques from the field of AI, with causal methods, to be more automated, consistent, and accurate than traditional methods. A key feature of the present method comprises the automatic categorization of incidents into leaks and then further categorizing by leak type (e.g. piping leak, bolted flange leak, etc.) to develop KPIs around types of leaks.

A wide class of methods may be used for the classification portion of the present method. A nonlimiting example of one classification method for use in the present prioritization method is referred to as Naive Bayes. Naive Bayes is a specific type of a broader class of solution methods based on causal networks. Causal networks are powerful tools for probabilistic inference, especially when information is uncertain and incomplete (e.g., diagnosing a disease from a set of symptoms). Answers are always presented in probabilistic terms, with more accurate and complete evidence leading to more reliable answers. Causal networks will always provide an answer, regardless of the quantity or accuracy of the inputs. The answer, or output, is a probabilistic classification prediction.

The present system and method for incident prioritization provides a solution to traditional problems of incident report categorization. The incident prioritization method comprises building a causal network to represent the rules for the categorization that have already been defined and others that are dynamically learned and updated over time. The baseline rule set represents “expert knowledge” that is encoded into the network as prior and conditional probabilities. The simplest network, consisting of a set of nodes for the categories and a set of nodes for the features or characteristics of those categories, leads to a Naive Bayes model, but this can be generalized to more complex networks as the rules get more complex. Because causal networks may be used to make all sorts of predictions beyond classification, this approach may be extended to many more advanced predictive capabilities.

A Naive Bayes model may be trained with large data sets consisting of features along with the known category that the features fall into, as established by a human expert. The feature set may be a set of words that appear in the Title, Event Description, or Immediate Action sections of the incident report. The context of the set of words may be important (i.e., which section they appear in, what part of a sentence the words are found in). Additional features besides the presence of words can also be taken into consideration, such as a combination of words in some grammatical structure. It is also possible to work with partial features (i.e., not all features need to be specified if there is missing data).

The causal network by itself does not do any NLP. The causal network is simply a conceptual network used for inference and categorization given a set of features. However, causal networks are probabilistic machine learning algorithms that learn and get smarter over time as new knowledge becomes available. To obtain evidence in the form of features for the classification problem, a set of NLP tools are used to process the text and extract the necessary information and its context. NLP is one area in the broad field of AI, and classification is one of the subtypes of NLP.

Taking a subset of tagged data, the NLP method trains a neural network to recognize underlying patterns in the data. The NLP methodology allows for an out-of-the-box solution when a subset of the data is well understood and there is a large enough amount of data available for training. This is a pre-processing step to the causal networks, where probabilistic and causal relationships are more concretely established to make decisions and recommendations about the vast collection of textual data.

As a first step for any categorization system, or incident reporting for various users, the present systems and methods comprise encoding the initial rule set into a causal network. The method further comprises testing that network by setting features and ensuring that the proper categorization is made when features are entered as exact evidence (i.e., by clicking on evidence in the graphical representation of the network). The present systems and methods may comprise baseline or default rules already encoded if a facility or user does not wish to use its own baseline or default rules. A combination of NLP methods may be used to process the text from the incident reports (e.g., pulled from a database or uploaded via a spreadsheet). The method further comprises setting the evidence in the causal network to perform probabilistic classification.

The evidence provided to the causal network may be entered as discrete probabilities based on the results of NLP. The system and method may be automated and may connect to user systems to allow for dynamic updates as soon as new incidents are reported. Additionally, as new data is gathered, the networks may be expanded and refined dynamically to reflect the current, most up-to-date state of knowledge for the entire facility. Such a hybrid-AI method may be implemented for all data gathered at the facility, including sensor data, thermography data, nondestructive inspection scans, and visual imagery.

While several embodiments of the present disclosure have been described and illustrated herein, those of ordinary skill in the art will readily envision a variety of other means or structures for performing the functions, obtaining the results, and/or obtaining one or more of the advantages described herein. Each of such variations and/or modifications is deemed to be within the scope of the present disclosure. Those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. Any combination of two or more such features, systems, articles, materials, kits, and/or methods, if such features, systems, articles, materials, kits, and/or methods are not mutually inconsistent, is included within the scope of the present disclosure.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Indefinite articles “a” and “an” as used herein in the specification and in the claims, unless clearly indicated to the contrary, should be understood to mean “at least one.”

The phrase “and/or” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. As a non-limiting example, a reference to “A and/or B,” when used in conjunction with open-ended language such as “comprising” can refer, in one embodiment, to A without B (optionally including elements other than B); in another embodiment, to B without A (optionally including elements other than A); and in yet another embodiment, to both A and B (optionally including other elements).

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one” in reference to a list of one or more elements should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. As a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A probabilistic, physics-based, causal method for predicting the evolution of damage and failure time of an aging asset comprising:
providing a probabilistic, physics-based, causal network, comprising a plurality of random-variable nodes, wherein the nodes represent at least one of:
damage initiation time,
damage state,
damage rate,
damage causal factors,
observations,
human expert knowledge,
failure state, and
failure time;
applying the probabilistic physics-based causal network to an aging asset; and
predicting the evolution of damage and failure time of the aging asset.

2. The method of claim 1, wherein each node in the plurality of random-variable nodes comprises one or more probabilistic states representing discrete numerical values, continuous numerical ranges, or categorical values.

3. The method of claim 2, wherein the aging asset comprises:
one or more aging components; and
zero or more aging damage barriers that are used to inhibit aging of the components.

4. The method of claim 3, wherein the aging asset, aging components, and aging damage barriers are aging due to the evolution of damage over time from one or more damage mechanisms resulting in one or more damage defects.

5. The method of claim 4, wherein the evolution of damage over time is represented by a time-dependent, spatial distribution of damage comprising one or more damage-state nodes at one or more locations on the aging components.

6. The method of claim 5, wherein time-dependent state probabilities of one or more damage-state nodes depend on one or more damage-initiation-time nodes and one or more damage-rate nodes.

7. The method of claim 6, wherein the one or more damage-initiation-time nodes and the one or more damage-rate nodes depend on zero or more damage causal factor nodes.

8. The method of claim 1, wherein the failure time node comprises an aging asset failure time node, an aging component failure time node, or an aging damage barrier failure time node, wherein the failure time node comprises states representing discretized time intervals with the probability of each state being the probability that failure occurs during that time interval.

9. The method of claim 8, wherein the probability of failure (POF) of the aging asset, aging component, or aging damage barrier during a time interval is the probability that a failure state condition is met during the time interval, wherein the failure state condition depends on the state probabilities of one or more damage-state nodes.

10. The method of claim 9, wherein the failure time of the aging asset comprises a minimum failure time selected from failure times of the aging components.

11. The method of claim 10, wherein the failure of the aging damage barrier influences the one or more damage-initiation time nodes and damage-rate nodes.

12. The method of claim 1, wherein the damage causal factor nodes comprise:
physical, mechanical, chemical, and thermodynamic properties of the aging asset, aging components, and aging damage barriers; or
physical, mechanical, chemical, and thermodynamic properties of an environment that the aging asset, aging components, and aging damage barriers are exposed to; or
planned actions that alter physical, mechanical, chemical, or thermodynamic properties of the aging asset, aging components, aging damage barriers, or a combination thereof, or environment of the aging asset, aging components, aging damage barriers, or a combination thereof; or
unplanned events that alter physical, mechanical, chemical, or thermodynamic properties of the aging asset, aging components, aging damage barriers, or a combination thereof, or environment of the aging asset, aging components, aging damage barriers, or a combination thereof; or
any combination thereof.

13. The method of claim 1, wherein the observation nodes comprise observations of one or more damage causal factor nodes, one or more damage state nodes, or one or more failure time nodes.

14. The method of claim 13, wherein the observations are gathered using detection or measuring methods by a mechanical device or human, at one or more points in time.

15. The method of claim 13, further comprising a time node and an uncertainty node for each observation.

16. The method of claim 1, wherein the human expert knowledge nodes comprise knowledge about one or more damage causal factor nodes, one or more damage state nodes, one or more damage-initiation-time nodes, one or more damage-rate nodes, or one or more failure time nodes.

17. The method of claim 16, further comprising an error, variance, or confidence node representing a confidence in the human expert knowledge.

18. The method of claim 1, wherein the probabilistic, physics-based, causal network infers the state probabilities of nodes in the network from state probabilities set on other nodes in the network.

19. The method of claim 1, wherein the method further comprises extending the probabilistic, physics-based, causal network to comprise a plurality of decision nodes representing decisions that affect the state probabilities of random-variable nodes in the network.

20. The method of claim 19, wherein the extended probabilistic, physics-based, causal network comprises a plurality of utility nodes representing conditional costs and benefits of decision nodes and random-variables nodes in the network.

21. The method of claim 20, wherein the method further comprises using the extended probabilistic, physics-based, causal network for optimizing aging asset life cycle management decision strategies for future actions by maximizing a total expected utility or a time-averaged expected utility.

22. The method of claim 1, wherein the method further comprises inspection effectiveness methods, comprising using one or more causal networks to account for measurement error, probability of detection, coverage area, or any combination thereof.

23. The method of claim 1, wherein the method further comprises blending multiple knowledge sources, wherein multiple knowledge sources comprise two or more of:
physics-based model predictions;
observations;
human expert knowledge; or
any combination thereof.

24. The method of claim 1, wherein the method further comprises sharing knowledge across a plurality of aging assets, from a plurality of facilities, from a plurality of industries, or any combination thereof.

25. The method of claim 1, wherein the aging asset further comprises:
damage from one or more damage mechanisms;
one or more flaws;
failure due to one or more failure modes; or
any combination thereof.

26. The method of claim 25, wherein the aging asset damage mechanisms comprise low temperature corrosion, high temperature corrosion, environmental corrosion, corrosion under insulation, contact point corrosion, microbiological corrosion, flow-induced corrosion, soil corrosion, low-cycle fatigue, high-cycle fatigue, vibration fatigue, crack initiation, crack growth, stress corrosion cracking, embrittlement, fracture, metallurgical attack, creep, high temperature hydrogen attack, other mechanical damage mechanisms, other chemical damage mechanisms, other electrochemical damage mechanisms, or any combination thereof.

27. The method of claim 1, wherein the method further comprises extreme value analysis (EVA) methods comprising:
using one or more causal methods to account for aging assets with complicated failure modes that have limited physics-based, predictive model availability.

28. The method of claim 27, wherein the EVA methods comprise:
defining a probability of failure (POF) of the aging asset in terms of an applicable EVA cumulative distribution function (CDF);
defining a corresponding probability density function (PDF) in terms of physics-based damage causal factors;
updating the PDF in real-time from observations comprising field data, inspection data, maintenance data, leaks, failures, other observations, or any combination thereof and from leveraging observation data from other aging assets;
using the updated PDF to predict an aging asset damage state; and
using the updated CDF to predict an aging asset failure-time.

29. The method of claim 1, wherein the method further comprises analytical and numerical solution procedures, or any combination thereof, wherein the analytical and numerical solution procedures are used for compilation, inference, and prediction, or any combination thereof.

30. The method of claim 21, wherein the method further comprises analytical and numerical solution procedures, or any combination thereof, wherein the analytical and numerical solution procedures are used for decision strategy optimization.

31. The method of claim 1, wherein the aging asset comprises:
an insulated aging asset;
an uninsulated aging asset;
a piping system, one or more pipes, one or more piping components, or any combination thereof;
a pressure vessel, a tower, a vessel, a drum, a tank, other fixed equipment, or any combination thereof;
a heat exchanger, cooler, heater, boiler, other heat transfer equipment, or any combination thereof;
a compressor, pump, turbine, other rotating equipment, or any combination thereof;
a pressure relief system, pressure relief valve, pressure relief device, or any combination thereof; or
any combination thereof.

32. The method of claim 20, wherein the method further comprises using the extended probabilistic, physics-based, causal network for risk-based inspection and maintenance planning comprising:
determining a consequences of failure (COF) including liquid fluid release and gas fluid release;
defining the COF as financial or non-financial and as absolute cost or relative cost;
calculating a time-dependent risk profile by multiplying the COF and probability of failure (POF);
simulating all inspection and maintenance strategies to determine a corresponding risk reduction before and after each strategy, and at all possible times being considered; and
performing facility-wide life cycle optimization to determine optimal asset inspection and maintenance decision strategies to maximize a facility-wide return on investment.

33. The method of claim 32, wherein the risk-based inspection and maintenance planning methods comprise determining the optimal inspection frequency, inspection technique, inspection location, inspection coverage area, other prescriptive inspection guidance, maintenance frequency, maintenance technique, maintenance location, other prescriptive maintenance guidance, or any combination thereof.

34. The method of claim 20, wherein the method further comprises using the extended probabilistic, physics-based, causal network for condition monitoring location (CML) optimization comprising:
accounting for all CML inspection techniques including ultrasonic testing, radiographic testing, visual inspection, pulsed eddy current testing, magnetic flux testing, other non-destructive testing techniques, or any combination thereof;
promoting CMLs to damage management locations (DML) once damage is detected;
further assessing a failure state of the detected damage via applicable fitness for service assessments;
simulating all inspection strategies, at all CMLs, to determine corresponding risk reduction before and after each strategy, at all CMLs, and at all possible times being considered; and
performing CML optimization to determine an optimal CML inspection strategy that maximizes a facility-wide return on investment.

35. The method of claim 34, wherein the CML optimization methods comprise determining optimal CML inspection frequency, CML inspection technique, CML inspection location, CML inspection coverage area, other prescriptive CML inspection guidance, or any combination thereof.

36. The method of claim 1, wherein the method further comprises combining probabilistic, physics-based, causal methods with statistical and data analysis methods for artificial intelligence (AI), comprising:
pre-processing raw data and observations by leveraging statistical and data analysis methods for AI for classification, clustering, trending, fitting, feature extraction, other data analysis techniques, or any combination thereof; and
using the pre-processed raw data and extracted features as inputs to the probabilistic, physics-based, causal methods.
